(19) United States
(12) Patent Application Publication
(10) Pub. No.: US 2025/0237163 A1
(43) Pub. Date: Jul. 24, 2025

(54) Turbine Dosing System with Bypass Delivery

(71) Applicants: Cummins Ltd, London (GB); Cummins Emission Solutions, Inc., Columbus, IN (US)

(72) Inventors: Chetan Kishorrao Chawane, Pune (IN); Jim L. Alonzo, Columbus, IN (US); Matthew Robert Brookes, West Yorkshire (GB); Atif Mahmood, West Yorkshire (GB); Donald Edward Willey, West Yorkshire (GB); Enoch Nanduru, Pune (IN); Ameya Navnath Warang, Pune (IN); Mohemmedtayab A. Mujawar, Pune (IN); Nikhil Digambar Giri, Pune (IN); Pavan L. Khanadalkar, Pune (IN); Abdul Rasheed M S, Pune (IN); Samuel Johnson, Columbus, IN (US); Paul T. Frisch, Columbus, IN (US)

(21) Appl. No.: 18/848,076

(22) PCT Filed: Mar. 16, 2023
(86) PCT No.: PCT/GB2023/050641

§ 371 Date: Sep. 17, 2024

(30) Foreign Application Priority Data
Mar. 17, 2022 (GB) 2203740.2

(51) Int. Cl. F01N 3/20; F01N 3/22

(52) U.S. Cl. CPC F01N 3/206; F01N 3/22; F01N 2340/06; F01N 2610/1453

(57) ABSTRACT

There is provided a turbine for a turbocharger, comprising: a turbine inlet passage configured to receive exhaust gas from an internal combustion engine, the exhaust gas received by the turbine inlet passage defining a turbine bulk flow; a turbine wheel chamber configured to receive the turbine bulk flow from the turbine inlet passage, the turbine wheel chamber configured to contain a turbine wheel supported for rotation about a turbine axis; a turbine outlet passage configured to receive the turbine bulk flow from the turbine wheel chamber; a dosing module configured to deliver a spray of aftertreatment fluid into a spray region of the turbine outlet passage through which the turbine bulk flow passes; and an auxiliary passage configured to receive a portion of the turbine bulk flow, the portion of the turbine bulk flow received by the auxiliary passage defining an auxiliary flow; wherein the auxiliary passage is configured to direct the auxiliary flow into the spray region of the turbine outlet passage.

Turbochargers are used within internal combustion engine systems to increase the pressure of the intake air entering the internal combustion engine to a pressure above atmospheric pressure. This is known as a “boost pressure”. By increasing the pressure of the intake air entering the internal combustion engine, more oxygen is available within the internal combustion engine to support the combustion of a larger amount of fuel, and therefore increases the amount of power produced by the engine.

Turbochargers comprise a compressor and a turbine. The compressor comprises a compressor wheel configured to impart energy to an incident fluid stream, and the turbine comprises a turbine wheel configured to extract energy from an incident fluid stream. The compressor wheel and the turbine wheel are attached to opposite ends of a turbocharger shaft, such that the two rotate in unison. The compressor receives intake air from the atmosphere and delivers the intake air to an intake manifold of the internal combustion engine. The turbine receives exhaust gas from an exhaust manifold of the internal combustion engine and delivers the exhaust gas to an aftertreatment system. During use, exhaust gas leaving the internal combustion engine passes through the turbine, causing the turbine wheel to rotate. The rotation of the turbine wheel drives the compressor wheel, which acts to compress the intake air as it is delivered to the intake manifold.

Exhaust gases from internal combustion engines contain substances that are harmful to the environment. Most countries have vehicle emission standards which limit the amount of such substances that an internal combustion engine system is permitted to emit. Consequently, modern internal combustion engine systems comprise exhaust gas aftertreatment systems designed to remove harmful substances from the exhaust gas.

Typically, an exhaust gas aftertreatment system will comprise a particulate filter and one or more catalytic reducers. The particulate filter removes heavy combustion products, e.g. soot, from the exhaust gas. The catalytic reducers remove harmful substances such as Nitrogen Oxides (NOx) from the exhaust gas. Catalytic reducers generally comprise a large number of narrow channels made from a material selected to support a chemical reaction that removes NOx from the exhaust gas. The narrow channels provide a large surface area for the catalytic reaction to take place. Several kinds of catalytic reducers are available on the market, such as two-way catalytic reducers, three-way catalytic reducers, diesel oxidation catalytic reducers (DOCs), and selective catalytic reducers (SCRs). DOCs and SCRs are typically employed in diesel engine systems. For the SCRs specifically, in order for the SCR reaction to work, it is necessary to mix an exhaust gas aftertreatment fluid with the exhaust gas before it enters the catalytic reducer. The exhaust gas aftertreatment fluid is usually a mixture of around 30% to 35% by volume urea (CO(NH2)2) to about 65% to 70% by volume deionised water (H2O). The exhaust gas aftertreatment fluid is often referred to as Diesel Exhaust Fluid (DEF) and is commonly available under the registered trademark AdBlue.

Conventionally, the DEF is mixed with the exhaust gas in a decomposition chamber. The DEF is injected into the decomposition chamber using a dosing module. In the decomposition chamber, heat is exchanged from the exhaust gas to the DEF which causes the water within the DEF to evaporate and the urea to thermally decompose into the reductants ammonia (NH3) and Isocyanic Acid (HNCO) which are required to support the SCR reaction.

A typical decomposition chamber comprises a relatively large cross-sectional area in comparison to the width of standard exhaust gas ducting. Exhaust gas entering the decomposition chamber expands, causing the velocity of the exhaust gas to reduce and the pressure of the exhaust gas to increase. This rapid expansion of the exhaust gas causes the formation of turbulent vortices. DEF is then injected into the decomposition chamber, whereupon the turbulent vortices encourage mixing of the DEF with the exhaust gas. The heat exchange between the exhaust gas and the DEF causes the urea in the DEF to decompose into the reductants, and the mixture of reductants and exhaust gas is then passed to the SCR.

If the exhaust gas and DEF are not mixed well enough, the heat exchange between the DEF and the exhaust gas will not be sufficient to decompose the DEF into the required reductants. Furthermore, poor mixing means that the reductants are not evenly distributed within the flow, and therefore some channels of the catalytic reducer will not receive enough reductant to support the SCR reaction. To ensure adequate mixing, it is common for the decomposition chamber to comprise a mixing plate configured to generate additional turbulence. However, the additional turbulence caused by the mixing plate and the fluidic friction exerted by the mixing plate on the exhaust gas creates a back-pressure on the exhaust gas in the decomposition chamber. This back pressure is passed upstream and acts to increase the pumping work required by the internal combustion engine, and accordingly reduces the overall efficiency of the engine system.

In turbocharged engine systems, the exhaust gas leaving the turbine wheel typically has a very high velocity and has pronounced directional characteristics such as high swirl around the turbine axis. Consequently, the flow regime in the immediate vicinity of the outlet of the turbine wheel is often laminar and does not mix well. As such, this makes the turbine outlet an unsuitable place to locate the dosing module. Furthermore the narrow geometry of the turbine outlet passage means that any aftertreatment fluid injected is likely to impinge on the surfaces defining the turbine outlet. To support adequate mixing and reduce the risk of impingement, the decomposition chamber and the dosing module are typically positioned at a distance significantly downstream of the turbine outlet passage and away from the turbine itself so that turbulent flow can be established. However, as the exhaust gas travels from the turbine wheel, it loses energy to pipe friction and transient heat dissipation. Accordingly, when the decomposition chamber is placed away from the turbine less heat is available to cause decomposition of the DEF.

Further, when aftertreatment fluid is injected into the exhaust gas, there is the potential for some of the aftertreatment fluid to impinge upon one or more surfaces of the network of enough there is a risk that that it will solidify and form a blockage in the turbine outlet passage. Such blockages can increase the back pressure on the internal combustion engine; increasing pumping work and reducing the power output of the engine system.

The amount of nitrous oxides (NOx) produced by the internal combustion engine will vary depending upon the operating conditions of the engine. When more NOx is produced, a greater mass of reductants are required to support the SCR reaction to sufficiently reduce the NOx content of the exhaust flow to below an acceptable level. However, if too much DEF is introduced into the exhaust gas flow the risk that the DEF will impinge upon the surfaces of the exhaust gas aftertreatment system and solidify increases. Accordingly, it is known to adjust the amount of DEF delivered to the exhaust gas flow by the dosing module in proportion to the amount of nitrous oxides that the flow contains. Typically, such exhaust gas aftertreatment systems are provided with sensors configured to measure the content of nitrous oxides in the exhaust gas flow.

However, sensors that are capable of detecting the presence of NOx also detect the presence of other substances, in particular ammonia (NH₃) and isocyanic acid (HNCO), and cannot detect the amount of NOx separately from the other substances. Therefore, the reading from such sensors is generally proportional to the total combined amount of NOx, ammonia and isocyanic acid in the exhaust gas. Accordingly, in many circumstances, should the reductants from the decomposed DEF reach the NOx sensor, the sensor reading will not accurately reflect the true NOx content of the exhaust gas produced by the engine. One solution to this problem is to provide additional sensors that are configured to sense the presence of ammonia (NH₃) and isocyanic acid (HNCO) and subtract the readings from these sensors from that of the NOx sensor. However, such arrangements are more expensive to manufacture and more complex to operate due to the increased number of sensors. Moreover, it has also been found that ammonia which condenses on the surface of the sensor can cause damage to the sensor.

Aftertreatment such as DEF is typically injected into the exhaust gas as a spray of droplets. By spraying the aftertreatment fluid, this acts to disperse the aftertreatment fluid throughout the exhaust gas. However, even though the aftertreatment fluid is sprayed, the aftertreatment fluid tends to follow the streamlines of the exhaust gas and so does not become uniformly mixed with the exhaust gas until it has dissipated over a length of pipework. However, in some engine systems the pipework may not provide a sufficient distance for the aftertreatment fluid to be fully mixed before entering any downstream aftertreatment components such as SCRs. Accordingly, there is a need to improve mixing of aftertreatment fluid in pipework downstream of an aftertreatment fluid injection site.

When injected, the aftertreatment fluid is typically composed of droplets of a range of sizes. Larger droplets are more massive than smaller droplets and therefore carry more momentum. As such, the larger droplets are more likely to impinge upon the walls of the pipework containing the exhaust gas. Droplets which settle on the walls of the pipework may result in the formation of solid deposits, which could cause a back pressure on the engine which reduces overall power output. Accordingly, there is a need to prevent deposit formation in pipework downstream of an aftertreatment fluid injection site.

It is an object of the invention to obviate or mitigate one or more disadvantages of the prior art, whether described herein or elsewhere.

According to a first aspect of the invention there is provided a turbine for a turbocharger, comprising: a turbine inlet passage configured to receive exhaust gas from an internal combustion engine, the exhaust gas received by the turbine inlet passage defining a turbine bulk flow; a turbine wheel chamber configured to receive the turbine bulk flow from the turbine inlet passage, the turbine wheel chamber configured to contain a turbine wheel supported for rotation about a turbine axis; a turbine outlet passage configured to receive the turbine bulk flow from the turbine wheel chamber; a dosing module configured to deliver a spray of aftertreatment fluid into a spray region of the turbine outlet passage through which the turbine bulk flow passes; and an auxiliary passage configured to receive a portion of the turbine bulk flow, the portion of the turbine bulk flow received by the auxiliary passage defining an auxiliary flow; wherein the auxiliary passage is configured to direct the auxiliary flow into the spray region of the turbine outlet passage.

The term “turbine bulk flow” encompasses the main flow of exhaust gas through the turbine. Principally, this is the exhaust gas that is received by the turbine from the internal combustion engine and which flows from the turbine inlet, through the turbine wheel chamber and into the turbine outlet, before passing downstream to an exhaust gas aftertreatment system comprising one or more catalytic reducers, such as DOC or SCR reducers.

The term “auxiliary flow” encompasses the flow of exhaust gas passing through the auxiliary passage up to the point at which it is completely merged with and fluidly indistinct from the turbine bulk flow. The skilled person will appreciate that it is possible to distinguish the auxiliary flow from the turbine bulk flow by their different flow characteristics, even when both flows are flowing through the turbine outlet passage. Flow characteristics that can be used to distinguish the auxiliary flow from the turbine bulk flow include velocity, pressure, temperature, Reynold's number, density or the like. For example, the auxiliary passage may condition the flow direction of the auxiliary flow within the auxiliary passage. The momentum of the auxiliary flow causes the auxiliary flow to continue flowing in the same direction after entering the turbine outlet passage until sufficient momentum has been exchanged with the turbine bulk flow that the auxiliary flow mixes with and begins to flow in the same direction as the turbine bulk flow. At this point, the auxiliary flow and the turbine bulk flow may become indistinct from one another.

The term “spray region” encompasses a region of space positioned within the turbine outlet into which aftertreatment fluid is sprayed by the dosing module. In particular, the spray region may be the spatial region in which the aftertreatment fluid has a larger component of velocity in a spray direction defined by the dosing module than in the direction of the turbine bulk flow. Put another way, the spray region encompasses the region in which the momentum and behaviour of the aftertreatment fluid is influenced more by the forces imparted onto it by the dosing module than those imparted by the turbine bulk flow.

The term “auxiliary passage” encompasses a passage that is separate to the turbine inlet passage, the turbine wheel chamber and the turbine outlet passage, and which is able to receive exhaust gas from a first location of the turbine and to deliver it to a second location of the turbine within the turbine outlet. The portion of the turbine from which the auxiliary passage inlet receives exhaust gas may be substantially any part of the turbine which contains exhaust gas but which does not form part of the auxiliary passage. This may include, for example, one or more of: the turbine inlet passage, the turbine wheel chamber, the turbine outlet passage, or a wastegate (i.e. bypass) passage.

The auxiliary passage being “configured to direct the auxiliary flow into the spray region” encompasses substantially any arrangement of the auxiliary passage, the turbine outlet passage, and the spray region in which the auxiliary flow travels through the spray region before the auxiliary flow merges with and becomes indistinct from the turbine bulk flow. That is to say, the geometry of the auxiliary passage, turbine outlet and/or spray region is chosen such that exhaust gas which has passed through the auxiliary passage fluidly interacts with the aftertreatment fluid injected by the dosing module into the spray region at or before the point at which the auxiliary flow and the turbine bulk flow are fully merged and/or mixed.

Because the auxiliary flow is separate to the turbine bulk flow, the auxiliary flow can be conditioned by the auxiliary passage so that it has separate fluid properties to the turbine bulk flow. For example, the geometry of the auxiliary passage can be chosen to condition the direction and velocity of the auxiliary flow. Accordingly, the auxiliary passage can condition the auxiliary flow so that the momentum of the auxiliary flow carries the auxiliary flow into the spray region. Because the auxiliary flow passes into the spray region, it exchanges momentum with the spray of aftertreatment fluid and the turbine bulk flow. This momentum exchange can be harnessed to provide one or more beneficial effects. Put another way, the auxiliary flow introduces additional energy into the spray region aside from the energy of the turbine bulk flow and the energy of the aftertreatment fluid spray itself, and this energy can be harnessed to provide one or more specific beneficial effects.

Various beneficial effects are possible depending upon how the auxiliary flow interacts with the turbine bulk flow and the aftertreatment fluid in the spray region. For example, the auxiliary flow may be delivered in such a manner that it exerts a high shearing force at the nozzle of the dosing module, to keep the nozzle clean from aftertreatment fluid and thereby reduce the risk of deposit formation at the nozzle. In another example, the auxiliary flow may be delivered in such a manner that the momentum of the auxiliary flow is used to carry aftertreatment fluid further into the turbine outlet passage and thereby promote a more uniform distribution of aftertreatment fluid across the entire width of the turbine outlet passage. In yet another example, the auxiliary flow may be delivered a manner which creates turbulence within the turbine outlet passage to promote improved heat transfer from the exhaust gas to the aftertreatment fluid so that the aftertreatment fluid decomposes at a faster rate. Other possible beneficial effects will be apparent from the specification.

The dosing module may comprise a nozzle configured to generate the spray of aftertreatment fluid, and the nozzle may be substantially aligned with or radially outwards of a side wall of the turbine outlet passage. In some embodiments, the nozzle may be positioned substantially flush with a side wall of the turbine outlet passage. The term “substantially flush” encompasses the dosing module being generally or exactly aligned with an interior surface of the turbine outlet passage defining the perimeter of the turbine outlet passage. In such embodiments, the nozzle does not protrude into the turbine outlet passage. Accordingly, the nozzle does not present an impediment to flow through the turbine outlet passage, and therefore avoids exerting a back-pressure on the internal combustion engine.

The nozzle of the dosing module may be configured to generate the spray of aftertreatment fluid, and may therefore be referred to as a spray-generating nozzle or atomising nozzle. As described in the introduction, the geometry within the turbine outlet passage is very narrow. When a dosing module comprising a spray-generating nozzle is mounted on the side wall of the turbine outlet, there is a propensity for sprayed aftertreatment fluid to impinge on the opposite wall of the turbine outlet. The impinged fluid may solidify, resulting in a blockage, and therefore the side wall of the turbine outlet has historically been viewed as an unsuitable place to position a nozzle of dosing module. However, in the in the present case, because the auxiliary passage delivers auxiliary flow to the spray of aftertreatment fluid, the auxiliary flow introduces additional energy into the aftertreatment fluid. This energy can be harnessed, for example to increase heat transfer to the aftertreatment fluid and thereby improve decomposition mitigating the solidification of impinged aftertreatment fluid. Accordingly, the use of the auxiliary flow enables the nozzle of the dosing module to be located at a position that was previously impossible.

The dosing module may be configured to deliver the aftertreatment fluid in a spray direction, and the auxiliary passage may be configured to direct the auxiliary flow into the spray region in an auxiliary flow direction generally normal to the spray direction. The term “spray direction” encompasses the overall or average direction in which the aftertreatment fluid is sprayed from the nozzle. This may be for example along a longitudinal centreline of the spray region. The term “generally normal to the spray direction” encompasses a flow having a substantial component of velocity in a direction orthogonal to the spray direction, although some angular misalignment may be permitted, as described below.

Because the auxiliary flow is delivered in a direction generally normal to the spray direction, the auxiliary flow and the aftertreatment fluid have high components of velocity in directions mutually orthogonal to one another. Accordingly, the auxiliary flow is able to exert a shearing force on the aftertreatment fluid in the spray region. This shearing force causes the droplets in the spray to break up into smaller droplets, thus increasing the surface area available between the two fluids for heat exchange and thus promoting faster decomposition of the aftertreatment fluid. Furthermore, the shearing force introduces turbulence into the spray region, which improves mixing of the aftertreatment fluid with the exhaust gas and again increases the amount of heat exchange between the two fluids.

The auxiliary flow direction may be angularly inclined relative to a normal of the spray direction by an angle of up to around 30°. The “normal of the spray direction” encompasses an axis lying in a plane orthogonal to the spray direction. In alternative embodiments, the auxiliary flow direction may be angularly inclined relative to a normal of the spray direction by an angle of up to around 30°.

It has been found that where the auxiliary flow is inclined relative to the normal of the spray direction within one of the ranges above, the shearing force exerted on the aftertreatment fluid by the auxiliary flow is sufficient to cause the aftertreatment droplets to break up and to also introduce sufficient turbulence to the flow to provide improved mixing.

The dosing module may comprise a nozzle, and the auxiliary passage may be configured to direct the auxiliary flow over the nozzle in a direction generally normal to the spray direction. The term “over the nozzle” encompasses the auxiliary flow being in sufficient proximity to the nozzle that the auxiliary flow generates a shearing force on the nozzle.

During use, droplets of aftertreatment fluid may coalesce at the nozzle of the dosing module. If the temperature of the exhaust gas in the vicinity of the nozzle is not hot enough, ammonia that has decomposed from the aftertreatment fluid will solidify and could potentially form deposits that will block or restrict flow of aftertreatment fluid from the nozzle. However, because the auxiliary flow is directed over the nozzle in a generally orthogonal direction relative to the spray direction, the auxiliary flow exerts a shearing force over the nozzle which acts to blow away any droplets that have formed at the nozzle. Accordingly, the nozzle is kept clean and the risk of deposit formation is mitigated.

The dosing module may be configured to deliver the aftertreatment fluid in a spray direction, and the auxiliary passage may be configured to direct the auxiliary flow into the spray region in an auxiliary flow direction opposing the spray direction. The term “opposing the spray direction” encompasses a flow in which the component of flow velocity acting in the direction opposite the spray direction is larger than the component of velocity normal to the spray direction. The direction opposing the spray direction may include a direction directly opposing the spray direction or inclined at an angle relative to the direction directly opposing the spray direction.

The aftertreatment fluid delivered to the turbine outlet passage by the dosing module may, in some instances, impinge upon the walls of the turbine outlet passage on the opposite side of the passage to the dosing module. Impinged aftertreatment fluid may coalesce into large droplets which have the potential to form solid deposits on the walls of the turbine outlet passage. In the present arrangement, because the auxiliary flow is delivered in a direction opposite the spray direction, the momentum of the auxiliary flow and the momentum of the aftertreatment fluid act in opposition to one another. Accordingly, the auxiliary flow is able to prevent the aftertreatment fluid from impinging on the walls of the turbine outlet passage. Furthermore, the momentum exchange between the auxiliary flow and the aftertreatment fluid causes the droplets of aftertreatment fluid to break up, thus increasing the available area for heat exchange between the exhaust gas and the aftertreatment fluid. The relatively large magnitude of the momentum exchange also generates a large amount of turbulence, which acts to improve mixing of the aftertreatment fluid and the exhaust gases in the spray region. Accordingly, more heat is exchanged from the exhaust gas to aftertreatment fluid, thus ensuring that as much of the aftertreatment fluid as possible decomposes into the required reductants. This helps to reduce the risk of deposit formation caused by pooling of aftertreatment fluid on the surfaces of the turbine outlet passage, and also ensures that the reductants are thoroughly and uniformly mixed into the turbine bulk flow.

The auxiliary flow may be oriented in an upstream direction in relation to the turbine bulk flow, and the auxiliary flow direction may be angularly inclined relative to the opposite of the spray direction by an angle of between around 50° to around 90°. The term “the opposite of the spray direction” encompasses a direction that is the directly inverted counterpart of the spray direction. In alternative embodiments the auxiliary flow direction may be angularly inclined relative to the opposite of the spray direction by an angle of between around 55° to around 80°, or around 60° to around 70°.

Because the auxiliary flow is delivered opposite the spray direction and in an upstream direction, the auxiliary flow has large components of velocity in the directions opposite both the aftertreatment fluid and the turbine bulk flow. Accordingly, a large amount of turbulence is generated within the spray region. The turbulence causes the aftertreatment fluid to break up into smaller droplets and to be better mixed. This leads to faster and more complete decomposition of the aftertreatment fluid into the reductants.

The auxiliary flow may be oriented in a downstream direction in relation to the turbine bulk flow, and the auxiliary flow direction may be angularly inclined relative to the opposite of the spray direction by an angle of between around 30° to around 90°. In alternative embodiments the auxiliary flow direction may be angularly inclined relative to the opposite of the spray direction by an angle of between around 40° to around 80°, around 45° to around 70°, or around 55°.

Because the auxiliary flow is delivered opposite the spray direction the auxiliary flow has a large component of velocity that opposes the aftertreatment fluid. This causes the droplets of aftertreatment fluid to break up, thus leading to more heat exchange and faster and fuller decomposition. However, because the flow is oriented in a downstream direction in relation to the turbine bulk flow, the amount of turbulence generated by the merging of the turbine bulk flow with the auxiliary flow in the turbine outlet passage is reduced. Accordingly, enough turbulence can be provided for encouraging mixing of the aftertreatment fluid and the exhaust gas in the spray region, whilst ensuring that the amount of turbulence does not increase to a magnitude which could cause significant resistance to flow through the turbine outlet passage and decrease the efficiency of the engine system.

The auxiliary passage may comprise an auxiliary passage outlet configured to deliver the auxiliary flow to the turbine outlet passage, and the turbine may further comprise a barrier member configured to substantially cover the auxiliary passage outlet from the perspective of the dosing module in the spray direction. As such, the barrier member forms a shield to prevent aftertreatment fluid from entering the auxiliary passage outlet. Accordingly, the chance of aftertreatment fluid solidifying in the auxiliary passage and forming solid deposits is reduced or eliminated.

The auxiliary passage may be configured to direct the auxiliary flow into the turbine outlet passage in an auxiliary flow direction facing a centreline of the turbine outlet passage; and the dosing module may be configured to deliver the aftertreatment fluid in a spray direction facing the centreline. The auxiliary passage may be configured to deliver the auxiliary flow in an auxiliary flow direction that is normal to the centreline. In some embodiments the auxiliary passage may be configured to deliver the auxiliary flow in an auxiliary flow direction that is inclined relative to the centreline, for example by up to around 45° in the upstream or downstream directions. The dosing module may be configured to deliver the aftertreatment fluid in a spray direction that is normal to the centreline. In some embodiments the dosing module may be configured to deliver the aftertreatment fluid in a spray direction that is inclined relative to the centreline, for example by up to around 45° in the upstream or downstream directions.

The auxiliary passage may be configured to direct the auxiliary flow into the turbine outlet passage in an auxiliary flow direction facing downstream in relation to the turbine bulk flow, and the auxiliary flow direction may be inclined relative to a centreline of the turbine outlet passage by an angle of at least around 45°. The “centreline” of the turbine outlet passage encompasses a line defined by the centroid of the turbine outlet passage in the direction of flow of exhaust gas. In its simplest form, the centreline may be a straight line coaxial with the turbine axis. However, in some embodiments the turbine outlet passage may comprise complex geometry resulting in a bent, curved, stepped or inclined centreline.

The incline between the auxiliary flow direction and the centreline encompasses the smallest angle of the auxiliary flow direction to the centreline at the point at which the auxiliary flow is introduced into the turbine outlet passage. For example, the auxiliary passage may comprise an auxiliary outlet defining a centroid, and the angle of the auxiliary flow direction may be measured at the centroid of the auxiliary passage outlet against a line parallel to the centreline. If the centreline is not straight, the angle may be measured relative to a tangent of the centreline. The position of the centreline from which the tangent is taken may be one in which a normal of the centreline passes through the centroid of the auxiliary passage outlet.

During use, the velocity of the turbine bulk flow through the turbine outlet passage is very high. Accordingly, if aftertreatment fluid was injected into the turbine outlet with no auxiliary flow present, the aftertreatment fluid would be carried downstream by the turbine bulk flow before it is able to disperse across the entire width of the turbine outlet passage. Accordingly, only a portion of the turbine bulk flow would carry aftertreatment fluid and the SCR reaction would only take place in a small portion of the SCR reducer (as the reductants required to support the SCR reaction would not be present).

However, the when the auxiliary flow direction is inclined relative to the centreline of the turbine outlet passage in a downstream direction, the auxiliary flow contains a component of velocity (i.e. one of the fundamental orthogonal components of the velocity vector of the auxiliary flow) that is normal to the direction of flow of the turbine bulk flow. Because of the normal component of velocity, when the auxiliary flow passes into the turbine outlet passage it will travel not only in the downstream direction but also across some or all of the width of the turbine outlet passage. When the auxiliary flow passes through the spray region it will transfer some of its momentum to the aftertreatment fluid to carry the aftertreatment fluid across a greater proportion of the width of the turbine outlet passage. Put another way, the auxiliary flow is used to “pick up” the aftertreatment fluid in the spray region and carry the aftertreatment fluid across a greater extent of the width of the turbine outlet passage. Accordingly, the aftertreatment fluid is more uniformly distributed across the turbine outlet passage, and is not concentrated in localised portions of the turbine bulk flow.

It will be appreciated that because the auxiliary flow and the turbine bulk flow face in the downstream direction, the two fluid streams can be merged with relatively minimal turbulence. Minimising turbulence between the auxiliary flow and the turbine bulk flow reduces back pressure on the turbine and the internal combustion engine which could otherwise adversely affect the performance of the engine.

The extent to which the auxiliary flow and the aftertreatment fluid are carried across the width of the turbine outlet passage will be a function of the magnitude of the normal component of velocity of the auxiliary flow relative to the velocity of the turbine bulk flow. It has been found that for most operating conditions of a turbocharger, and angle of at least around 45° is required to provide a noticeable increase in the extent of penetration of the aftertreatment fluid across the turbine bulk flow.

The auxiliary flow direction may be inclined relative to the centreline by an angle in the range of around 45° to around 90°, or around 45° to around 60°. In general terms, the larger the angle between the auxiliary flow direction and the centreline, the further across the turbine outlet passage the aftertreatment fluid is carried. If the angle is too shallow, the aftertreatment fluid may not penetrate across the full extent of the passage. However, if the angle it too steep, then aftertreatment fluid may impinge on the opposite wall of the turbine outlet passage to the dosing module. This aftertreatment fluid could solidify into deposits which restrict flow through the turbine outlet passage. It has been found that by keeping the angle between the auxiliary flow direction and the centreline within the range above, a balance between these two factors can be found so that aftertreatment fluid is more uniformly distributed across the turbine outlet passage but impingement on the walls of the turbine outlet passage is minimised.

The auxiliary passage may be configured to direct the auxiliary flow into the turbine outlet passage in an auxiliary flow direction facing upstream in relation to the turbine bulk flow, and the auxiliary flow direction may be inclined relative to a centreline of the turbine outlet passage by an angle of at least around 45°. Because the auxiliary flow and the turbine bulk flow face in generally opposite directions, a relatively large amount of turbulence is created at the point where the two fluid streams merge. This can be used to increase the turbulence in the spray region, and therefore provide improved mixing of aftertreatment fluid with the exhaust gases. In general, when the auxiliary flow direction faces upstream in relation to the turbine bulk flow, the smaller the angle between the auxiliary flow direction and the centreline the more the directions of the auxiliary flow and the turbine bulk flow oppose one another. This leads to increased turbulence at the point where the two fluid streams merge. If the turbulence in the turbine outlet passage increases too high, this can case a flow restriction which impedes the turbine bulk flow. It has been found that a minimum angle of around 45° between the auxiliary flow direction and the centreline is necessary to keep the amount of generated turbulence below an acceptable level.

The auxiliary flow direction may be inclined relative to the centreline by an angle in the range of around 45° to around 90°. When the auxiliary flow direction faces upstream in relation to the turbine bulk flow, if the angle between the auxiliary flow direction and the centreline is too shallow then too much turbulence will be generated. However if the angle is too steep than this can prevent aftertreatment fluid from fully penetrating across the entire width of the turbine outlet passage. It has been found that when the angle between the auxiliary flow direction and the centreline is in the range of around 45° to around 60° this provides a good balance between these two factors.

The dosing module may define a spray direction and the turbine outlet passage may define a centreline, and the spray direction may be oriented generally normal to the centreline. That is to say, the dosing module is oriented so that it injects aftertreatment fluid in a direction generally normal to the centreline.

Because the aftertreatment fluid is directed in a direction generally normal to the centreline, the momentum of the aftertreatment fluid is able to carry the aftertreatment fluid across the width of the turbine outlet passage. As such, the aftertreatment fluid can be uniformly distributed across the turbine outlet passage.

The dosing module may define a spray direction, and the spray direction may be oriented upstream in relation to the turbine bulk flow. That is to say, the dosing module is oriented so that it injects aftertreatment fluid in a direction having a component of velocity upstream in relation to the turbine bulk flow.

Because the aftertreatment fluid is injected in an upstream direction, it carries a component of momentum that is in opposition to the momentum of the turbine bulk flow. Accordingly, this increases the magnitude of the collision between the turbine bulk flow and the aftertreatment fluid, causing the aftertreatment fluid to break up into smaller droplets. The smaller droplets have a larger surface area for heat exchange and therefore decompose into the required reductants more rapidly.

The spray direction may be inclined at an angle up to around 90° relative to a normal of the centreline. By a “normal of the centreline” it is mean a line perpendicular to the centreline, for example at a point on the centreline. If the centreline is curved, the normal is a line perpendicular to the tangent of the centreline at a point on the centreline.

In general, as the angle between the spray direction and the centreline increases in the upstream direction, the magnitude of the collisions increases correspondingly. Accordingly, the spray direction may be oriented up to 90° relative to the centreline, such that it faces directly opposite the turbine bulk flow. However, this reduces the extent to which the aftertreatment fluid is carried across the turbine outlet passage. It has been found that when the spray direction is inclined relative to the centreline by around 10° to around 45°, this strikes a balance between these two factors.

The dosing module may define a spray direction, and the spray direction is oriented downstream in relation to the turbine bulk flow. That is to say, the dosing module is oriented so that it injects aftertreatment fluid into the turbine outlet passage in a direction generally downstream in relation to the direction of the turbine bulk flow.

Because the spray direction is oriented generally downstream, the momentum of the aftertreatment fluid acts in the same direction as the momentum of the turbine bulk flow, and therefore the two fluid streams can be merged with little flow disturbance. Accordingly, the addition of the aftertreatment fluid does not add additional turbulence to the turbine bulk flow. This is useful, for example, for keeping the overall magnitude of the turbulence in the bulk flow below an acceptable level, so that it does not restrict flow through the turbine outlet passage. For example, the auxiliary flow may be introduced into the turbine outlet passage in a manner that is configured to generate a relatively large amount of turbulence (e.g. facing upstream). In such cases, the turbine bulk flow may already be sufficiently turbulent that thorough mixing will take place once the aftertreatment fluid has been injected.

The spray direction may be inclined at an angle of up to around 90° relative to a normal of the centreline. In general, as the angle between the spray direction and the centreline increases in the downstream direction, less turbulence is generated. Accordingly, the spray direction may be oriented up to 90° relative to the centreline, such that it faces exactly with the turbine bulk flow. However, this reduces the extent to which the aftertreatment fluid is carried across the turbine outlet passage. It has been found that when the spray direction is inclined relative to the centreline by up to around 45°, this strikes a balance between these two factors.

The auxiliary passage may be configured to permit delivery of the auxiliary flow to the turbine outlet passage during all operating conditions of the turbine when exhaust gas is received from the internal combustion engine. For example, the auxiliary passage may be substantially free from any structures configured to selectively restrict, reduce or prevent flow along the auxiliary passage. In one embodiment, the auxiliary passage may be substantially free from valves, and in particular wastegate valves. In a further embodiment, the auxiliary passage may comprise a valve, such as a wastegate valve, however the valve may be configured such that leakage through the valve is always permitted.

Because delivery of the auxiliary flow to the turbine outlet passage is permitted in all operating conditions of the turbine, this ensures that there is always auxiliary flow which can provide the one or more beneficial effects.

The auxiliary passage may define a cross-section perpendicular to the direction of the auxiliary flow, and the narrowest part of the cross-section may be sized so that the mass flow rate of the auxiliary flow is no more than around 5% of the mass flow rate of the exhaust gas delivered to the turbine inlet passage from the engine. Accordingly, the flow rate of the auxiliary flow is sufficiently large that it can influence the aftertreatment fluid and the turbine bulk flow in the turbine outlet passage, but sufficiently small that it does not reduce the overall efficiency of the turbine. In general, the smaller the auxiliary flow, the more efficient the turbine. Preferably, the cross-section of the auxiliary passage is sized such that the mass flow rate of the auxiliary flow is no more than around 1% or around 2% of the mass flow rate of the exhaust gas delivered to the turbine inlet passage.

The auxiliary passage may comprise: an auxiliary passage inlet positioned in the turbine inlet passage; and an auxiliary passage outlet positioned in the turbine outlet passage. That is to say, the auxiliary passage may bypass the turbine wheel. When the auxiliary flow is sourced from the turbine inlet passage, it has a generally higher pressure and temperature than the turbine bulk flow in the turbine outlet passage, and therefore more energy is provided for interaction with the aftertreatment fluid.

The auxiliary passage may comprise a valve configured to control the flow through the auxiliary passage. As such, the auxiliary passage may function as a wastegate passage. The valve may be configured such that a small amount of leakage is permitted when the valve is in a closed configuration. The leakage may be large enough to support a particular interaction with the turbine bulk flow and the aftertreatment fluid in the turbine outlet passage, for example nozzle cleaning etc., whilst being small enough that turbine performance is not negatively impacted.

The valve may be configured such that auxiliary flow is permitted to pass therethrough during all operating conditions of the turbine. As such, the auxiliary flow is always able to influence the aftertreatment fluid and turbine bulk flow in the turbine outlet passage.

The valve may be configured such that the auxiliary flow therethrough is always at least around 0.1% of the mass flow rate of the exhaust gas delivered to the turbine inlet passage from the engine. The larger the amount of auxiliary flow permitted, the greater the influence of the auxiliary flow on the aftertreatment fluid and the turbine bulk flow in the turbine outlet passage. In alternative embodiments, the valve may be configured such that the auxiliary flow therethrough is always at least around 0.2%, around 0.5%, around 1%, around 2% or around 5% of the mass flow rate of the exhaust gas delivered to the turbine inlet passage from the engine.

In addition to the auxiliary passage the turbine may further comprise a wastegate arrangement, the wastegate arrangement may comprise: a wastegate passage fluidly connecting the turbine inlet passage and the turbine outlet passage such that exhaust gas travelling though the wastegate passage may not pass through the turbine wheel chamber; and a wastegate valve configured to selectively permit or prevent fluid flow through the wastegate passage. The term “wastegate passage” encompasses a fluid carrying passage which is configured to provide fluid flow communication between the turbine inlet passage and the turbine outlet passage whilst bypassing the turbine wheel and turbine wheel chamber. The flow through the wastegate passage may be referred to as wastegate flow. The wastegate arrangement may be provided separately and in addition to the auxiliary passage. That is to say, the turbine may comprise both an auxiliary passage and a wastegate passage which are separate to one another.

The wastegate passage may be configured to direct the wastegate flow into the spray region of the turbine outlet passage. By doing so, the wastegate arrangement is able to provide influence the aftertreatment fluid and turbine bulk flow in the same manner as described above when the auxiliary flow is directed into the spray region of the turbine outlet passage. It will be appreciated that the wastegate arrangement may deliver the wastegate flow in a corresponding manner to any of the configurations described herein relating to the auxiliary flow. For example, the wastegate arrangement may be used to support nozzle cleaning of the dosing module, to increase turbulence in the turbine outlet passage, to prevent impingement of aftertreatment fluid on the walls of the turbine outlet passage or the like.

The wastegate passage may fluidly merge with the auxiliary passage such that the wastegate passage may be in fluid communication with the turbine outlet passage via the auxiliary passage. That is to say, the wastegate passage is in direct fluid communication with the auxiliary passage such that, during use when the wastegate valve is open, exhaust gas passes through the wastegate passage, into the auxiliary passage, and then onwards to the turbine outlet passage.

Such arrangements may be more compact and simpler to manufacture than arrangements in which the wastegate passage and auxiliary passage are entirely separate. Furthermore, in such arrangements the wastegate flow merges with the auxiliary flow to become part of the auxiliary flow. Typically, the wastegate flow has a much greater flowrate than the auxiliary flow, and therefore the wastegate flow can effectively be “added” to the auxiliary flow to increase the magnitude of the benefit provided by the auxiliary flow. This is particularly beneficial where auxiliary flow does not originate from a position upstream of the turbine outlet, since in such arrangements the wastegate flow will have a higher pressure than the auxiliary flow.

The dosing module may be configured to deliver aftertreatment fluid to the turbine outlet passage via the auxiliary passage. That is to say, the nozzle of the dosing module may be positioned within the auxiliary passage such that during use the dosing module delivers aftertreatment fluid to the auxiliary passage, the aftertreatment fluid passing through the auxiliary passage and into the turbine outlet passage.

The auxiliary passage may comprise an auxiliary passage inlet configured to receive exhaust gas from the turbine outlet passage, and an auxiliary passage outlet configured to deliver exhaust gas to the turbine outlet passage.

The auxiliary passage may comprise an outlet portion extending from the nozzle to the auxiliary passage outlet, the outlet portion may define an outlet axis, and the outlet axis may be inclined relative to a centreline of the turbine outlet passage by an angle up to around 70°. In alternative embodiments, the outlet axis may be inclined relative to the centreline by an angle between around 20° to around 70°, around 30° to around 60°, around 40° to around 50°, or around 45°. The relative angle between the outlet axis and the centreline may be measured at the centroid of the auxiliary passage outlet.

Due to the momentum carried by the mixture of the auxiliary flow and aftertreatment fluid passing through the outlet portion of the auxiliary passage, as the angle between the outlet axis and the centreline increases, the likelihood of impingement of aftertreatment fluid on the wall of the turbine outlet passage opposite to the auxiliary passage outlet also increases. Aftertreatment fluid which impinges on the wall of the turbine outlet may not be hot enough to evaporate, and my lead to deposit formation. Whilst this can be mitigated by reducing the angle between the outlet axis and the centreline, if the angle is too small the length of the auxiliary passage must be increased and so the auxiliary passage outlet must be placed further downstream (and potentially outside of the preferred distance from the turbine wheel exducer as discussed below). It has been found that when the angle between the outlet axis and centreline is in the ranges above, this reduces the risk of aftertreatment fluid impingement on the wall of the turbine outlet passage whilst keeping the auxiliary passage compact.

The auxiliary passage may comprise an inlet portion extending from auxiliary passage inlet to the nozzle, the inlet portion may define an inlet axis, and wherein the inlet axis may be inclined relative to a centreline of the turbine outlet passage by an angle between around 20° to around 70°. In alternative embodiments, the inlet axis may be inclined relative to the centreline by an angle between around 30° to around 60°, around 40° to around 50°, or around 45°. The relative angle between the inlet axis and the centreline may be measured at the centroid of the auxiliary passage inlet.

As the angle of the inlet axis of the auxiliary passage increases, the momentum change required for exhaust gas to pass into the auxiliary passage increases, thus causing resistance to flow. However, if the angle of the inlet axis is too small, the auxiliary passage must be made longer. It has been found that when the angle between the inlet axis and the centreline is in the ranges above, this reduces the amount of momentum change required for the exhaust gas to enter the auxiliary passage whilst keeping the overall length of the auxiliary passage compact.

The cross-sectional area of the outlet portion of the auxiliary passage may increase along the outlet axis from the nozzle of the dosing module to the auxiliary passage outlet. That is to say, the second portion of the auxiliary passage comprises diverging sides which diverge outwards in the direction of the auxiliary passage outlet.

The dosing module will produce a fine spray of atomised aftertreatment fluid which emanates in the shape of a cone from the tip of the dosing module. In some embodiments, the outlet portion of the auxiliary passage diverges at an angle that is around equal to or greater than the spray cone angle of the nozzle. For example, the spray cone angle may be around 45° to around 50°, and the outlet portion may diverge at an angle of around 60°. In such embodiments, because the outlet portion of the auxiliary passage diverges at the same or a higher rate than the spray cone, this reduces the risk of impingement of aftertreatment fluid on the walls of the auxiliary passage. However, if the outlet portion diverges at too steep of an angle, the auxiliary flow will decelerate such that it loses the potential to influence flow in the turbine outlet passage. Therefore, in alternative embodiments the spray cone angle may be the same as set out above, whilst the outlet portion of the auxiliary passage diverges at a shallower angle, such as a round 5° to 10°. Although the aftertreatment fluid will be likely to impinge on the walls of the outlet portion, the velocity of the auxiliary flow will remain high such that shearing forces will clean any impinged aftertreatment fluid from the walls to avoid deposit formation.

The turbine outlet passage may define a diffuser portion, and the dosing module may be oriented such that the spray region is located within the diffuser portion. The term “diffuser portion” encompasses a part of the turbine outlet passage in which the cross-sectional area of the turbine outlet passage increases along the centreline of the turbine outlet passage. The diffuser portion may be, for example, a straight axial diffuser comprising frusto-conically shaped walls that taper outwardly relative to the turbine bulk flow. Such an axial diffuser may be axially aligned with the turbine axis. However, in alternative embodiments substantially any diverging geometry may be used to define the diffuser portion. For example, the diffuser portion may comprise one or more bends.

In such arrangements, the purpose of the diffuser portion is to decelerate and increase the pressure of the turbine bulk flow according to the Bernoulli principal. Because the turbine outlet is connected to atmosphere, the pressure of the exhaust gas downstream of the turbine outlet will be approximately atmospheric. By using the diffuser, the pressure of the bulk flow immediately downstream of the turbine wheel can be reduced, thus increasing the pressure difference over the turbine wheel and allowing further energy to be extracted from the turbine bulk flow. Because the turbine bulk flow expands, turbulence is naturally generated in the diffuser portion. By aligning the dosing module relative to the diffuser portion so that the spray region is positioned within the diffuser portion, the natural turbulence can be harnessed to provide improved mixing of aftertreatment fluid, and therefore promote faster and fuller decomposition. Furthermore, the expanding diameter of the diffuser portion reduces the amount of aftertreatment fluid that will impinge on the walls and therefore lowers the risk of deposit formation. Additionally, the diffuser enables the doser to be naturally angled downstream, and therefore improves doser integration to the turbine housing components.

The turbine may comprise a turbine wheel having an exducer portion defining an exducer diameter, and the dosing module may be oriented such that at least a portion of the spray region is positioned within around 10 exducer diameters from the turbine wheel relative to a centreline of the turbine outlet passage. The term “exducer portion” encompasses the part of the turbine wheel which functions as the outlet of the turbine wheel (i.e. the distal end of the turbine wheel from the perspective of the turbine bulk flow travelling therethrough). The term “exducer diameter” encompasses the diameter of the exducer portion, at the most distal part of the turbine wheel from the perspective of the turbine bulk flow. It has been found that the bulk flow maintains relatively high velocity until at least around 4 or 5 exducer diameters downstream of the turbine wheel. Accordingly, in alternative embodiments, the spray region may be positioned no more than around 5, around 3, or around 2 exducer diameters from the turbine wheel relative to the centreline so that the aftertreatment fluid interacts with bulk flow in the regions having high velocity.

As the turbine bulk flow exits the turbine wheel the temperature of the turbine bulk flow will be at its hottest relative to any position downstream. Generally speaking, the hotter the turbine bulk flow, the more heat is available for heat exchange with the aftertreatment fluid to promote decomposition into the required reductants. By positioning and orienting the dosing module such that the spray region is closer to the turbine wheel, it can be ensured that more heat is available so that faster and fuller aftertreatment fluid decomposition is achieved. By experimentation, it has been found that when the spray region is further than around 10 exducer diameters from the turbine wheel along the centreline, heat has dissipated from the turbine bulk flow and the rate of decomposition is reduced.

The turbine may comprise a housing having a mounting structure to which the dosing module is mounted and may define a hole through which a nozzle of the dosing module passes. The housing may be substantially any solid body forming part of a structure which defines the turbine inlet passage, turbine wheel passage, turbine outlet passage, the auxiliary passage and/or any other passages that may be present depending upon the circumstances (e.g. a wastegate passage, exhaust gas recirculation passage or the like). The housing may, in particular, be a housing that is part of an assembly of individual housing components defining portions of the various passages of the turbine listed above.

Because the nozzle passes through the hole in the housing, this enables the dosing module to deliver aftertreatment fluid to the turbine outlet passage.

The hole may be positioned no more than around 10 exducer diameters from the turbine wheel relative to a centreline of the turbine outlet passage.

According to second aspect of the invention there is provided a method of operating a turbine for a turbocharger, comprising: receiving exhaust gas from an internal combustion engine into a turbine inlet passage, the exhaust gas received by the turbine inlet passage defining a turbine bulk flow; receiving the turbine bulk flow from the turbine inlet passage into a turbine wheel chamber, the turbine wheel chamber configured to contain a turbine wheel supported for rotation about a turbine axis; receiving the turbine bulk flow from the turbine wheel chamber into a turbine outlet passage; delivering an aftertreatment fluid into a spray region of the turbine outlet passage through which the turbine bulk flow passes using a dosing module; receiving a portion of the turbine bulk flow into an auxiliary passage, the portion of the turbine bulk flow received by the auxiliary passage defining an auxiliary flow; and directing the auxiliary flow into the spray region of the turbine outlet passage.

The dosing module may be configured to deliver the aftertreatment fluid in a spray direction, and the method may further comprise directing the auxiliary flow into the spray region in an auxiliary flow direction generally normal to the spray direction.

The auxiliary flow direction may be angularly inclined relative to a normal of the spray direction by an angle of up to around 30°.

The dosing module may comprise a nozzle, and the method may further comprise directing the auxiliary flow over the nozzle in a direction generally normal to the spray direction.

The dosing module may be configured to deliver the aftertreatment fluid in a spray direction, and wherein the method may further comprise directing the auxiliary flow into the spray region in an auxiliary flow direction opposing the spray direction.

The method may further comprise orienting the auxiliary flow direction in an upstream direction in relation to the turbine bulk flow, and inclining the auxiliary flow direction relative to the opposite of the spray direction by an angle of up to around 45°.

The method may further comprise orienting the auxiliary flow direction in a downstream direction in relation to the turbine bulk flow, and inclining the auxiliary flow direction relative to the opposite of the spray direction by an angle of up to around 45°.

The auxiliary passage may comprise an auxiliary passage outlet configured to deliver the auxiliary flow to the turbine outlet passage, and the method may further comprise shielding the auxiliary passage outlet from the aftertreatment fluid using a barrier member configured to substantially cover the auxiliary passage outlet from the perspective of the dosing module in the spray direction.

The auxiliary passage may be configured to direct the auxiliary flow into the turbine outlet passage in an auxiliary flow direction facing a centreline of the turbine outlet passage; and may further comprise directing the aftertreatment fluid in a spray direction facing the centreline.

The method may further comprise directing the auxiliary flow into the turbine outlet passage in an auxiliary flow direction facing downstream in relation to the turbine bulk flow, and the auxiliary flow direction may be inclined relative to a centreline of the turbine outlet passage by an angle of at least around 45°.

The auxiliary flow direction may be inclined relative to the centreline by an angle in the range of around 45° to around 90°.

The method may further comprise directing the auxiliary flow into the turbine outlet passage in an auxiliary flow direction facing upstream in relation to the turbine bulk flow, and the auxiliary flow direction may be inclined relative to a centreline of the turbine outlet passage by an angle of at least around 45°.

The auxiliary flow direction may be inclined relative to the centreline by an angle in the range of around 45° to around 90°.

The dosing module may define a spray direction and the turbine outlet passage may define a centreline, and the method may comprise orienting the spray direction generally normal to the centreline.

The dosing module may define a spray direction, and the method may comprise orienting the spray direction upstream in relation to the turbine bulk flow.

The spray direction may be inclined at an angle of up to around 90° relative to a normal of the centreline.

The dosing module may define a spray direction, and the method may comprise orienting the spray direction downstream in relation to the turbine bulk flow.

The spray direction may be inclined at an angle of up to around 90° relative to a normal of the centreline.

The auxiliary passage may be configured to permit delivery of the auxiliary flow to the turbine outlet passage during all operating conditions of the turbine when exhaust gas is received from the internal combustion engine.

The auxiliary passage may define a cross-section perpendicular to the direction of the auxiliary flow, and the narrowest part of the cross-section may be sized so that the mass flow rate of the auxiliary flow is no more than around 5% of the mass flow rate of the exhaust gas delivered to the turbine inlet passage from the engine.

The auxiliary passage may comprise: an auxiliary passage inlet positioned in the turbine inlet passage; and an auxiliary passage outlet positioned in the turbine outlet passage.

The auxiliary passage may comprise a valve configured to control the flow through the auxiliary passage.

The valve may be configured such that auxiliary flow is permitted to pass therethrough during all operating conditions of the turbine.

The valve may be configured such that the auxiliary flow therethrough is always at least around 1% of the mass flow rate of the exhaust gas delivered to the turbine inlet passage from the engine.

The turbine may further comprise a wastegate arrangement, the wastegate arrangement may comprise: a wastegate passage fluidly connecting the turbine inlet passage and the turbine outlet passage such that exhaust gas travelling though the wastegate passage may not pass through the turbine wheel chamber; and a wastegate valve configured to selectively permit or prevent fluid flow through the wastegate passage.

The wastegate passage may be configured to direct the wastegate flow into the spray region of the turbine outlet passage.

The wastegate passage may fluidly merge with the auxiliary passage such that the wastegate passage is in fluid communication with the turbine outlet passage via the auxiliary passage.

The dosing module may be configured to deliver aftertreatment fluid to the turbine outlet passage via the auxiliary passage.

The auxiliary passage may comprise an auxiliary passage inlet configured to receive exhaust gas from the turbine outlet passage, and an auxiliary passage outlet configured to deliver exhaust gas to the turbine outlet passage.

The auxiliary passage may comprise an outlet portion extending from the nozzle to the auxiliary passage outlet, the outlet portion may define an outlet axis, and the outlet axis may be inclined relative to a centreline of the turbine outlet passage by an angle up to around 70°.

The auxiliary passage may comprise an inlet portion extending from auxiliary passage inlet to the nozzle, the inlet portion may define an inlet axis, and the inlet axis may be inclined relative to a centreline of the turbine outlet passage by an angle between around 20° to around 70°.

The cross-sectional area of the outlet portion of the auxiliary passage may increase along the outlet axis from the nozzle of the dosing module to the auxiliary passage outlet.

The turbine outlet passage may define a diffuser portion, and the dosing module may be oriented such that the spray region is located within the diffuser portion.

The turbine may comprise a turbine wheel having an exducer portion defining an exducer diameter, and the dosing module may be oriented such that at least a portion of the spray region is positioned within around 10 exducer diameters from the turbine wheel relative to a centreline of the turbine outlet passage.

The turbine may comprise a housing having a mounting structure to which the dosing module is mounted and may define a hole through which a nozzle of the dosing module passes.

The hole may be positioned no more than around 10 exducer diameters from the turbine wheel relative to a centreline of the turbine outlet passage.

According to a third aspect of the invention there is provided a turbine for a turbocharger, comprising: a turbine inlet passage configured to receive exhaust gas from an internal combustion engine, the exhaust gas received by the turbine inlet passage defining a turbine bulk flow; a turbine wheel chamber configured to receive the turbine bulk flow from the turbine inlet passage, the turbine wheel chamber configured to contain a turbine wheel supported for rotation; a turbine outlet passage configured to receive the turbine bulk flow from the turbine wheel chamber, the turbine outlet passage being at least partially defined by a turbine outlet passage surface and defining a centreline; an auxiliary passage configured to receive a portion of the turbine bulk flow, the portion of the turbine bulk flow received by the auxiliary passage defining an auxiliary flow; and a dosing module configured to deliver a spray of aftertreatment fluid into the turbine outlet passage; wherein the auxiliary passage is configured to direct the auxiliary flow along the turbine outlet passage surface in an auxiliary flow layer.

The auxiliary flow layer encompasses a layer of fluid flowing over the turbine outlet passage surface that exerts a shearing action on the surface. The creation of an auxiliary flow layer provides a number of distinct advantages.

First, the auxiliary flow layer may act as a fluidic obstruction that substantially inhibits aftertreatment fluid from reaching the turbine outlet passage surface. In this context, it will be appreciated that a fluidic obstruction encompasses a fluidic interaction between the auxiliary flow and the aftertreatment fluid in which momentum is exchanged between the two fluids in such a manner that the aftertreatment fluid is deflected away from the turbine outlet passage surface. In particular, the auxiliary flow exerts a shearing force on the aftertreatment fluid preventing the aftertreatment fluid from contacting the turbine outlet passage surface or substantially reducing the amount of aftertreatment fluid that is able to contact the turbine outlet passage surface. The shearing force may further cause the droplets of aftertreatment fluid to break up, reducing their relative masses and making the droplets easier to deflect. Consequently, the auxiliary flow layer acts as a “cushion”, inhibiting aftertreatment fluid from contacting the turbine outlet passage surface. Consequently, droplets of aftertreatment fluid are less likely to solidify on the surface of the turbine outlet passage.

Secondly, the shearing action of the auxiliary flow layer acts to “spread out” any aftertreatment fluid that reaches the surface of the turbine outlet passage. That is to say, the auxiliary flow layer acts to thin any film of aftertreatment fluid that forms on the turbine outlet passage. This “thinning” or “spreading” action increases the surface area of the aftertreatment fluid and thus enables more heat to be transferred to the aftertreatment fluid. Because more heat is transferred to the aftertreatment fluid, the aftertreatment fluid is more likely to evaporate. This improves decomposition of the aftertreatment fluid and reduces the change of aftertreatment fluid solidifying and forming a blockage in the turbine outlet passage.

Thirdly, the shearing action of the auxiliary flow layer also acts to strip aftertreatment fluid that has settled on the surface of the turbine outlet passage from the surface, so that the aftertreatment fluid is re-entrained in the exhaust gas. By re-entraining the aftertreatment fluid, decomposition of the aftertreatment fluid is improved and the aftertreatment fluid is less likely to solidify. Finally, the shearing action simply pushes the aftertreatment fluid further downstream and towards further aftertreatment components such as SCR catalysts and the like.

As a result of the effects above, the use of an auxiliary flow layer makes the turbine outlet passage a suitable location for the injection of aftertreatment fluid. In particular, as explained above the risk of aftertreatment deposit formation in the turbine outlet passage is mitigated, and thus the turbine outlet passage can function as a decomposition chamber for the receipt and decomposition of aftertreatment fluid. This means that the dosing module can be placed closer to the turbine wheel than was previously possible. The temperature of the turbine bulk flow will be higher closer to the turbine wheel, and therefore the higher temperature of the turbine bulk flow can be used to provide improved heat transfer to the aftertreatment fluid so that the aftertreatment fluid decomposes more rapidly into the reductants required to support the SCR reaction.

The “auxiliary flow” encompasses the exhaust gas which has passed through the auxiliary passage. The momentum of the auxiliary flow is primarily influenced by the geometry and flow conditions within the auxiliary passage. Once the auxiliary flow leaves the auxiliary passage, it will dissipate until it becomes completely merged with the turbine bulk flow. The “auxiliary passage” encompasses a passage separate to and distinct from the turbine outlet passage. In some embodiments, the auxiliary passage may be a wastegate passage bypassing the turbine wheel and comprising a wastegate valve. However, in alternative embodiments the auxiliary passage may not bypass the turbine wheel and/or may not comprise a wastegate valve.

The dosing module may comprise a nozzle in fluid communication with the turbine outlet passage, the nozzle may be configured to generate a spray of aftertreatment fluid; and the nozzle may be positioned on an opposite side of the turbine outlet passage to the auxiliary flow layer. Optionally, during use, the auxiliary flow layer may inhibit aftertreatment fluid from reaching the portion of the turbine outlet passage surface opposite the nozzle. That is to say, the nozzle of the dosing module and at least part of the auxiliary flow layer are arranged on opposite sides of the turbine outlet passage to one another. Accordingly, the auxiliary flow layer is able to “catch” the aftertreatment fluid dispensed by the nozzle and impede or prevent the aftertreatment fluid from contacting the portion of the turbine outlet passage surface generally opposite to the nozzle. The auxiliary flow layer may also exert high shearing forces on any fluid that has impinged upon the turbine outlet passage surface, thus spreading the impinged fluid out and increasing heat transfer to the impinged fluid to prevent the solidification of deposits. The nozzle may be aligned so that it is substantially flush with a side wall of the turbine outlet passage. The term “substantially flush” encompasses the dosing module being generally or exactly aligned with an interior surface of the turbine outlet passage defining the perimeter of the turbine outlet passage. In such embodiments, the nozzle does not protrude into the turbine outlet passage. Accordingly, the nozzle does not present an impediment to flow through the turbine outlet passage, and therefore avoids exerting a back-pressure on the internal combustion engine. The spray of aftertreatment fluid may be atomised.

The auxiliary passage may be configured to direct the auxiliary flow layer in a generally axial direction downstream relative to the centreline. The turbine bulk flow travels in a generally axial direction through the turbine outlet passage. When the auxiliary passage directs the auxiliary flow layer in a generally axial direction, the momentum of the auxiliary flow layer and the momentum of the turbine bulk flow act in generally the same direction. Accordingly, the two momentums work together to increase the shearing forces in the auxiliary flow layer.

The turbine may comprise a shield structure protruding into the turbine outlet passage, the shield structure may define a portion of the auxiliary passage.

The turbine wheel may impart a swirling momentum onto the turbine bulk flow, the swirling momentum of the turbine bulk flow may define a positive angular direction, and the auxiliary passage may be configured to deliver the auxiliary flow to the turbine outlet passage in a direction that induces swirling of the auxiliary flow layer about the centreline in the positive angular direction. Because the auxiliary passage directs the auxiliary flow into the turbine outlet passage in a direction which induces swirling in the same angular direction as the turbine bulk flow, the swirling momentum of the auxiliary flow will be imparted on the swirling momentum of the turbine bulk flow thus increasing the magnitude of the swirling momentum of the turbine bulk flow. The increased swirling momentum of the combined turbine and auxiliary flows further increases the velocity and shear stress of the auxiliary flow layer. This increases the amount of energy available for the deflection and breaking up of the aftertreatment fluid in the auxiliary flow layer, and thus improves the “cushioning” effect. Furthermore, when the auxiliary flow has swirling momentum, the auxiliary flow layer acts as a kind of fluidic agitator which causes the turbine bulk flow to be more thoroughly mixed. This improves heat transfer to the aftertreatment fluid, thus ensuring more of the aftertreatment fluid decomposes and at a faster rate.

The increased velocity and shear near the surface of the turbine outlet passage makes the turbine outlet passage a suitable location for the injection of aftertreatment fluid. In particular, aftertreatment fluid injected in the turbine outlet passage will be deflected by the high-velocity high-shear exhaust gas and prevented from reaching the surface of the turbine outlet passage. Accordingly, the risk of aftertreatment pooling and deposit formation in the turbine outlet passage is mitigated, and thus the turbine outlet passage can function as a decomposition chamber for the receipt and decomposition of aftertreatment fluid.

In order to achieve swirling in a positive direction, the auxiliary passage may be configured to deliver the auxiliary flow in a direction having a directional component that is tangential to the turbine outlet passage surface in a plane normal to the centreline. That is to say, the auxiliary flow may have a directional component that is tangential to the turbine outlet passage surface in a plane normal to the centreline. Because the auxiliary flow has a directional component tangential to the turbine outlet passage surface, the turbine outlet passage surface will induce the auxiliary flow to swirl around the centreline.

The auxiliary passage may be configured to deliver the auxiliary flow into the turbine outlet passage in a direction that is between 0° to around 60° relative to a direction that is orthogonal to the centreline. That is to say, the auxiliary passage may be configured such that, in the absence of any turbine bulk flow, the auxiliary flow would enter the turbine outlet passage in a direction that is orthogonal to the turbine axis (or the centreline of the turbine outlet passage) or inclined relative to such an orthogonal direction by up to around 60°.

The auxiliary passage may be configured to deliver the auxiliary flow to the turbine outlet passage at a swirl angle of between around 30° to around 85°. The term “swirl angle” encompasses the angle subtended between a velocity vector of a flow relative to a directional component of the velocity vector parallel to the centreline during use. Put another way, the velocity vector may define the hypotenuse of a right-angled triangle, the directional component of the velocity vector parallel the centreline may define the adjacent of the triangle, and the directional component of the velocity vector tangential to the turbine outlet passage surface in the plane normal to the centreline may define the opposite of the triangle. The swirl angle is the angle subtended between the hypotenuse and the adjacent of the triangle.

The auxiliary passage may be at least partially defined by an auxiliary passage surface, wherein the auxiliary passage surface and the turbine outlet passage surface define an interface therebetween, and, at the interface, the auxiliary passage surface may be generally tangential to the turbine outlet passage surface. By “generally tangential” it will be understood that the auxiliary passage surface and turbine outlet passage surface may be fully tangential to one another, or may have some angular misalignment as described below. When the two surfaces are tangential to one another, this ensures a smooth delivery of the auxiliary flow to the turbine outlet passage which results in minimal flow recirculation or disturbances proximate the turbine outlet passage surface.

At the interface, the auxiliary passage surface may be inclined relative to a tangent of the turbine outlet passage surface in a plane normal to the centreline by an angle up to around 15°. The angle of misalignment may be in either a positive direction or a negative direction relative to a tangent of the turbine outlet passage surface. It has been found that where the angular misalignment between the two surfaces is within the range above, flow recirculation and disturbances are minimised. Preferably the auxiliary passage surface is as tangential as possible to the tangent of the turbine outlet passage surface. Alternatively, the auxiliary passage surface may be inclined relative to the tangent of the turbine outlet passage surface by up to around 2°, around 5° or around 10°. When the relative angle between the auxiliary outlet passage surface and the tangent of the turbine outlet passage surface increases, it is preferable for the interface therebetween to transition as smoothly as possible from one surface to the other.

The turbine may further comprise a sensor arrangement comprising a sensor passage having a sensor passage inlet and a sensor passage outlet; the sensor passage inlet may be configured to receive a portion of the turbine bulk flow from the turbine outlet passage to define a sensor flow and the sensor passage outlet may be configured to deliver the sensor flow to the turbine outlet passage; and the auxiliary passage may be configured to direct the auxiliary flow into the turbine outlet passage such that the auxiliary flow layer passes downstream of the sensor passage outlet. That is to say, the auxiliary passage may be configured such that the auxiliary flow layer does not pass upstream of the sensor passage outlet. In some embodiments, the sensor passage may be defined by a conduit at least partially extending into the turbine outlet passage. If the auxiliary flow layer passes upstream of the sensor passage outlet, the auxiliary flow layer will impinge upon the conduit, creating unwanted additional turbulence and dissipating energy from the auxiliary flow layer. However, when the auxiliary flow layer passes downstream of the sensor passage outlet, the auxiliary flow layer misses the conduit, and therefore flow disturbances to the auxiliary flow layer are minimised.

The turbine may be configured for connection to a network of exhaust gas conduits downstream of the turbine outlet passage, the network may comprise a bent portion configured to receive the turbine bulk flow from the turbine outlet passage, and the auxiliary passage may be configured to direct the auxiliary flow into the turbine outlet passage such that the auxiliary flow layer passes over an outer apex of the bent portion. Due to the axial momentum of the turbine bulk flow, any aftertreatment fluid carried by the turbine bulk flow will be likely to impinge upon the outer apex of the bent portion. However, because the auxiliary flow layer is directed over the outer apex of the bent portion, the auxiliary flow layer is able to form a fluidic barrier over the outer apex of the bent portion thus inhibiting aftertreatment fluid from contacting the outer apex and forming deposits. The term “outer apex” refers to an internal surface of the bent portion which defines the radially outermost part of the bent portion relative to an axis of curvature of the bent portion.

The auxiliary passage may comprise an auxiliary passage outlet configured to deliver the auxiliary flow into the turbine outlet passage so that the auxiliary flow layer has a thickness between at least around 5% and at most around 25% of a distance defined between the turbine outlet passage surface and the centreline. Alternatively the thickness of the auxiliary flow layer may be around 10%, 15% or 20% of the distance between the turbine outlet passage and the centreline. As the thickness of the auxiliary flow layer increases, more shearing momentum is available to deflect the aftertreatment fluid and prevent it from reaching the auxiliary passage surface. It has been found that in order to provide a sufficient amount of shearing momentum, the thickness of the auxiliary flow layer should be at least around 5% of the distance from the turbine outlet passage surface to the centreline. However, if the thickness of the auxiliary flow layer increases too much, it can impede the passage of the turbine bulk flow through the turbine outlet passage. It has been found that the thickness of the auxiliary flow layer should therefore be no more than around 25% of the distance from the turbine outlet passage surface to the centreline. Where the turbine outlet passage is generally circular in cross-section, the distance defined between the turbine outlet passage surface and the centreline may be a radius of the turbine outlet passage surface relative to the centreline.

The auxiliary passage may comprise an auxiliary passage outlet configured to deliver the auxiliary flow into the turbine outlet passage so that the auxiliary flow layer may have a width between around 50% to around 100% of a diameter of the turbine outlet passage defined by the turbine outlet passage surface. Typically the dosing module disperses aftertreatment fluid in a conical spray region. It will be appreciated that in order to form an effective fluidic barrier to impede contact of aftertreatment fluid with the turbine outlet passage surface, the auxiliary flow layer must be sufficiently wide that it is able to capture aftertreatment fluid that has been dispersed by the dosing module. The diameter of the turbine outlet passage surface may be taken in a plane normal to the centreline in which a centroid of the auxiliary passage outlet is located.

The auxiliary passage outlet may define a width and a depth, and the depth may be around 15% to around 50% of the width, and may preferably be around 25% of the width. Accordingly, the auxiliary passage opening is long and narrow such that it is generally “letterbox” shaped. When the auxiliary passage is long and narrow, this acts to form the auxiliary flow layer into a wide “blanket” covering a large area of the turbine outlet passage surface. Furthermore, the narrow dimension of the depth relative to the width acts to accelerate the auxiliary flow into the turbine outlet passage. As such, the shearing forces in the auxiliary flow layer are sufficient to provide the effects above, whilst the auxiliary flow layer is wide enough to catch as much aftertreatment fluid as possible.

The auxiliary passage may comprise a wastegate valve configured to selectively permit or prevent auxiliary flow passing through the auxiliary passage; the wastegate valve may comprise a valve opening defining a valve flow area; the auxiliary passage outlet may define an auxiliary flow area in a plane normal to the direction of the auxiliary flow; and the auxiliary flow area may be around 1.2 times larger than the valve flow area. Because the auxiliary flow area is larger than the valve flow area, this prevents choking occurring at the auxiliary passage outlet.

The auxiliary passage may be configured to receive the portion of turbine bulk flow from the turbine inlet passage. As such, the auxiliary flow bypasses the turbine wheel chamber. Because the auxiliary flow is taken from a position upstream of the turbine wheel, the pressure of the auxiliary flow is higher than that of the turbine bulk flow. Accordingly, more energy is available to deflect and break up droplets of aftertreatment fluid in the auxiliary flow layer, thus improving the cushioning effect.

The auxiliary passage may comprise a valve configured to control the flowrate of auxiliary flow through the auxiliary passage. In such embodiments the auxiliary passage is functionally equivalent to a wastegate passage. When the valve is closed, substantially all of the exhaust gas delivered to the turbine will pass through the turbine wheel as the turbine bulk flow. In such conditions, the flow rate of the turbine bulk flow may be sufficiently high to impede impingement of the aftertreatment fluid on the turbine outlet passage surface. This may be aided by one or more further features of the turbine which act to impede contact between the aftertreatment fluid and the turbine outlet passage surface, such as diffusers, turbulators or the like which improve mixing of the aftertreatment fluid with the turbine bulk flow. When the valve is open, the energy of the turbine bulk flow will decrease, and therefore aftertreatment fluid may be more likely to impinge on the turbine outlet passage surface. However, because the auxiliary passage delivers the auxiliary flow into to turbine outlet passage in an auxiliary flow layer, the aftertreatment fluid is “cushioned” by the auxiliary flow layer and prevented from contacting the turbine outlet passage surface.

The auxiliary passage may be sized such that, when the valve is open, the flow rate of auxiliary flow through the auxiliary passage may be between at least around 25% of the flow rate of turbine bulk flow received by the turbine inlet passage. In order to provide a sufficient wastegating effect, the auxiliary passage needs to be sufficiently large that the amount of exhaust gas which bypasses the turbine wheel causes a significant drop in the amount of power produced by the turbine wheel. It has been found that the auxiliary passage should therefore be capable of receiving at least around 25% to at least around 50% of the total exhaust gas delivered to the turbine.

The auxiliary passage may comprise an auxiliary passage outlet configured to deliver the auxiliary flow into the turbine outlet passage, and the valve may be positioned at the auxiliary passage outlet. During use, as the valve moves between a closed and an open position, the valve will define an opening of variable size. When the opening is small, the auxiliary flow will accelerate through the opening. In conventional wastegate arrangements, the valve is typically positioned close to an inlet of the wastegate passage (rather than an outlet of the wastegate passage). The wastegate flow which passes through the valve therefore expands in the wastegate passage, causing the wastegate flow to decelerate. However, in the present embodiment, by positioning the valve at the auxiliary passage outlet it can be ensured that the auxiliary flow entering the turbine outlet passage has high velocity. This further increases the shearing momentum of the auxiliary flow in the auxiliary flow layer, thus improving the “cushioning” effect.

The valve being positioned “at” the auxiliary passage outlet may encompass at least the valve being configured to selectively block the auxiliary passage outlet itself. Additionally or alternatively, the auxiliary passage outlet may define a depth in a plane normal to the centreline, and the valve may be positioned upstream of the auxiliary passage outlet by no more than around two such depths.

In alternative embodiments, the valve may not be positioned at the auxiliary passage outlet, and may, for example, be placed upstream of the auxiliary passage outlet. For example, the valve may be positioned upstream of the turbine passage outlet by up to around 6, 7, 8, 10, or 15 depths of the auxiliary passage outlet.

The auxiliary passage may be configured to receive the portion of turbine bulk flow from the turbine outlet passage.

The auxiliary passage may be configured so that auxiliary flow therethrough is always permitted. That is to say, the auxiliary passage may be substantially free from control means, such as valves or the like, which act to prevent fluid flow through the auxiliary passage. Accordingly, the auxiliary passage can be considered to be “always open”. In such embodiments, the auxiliary flow layer is always present in the turbine passage outlet, and therefore the “cushioning” effect is provided across all operating conditions of the turbine.

The auxiliary passage may be sized such that during use the flow rate of the auxiliary flow may be around 0.5% to around 2% of the flow rate of the turbine bulk flow received by the turbine inlet passage. When the auxiliary passage is “always open”, a portion of the exhaust gas will always be able to bypass the turbine wheel, and therefore the efficiency of the turbine will decrease. However, it is has been found that when the auxiliary flow is sufficiently small in comparison to the total exhaust gas delivered to the turbine, the decrease in efficiency of the turbine in minimal and/or negligible. In alternative embodiments the auxiliary passage may receive around 1%, 1.5%, 2%, 2.5%, 3%, 4%, or 5% of the turbine bulk flow. In general, the larger the auxiliary flow is in proportion to the turbine bulk flow delivered to the turbine by the engine, the more energy there is available to support the “cushioning” effect of the auxiliary flow layer.

The auxiliary passage may comprise an auxiliary passage outlet, and may define a flow area normal to the direction of flow of auxiliary flow therethrough, and the flow area may narrow towards the auxiliary passage outlet. Because the flow area narrows towards the auxiliary passage outlet, the auxiliary flow is accelerated as it passes through the auxiliary passage outlet. This results in the creation of higher shearing forces in the auxiliary flow layer, which inhibits aftertreatment fluid from reaching the turbine outlet passage surface.

The auxiliary passage may comprise a plurality of auxiliary passage outlets configured to deliver the auxiliary flow into the turbine outlet passage.

The auxiliary passage may comprise first and second branches, the first branch may define the auxiliary passage outlet and the second branch may define a second auxiliary passage outlet, the second auxiliary passage outlet may be positioned on a generally opposite side of the turbine outlet passage to the auxiliary passage outlet.

The auxiliary passage outlets may be equispaced about the centreline.

The auxiliary passage may comprise a plenum and a plurality of branches fluidly connected to the plenum, the plenum may be configured to receive the auxiliary flow from the auxiliary passage inlet and the branches may be configured to deliver the auxiliary flow to the auxiliary passage outlets.

The branches may each be configured to deliver the auxiliary flow to the turbine outlet passage in a direction that may induce swirling of the auxiliary flow layer about the centreline.

The auxiliary passage may comprise: a first auxiliary passage branch configured to receive a first auxiliary flow portion and to direct the first auxiliary flow portion into the turbine outlet passage in a first auxiliary flow layer; and a second auxiliary passage branch configured to receive a second auxiliary flow portion and to direct the second auxiliary flow portion into the turbine outlet passage in a second auxiliary flow layer.

The first auxiliary passage branch may be configured to direct the first auxiliary flow layer into the turbine outlet passage in a generally axial direction downstream relative to the centreline; and the second auxiliary passage branch may be configured to direct the second auxiliary flow layer into the turbine outlet passage in a generally axial direction downstream relative to the centreline.

The first auxiliary passage branch may be configured to direct the first auxiliary flow layer into the turbine outlet passage in a direction that induces swirling of the first auxiliary flow layer about the centreline in a positive angular direction; and the second auxiliary passage branch may be configured to direct the second auxiliary flow layer into the turbine outlet passage in a direction that induces swirling of the second auxiliary flow layer about the centreline in the positive angular direction.

The first auxiliary passage branch may be configured to direct the first auxiliary flow layer into the turbine outlet passage in a generally axial direction downstream relative to the centreline; and the second auxiliary passage branch may be configured to direct the second auxiliary flow layer into the turbine outlet passage in a direction that induces swirling of the second auxiliary flow layer about the centreline in the positive angular direction.

The turbine outlet passage may define a diffuser portion, and the turbine outlet passage surface may be a surface of the diffuser portion.

The turbine may comprise a housing assembly having: a turbine housing defining the turbine inlet passage and the turbine wheel chamber; and a connection adapter defining at least part of the turbine outlet passage and the turbine outlet passage surface.

The third aspect of the invention may be embodied in a turbocharger.

According to a fourth aspect of the invention there is provided a method of operating a turbine for a turbocharger, comprising: receiving exhaust gas from an internal combustion engine into a turbine inlet passage, the exhaust gas received by the turbine inlet passage defining a turbine bulk flow; receiving the turbine bulk flow from the turbine inlet passage into a turbine wheel chamber, the turbine wheel chamber configured to contain a turbine wheel supported for rotation; receiving the turbine bulk flow from the turbine wheel chamber into a turbine outlet passage, the turbine outlet passage being at least partially defined by a turbine outlet passage surface, the turbine outlet passage defining a centreline; receiving a portion of the turbine bulk flow into an auxiliary passage, the portion of the turbine bulk flow received by the auxiliary passage defining an auxiliary flow; delivering a spray of aftertreatment fluid into the turbine outlet passage using a dosing module; and directing the auxiliary flow along the turbine outlet passage surface in an auxiliary flow layer.

The dosing module may comprise a nozzle in fluid communication with the turbine outlet passage, the nozzle may be configured to generate a spray of aftertreatment fluid; and the nozzle may be positioned on an opposite side of the turbine outlet passage to the auxiliary flow layer such that, during use, the auxiliary flow layer may inhibit aftertreatment fluid from reaching the portion of the turbine outlet passage surface opposite the nozzle.

The auxiliary passage may be configured to direct the auxiliary flow layer in a generally axial direction downstream relative to the centreline.

The turbine may comprise a shield structure protruding into the turbine outlet passage, the shield structure may define a portion of the auxiliary passage.

The turbine wheel may impart a swirling momentum onto the turbine bulk flow, the swirling momentum of the turbine bulk flow may define a positive angular direction, and the auxiliary passage may be configured to deliver the auxiliary flow to the turbine outlet passage in a direction that may induce swirling of the auxiliary flow layer about the centreline in the positive angular direction.

The auxiliary passage may be configured to deliver the auxiliary flow into the turbine outlet passage in a direction that is between 0° to around 60° relative to a direction that is orthogonal to the centreline.

The auxiliary passage may be configured to deliver the auxiliary flow to the turbine outlet passage at a swirl angle of between around 30° to around 85°.

The auxiliary passage may be at least partially defined by an auxiliary passage surface, the auxiliary passage surface and the turbine outlet passage surface may define an interface therebetween, and, at the interface, the auxiliary passage surface may be generally tangential to the turbine outlet passage surface.

At the interface, the auxiliary passage surface may be inclined relative to a tangent of the turbine outlet passage surface in a plane normal to the centreline by an angle up to around 15°.

The turbine may further comprise a sensor arrangement comprising a sensor passage having a sensor passage inlet and a sensor passage outlet; the sensor passage inlet may be configured to receive a portion of the turbine bulk flow from the turbine outlet passage to define a sensor flow and the sensor passage outlet may be configured to deliver the sensor flow to the turbine outlet passage; and the auxiliary passage may be configured to direct the auxiliary flow into the turbine outlet passage such that the auxiliary flow layer passes downstream of the sensor passage outlet.

The turbine may be configured for connection to a network of exhaust gas conduits downstream of the turbine outlet passage, the network may comprise a bent portion configured to receive the turbine bulk flow from the turbine outlet passage, and the auxiliary passage may be configured to direct the auxiliary flow into the turbine outlet passage such that the auxiliary flow layer passes over an outer apex of the bent portion.

The auxiliary passage may comprise an auxiliary passage outlet configured to deliver the auxiliary flow into the turbine outlet passage so that the auxiliary flow layer may have a thickness between at least around 5% and at most around 25% of a distance defined between the turbine outlet passage surface and the centreline.

The auxiliary passage may comprise an auxiliary passage outlet configured to deliver the auxiliary flow into the turbine outlet passage so that the auxiliary flow layer may have a width between around 50% to around 100% of a diameter of the turbine outlet passage defined by the turbine outlet passage surface.

The auxiliary passage outlet may define a width and a depth, and the depth may be around 15% to around 50% of the width, and may preferably be around 25% of the width.

The auxiliary passage may comprise a wastegate valve configured to selectively permit or prevent auxiliary flow passing through the auxiliary passage; the wastegate valve may comprise a valve opening defining a valve flow area; the auxiliary passage outlet may define an auxiliary flow area in a plane normal to the direction of the auxiliary flow; and the auxiliary flow area may be around 1.2 times larger than the valve flow area.

The auxiliary passage may be configured to receive the portion of turbine bulk flow from the turbine inlet passage.

The auxiliary passage may comprise a valve configured to control the flowrate of auxiliary flow through the auxiliary passage.

The auxiliary passage may be sized such that, when the valve is open, the flow rate of auxiliary flow through the auxiliary passage may be between at least around 25% of the flow rate of turbine bulk flow received by the turbine inlet passage.

The auxiliary passage may comprise an auxiliary passage outlet configured to deliver the auxiliary flow into the turbine outlet passage, and the valve may be positioned at the auxiliary passage outlet.

The auxiliary passage may be configured to receive the portion of turbine bulk flow from the turbine outlet passage.

The auxiliary passage may be configured so that auxiliary flow therethrough is always permitted.

The auxiliary passage may be sized such that during use the flow rate of the auxiliary flow may be around 0.5% to around 2% of the flow rate of the turbine bulk flow received by the turbine inlet passage.

The auxiliary passage may comprise an auxiliary passage outlet, and may define a flow area normal to the direction of flow of auxiliary flow therethrough, and the flow area may narrow towards the auxiliary passage outlet.

The auxiliary passage may comprise a plurality of auxiliary passage outlets configured to deliver the auxiliary flow into the turbine outlet passage.

The auxiliary passage may comprise first and second branches, the first branch may define the auxiliary passage outlet and the second branch may define a second auxiliary passage outlet, the second auxiliary passage outlet may be positioned on a generally opposite side of the turbine outlet passage to the auxiliary passage outlet.

The auxiliary passage outlets may be equispaced about the centreline.

The auxiliary passage may comprise a plenum and a plurality of branches fluidly connected to the plenum, the plenum may be configured to receive the auxiliary flow from the auxiliary passage inlet and the branches may be configured to deliver the auxiliary flow to the auxiliary passage outlets.

The branches may each be configured to deliver the auxiliary flow to the turbine outlet passage in a direction that may induce swirling of the auxiliary flow layer about the centreline.

The auxiliary passage may comprise: a first auxiliary passage branch configured to receive a first auxiliary flow portion and to direct the first auxiliary flow portion into the turbine outlet passage in a first auxiliary flow layer; and a second auxiliary passage branch configured to receive a second auxiliary flow portion and to direct the second auxiliary flow portion into the turbine outlet passage in a second auxiliary flow layer.

The first auxiliary passage branch may be configured to direct the first auxiliary flow layer into the turbine outlet passage in a generally axial direction downstream relative to the centreline; and the second auxiliary passage branch may be configured to direct the second auxiliary flow layer into the turbine outlet passage in a generally axial direction downstream relative to the centreline.

The first auxiliary passage branch may be configured to direct the first auxiliary flow layer into the turbine outlet passage in a direction that may induce swirling of the first auxiliary flow layer about the centreline in a positive angular direction; and the second auxiliary passage branch may be configured to direct the second auxiliary flow layer into the turbine outlet passage in a direction that may induce swirling of the second auxiliary flow layer about the centreline in the positive angular direction.

The first auxiliary passage branch may be configured to direct the first auxiliary flow layer into the turbine outlet passage in a generally axial direction downstream relative to the centreline; and the second auxiliary passage branch may be configured to direct the second auxiliary flow layer into the turbine outlet passage in a direction that may induce swirling of the second auxiliary flow layer about the centreline in the positive angular direction.

The turbine outlet passage may define a diffuser portion, and the turbine outlet passage surface may be a surface of the diffuser portion.

The turbine may comprise a housing assembly having: a turbine housing defining the turbine inlet passage and the turbine wheel chamber; and a connection adapter defining at least part of the turbine outlet passage and the turbine outlet passage surface.

According to a fifth aspect of the invention there is provided an aftertreatment system for an internal combustion engine system, comprising: a decomposition chamber configured to receive a bulk flow from the internal combustion engine, the decomposition chamber being at least partially defined by a decomposition chamber surface and defining a centreline; an auxiliary passage configured to receive a portion of the bulk flow, the portion of the bulk flow received by the auxiliary passage defining an auxiliary flow; and a dosing module configured to deliver a spray of aftertreatment fluid into the decomposition chamber; wherein the auxiliary passage is configured to direct the auxiliary flow along the decomposition chamber surface in an auxiliary flow layer.

Therefore, this aspect of the invention differs from the previous (fourth) aspect of the invention of a turbine for a turbocharger principally in that the auxiliary flow layer is formed in a decomposition chamber rather than a turbine outlet passage. Aside from this difference, it will be appreciated that the working principles and advantages of this aspect of the invention are the same as or equivalent to the previous aspect of the invention. In particular, the decomposition chamber of the this aspect may be considered equivalent to the turbine outlet passage of the previous aspect, the decomposition chamber surface of this aspect may be considered equivalent to the auxiliary passage surface of the previous aspect, the auxiliary passage of this aspect may be considered equivalent to the auxiliary passage of the previous aspect, and the dosing module of this aspect may be considered equivalent to the dosing module of the previous aspect. Since the underlying operational principles are the same, it will be appreciated that this aspect may include any of the optional features of the previous aspect described above. Nevertheless, additional optional features of this aspect are put forward below.

The dosing module may comprise a nozzle in fluid communication with the decomposition chamber, the nozzle may be configured to generate the spray of aftertreatment fluid; and the nozzle may be positioned on an opposite side of the decomposition chamber to the auxiliary flow layer such that, during use, the auxiliary flow layer may inhibit aftertreatment fluid from reaching the portion of the decomposition chamber surface opposite the nozzle.

The auxiliary passage may be configured to direct the auxiliary flow layer in a generally axial direction downstream relative to the centreline.

The auxiliary passage may be configured to deliver the auxiliary flow to the decomposition chamber in a direction that may induce swirling of the auxiliary flow layer about the centreline.

The auxiliary passage may be configured to deliver the auxiliary flow to the decomposition chamber in a tangential direction in relation to the decomposition chamber surface in a plane normal to the centreline.

The internal combustion engine system may comprise a turbine having a turbine wheel and the auxiliary passage may receive the auxiliary flow from a position upstream of the turbine wheel. That is to say, the auxiliary passage functions as a wastegate passage. The auxiliary passage may comprise a valve arrangement configured to control therethrough.

The turbine may impart a swirling momentum onto the bulk flow, the swirling momentum of the bulk flow may define a positive angular direction, and the auxiliary passage may be configured to deliver the auxiliary flow to the decomposition chamber in a direction that may induce swirling of the auxiliary flow layer about the centreline in the positive angular direction.

The swirling momentum imparted onto the turbine bulk flow by the turbine may define a first swirl angle, and the auxiliary passage may be configured to deliver the auxiliary flow to the decomposition chamber at a second swirl angle that is equal to or steeper than the first swirl angle.

The auxiliary passage may be configured to deliver the auxiliary flow to the decomposition chamber at a swirl angle of between around 30° to around 85°.

The auxiliary passage may be at least partially defined by an auxiliary passage surface, the auxiliary passage surface and the decomposition chamber surface may define an interface therebetween, and, at the interface, the auxiliary passage surface may be generally tangential to the decomposition chamber surface.

At the interface, the auxiliary passage surface may be inclined relative to a tangent of the decomposition chamber surface in a plane normal to the centreline by an angle up to around 15°.

The decomposition chamber may further comprise a sensor arrangement comprising a sensor passage having a sensor passage inlet and a sensor passage outlet; the sensor passage inlet may be configured to receive a portion of the bulk flow from the decomposition chamber to define a sensor flow and the sensor passage outlet may be configured to deliver the sensor flow to the decomposition chamber; and the auxiliary passage may be configured to direct the auxiliary flow into the decomposition chamber such that the auxiliary flow layer may pass downstream of the sensor passage outlet.

The decomposition chamber may comprise a bent portion and the auxiliary passage may be configured to direct the auxiliary flow into the decomposition chamber such that the auxiliary flow layer passes over an outer apex of the bent portion.

The auxiliary passage may comprise an auxiliary passage outlet configured to deliver the auxiliary flow into the decomposition chamber so that the auxiliary flow layer may have a thickness between at least around 5% and at most around 25% of a distance defined between the decomposition chamber surface and the centreline.

The auxiliary passage may comprise an auxiliary passage outlet configured to deliver the auxiliary flow into the decomposition chamber so that the auxiliary flow layer may have a width between around 50% to around 100% of a diameter of the turbine outlet passage defined by the decomposition chamber surface.

The auxiliary passage outlet may define a width and a depth, and the depth my be around 15% to around 50% of the width, and may preferably be around 25% of the width.

The auxiliary passage may comprise a valve configured to control the flowrate of auxiliary flow through the auxiliary passage.

The auxiliary passage may comprise an auxiliary passage outlet configured to deliver the auxiliary flow into the decomposition chamber, and the valve may be positioned at the auxiliary passage outlet.

The auxiliary passage may comprise an auxiliary passage outlet and may define a flow area normal to the direction of flow of auxiliary flow therethrough, and the flow area may narrow towards the auxiliary passage outlet.

The auxiliary passage may comprise a plurality of auxiliary passage outlets configured to deliver the auxiliary flow into the decomposition chamber.

The auxiliary passage outlets may be equispaced about the centreline.

The auxiliary passage may comprise a plenum and a plurality of branches fluidly connected to the plenum, the plenum may be configured to receive the auxiliary flow from the auxiliary passage inlet and the branches may be configured to deliver the auxiliary flow to the auxiliary passage outlets.

The branches may each be configured to deliver the auxiliary flow to the turbine outlet passage in a direction that may induce swirling of the auxiliary flow layer about the centreline.

The auxiliary passage may comprise: a first auxiliary passage branch configured to receive a first auxiliary flow portion and to direct the first auxiliary flow portion into the decomposition chamber in a first auxiliary flow layer; and a second auxiliary passage branch configured to receive a second auxiliary flow portion and to direct the second auxiliary flow portion into the decomposition chamber in a second auxiliary flow layer.

The first auxiliary passage branch may be configured to direct the first auxiliary flow layer into the decomposition chamber in a generally axial direction downstream relative to the centreline; and the second auxiliary passage branch may be configured to direct the second auxiliary flow layer into the decomposition chamber in a generally axial direction downstream relative to the centreline.

The first auxiliary passage branch may be configured to direct the first auxiliary flow layer into the decomposition chamber in a direction that may induce swirling of the first auxiliary flow layer about the centreline in a positive angular direction; and the second auxiliary passage branch may be configured to direct the second auxiliary flow layer into the decomposition chamber in a direction that may induce swirling of the second auxiliary flow layer about the centreline in the positive angular direction.

The first auxiliary passage branch may be configured to direct the first auxiliary flow layer into the decomposition chamber in a generally axial direction downstream relative to the centreline; and the second auxiliary passage branch may be configured to direct the second auxiliary flow layer into the decomposition chamber in a direction that may induce swirling of the second auxiliary flow layer about the centreline in the positive angular direction.

According to a sixth aspect of the invention there is provided a turbine for a turbocharger, comprising: a turbine inlet passage configured to receive exhaust gas from an internal combustion engine, the exhaust gas received by the turbine inlet passage defining a turbine bulk flow; a turbine wheel chamber configured to receive the turbine bulk flow from the turbine inlet passage, the turbine wheel chamber containing a turbine wheel supported for rotation; a turbine outlet passage configured to receive the turbine bulk flow from the turbine wheel chamber and defining a centreline; an auxiliary passage configured to receive a portion of the turbine bulk flow, the portion of the turbine bulk flow received by the auxiliary passage defining an auxiliary flow; and wherein the turbine wheel is configured to discharge the turbine bulk flow into the turbine outlet passage so that it swirls about the centreline in a positive angular direction, and wherein the auxiliary passage is configured to direct the auxiliary flow into the turbine outlet passage in a negative angular direction opposite the positive angular direction.

Because the auxiliary flow is directed in an opposite angular direction to the natural swirling motion of the turbine bulk flow, the auxiliary flow and the turbine bulk flow collide with one another causing a large amount of turbulence to be generated in the turbine outlet passage. This increased turbulence causes improved mixing of the turbine bulk flow, the auxiliary flow and the aftertreatment fluid, which enables a larger amount of heat to be transferred to the aftertreatment fluid at a faster rate. Accordingly, the water content of the aftertreatment fluid evaporates more fully and faster and the urea content is more rapidly decomposed into the reductants required to support the SCR reaction. Furthermore, the improved mixing leads to a more even distribution of decomposed reductants throughout the turbine bulk flow downstream of the turbine, thus ensuring substantially all of the downstream SCR catalyst has sufficient reductant available to support the required reaction.

The “auxiliary flow” encompasses the exhaust gas which has passed through the auxiliary passage. The momentum of the auxiliary flow is primarily influenced by the geometry and flow conditions within the auxiliary passage. Once the auxiliary flow leaves the auxiliary passage, it will dissipate until it becomes completely merged with the turbine bulk flow. The “auxiliary passage” encompasses a passage separate to and distinct from the turbine outlet passage. In some embodiments, the auxiliary passage may be a wastegate passage bypassing the turbine wheel and comprising a wastegate valve. However, in alternative embodiments the auxiliary passage may not bypass the turbine wheel and/or may not comprise a wastegate valve.

The turbine may further comprise a dosing module configured to deliver a spray of aftertreatment fluid into the turbine outlet passage. The turbine may comprise a dosing module mount configured to receive a dosing module.

The auxiliary flow may collide with the turbine bulk flow within the turbine outlet passage to generate a turbulence region, and the dosing module may comprise a nozzle configured to generate the spray of aftertreatment fluid, the nozzle may be oriented to direct the aftertreatment fluid into the turbulence region. Because the aftertreatment fluid is directed into the turbulence region, the aftertreatment fluid is delivered directly to the position within the turbine outlet passage where the largest amount of mixing occurs. As such, the rate of decomposition of the aftertreatment fluid is increased.

The swirling momentum imparted onto the turbine bulk flow by the turbine wheel may define a first swirl angle, and the auxiliary passage may be configured to deliver the auxiliary flow to the turbine outlet passage at a second swirl angle that may be equal to or steeper in magnitude than the first swirl angle. That is to say, whilst the swirl angles of the turbine bulk flow and the auxiliary flow will be inclined relative to the centreline in different directions, the magnitude of the incline of the second swirl angle is equal to or greater than that of the second swirl angle. Because the second swirl angle is equal or greater in magnitude to the first swirl angle, this means that the auxiliary flow has sufficient momentum acting in the negative angular direction to cause turbulence in the turbine outlet passage.

The auxiliary passage may be configured to deliver the auxiliary flow to the turbine outlet passage in a direction that is between 0° to around 60° relative to a direction that may be orthogonal to the centreline.

The auxiliary passage may be at least partially defined by an auxiliary passage surface, the auxiliary passage surface and the turbine outlet passage surface may define an interface therebetween, and, at the interface, the auxiliary passage surface may be generally tangential to the turbine outlet passage surface. As such, the momentum of the auxiliary flow faces directly opposite to the momentum of the turbine bulk flow, thus resulting in the generation of maximum turbulence.

The auxiliary passage may be configured to receive the portion of turbine bulk flow from the turbine inlet passage. As such, the auxiliary flow bypasses the turbine wheel chamber. Because the auxiliary flow is taken from a position upstream of the turbine wheel, the pressure of the auxiliary flow is higher than that of the turbine bulk flow. Accordingly, more energy is available to generate turbulence to ensure that the aftertreatment fluid fully decomposes.

The auxiliary passage may comprise a valve configured to control the flowrate of auxiliary flow through the auxiliary passage. The valve may be, for example, a wastegate valve The auxiliary passage may be sized such that, when the valve is open, the flow rate of auxiliary flow through the auxiliary passage may be between at least around 25% to around 50% of the flow rate of turbine bulk flow received by the turbine inlet passage.

In order to provide a sufficient wastegating effect, the auxiliary passage needs to be sufficiently large that the amount of exhaust gas which bypasses the turbine wheel causes a significant drop in the amount of power produced by the turbine wheel. It has been found that the auxiliary passage should therefore be capable of receiving at least around 25% to at least around 50% of the total exhaust gas delivered to the turbine.

The auxiliary passage may be configured to receive the portion of turbine bulk flow from the turbine outlet passage.

The auxiliary passage may be configured so that auxiliary flow therethrough is always permitted. That is to say, the auxiliary passage may be substantially free from control means, such as valves or the like, which act to prevent fluid flow through the auxiliary passage. Accordingly, the auxiliary passage can be considered to be “always open”. In such embodiments, the auxiliary flow always collides with the turbine bulk flow in the turbine passage outlet to generate turbulence across all operating conditions of the turbine.

The auxiliary passage may be sized such that during use the flow rate of the auxiliary flow may be around 0.1% to around 2% of the flow rate of the turbine bulk flow received by the turbine inlet passage. When the auxiliary passage is “always open”, a portion of the exhaust gas will always be able to bypass the turbine wheel, and therefore the efficiency of the turbine will decrease. However, it has been found that when the auxiliary flow is sufficiently small in comparison to the total exhaust gas delivered to the turbine, the decrease in efficiency of the turbine in minimal and/or negligible. In alternative embodiments the auxiliary passage may receive around 0.1%, 0.2%, 0.3%, 0.4%, 0.5%, 1%, 1.5%, 2%, 2.5%, 3%, 4%, or 5% of the turbine bulk flow. In general, the larger the auxiliary flow is in proportion to the turbine bulk flow delivered to the turbine by the engine, the more energy there is available to support the improved turbulence generation and improved mixing in the turbine outlet passage.

The auxiliary passage may comprise an auxiliary passage outlet configured to deliver the auxiliary flow into the turbine outlet passage.

The turbine outlet passage may define a diffuser portion. The diffuser portion will cause the turbine bulk flow to expand and decelerate, thus resulting in the formation of turbulent eddies in the turbine outlet passage. The turbulent eddies improve mixing to support faster reductant decomposition and improved distribution of reductants throughout the turbine bulk flow.

The auxiliary passage outlet may be defined by a surface of the diffuser portion. Because the auxiliary passage outlet is positioned in the diffuser portion, the auxiliary flow collides with the turbine bulk flow in the diffuser portion. Accordingly, the turbulence generated by the diffuser portion and the turbulence region generated by the collision of the auxiliary flow with the turbine bulk flow occurs at the same location within the turbine outlet passage. As a result, the magnitude of turbulent mixing is increased, further improving the rate of decomposition and evenly distributing the reductants throughout the turbine bulk flow.

The auxiliary passage may comprise a plurality of auxiliary passage outlets configured to deliver the auxiliary flow into the turbine outlet passage.

The turbine may comprises a housing assembly having: a turbine housing defining the turbine inlet passage and the turbine wheel chamber; and a connection adapter defining at least part of the turbine outlet passage and the turbine outlet passage surface.

The sixth aspect of the invention may be embodied in a turbocharger.

According to a seventh aspect of the invention, there is provided a method of operating a turbine for a turbocharger, comprising: receiving exhaust gas from an internal combustion engine into a turbine inlet passage, the exhaust gas received by the turbine inlet passage defining a turbine bulk flow; receiving the turbine bulk flow from the turbine inlet passage into a turbine wheel chamber, the turbine wheel chamber containing a turbine wheel supported for rotation; receiving the turbine bulk flow from the turbine wheel chamber into a turbine outlet passage, the turbine outlet passage defining a centreline; receiving a portion of the turbine bulk flow into an auxiliary passage, the portion of the turbine bulk flow received by the auxiliary passage defining an auxiliary flow; discharging the turbine bulk flow into the turbine outlet passage so that it swirls about the centreline in a positive angular direction using the turbine wheel; and directing the auxiliary flow into the turbine outlet passage in a negative angular direction opposite the positive angular direction.

The method may further comprise delivering a spray of aftertreatment fluid into the turbine outlet passage using a dosing module.

The auxiliary flow may collide with the turbine bulk flow within the turbine outlet passage to generate a turbulence region, and the dosing module may comprise a nozzle configured to generate the spray of aftertreatment fluid, the nozzle may be oriented to direct the aftertreatment fluid into the turbulence region.

The swirling momentum imparted onto the turbine bulk flow by the turbine wheel may define a first swirl angle, and the auxiliary passage may be configured to deliver the auxiliary flow to the turbine outlet passage at a second swirl angle that may be equal to or steeper in magnitude than the first swirl angle.

The auxiliary passage may be configured to deliver the auxiliary flow to the turbine outlet passage in a direction that may be between 0° to around 60° relative to a direction that is orthogonal to the centreline The auxiliary passage may be at least partially defined by an auxiliary passage surface, the auxiliary passage surface and the turbine outlet passage surface may define an interface therebetween, and, at the interface, the auxiliary passage surface may be generally tangential to the turbine outlet passage surface.

The auxiliary passage may be configured to receive the portion of turbine bulk flow from the turbine inlet passage.

The auxiliary passage may comprise a valve configured to control the flowrate of auxiliary flow through the auxiliary passage.

The auxiliary passage may be sized such that, when the valve is open, the flow rate of auxiliary flow through the auxiliary passage may be between at least around 25% to around 50% of the flow rate of turbine bulk flow received by the turbine inlet passage.

The auxiliary passage may be configured to receive the portion of turbine bulk flow from the turbine outlet passage.

The auxiliary passage may be configured so that auxiliary flow therethrough is always permitted.

The auxiliary passage may be sized such that during use the flow rate of the auxiliary flow may be around 0.1% to around 2% of the flow rate of the turbine bulk flow received by the turbine inlet passage.

The auxiliary passage may comprise an auxiliary passage outlet configured to deliver the auxiliary flow into the turbine outlet passage.

The turbine outlet passage may define a diffuser portion.

The auxiliary passage outlet may be defined by a surface of the diffuser portion.

The auxiliary passage may comprise a plurality of auxiliary passage outlets configured to deliver the auxiliary flow into the turbine outlet passage.

The turbine may comprise a housing assembly having: a turbine housing defining the turbine inlet passage and the turbine wheel chamber; and a connection adapter defining at least part of the turbine outlet passage and the turbine outlet passage surface.

According to an eighth aspect of the invention there is provided a turbine for a turbocharger, comprising: a turbine inlet passage configured to receive exhaust gas from an internal combustion engine, the exhaust gas received by the turbine inlet passage defining a turbine bulk flow; a turbine wheel chamber configured to receive the turbine bulk flow from the turbine inlet passage, the turbine wheel chamber configured to contain a turbine wheel supported for rotation; a turbine outlet passage configured to receive the turbine bulk flow from the turbine wheel chamber, the turbine outlet passage extending along a centreline and being defined at least in part by a first surface of a dividing wall; a dosing module configured to deliver a spray of aftertreatment fluid into the turbine outlet passage; and an auxiliary passage configured to receive a portion of the turbine bulk flow, the portion of the turbine bulk flow received by the auxiliary passage defining an auxiliary flow, the auxiliary passage being at least in part defined by a second surface of the dividing wall; wherein the dividing wall is configured to provide thermal communication from the auxiliary passage to the first surface, via the second surface.

The term “turbine bulk flow” encompasses the main flow of exhaust gas through the turbine. Principally, this is the exhaust gas that is received by the turbine from the internal combustion engine and which flows from the turbine inlet, through the turbine wheel chamber and into the turbine outlet, before passing downstream to an exhaust gas aftertreatment system comprising one or more catalytic reducers, such as DOC or SCR reducers.

The term “auxiliary passage” encompasses a passage that is separate to the turbine inlet passage, the turbine wheel chamber and the turbine outlet passage, and which is able to receive exhaust gas from a first location of the turbine and to deliver it to a second location. The second location may be a location within the turbine outlet passage. The portion of the turbine from which the auxiliary passage inlet receives exhaust gas may be substantially any part of the turbine which contains exhaust gas but which does not form part of the auxiliary passage. This may include, for example, one or more of: the turbine inlet passage, the turbine wheel chamber, the turbine outlet passage, or a wastegate (i.e. bypass) passage.

The term “auxiliary flow” encompasses the flow of exhaust gas passing through the auxiliary passage. The term “dividing wall” encompasses a structure separating the auxiliary flow in the auxiliary passage from the turbine bulk flow in the turbine outlet passage.

As used herein, the term “centreline” encompasses a line prescribed by the centroid of a cross-section of the turbine outlet passage along the direction of flow of exhaust gas. That is to say, the centreline of the turbine outlet passage is an imaginary line drawn along the turbine outlet passage which is always positioned at the geometric centre of the exhaust gas flowing therethrough. Typically, although not always, the centreline will be an extension of a turbine axis, which may diverge from the turbine axis in dependence upon the geometry of the turbine outlet passage. The turbine axis, being the axis about which the turbine wheel is configured to rotate.

As used herein, the term “dosing module” encompasses any device configured to introduce aftertreatment fluid into the turbine outlet passage. The aftertreatment fluid may be a fluid required to support a chemical reaction in an exhaust gas aftertreatment process. For example, the aftertreatment fluid may be DEF for use in an SCR process. The aftertreatment fluid may comprise reductant (i.e. a reducing agent). The term “nozzle” refers to the part of the dosing module from which the aftertreatment fluid leaves the dosing module. That is to say, the part of the dosing module from which aftertreatment fluid emanates.

The term “thermal communication” encompasses the transfer of heat energy from a source location to a sink location. This may include, for example, transmission by conductive or convective heat transfer.

During use, when aftertreatment fluid is injected into the turbine outlet passage it may impinge on the first surface. The aftertreatment fluid is generally at a lower temperature than the turbine bulk flow, and therefore forms a heat sink driving heat transfer from the first surface to the aftertreatment fluid. The first surface is heated from two sources. First, the first surface is heated by convective heat transfer from the turbine bulk flow passing through the turbine outlet passage. Secondly, the first surface is heated by the auxiliary flow passing through the auxiliary passage; and in particular by convective heat transfer from the auxiliary flow to the second surface and conductive heat transfer from the second surface to the first surface through the material of the dividing wall. The first and second surfaces therefore ensure that there is a large surface area available for capturing heat from the bulk and auxiliary flows so that this can be transferred to the pooled aftertreatment fluid (for example, compared to the situation in which the auxiliary passage was absent). As a result, the amount of heat that is transferred to the impinged aftertreatment fluid is increased, causing the temperature of the aftertreatment fluid to rise until the aftertreatment fluid evaporates. Accordingly, the formation of deposits in the turbine outlet passage is reduced or prevented.

Because the dividing wall and first surface are able to mitigate against the formation of solid deposits, it is possible to inject the aftertreatment fluid at a position much closer to the turbine wheel than previously thought possible. Injecting the aftertreatment fluid closer to the turbine wheel may enable improved mixing and decomposition of the aftertreatment fluid, and thus eliminate the need for any ancillary mixing baffles or the like downstream.

The first surface may be disposed on an opposite side of the dividing wall to the second surface. The first surface may, in particular, be parallel to the second surface and face in an opposite direction to the second surface. Because the first and second surfaces are on opposite sides of the dividing wall, this provides a direct path for thermal conduction from the second surface to the first surface, leading to improved heating of the first surface.

The dividing wall may define a thickness between the first surface and the second surface, wherein the turbine comprises a turbine wheel having an exducer portion defining an exducer diameter, and wherein the thickness of the dividing wall is around 5% of the exducer diameter. Accordingly, the dividing wall is relatively thin compared to the flow area of the turbine wheel and the turbine outlet passage. Therefore, the first surface is in close proximity to the second surface, such that conductive heat transfer from the second surface to the first surface is improved.

The auxiliary passage may be configured to receive the auxiliary flow from the turbine outlet passage. The auxiliary passage receiving a portion of the turbine bulk flow from the turbine outlet passage increases the amount of heat energy which can be recovered from the turbine bulk flow and be used to heat the first surface of the dividing wall. Accordingly, the rate of heat transfer to the dividing wall may be increased, such that the temperature of the first surface is high enough to cause evaporation of any aftertreatment fluid which impinges the surface.

The auxiliary passage may be configured to receive the auxiliary flow from the turbine inlet passage. As the turbine bulk flow passes from the turbine inlet passage to the turbine outlet passage via the turbine wheel chamber, the energy of the turbine bulk flow decreases as it does work on the turbine wheel to cause rotation of the turbine wheel. This decrease in energy of the turbine bulk flow is generally observed as a decrease in temperature and pressure. Accordingly, the temperature of the turbine bulk flow in the turbine inlet passage is higher than in the turbine outlet passage.

Because the auxiliary passage receives the auxiliary flow from the turbine inlet passage, the temperature of the auxiliary flow is greater than the temperature of the turbine bulk flow in the turbine outlet passage. As such, the amount of heat transferred to the first surface of the dividing wall is increased (at least compared to alternative embodiments in which the auxiliary flow is received from the turbine outlet passage). Put another way, because the auxiliary flow bypasses the turbine wheel, the auxiliary flow contains more energy that can be extracted by the second surface of the dividing wall and used to heat aftertreatment fluid which collects on the first surface.

The auxiliary passage may comprise a valve arrangement configured to selectively permit, prevent and/or regulate the flow of auxiliary flow through the auxiliary passage. As such, the auxiliary passage may function as a wastegate passage for selectively bypassing a portion of the turbine bulk flow around the turbine wheel.

The auxiliary passage may be configured such that flow therethrough is always permitted. That is to say, the auxiliary passage may be substantially free from valves or closures which would block the passage of auxiliary flow therethrough. However, in some embodiments the auxiliary passage may comprise vales or closures, provided that these can be controlled such that at least some leakage therethrough is provided across all operating conditions of the turbine.

The turbine may comprise a turbine wheel having an exducer defining an exducer diameter, and the dosing module may comprise a nozzle configured to inject the atomised spray of aftertreatment fluid into the turbine outlet passage, and the nozzle of the dosing module may be spaced apart from the exducer of the turbine wheel by a distance of at most around 10 exducer diameters along the centreline of the turbine outlet passage. As used herein, the term “exducer” encompasses the part of the turbine wheel configured to discharge exhaust gas to the turbine outlet passage. The spacing of the nozzle from the exducer of the turbine wheel may be measured from the most downstream part of the tips of the blades of the turbine wheel to the most upstream part of the nozzle viewed from the perspective of the centreline. Preferably, the nozzle of the dosing module is spaced apart from the exducer of the turbine wheel by a distance of at most around 2, 3, 4 or 5 exducer diameters along the centreline of the turbine outlet passage, and is spaced apart from the exducer of the turbine wheel by at least about 0.5, 1 or 2 exducer diameters along the centreline.

Because the nozzle is within a distance of at most around 10 exducer diameters from the turbine wheel, the location at which aftertreatment fluid is injected is relatively close to the turbine wheel. This ensures that the aftertreatment fluid can be delivered into a region of the turbine bulk flow in the turbine outlet passage which has relatively high energy, in particular, relatively high turbulent kinetic energy, and has a high temperature, compared to a downstream location. Delivering aftertreatment fluid into a region of the turbine bulk flow which has relatively high turbulent kinetic energy promotes mixing of the aftertreatment fluid with the turbine bulk flow, and similarly the relatively high temperature promotes the decomposition of the delivered aftertreatment fluid.

Further, as the auxiliary flow passes through the auxiliary passage, the rate of heat transfer to the dividing wall decreases, and hence the temperature of the first surface of the dividing wall decreases along the length of the centreline. Therefore, by delivering the aftertreatment fluid close to the turbine wheel, any impingement of aftertreatment on the dividing wall occurs generally at the hottest region of the first surface of the dividing wall, meaning that the rate of evaporation of any aftertreatment fluid which impinges on the first surface of the dividing wall is greater than at a location further downstream.

The nozzle may be substantially aligned with or radially outwards of a side wall of the turbine outlet passage. In some embodiments, the nozzle may be positioned substantially flush with a side wall of the turbine outlet passage. The term “substantially flush” encompasses the dosing module being generally or exactly aligned with an interior surface of the turbine outlet passage defining the perimeter of the turbine outlet passage. In such embodiments, the nozzle does not protrude into the turbine outlet passage. Accordingly, the nozzle does not present an impediment to flow through the turbine outlet passage, and therefore avoids exerting a back-pressure on the internal combustion engine.

The dosing module may be configured to deliver the atomised spray of aftertreatment fluid into the turbine outlet passage in a direction facing the first surface. In particular, the nozzle of the dosing module may be generally facing the first surface of the dividing wall. The dosing module may produce a fine spray of atomised aftertreatment fluid which emanates in the shape of a cone from the nozzle of the dosing module. The cone may have an apex at the nozzle of the dosing module and extend generally towards the first surface of the dividing wall. The dividing wall may define a distal end relative to the turbine wheel, and a nozzle of the dosing module may be positioned between the turbine wheel and the distal end of the dividing wall, the nozzle oriented to face the first surface of the dividing wall.

The first surface of the dividing wall is heated by the transfer of heat energy from the turbine bulk flow in the turbine outlet passage and from the auxiliary flow. Delivering the atomised spray of aftertreatment fluid in a direction facing the first surface of the dividing wall improves the likelihood that any aftertreatment fluid which impinges on the internal surfaces of the turbine impinges on the first surface and will therefore be evaporated.

That is to say, the aftertreatment fluid may be delivered into the turbine outlet passage in a direction that is generally offset to the turbine bulk flow direction. For example, the aftertreatment fluid may be delivered in a direction that is generally perpendicular to the turbine bulk flow direction in the turbine outlet passage. Not only does this promote any impingement of aftertreatment fluid on the dividing wall to impinge the, hotter, first surface of the dividing wall, the benefits of which are set out above, but, encourages the delivered aftertreatment fluid to penetrate across the turbine bulk flow such that it is more uniformly mixed with the turbine bulk flow. Further, because the aftertreatment fluid may be delivered into the turbine outlet passage in a direction generally perpendicular to the turbine bulk flow, the momentum exchange between the aftertreatment fluid and the turbine bulk flow may be greater which results in improved mixing of the aftertreatment fluid with the turbine bulk flow.

The auxiliary passage may define an auxiliary passage outlet configured to deliver the auxiliary flow into the turbine outlet passage, and the auxiliary passage outlet may be located at least around 0.5 exducer diameter downstream of the nozzle along the centreline. Because the dividing wall is downstream of the nozzle, the first surface of the dividing wall is able to catch aftertreatment fluid that has been injected into the turbine outlet passage by the nozzle. That is to say, the dividing wall covers an area where aftertreatment fluid is likely to impinge. Any aftertreatment fluid which impinges on the first surface of the dividing wall will be heated by the dividing wall and evaporate. In alternative embodiments the auxiliary passage outlet may be positioned at least around 1 or 2 exducer diameters from the nozzle and up to around 5 or around 10 exducer diameters from the nozzle. The distance between the nozzle and the auxiliary passage outlet may be measured between their respective geometric centres.

The turbine may comprise a surface at least partially defining the turbine outlet passage, and the nozzle may be substantially aligned with, or may be radially outwards of, the surface in a radial direction relative to the centreline. That is to say the nozzle is aligned with one of the surfaces defining the turbine outlet passage such that the nozzle does not protrude into the turbine outlet passage. Accordingly, the nozzle does not present an obstruction to flow through the turbine outlet passage.

The surface may be a surface of the dividing wall, for example the first surface.

The term “aligned” encompasses the fluid-injecting part of the nozzle lying substantially flush with the surface. As the skilled person would understand, such alignment does not need to be absolute, and small amounts of misalignment may be tolerated provided that the nozzle of the dosing module does not protrude into the turbine outlet passage in an manner which would cause a significant obstruction to flow. The term “radially outwards of” encompasses the fluid injecting part of the nozzle being spaced apart from the surface.

The dividing wall may extend circumferentially about the centreline. In particular, the dividing wall may be generally annular or frusto-conically annular and concentrically arranged about the centreline. The dividing wall may be a continuous wall formed as a single integral structure. The dividing wall may be a sleeve which is provided in a turbine housing.

The dividing wall may be supported by a pair of elongate support struts, and the auxiliary passage may be at least partially defined between the support struts. The support struts act to concentrate the energy of the auxiliary flow to a specific location, such that specific portions of the dividing wall can be heated using the auxiliary flow.

The support struts may be positioned on an opposite side of the turbine outlet passage to the dosing module and the auxiliary passage may be defined between the support struts on the opposite side of the turbine outlet passage to the dosing module. The portion of the dividing wall where aftertreatment fluid is most likely to impinge is the portion opposite the dosing module. Because the struts define the auxiliary passage opposite the dosing module, this ensure that the portion of the dividing wall opposite the dosing module is hot enough to cause evaporation of any impinged aftertreatment fluid.

The auxiliary passage may define an annular nozzle. The term “annular nozzle” encompasses an annularly shaped passage having a generally reducing cross-sectional area in the direction of flow. As the auxiliary flow passes through the nozzle, due to the decreasing cross-sectional area of the auxiliary passage, the velocity of the flow generally increases and the pressure of the flow generally decreases. Increasing the velocity. The accelerated auxiliary flow may be reintroduced into the turbine outlet passage to provide a high shear layer close to the surface of the turbine outlet passage. A high shear layer may dislodge solid deposits that are formed on the surface of the turbine outlet passage, and may also displace aftertreatment fluid which has settled on the surface. Providing a high shear layer, makes the turbine outlet passage a suitable location for the delivery of aftertreatment fluid, as the risk of aftertreatment pooling and deposit formation in the turbine outlet passage is mitigated.

The turbine outlet passage may comprise a diffuser portion at least partially defined by the dividing wall. That is to say the turbine outlet passage may comprise a diffuser, for example defined by one or more tapered portions of the dividing wall and/or turbine housing. As used herein the term “diffuser” encompasses a divergent passage, where the cross sectional area of the passage increases along a length of the passage. As the cross sectional area of the diffuser increases (i.e. as the walls which define the turbine outlet passage diverge) the velocity of the turbine bulk flow decreases and the pressure increases. The increase in pressure may be used to increase the efficiency of the turbine. It will be appreciated that the cross-sectional area of the diffuser portion may increase linearly or non-linearly along its length.

The diffuser portion may be aligned with and extend symmetrically about the turbine axis. That is to say, the diffuser may be an axial diffuser. The diffuser, may comprise a generally circular cross-section, defined by conically shaped walls of the turbine outlet passage.

The diffuser portion may define a centreline which is defined by the centroid of the turbine outlet passage. The centreline may deviate away from the turbine axis, such that the centreline of the diffuser portion is offset from the turbine axis. The diffuser portion, although offset, may comprise a generally circular cross-section.

The dosing module may be configured to deliver aftertreatment fluid into the diffuser portion. As explained above, as the turbine bulk flow passes through the diffuser portion, the velocity of the turbine bulk flow generally decreases and the pressure generally increases. Delivering aftertreatment fluid into a region of the turbine outlet passage where the turbine bulk flow velocity has decreases allows the aftertreatment fluid to permeate across the turbine bulk flow and mix more uniformly with the turbine bulk flow in the turbine outlet passage.

Further, dependent on the geometry of the diffuser portion, and the flow conditions of the turbine bulk flow, the diffuser portion may promote regions of turbulence in the turbine bulk flow. Delivering aftertreatment fluid into a turbulent regime of the turbine bulk promotes mixing of the aftertreatment fluid with the turbine bulk flow and also mitigates against the aftertreatment fluid impinging on a surface of the turbine outlet passage.

The turbine may comprise a support structure disposed in the auxiliary passage and may be configured to support the dividing wall. That is to say, a support structure may, for example, be a strut, fin, arm, vane, baffle or any other suitable type of structure which is suitable for supporting the dividing wall and spacing the dividing wall from the turbine housing. The support structure may extend from a surface of the turbine housing which at least partly defines an outermost surface of the auxiliary passage to an innermost surface of the auxiliary passage, such as the second surface of the dividing wall. The support structure may be aerodynamically shaped so as to minimise disturbance to the auxiliary flow in the auxiliary passage.

The turbine may comprise a plurality of support structures. Where the auxiliary passage is a generally annular passage the plurality of support structures may be equally circumferentially spaced about the centreline.

The dosing module may comprise a nozzle, and the support structure may be configured to shield the nozzle from the auxiliary flow and/or from the turbine bulk flow. That is to say, the support structure may be configured to divert the auxiliary flow and/or the turbine bulk flow away from the nozzle. For example, the support structure may substantially surround the nozzle, so as to prevent the auxiliary flow or the turbine bulk flow passing over the nozzle, by blocking or obstructing the nozzle from the exhaust gasses of the auxiliary flow and/or the turbine outlet flow.

Aftertreatment fluid is delivered from the nozzle of the dosing module to the turbine outlet passage as an atomised spray. The atomised spray of aftertreatment fluid generally emanates from the nozzle in a conical fashion, where the apex of the aftertreatment fluid cone is at the nozzle. Shielding of the nozzle allows for the aftertreatment fluid cone to develop, thereby promoting uniform mixing of the aftertreatment fluid with the turbine bulk flow in the turbine.

The nozzle may be shielded from the turbine bulk flow and/or the auxiliary flow by a wall of the turbine housing. For example, a wall of the turbine housing may define a recessed portion and the nozzle may be provided in the recessed portion such that the recessed portion shields the nozzle.

The dosing module may comprise a nozzle, positioned in fluid communication with the auxiliary passage such that, in use, the auxiliary flow may pass over the nozzle of the dosing module. It is known that when aftertreatment fluid is expelled from a dosing module remnants of the aftertreatment fluid may be left at, and proximate to, the nozzle, and can result in the formation of solid deposits which block the nozzle. One benefit of the auxiliary flow passing over the nozzle is that it provides a cleaning effect, in that the flow, due to its relatively high temperature can cause aftertreatment fluid which may have settled around the nozzle to evaporate, further, the auxiliary flow may be configured to dislodge solid deposits which have formed near the nozzle, both of which mitigate against the nozzle becoming blocked and unable to deliver aftertreatment fluid as an atomised spray.

Another benefit of the auxiliary flow passing over the nozzle, is that as aftertreatment fluid is expelled from the nozzle, the aftertreatment fluid is able to exchange momentum with the auxiliary flow before entering the turbine outlet passage. This momentum exchange may be used to provide a beneficial effect such as ensuring the aftertreatment fluid is carried across a greater lateral extent of the turbine outlet passage.

The turbine outlet passage may comprise a bend portion defining an apex, and the dosing module may comprise a nozzle configured to deliver aftertreatment fluid into the turbine outlet passage, the nozzle may be positioned at or upstream of the apex of the bend portion. The term “bend portion” encompasses the centreline deviating away from a linear axis, such that the turbine bulk flow changes direction. Examples of a bend portion, include, but are not limited to, arcuate paths, stepped portions and dogleg bends. In other words, a bend portion is a region of a passage which causes the turbine bulk flow to change direction. The inclusion of a bend portion may be necessary due to packaging requirements in the engine compartment.

Turbulent kinetic energy dissipates around bends in pipework. Accordingly, it is beneficial to position the nozzle so that it is not downstream of the apex of the bend portion. This ensures that the aftertreatment fluid is injected into a region with sufficient turbulent kinetic energy to cause the aftertreatment fluid to be fully mixed.

The first surface may define a surface of the bend portion and the nozzle may face the first surface. Because the dosing module faces (i.e. is generally opposite) the first surface and the first surface defines part of the bend portion aftertreatment which does not mix with the turbine bulk flow will impinge on the hot first surface rather than a cooler downstream surface.

The auxiliary passage may comprise an auxiliary passage outlet configured to deliver a portion of the auxiliary flow to the turbine outlet passage at a position downstream of a nozzle of the dosing module, and the dividing wall may comprise an auxiliary aperture configured to deliver a portion of the auxiliary flow to the turbine outlet passage at a position aligned with or upstream of the nozzle. The term “auxiliary aperture” encompasses a slot, hole, opening or the like in the dividing wall and is suitable to provide a fluid pathway from the auxiliary passage to the turbine outlet passage separately to the auxiliary passage outlet.

The dividing wall may comprise a plurality of auxiliary apertures and/or a plurality of auxiliary passage outlets.

The auxiliary aperture may be configured to deliver a portion of the auxiliary flow into the turbine outlet passage into a region of the turbine bulk flow that has relatively low turbulent kinetic energy. Regions of the turbine bulk flow with relatively low turbulent kinetic energy may be referred to as “recirculation zones”. Delivering a portion of the auxiliary flow into a recirculation zone of the turbine bulk flow results in an exchange of momentum between the delivered auxiliary flow and the turbine bulk flow and increases the turbulent kinetic energy of the turbine bulk flow. Accordingly, the turbulence in the turbine outlet passage is increased and recirculation zones are avoided.

The turbine may further comprise a turbine housing assembly, the turbine housing assembly may comprise: a turbine housing defining the turbine inlet passage, the turbine wheel chamber and at least a portion of the turbine outlet passage; and a connection adapter defining at least a portion of the turbine outlet passage and at least a portion of the auxiliary passage, the connection adapter may be coupled to the turbine housing at a first interface; the connection adapter may be configured to support the dividing wall for extension along the centreline; and the dividing wall may extend axially along the centreline across the first interface. The term “interface” encompasses a mechanical join between two components. Such interfaces may cause localised surface discontinuities between components which present a risk for aftertreatment fluid pooling and deposit formation. However, where the dividing wall extends across the first interface, the dividing wall shields the first interface from aftertreatment fluid impingement. Put another way, the dividing wall forms a barrier to block aftertreatment fluid and prevent it from reaching the first interface. Accordingly, the risk of pooling and deposit formation at the first interface is reduced or avoided.

The turbine housing assembly may further comprise a downpipe adapter configured for connection to a downpipe, the downpipe adapter may define at least a portion of the turbine outlet passage and/or the auxiliary passage, and may be coupled to the connection adapter at a second interface; and the dividing wall may extend axially along the centreline across the second interface. The term “downpipe adapter” encompasses a component which is provided between a connection adapter and a downstream conduit such as a downpipe. As explained above in relation to the first interface, the second interface may present a surface discontinuity which is at risk of aftertreatment pooling and deposit formation. However, when the dividing wall extends across the second interface, the dividing wall acts as a barrier preventing aftertreatment fluid reaching the second interface. Accordingly, aftertreatment pooling and deposit formation at the second interface is reduced or avoided.

The auxiliary passage may be a first auxiliary passage and the auxiliary flow may be a first auxiliary flow, and the turbine may further comprise a second auxiliary passage configured to receive a portion of the turbine bulk flow from the turbine inlet passage, the portion of the turbine bulk flow received by the second auxiliary passage may define a second auxiliary flow, and the second auxiliary passage may be configured to deliver the second auxiliary flow to the turbine outlet passage. The term “second auxiliary passage” encompasses a passage that is separate to the first auxiliary passage, the turbine inlet passage, the turbine wheel chamber and the turbine outlet passage, and which is able to receive exhaust gas from the turbine inlet passage and to deliver it to the turbine outlet passage.

Because the second auxiliary passage receives a portion of the turbine bulk flow from the turbine inlet passage, the energy of the second auxiliary flow is greater than the energy of the turbine bulk flow in the turbine outlet passage. This energy difference can be harnessed to provide a specific beneficial effect. By way of example, the second auxiliary flow may be delivered into the turbine outlet passage in a manner so as to increase the turbulent kinetic energy of the turbine bulk flow in the turbine outlet passage, or as another example, the second auxiliary flow may be delivered in a manner so as to provide a cleaning effect around an area of the nozzle. The second auxiliary passage may be functionally equivalent to a wastegate passage.

The second auxiliary passage may comprise a second auxiliary passage outlet, the second auxiliary passage outlet may be aligned with or positioned upstream of a nozzle of the dosing module relative to the centreline, and the second auxiliary passage outlet may be configured to direct the second auxiliary flow along the first surface of the dividing wall in a second auxiliary flow layer. The second auxiliary flow generally has a temperature which is higher than that of the turbine bulk flow in the turbine outlet passage because the second auxiliary flow does not pass through the turbine wheel. Therefore, directing the second auxiliary flow along the first surface of the dividing wall in a second auxiliary flow layer promotes the transfer of heat to the first surface and thereby further increases the temperature of the first surface. The second auxiliary flow layer may be provided along a region of the first surface which aftertreatment fluid is likely to impinge on.

Additionally, the second auxiliary flow layer may form a fluidic obstruction substantially inhibiting aftertreatment fluid from reaching the first surface. In this context, it will be appreciated that a fluidic obstruction encompasses a fluidic interaction between the second auxiliary flow layer and the aftertreatment fluid in which momentum is exchanged between the two fluids in such a manner that the aftertreatment fluid is deflected away from the first surface of the dividing wall. In particular, the second auxiliary flow layer may exert a shearing force on the aftertreatment fluid preventing the aftertreatment fluid from contacting the first surface of the dividing wall or substantially reducing the amount of aftertreatment fluid that is able to contact the first surface of the dividing wall. The shearing force may further cause the droplets of aftertreatment fluid to break up, reducing their relative masses and making the droplets easier to deflect. Consequently, the second auxiliary flow layer acts as a “cushion”, inhibiting aftertreatment fluid from contacting the first surface of the dividing wall.

This “cushioning” effect makes the turbine outlet passage a suitable location for the injection of aftertreatment fluid. In particular, aftertreatment fluid injected in the turbine outlet passage will be deflected by the second auxiliary flow layer and prevented from reaching the first surface of the dividing wall. Accordingly, the risk of aftertreatment pooling and deposit formation in the turbine outlet passage is mitigated, and thus the turbine outlet passage can function as a decomposition chamber for the receipt and decomposition of aftertreatment fluid. This means that the dosing module can be placed closer to the turbine wheel than was previously possible. The temperature of the turbine bulk flow will be higher closer to the turbine wheel, and therefore the higher temperature of the turbine bulk flow can be used to provide improved heat transfer to the aftertreatment fluid so that the aftertreatment fluid decomposes more rapidly into the reductants required to support the SCR reaction.

The nozzle of the dosing module may be positioned on an opposite side of the turbine outlet passage to the second auxiliary flow layer such that, during use, the second auxiliary flow layer inhibits aftertreatment fluid from reaching the portion of the first surface of the dividing wall opposite the nozzle. That is to say, the nozzle of the dosing module and at least part of the second auxiliary flow layer are arranged on opposite sides of the turbine outlet passage to one another. Accordingly, the second auxiliary flow layer is able to “catch” the aftertreatment fluid dispensed by the nozzle and impede or prevent the aftertreatment fluid from contacting the portion of the turbine outlet passage surface generally opposite to the nozzle.

The second auxiliary passage may be configured to direct the second auxiliary flow into the turbine outlet passage in a direction that induces swirling of the second auxiliary flow about the centreline in the turbine outlet passage in the same angular direction as the turbine bulk flow in the turbine outlet passage. Because the second auxiliary passage directs the second auxiliary flow into the turbine outlet passage in a direction which induces swirling in the same angular direction as the turbine bulk flow, the swirling momentum of the second auxiliary flow will be imparted on the swirling momentum of the turbine bulk flow thus increasing the magnitude of the swirling momentum of the turbine bulk flow. The increased swirling momentum of the combined turbine and second auxiliary flow further increases the velocity and shear stress of the second auxiliary flow layer. This increases the amount of energy available for the deflection and breaking up of the aftertreatment fluid in the second auxiliary flow layer, and thus improves the “cushioning” effect. Furthermore, when the second auxiliary flow has swirling momentum, the second auxiliary flow layer acts as a kind of fluidic agitator which causes the turbine bulk flow to be more thoroughly mixed. This improves heat transfer to the aftertreatment fluid, thus ensuring more of the aftertreatment fluid decomposes and at a faster rate.

The increased velocity and shear near the first surface of the dividing wall makes the turbine outlet passage a suitable location for the injection of aftertreatment fluid. In particular, aftertreatment fluid injected in the turbine outlet passage will be deflected by the high-velocity high-shear exhaust gas and prevented from reaching the first surface of the dividing wall. Accordingly, the risk of aftertreatment pooling and deposit formation in the turbine outlet passage is mitigated, and thus the turbine outlet passage can function as a decomposition chamber for the receipt and decomposition of aftertreatment fluid.

In order to achieve swirling in a positive direction, the second auxiliary passage may be configured to deliver the second auxiliary flow in a direction having a directional component that is tangential to the turbine outlet passage surface in a plane normal to the centreline. That is to say, the second auxiliary flow may have a directional component that is tangential to the turbine outlet passage surface in a plane normal to the centreline. Because the second auxiliary flow has a directional component tangential to the turbine outlet passage surface, the turbine outlet passage will induce the second auxiliary flow to swirl around the centreline.

The second auxiliary passage may comprise a second auxiliary passage valve arrangement configured to selectively permit, prevent and/or regulate the flow of second auxiliary flow through the second auxiliary passage. As such, the second auxiliary passage may function as a wastegate passage for selectively bypassing a portion of the turbine bulk flow around the turbine wheel.

Additionally, or alternatively, the second auxiliary passage may be configured such that flow therethrough is always permitted. In particular, the second auxiliary passage may be substantially free from valves or closures. The second auxiliary passage may alternatively comprise one or more valves or closures which are configured to provide at least some leakage therethrough across all operating conditions of the turbine.

Although only a first and a second auxiliary passage are described, it will be appreciated that the turbine may comprise any number of auxiliary passage, wherein different auxiliary passages may be configured to condition the respective flow within each passage to provide different or additional beneficial effects.

The turbine may further comprise a controller configured to selectively activate the dosing module to deliver aftertreatment fluid into the turbine outlet passage. In particular, the controller may be configured to activate the dosing module in dependence upon the temperature of the first surface or the time since engine ignition. In particular, the controller may be configured to activate the dosing module when the first surface has reached a predetermined temperature.

According to a ninth aspect of the invention there is provided a method of operating a turbine for a turbocharger, comprising: receiving exhaust gas from an internal combustion engine into a turbine inlet passage, the exhaust gas received by the turbine inlet passage defining a turbine bulk flow; receiving the turbine bulk flow from the turbine inlet passage into a turbine wheel chamber, the turbine wheel chamber configured to contain a turbine wheel supported for rotation; receiving the turbine bulk flow from the turbine wheel chamber into a turbine outlet passage, the turbine outlet passage extending along a centreline and being defined at least in part by a first surface of a dividing wall; delivering an atomised spray of aftertreatment fluid into the turbine outlet passage using a dosing module comprising a nozzle; and receiving a portion of the turbine bulk flow into an auxiliary passage, the portion of the turbine bulk flow received by the auxiliary passage defining an auxiliary flow, the auxiliary passage being at least in part defined by a second surface of the dividing wall; wherein the dividing wall is configured to provide thermal communication from the auxiliary passage to the first surface, via the second surface.

The first surface may be disposed on an opposite side of the dividing wall to the second surface.

The dividing wall may define a thickness between the first surface and the second surface, the turbine may comprise a turbine wheel having an exducer portion defining an exducer diameter, and the thickness of the dividing wall may be around 5% of the exducer diameter.

The auxiliary passage may be configured to receive the auxiliary flow from the turbine outlet passage.

The auxiliary passage may be configured to receive the auxiliary flow from the turbine inlet passage.

The auxiliary passage may comprise a valve arrangement configured to selectively permit, prevent and/or regulate the flow of auxiliary flow through the auxiliary passage.

The auxiliary passage may be configured such that flow therethrough is always permitted.

The turbine may comprise a turbine wheel having an exducer defining an exducer diameter, and the dosing module may comprise a nozzle configured to inject the atomised spray of aftertreatment fluid into the turbine outlet passage, and the nozzle of the dosing module may be spaced apart from the exducer of the turbine wheel by a distance of at most around 10 exducer diameters along the centreline of the turbine outlet passage.

The nozzle may be substantially aligned with or radially outwards of a side wall of the turbine outlet passage. In some embodiments, the nozzle may be positioned substantially flush with a side wall of the turbine outlet passage.

The dosing module may be configured to deliver the atomised spray of aftertreatment fluid into the turbine outlet passage in a direction facing the first surface.

The auxiliary passage may define an auxiliary passage outlet configured to deliver the auxiliary flow into the turbine outlet passage, and the auxiliary passage outlet may be located at least around 0.5 exducer diameter downstream of the nozzle along the centreline.

The turbine may comprise a surface at least partially defining the turbine outlet passage, and the nozzle may be substantially aligned with, or may be radially outwards of, the surface in a radial direction relative to the centreline.

The dividing wall may extend circumferentially about the centreline.

The dividing wall may be supported by a pair of elongate support struts, and the auxiliary passage may be at least partially defined between the support struts.

The support struts may be positioned on an opposite side of the turbine outlet passage to the dosing module and the auxiliary passage may be defined between the support struts on the opposite side of the turbine outlet passage to the dosing module.

The auxiliary passage may define an annular nozzle.

The turbine outlet passage may comprise a diffuser portion at least partially defined by the dividing wall.

The dosing module may be configured to deliver aftertreatment fluid into the diffuser portion.

The turbine may comprise a support structure disposed in the auxiliary passage and configured to support the dividing wall.

The dosing module may comprise a nozzle, and the support structure may be configured to shield the nozzle from the auxiliary flow and/or from the turbine bulk flow.

The dosing module may comprise a nozzle, positioned in fluid communication with the auxiliary passage such that, in use, the auxiliary flow may pass over the nozzle of the dosing module.

The turbine outlet passage may comprise a bend portion defining an apex, and the dosing module may comprise a nozzle configured to deliver aftertreatment fluid into the turbine outlet passage, the nozzle may be positioned at or upstream of the apex of the bend portion.

The first surface may define a surface of the bend portion and the nozzle may face the first surface.

The auxiliary passage may comprise an auxiliary passage outlet configured to deliver a portion of the auxiliary flow to the turbine outlet passage at a position downstream of a nozzle of the dosing module, and the dividing wall may comprise an auxiliary aperture configured to deliver a portion of the auxiliary flow to the turbine outlet passage at a position aligned with or upstream of the nozzle.

The method may further comprise a turbine housing assembly, the turbine housing assembly may comprise: a turbine housing defining the turbine inlet passage, the turbine wheel chamber and at least a portion of the turbine outlet passage; and a connection adapter defining at least a portion of the turbine outlet passage and at least a portion of the auxiliary passage, the connection adapter may be coupled to the turbine housing at a first interface; the connection adapter may be configured to support the dividing wall for extension along the centreline; and the dividing wall may extend axially along the centreline across the first interface.

The turbine housing assembly may further comprise a downpipe adapter configured for connection to a downpipe, the downpipe adapter may define at least a portion of the turbine outlet passage and/or the auxiliary passage, and may be coupled to the connection adapter at a second interface; and the dividing wall may extend axially along the centreline across the second interface.

The auxiliary passage may be a first auxiliary passage and the auxiliary flow may be a first auxiliary flow, and the turbine may further comprise a second auxiliary passage configured to receive a portion of the turbine bulk flow from the turbine inlet passage, the portion of the turbine bulk flow received by the second auxiliary passage may define a second auxiliary flow, and the second auxiliary passage may be configured to deliver the second auxiliary flow to the turbine outlet passage.

The second auxiliary passage may comprise a second auxiliary passage outlet, the second auxiliary passage outlet may be aligned with or positioned upstream of a nozzle of the dosing module relative to the centreline, and the second auxiliary passage outlet may be configured to direct the second auxiliary flow along the first surface of the dividing wall in a second auxiliary flow layer.

The second auxiliary passage may comprise a second auxiliary passage valve arrangement configured to selectively permit, prevent and/or regulate the flow of second auxiliary flow through the second auxiliary passage.

The method may further comprise a controller configured to selectively activate the dosing module to deliver aftertreatment fluid into the turbine outlet passage.

The step of delivering an atomised spray of aftertreatment fluid into the turbine outlet passage may be carried out in dependence upon the time from engine ignition and/or the temperature of the first surface.

According to a tenth aspect of the present invention, there is provided a turbine for a turbocharger, comprising: a turbine inlet passage configured to receive exhaust gas from an internal combustion engine, the exhaust gas received by the turbine inlet passage defining a turbine bulk flow; a turbine wheel chamber configured to receive the turbine bulk flow from the turbine inlet passage, the turbine wheel chamber containing a turbine wheel supported for rotation about a turbine axis; a turbine outlet passage configured to receive the turbine bulk flow from the turbine wheel chamber; a dosing module configured to deliver an atomised spray of aftertreatment fluid to the turbine outlet passage; an auxiliary passage configured to receive a portion of the turbine bulk flow from a position upstream of the turbine outlet passage, the portion of the turbine bulk flow received by the auxiliary passage defining an auxiliary flow; and an exhaust gas sensor in the auxiliary passage; wherein the exhaust gas sensor is configured to sense one or more physical parameters of the auxiliary flow.

Because the turbine wheel extracts energy from the turbine bulk flow, the pressure of the turbine bulk flow upstream of the turbine outlet passage is generally higher than the pressure of the turbine bulk flow within the turbine outlet passage. As such, the turbine bulk flow flows away from the turbine wheel chamber and carries the aftertreatment fluid with it. Accordingly, the aftertreatment fluid and any reductants decomposed from the aftertreatment fluid such as ammonia (NH3), generally do not pass upstream of the turbine outlet passage. In the present invention, because the auxiliary passage receives the auxiliary flow from a position upstream of the turbine outlet passage, the presence of aftertreatment fluid or reductants in the auxiliary flow is almost entirely eliminated. Accordingly, the auxiliary flow is not contaminated with aftertreatment fluid or reductants, and therefore the auxiliary flow provides an accurate representation of the true physical properties of the exhaust gas produced by the internal combustion engine. As such, more accurate readings of the physical parameters measured by the exhaust gas sensor can be obtained.

In the context of the present invention, a “physical parameter” of an exhaust gas encompasses substantially any quantifiable property of an exhaust gas. This may include for example temperature, pressure, velocity, mass, volumetric flow rate, mass flow rate, or the like. In particular, such a “physical parameter” may include the chemical composition of the exhaust gas and, more particularly, the absolute or relative concentration of a particular chemical constituent of the exhaust gas.

In the context of the present invention, a “position upstream of the turbine outlet passage” encompasses substantially any fluidic position of the turbine from which fluid can flow to the turbine outlet passage (other than from within the auxiliary passage itself).

In the context of the present invention, the exhaust gas sensor being in the auxiliary flow passage encompasses the exhaust gas sensor having a sensing portion configured to interact with the auxiliary flow in which the sensing portion is exposed to the auxiliary flow in the auxiliary passage. That is to say, the exhaust gas sensor is positioned within the auxiliary passage such that when auxiliary flow flows through the auxiliary passage the exhaust gas sensor is able to detect a parameter of the auxiliary flow.

The exhaust gas sensor may be configured to measure the concentration of Nitrogen Oxides (NOx) in the auxiliary flow. That is to say the sensor may be a NOx sensor. The turbine may be for use within an exhaust gas aftertreatment systems comprising an SCR catalysts. Because the exhaust gas sensor is configured to measure the concentration of NOx in the auxiliary flow, the amount of aftertreatment fluid required to reduce the NOx to an acceptable level can be calculated, and the operation of the dosing module controlled accordingly. The exhaust gas sensor may be configured to sense the presence of other substances in addition to NOx in the auxiliary flow, for example the exhaust gas sensor may sense the presence of ammonia (NH3) and isocyanic acid (HNCO).

The auxiliary passage may be sized to receive at least around 0.1% of the turbine bulk flow received by the turbine inlet passage.

That is to say, the proportions of the auxiliary passage are such that at least around 0.5% of the total exhaust gas delivered to the turbine from the internal combustion engine is able to pass through the auxiliary passage. The remaining exhaust gas (i.e. the remaining turbine bulk flow) will pass through the turbine wheel chamber and into the turbine outlet passage. Alternatively, the auxiliary passage may be sized to receive at least around 0.2%, 0.3%, 0.4%, 0.5%, 1%, 1.5%, 2%, or 5% of the turbine bulk flow received by the turbine inlet passage. The relative proportion of the exhaust gas received by the auxiliary passage may be determined based on mass and/or volumetric flow rate. Because the auxiliary passage receives at least around 0.5% of the turbine bulk flow received by the turbine inlet passage, there is a sufficient amount of auxiliary flow available to the exhaust gas sensor to make an accurate measurement of the one or more physical parameters of the auxiliary flow.

The auxiliary passage may be sized to receive at most around 10% of the turbine bulk flow received by the turbine inlet passage. That is to say the proportions of the auxiliary passage are such that at most around 10% of the total exhaust gas delivered to the turbine from the internal combustion engine is able to pass through the auxiliary passage. The remaining exhaust gas (i.e. the remaining turbine bulk flow) will pass through the turbine wheel chamber and into the turbine outlet passage. Alternatively, the auxiliary passage may be sized to receive at most around 1%, 1.5%, 2%, or 5% of the turbine bulk flow received by the turbine inlet passage. The relative proportion of the exhaust gas received by the auxiliary passage may be determined based on mass and/or volumetric flow rate. It will be appreciated that because the auxiliary flow is received from a position upstream of the turbine outlet passage, the auxiliary flow will have bypassed at least a portion of the turbine wheel. This will reduce the amount of power produced by the turbine wheel. However, because the auxiliary passage receives at most around 10% of the turbine bulk flow received by the turbine inlet passage, the amount of power lost is reduced.

The auxiliary passage may be configured such that the auxiliary flow is always permitted to flow therethrough during all operating conditions of the turbine. That is to say, the auxiliary passage may be substantially free of valves and/or closures which are configured prevent the passage of auxiliary flow along the auxiliary passage. Put another way, the auxiliary passage may comprise an auxiliary passage inlet in communication with the position upstream of the turbine outlet passage and an auxiliary passage outlet in communication with the turbine outlet passage, and the auxiliary passage may be configured such that flow from the auxiliary passage inlet to the auxiliary passage outlet is always permitted regardless of the operating condition of the engine. Because flow through the auxiliary passage is always permitted, this ensures that there is a constant supply of auxiliary flow to the exhaust gas sensor during all operating conditions of the engine. Accordingly, flow to the exhaust gas sensor is not interrupted and therefore the readings produced by the exhaust gas sensor are more reliable.

The auxiliary passage may comprise a valve assembly configured to control the flow rate of the auxiliary flow through the auxiliary passage. In particular, the auxiliary passage may be a wastegate passage having a wastegate valve. In such embodiments, the exhaust gas sensor can be positioned within an existing wastegate arrangement and thus the auxiliary passage does not need to be embodied in a passage separate and additional to the wastegate passage. When the auxiliary passage is configured to always permit flow therethrough, the valve assembly may be configured such that in its closed position some leakage across the valve is permitted. Alternatively, the valve assembly may be controlled such that it does not fully close.

The valve assembly may define an open configuration in which auxiliary flow may be permitted to pass therethrough and a closed position in which auxiliary flow may be substantially blocked by the valve assembly, and the valve assembly may comprise a leakage passage configured to permit leakage from one side of the valve assembly to the other when the valve is in the closed configuration. The leakage hole may be considered to form part of the auxiliary passage. It will be understood that the valve assembly may substantially block the auxiliary flow in the closed configuration by blocking a large proportion of the auxiliary flow (e.g. around 90%, 95%, 98%, 98.5%, 99%, 99.5%, 99.6%, 99.7%, 99.8% or 99.9% of the auxiliary flow may be blocked by the valve assembly). The leakage passage may be positioned within the valve itself, for example within a valve member, or may be positioned within a portion of the turbine housing containing the valve assembly.

The auxiliary passage may be configured to deliver the auxiliary flow to the turbine outlet passage. That is to say, the auxiliary passage may be configured to deliver the auxiliary flow to the turbine bulk flow at a position of the turbine outlet passage downstream of the turbine wheel chamber.

The auxiliary passage may be configured to deliver the auxiliary flow to the turbine inlet passage.

The dosing module may comprise a nozzle configured to generate the spray of aftertreatment fluid. For example, the nozzle may be an atomising nozzle.

The turbine outlet passage may be at least partially defined by a surface and may define a centreline, and the nozzle may be substantially aligned with the surface or may be radially outwards of the surface relative to the centreline. That is to say, the nozzle of the dosing module does not protrude into the turbine outlet passage. It is an inherent property of the turbine outlet passage that it will be defined by the surfaces of a housing component, such as for example a turbine housing, a connection adapter, a diffuser or the like. The term “aligned” encompasses the fluid-injecting part of the nozzle lying substantially flush with the surface. As the skilled person would understand, such alignment does not need to be absolute, and small amounts of misalignment may be tolerated provided that the nozzle of the dosing module does not protrude into the turbine outlet passage in a manner which would cause a significant obstruction to the turbine bulk flow. Because the nozzle is substantially aligned with the surface, the turbine outlet passage is generally free of obstructions which would impede exhaust gas flow therethrough.

The turbine may comprise a turbine wheel having an exducer defining an exducer diameter, the turbine outlet passage may define a centreline; and the nozzle may be spaced apart from the exducer of the turbine wheel by a distance of at most around 10 exducer diameters along the centreline of the turbine outlet passage. The term “exducer” encompasses the part of the turbine wheel which functions as the outlet of the turbine wheel. Put another way, the distal end of the turbine wheel from the perspective of the turbine bulk flow travelling therethrough. The term “exducer diameter” encompasses the diameter of the exducer, at the most distal part of the turbine wheel from the perspective of the turbine bulk flow. In alternative embodiments, the nozzle may be positioned no more than around 5, around 3, or around 2 exducer diameters along the centreline of the turbine outlet passage relative to the turbine wheel.

As the turbine bulk flow exits the turbine wheel the temperature of the turbine bulk flow will be at its hottest relative to any position downstream. Generally speaking, the hotter the turbine bulk flow, the more heat is available for heat exchange with the aftertreatment fluid to promote decomposition into the required reductants. By positioning and orienting the dosing module such that the spray region is closer to the turbine wheel, it can be ensured that more heat is available so that faster and fuller aftertreatment fluid decomposition is achieved. By experimentation, it has been found that when the spray region is further than around 10 exducer diameters from the turbine wheel along the centreline, heat has dissipated from the turbine bulk flow and the rate of decomposition is reduced.

The auxiliary passage may be configured to deliver the auxiliary flow into the turbine outlet passage upstream of the nozzle. That is to say, the auxiliary passage may comprise an auxiliary passage outlet configured to deliver the auxiliary flow into the turbine outlet passage, and the auxiliary passage outlet may be positioned upstream of the nozzle relative to the centreline. When the auxiliary flow re-joins the turbine bulk flow in the turbine outlet passage it will disturb the turbine bulk flow causing turbulence. Having some turbulence in the turbine bulk flow is generally beneficial, as this improves mixing of the aftertreatment fluid with the exhaust gas. This in turn increases the rate at which heat is transferred to the aftertreatment fluid, resulting in faster decomposition of the aftertreatment fluid into the reductants required for the SCR reaction. Because the auxiliary flow is delivered to the turbine outlet passage upstream of the nozzle, the turbulence can be established or promoted at a position upstream of the nozzle. Accordingly, when the nozzle injects the aftertreatment fluid into the turbine outlet passage, it does so into a region of turbulent flow, and so the aftertreatment fluid will decompose faster.

The auxiliary passage may be configured to direct the auxiliary flow over the nozzle. During use, aftertreatment fluid may pool at the nozzle. If the aftertreatment fluid cools, it may solidify and block the nozzle. However, when the auxiliary flow is directed over the nozzle, the auxiliary flow will dislodge the pooled aftertreatment fluid thus keeping the nozzle clean.

The auxiliary passage may be configured to receive the auxiliary flow from the turbine inlet passage. In particular, the auxiliary passage may comprise an auxiliary passage inlet in direct fluid communication with the turbine inlet passage. Because the auxiliary flow is received from the turbine inlet passage, and the aftertreatment fluid is delivered within the turbine outlet passage, the chance of aftertreatment fluid entering the auxiliary passage and distorting the measurements of the exhaust gas sensor is further reduced and/or eliminated.

The turbine inlet passage may comprise a first volute and a second volute, and the auxiliary passage may be configured to receive the auxiliary flow from the first volute. That is to say, the auxiliary passage may comprise an auxiliary passage inlet in communication with the first volute. In particular, the auxiliary passage may be configured to receive the auxiliary flow from only the first volute, and not also the second volute. Because the auxiliary passage receives the auxiliary flow from only the first volute, any flow disturbances caused by the auxiliary flow in the turbine inlet passage are limited to the first volute.

The tenth aspect of the invention may be embodied in a turbocharger.

According to an eleventh aspect of the invention, there is provided an exhaust gas aftertreatment system comprising a turbine or a turbocharger according to the previous aspects of the invention; and a catalyst configured to receive the turbine bulk flow downstream of the turbine outlet passage. In particular, the catalyst may be a selective catalytic reduction (SCR) catalyst.

The system may further comprise a controller in communication with the exhaust gas sensor and may be configured to determine a measurement of the one or more physical parameters of the auxiliary flow sensed by the exhaust gas sensor; the controller may be further configured to generate a control signal in dependence upon the measurement of the one or more physical parameters, and the dosing module may be in communication with the controller to receive the control signal and the dosing module may be operable to regulate the rate of delivery of aftertreatment fluid to the turbine outlet passage in dependence upon the control signal. In the context of the present invention, “in communication” may include for example electrical communication, optical communication, wireless communication or the like. The term “regulate” encompasses the dosing module being configured to adjust the rate of delivery of aftertreatment fluid. This may include, for example, increasing or decreasing the rate of delivery, or stopping delivery completely. Because the rate of delivery of aftertreatment fluid is adjusted in dependence upon the output of the exhaust gas sensor, over-delivery of aftertreatment fluid can be avoided and thus the risk of deposit formation can be reduced.

According to a twelfth aspect of the invention, there is provided a method of operating a turbine for a turbocharger, comprising: receiving exhaust gas from an internal combustion engine into a turbine inlet passage, the exhaust gas received by the turbine inlet passage defining a turbine bulk flow; receiving the turbine bulk flow from the turbine inlet passage into a turbine wheel chamber, the turbine wheel chamber containing a turbine wheel supported for rotation about a turbine axis; receiving the turbine bulk flow from the turbine wheel chamber into a turbine outlet passage; receiving a portion of the turbine bulk flow into an auxiliary passage, the portion of the turbine bulk flow received by the auxiliary passage defining an auxiliary flow; delivering an atomised spray of aftertreatment fluid into the turbine outlet passage using a dosing module; and sensing one or more physical parameters of the auxiliary flow using an exhaust gas sensor in fluid communication with the auxiliary flow.

The exhaust gas sensor may be configured to measure the concentration of Nitrogen Oxides (NOx) in the auxiliary flow.

The auxiliary passage may be sized to receive at least around 0.1% of the turbine bulk flow received by the turbine inlet passage.

The auxiliary passage may be sized to receive at most around 10% of the turbine bulk flow received by the turbine inlet passage.

The auxiliary passage may be configured such that the auxiliary flow is always permitted to flow therethrough during all operating conditions of the turbine.

The auxiliary passage may comprise a valve assembly configured to control the flow rate of the auxiliary flow through the auxiliary passage.

The valve assembly may define an open configuration in which auxiliary flow is permitted to pass therethrough and a closed position in which auxiliary flow is substantially blocked by the valve assembly, and the valve assembly may comprise a leakage passage configured to permit leakage from one side of the valve assembly to the other when the valve may be in the closed configuration.

The auxiliary passage may be configured to deliver the auxiliary flow to the turbine outlet passage.

The auxiliary passage may be configured to deliver the auxiliary flow to the turbine inlet passage.

The dosing module may comprise a nozzle configured to generate the spray of aftertreatment fluid.

The turbine outlet passage may be at least partially defined by a surface and defines a centreline, and the nozzle may be substantially aligned with the surface or may be radially outwards of the surface relative to the centreline.

The turbine may comprise a turbine wheel having an exducer defining an exducer diameter, the turbine outlet passage may define a centreline; and the nozzle may be spaced apart from the exducer of the turbine wheel by a distance of at most around 10 exducer diameters along the centreline of the turbine outlet passage.

The auxiliary passage may be configured to deliver the auxiliary flow into the turbine outlet passage upstream of the nozzle.

The auxiliary passage may be configured to direct the auxiliary flow over the nozzle.

The auxiliary passage may be configured to receive the auxiliary flow from the turbine inlet passage.

The turbine inlet passage may comprise a first volute and a second volute, and the auxiliary passage may be configured to receive the auxiliary flow from the first volute.

The method may further comprise: determining a measurement of the one or more physical parameters of the auxiliary flow sensed by the exhaust gas sensor using a controller; and generating a control signal in dependence upon the measurement of the one or more physical parameters of the auxiliary flow using the controller; regulating the rate of delivery of aftertreatment fluid to the turbine outlet passed in dependence upon the control signal using the dosing module.

According to a thirteenth aspect of the invention, there is provided an exhaust gas aftertreatment system comprising: a turbine configured to receive an exhaust gas flow from an internal combustion engine, the turbine comprising: a turbine inlet passage configured to receive exhaust gas from an internal combustion engine, the exhaust gas received by the turbine inlet passage defining a bulk flow, a turbine wheel chamber configured to receive the bulk flow from the turbine inlet passage, the turbine wheel chamber configured to contain a turbine wheel supported for rotation about a turbine axis, a turbine outlet passage configured to receive the bulk flow from the turbine wheel chamber, and a dosing module configured to deliver a spray of aftertreatment fluid into the turbine outlet passage; an exhaust gas passage configured to receive the bulk flow from the turbine outlet passage; and an auxiliary passage configured to receive a portion of the bulk flow, the portion of the bulk flow received by the auxiliary passage defining an auxiliary flow; wherein the exhaust gas passage comprises a predicted aftertreatment fluid concentration zone, and wherein the auxiliary passage is configured to deliver the auxiliary flow to the exhaust gas passage into the predicted aftertreatment fluid concentration zone.

In this context, the term “aftertreatment fluid” encompasses fluid that is injected into the turbine outlet passage by the dosing module and any products that are derived therefrom, such as for example due to heating. Aftertreatment fluid is typically referred to as Diesel Exhaust Fluid (DEF), and comprises a mixture of urea and water. During use, the urea will decompose into the products ammonia and isocyanic acid, however other products may form in addition to this. In this context, such reductants are also encompassed under the meaning of aftertreatment fluid.

An aftertreatment fluid concentration zone encompasses a spatial region of the exhaust gas passage exhibiting a high concentration of aftertreatment fluid relative to exhaust gas. In this context, a high concentration of aftertreatment fluid encompasses a spatial region in which the concentration of aftertreatment fluid is more than the expected concentration of aftertreatment fluid in the exhaust gas passage when the aftertreatment is uniformly distributed. The concentration of aftertreatment fluid may be quantified as a volumetric fraction of the bulk flow in the exhaust gas passage, in parts per million, as a mole fraction, or by any other suitable metric. Such aftertreatment fluid concentration zones are undesirable since the aftertreatment fluid is not sufficiently mixed with the exhaust gas to support conversion of the NOx contained within the exhaust gas by a catalyst positioned further downstream. For example, within the aftertreatment fluid concentration zone the urea content of the aftertreatment fluid may not have decomposed. Even if the urea has decomposed, due to the existence of the aftertreatment fluid concentration zone the urea is not evenly distributed across the width of the exhaust gas passage. This may result in some portions of the downstream catalyst receiving an insufficient supply of reductants to support conversion of NOx.

The predicted aftertreatment fluid concentration zone encompasses a theoretical spatial region of the exhaust gas passage in which the aftertreatment fluid concentration zone would be expected to exist in the absence of the delivery of the auxiliary flow into the exhaust gas passage. That is to say, the predicted aftertreatment fluid concentration zone does not define an aftertreatment fluid concentration zone per se, but rather the position of a possible aftertreatment fluid concentration zone should auxiliary flow not be delivered to the exhaust gas passage. The predicted aftertreatment fluid concentration zone may be calculated, for example, using computational fluid dynamics, and/or could be determined by real-world testing in an engine test cell.

During use, because the auxiliary flow is delivered to the exhaust gas passage into the predicted aftertreatment fluid concentration zone, the auxiliary flow exchanges momentum with the aftertreatment fluid in the predicted aftertreatment fluid concentration zone causing the aftertreatment fluid to disperse more evenly across the width of the exhaust gas passage. Accordingly, decomposition of urea is increased and the resulting reductants are spread evenly across the width of the exhaust gas passage. This ensures that all portions of the downstream catalyst receive sufficient quantities of reductant to support conversion of NOx.

The exhaust gas passage may define a centreline and may comprise a non-linearity that causes a change in momentum of the bulk flow, the turbine may comprise a turbine wheel having an exducer defining an exducer diameter; and the auxiliary passage may be configured to deliver the auxiliary flow into the predicted aftertreatment fluid concentration zone at a position within around 5 exducer diameters of the non-linearity along the centreline. In this context a “non-linearity” encompasses any feature of the exhaust gas passage that diverges from a straight pipe section and which would induce a measureable change in the momentum of the bulk flow. This encompasses, but is not limited to, changes in pipe width, tapered and stepped pipe sections, bends, the presence or turbulators or bluff bodies in the turbine bulk flow, or the like. Because such non-linearities cause the momentum of the bulk flow to change, it has been found that such non-linearities increase the chance that an aftertreatment fluid concentration zone will form. For example, such non-linearities may result in stagnation or recirculation zones at which aftertreatment fluid may collect. When the auxiliary flow is introduced to the exhaust gas passage within around 5 exducer diameters of the non-linearity, the auxiliary flow is able to exchange momentum with the aftertreatment fluid at a position where an aftertreatment fluid concentration zone is likely to occur. In alternative embodiments, the auxiliary passage may be configured to deliver the auxiliary flow into the predicted aftertreatment fluid concentration zone at a position within around 3, around 2, or around 1 exducer diameters of the bend along the centreline. In a further alternative embodiment, the auxiliary passage may be configured to deliver the auxiliary flow into the predicted aftertreatment fluid concentration zone at the non-linearity. In general, the closer that the auxiliary flow is delivered to the non-linearity the more likely it is that the auxiliary flow will disperse the aftertreatment fluid. The auxiliary flow may be delivered upstream or downstream of the non-linearity.

The non-linearity may comprise a bend. Because bends change the direction of the momentum of the bulk flow, it has been found that aftertreatment fluid concentration zones are likely to occur at bends in the exhaust gas passage. In particular, aftertreatment fluid concentration zones are likely to occur slightly downstream of a bend.

The exhaust gas passage may comprise a bend having an inner bend surface defining an inner bend radius and an outer bend surface defining an outer bend radius, the outer bend radius may be larger than the inner bend radius, a portion of the predicted aftertreatment fluid concentration zone may cover at least part of the outer bend surface; and the auxiliary passage may be configured to deliver the auxiliary flow into the portion of the predicted aftertreatment fluid concentration zone covering the outer bend surface. In this context, the term “covers” encompasses the spatial region of the predicted aftertreatment fluid concentration zone being spread over a portion of a wall of the exhaust gas passage defining the outer bend surface. Typically, due to the momentum of the aftertreatment fluid upstream of the bend, a predicted aftertreatment fluid concentration zone will form along at least part of the outer surface of a bend, since the aftertreatment fluid will not change direction until acted upon by the outer surface. Accordingly, the outer surface of a bend in the exhaust gas passage is a suitable location for delivering the auxiliary flow.

The auxiliary passage may comprise an auxiliary passage outlet configured to deliver the auxiliary flow to the exhaust gas passage, and the auxiliary passage outlet may be defined by an opening formed in the outer bend surface.

The outer bend surface may define a proximal end and a distal end relative to the direction of the bulk flow, and the auxiliary passage outlet may be positioned at the distal end of the outer bend surface. Due to the momentum of the aftertreatment fluid upstream of the bend, it is more likely that the predicted aftertreatment fluid concentration zone will form at and cover the outer surface at the distal end of the bend rather than the proximal end of the bend. Therefore, the distal end of the outer bend surface is a suitable location for the introduction of the auxiliary flow.

The bend may define a centreline having an inlet vector and an outlet vector, and the outlet vector may be inclined at an angle of at least around 30° relative to the inlet vector. That is to say, the bend may be a bend having a magnitude of at least around 30°. In alternative embodiments, the outlet vector may be inclined at an angle of at least around 45°, around 60°, around 75°, or around 90° relative to the inlet vector. In general, the larger the change in direction around the bend, the more likely it is that an aftertreatment fluid concentration zone will form. Accordingly, it is beneficial to introduce the auxiliary flow at bends having a large degree of curvature.

The exhaust gas passage may define a centreline; and the auxiliary passage may be configured to deliver the auxiliary flow to the exhaust gas passage in an auxiliary flow direction that may be inclined relative to the centreline by at least around 15°. The auxiliary flow direction encompasses the direction vector of the auxiliary flow at the auxiliary passage outlet. In alternative embodiments, the auxiliary flow direction may be inclined at an angle of at least around 30°, around 45°, around 60°, around 75°, or around 90° relative to the centreline. In general, the steeper the relative angle between the auxiliary flow direction and the centreline, the more turbulence that is generated by momentum exchange between the auxiliary flow and the bulk flow. Increased turbulence in the bulk flow acts to disperse the aftertreatment fluid, and therefore mitigates against the formation or continuation of aftertreatment fluid concentration zones.

The auxiliary flow direction may face upstream relative to direction of the bulk flow. The auxiliary flow direction may be inclined upstream at an angle of at least around 15°, around 30°, around 45°, around 60°, or around 75°. When the auxiliary flow faces upstream, the difference in magnitude between the momentums of bulk flow and the auxiliary flow is increased, thus leading to increased turbulence formation and improved aftertreatment fluid dispersion.

The auxiliary flow direction may face downstream relative to direction of the bulk flow. The auxiliary flow direction may be inclined downstream at an angle of at least around 15°, around 30°, around 45°, around 60°, or around 75°. When the auxiliary flow faces downstream, the difference in magnitude between the momentums of bulk flow and the auxiliary flow is reduced. Accordingly, the angle of introduction can be altered so generate enough turbulence to improve dispersion of the aftertreatment fluid, but not so much that the turbulence causes an impediment to flow of the bulk flow.

The geometry of the predicted aftertreatment fluid concentration zone may be determined using a computational model.

The predicted aftertreatment fluid concentration zone may comprise a spatial region in which the concentration of aftertreatment fluid may be at least around 50% more than the expected concentration of aftertreatment fluid in the exhaust gas passage when the aftertreatment fluid is uniformly distributed. Put another way, the aftertreatment fluid concentration zone comprises a spatial region in which the concentration of aftertreatment fluid is at least around 50% higher than the average concentration of aftertreatment fluid throughout the exhaust gas passage. In alternative embodiments the aftertreatment fluid concentration zone may encompass a spatial region in which the concentration of aftertreatment fluid is at least around 100%, around 150% or around 200% more than the average concentration of aftertreatment fluid throughout the exhaust gas passage

The predicted aftertreatment fluid concentration zone may comprise a spatial region in which the concentration of aftertreatment fluid may be at least around 2.25% by volume of the bulk flow. It has been found that if the aftertreatment fluid is entirely uniformly distributed throughout the bulk flow the relative concentration of the aftertreatment fluid is around 1.5% by volume of the bulk flow. In the context of the present invention, a high concentration zone may therefore encompass a spatial region in which the concentration of aftertreatment fluid is at least 2.25% by volume of the bulk flow. In alternative embodiments, the predicted aftertreatment fluid concentration zone may comprise a spatial region in which the concentration of aftertreatment fluid is at least around 3%, around 3.5%, around 4% or around 5% by volume of the bulk flow.

The auxiliary passage may receive the auxiliary flow from a position upstream of the turbine outlet passage. For example, the auxiliary passage may receive the auxiliary flow from the turbine inlet passage, from leakage over the blades of the turbine wheel in the turbine wheel chamber, or from leakage around nozzle vanes in a variable geometry mechanism.

The auxiliary passage may comprise a valve configured to permit, prevent or regulate the flow rate of auxiliary flow. The valve may be a wastegate valve and the auxiliary passage may be a wastegate passage. The auxiliary passage may be sized so that it is able to receive a sufficient amount of auxiliary flow to provide a wastegating effect on the turbine. For example, the auxiliary passage may be sized so that the flow rate of the auxiliary flow is at least around 20%, or around 50% of the flow rate of the bulk flow delivered to the turbine inlet passage by the internal combustion engine.

The auxiliary passage may be configured such that auxiliary flow is always permitted to pass therethrough. In such embodiments the auxiliary passage may be sized such that the flow rate of the auxiliary flow is small in comparison to the bulk flow, such that the auxiliary flow does not adversely affect the power produced by the turbine. For example, the auxiliary passage may be sized so that the flow rate of auxiliary flow is at most around 1%, around 2%, around 5% or around 10% of the flow rate of the bulk flow delivered to the turbine inlet passage by the internal combustion engine.

According to a fourteenth aspect of the invention, there is provided an exhaust gas aftertreatment system comprising: a turbine configured to receive an exhaust gas flow from an internal combustion engine, the turbine comprising: a turbine inlet passage configured to receive exhaust gas from an internal combustion engine, the exhaust gas received by the turbine inlet passage defining a bulk flow, a turbine wheel chamber configured to receive the bulk flow from the turbine inlet passage, the turbine wheel chamber containing a turbine wheel supported for rotation about a turbine axis, the turbine having an exducer defining an exducer diameter, a turbine outlet passage configured to receive the bulk flow from the turbine wheel chamber, and a dosing module configured to deliver a spray of aftertreatment fluid into the turbine outlet passage; an exhaust gas passage configured to receive the bulk flow from the turbine outlet passage, the exhaust gas passage defining a centreline and comprising a non-linearity; and an auxiliary passage configured to receive a portion of the bulk flow, the portion of the bulk flow received by the auxiliary passage defining an auxiliary flow; wherein the auxiliary passage is configured to deliver the auxiliary flow into exhaust gas passage at a position within around 5 exducer diameters of the non-linearity along the centreline.

The non-linearity may comprise a bend.

The bend may comprise an inner bend surface defining an inner bend radius and an outer bend surface defining an outer bend radius, the outer bend radius may be larger than the inner bend radius; the auxiliary passage may comprise an auxiliary passage outlet configured to deliver the auxiliary flow to the exhaust gas passage; and the auxiliary passage outlet may be defined by an opening formed in the outer bend surface.

The outer bend surface may define a proximal end and a distal end relative to the direction of the bulk flow, and the auxiliary passage outlet may be positioned at the distal end of the outer bend surface.

The bend may define a centreline having an inlet vector and an outlet vector, and the outlet vector may be inclined at an angle of at least around 30° relative to the inlet vector.

The auxiliary passage may be configured to deliver the auxiliary flow to the exhaust gas passage in an auxiliary flow direction that may be inclined relative to the centreline by at least around 15°.

The auxiliary flow direction may face upstream relative to direction of the bulk flow.

The auxiliary flow direction may face downstream relative to direction of the bulk flow.

According to a fifteenth aspect of the invention, there is provided An exhaust gas aftertreatment system comprising: a turbine configured to receive an exhaust gas flow from an internal combustion engine, the turbine comprising: a turbine inlet passage configured to receive exhaust gas from an internal combustion engine, the exhaust gas received by the turbine inlet passage defining a bulk flow, a turbine wheel chamber configured to receive the bulk flow from the turbine inlet passage, the turbine wheel chamber configured to contain a turbine wheel supported for rotation about a turbine axis, a turbine outlet passage configured to receive the bulk flow from the turbine wheel chamber, and a dosing module configured to deliver a spray of aftertreatment fluid into the turbine outlet passage; an exhaust gas passage configured to receive the bulk flow from the turbine outlet passage; and an auxiliary passage configured to receive a portion of the bulk flow, the portion of the bulk flow received by the auxiliary passage defining an auxiliary flow; wherein an internal surface of the exhaust gas passage comprises a predicted aftertreatment fluid impingement risk zone, and wherein the auxiliary passage is configured to direct the auxiliary flow along the portion of the internal surface defining the predicted aftertreatment fluid impingement risk zone in an auxiliary flow layer.

In this context, the term “aftertreatment fluid” encompasses fluid that is injected into the turbine outlet passage by the dosing module and any products that are derived therefrom such as for example due to heating. Aftertreatment fluid is typically referred to as Diesel Exhaust Fluid (DEF), and comprises a mixture of urea and water. During use, the urea will decompose into the products ammonia and isocyanic acid. Such reductants are also encompassed under the meaning of aftertreatment fluid.

An “aftertreatment fluid impingement risk zone” encompasses a region of the internal surfaces of the exhaust gas passage in which there is a high risk that aftertreatment fluid will impinge. That is to say, the aftertreatment fluid impingement risk zone includes regions of the inside of the exhaust gas passage where the momentum of the aftertreatment fluid will cause it to collide with the walls of the exhaust gas passage. In such regions, the walls will to some extent be coated in a layer of impinged aftertreatment fluid. A high aftertreatment fluid impingement risk zone may be defined as any theoretical or observed area of the internal surfaces of the exhaust gas passage having a higher concentration of aftertreatment fluid resting thereupon than the average concentration of aftertreatment fluid resting upon the internal surfaces of the exhaust gas passage as a whole. Additionally or alternatively, the presence of an aftertreatment fluid impingement risk zone may be determined based upon a theoretical or observed wall film thickness of aftertreatment fluid on the internal surface of the exhaust gas conduit. The presence of such aftertreatment fluid impingement risk zones can be determined using computational fluid dynamics and/or by real-life modelling in an engine test cell. Such aftertreatment fluid impingement risk zones are undesirable since aftertreatment fluid which impinges on the walls of the exhaust gas passage may solidify and cause a blockage.

The predicted aftertreatment fluid impingement risk zone encompasses a theoretical region of the internal surfaces of the exhaust gas passage in which the aftertreatment fluid impingement risk zone would be expected to exist in the absence of the delivery of the auxiliary flow into the exhaust gas passage. That is to say, the predicted aftertreatment fluid impingement risk zone does not define an aftertreatment fluid impingement risk zone per se, but rather the position of a possible aftertreatment fluid impingement risk zone should auxiliary flow not be delivered to the exhaust gas passage. The predicted aftertreatment impingement risk zone may be calculated, for example, using computational fluid dynamics.

The “auxiliary flow layer” encompasses a fast-moving and high-shear layer of exhaust gas which passes over the internal surface of the exhaust gas passage. The auxiliary flow layer helps to reduce the amount of aftertreatment fluid which impinges on the internal surface of the exhaust gas passage in a number of ways. First, the auxiliary flow layer forms a fluidic obstruction substantially inhibiting aftertreatment fluid from reaching the predicted aftertreatment fluid impingement risk zone of the internal surface. Secondly, the auxiliary flow layer exerts a shearing force on the aftertreatment fluid which acts to “spread out” any impinged aftertreatment fluid so that it forms a wider and thinner layer on the internal surface of the exhaust gas passage. This increases heat transfer to the impinged aftertreatment fluid so that it evaporates more quickly and prevents it from forming solid deposits. Finally, the high shearing force applied on the impinged aftertreatment fluid by the auxiliary flow layer acts to re-entrain aftertreatment fluid that has collected on the internal surface. As a result of the combination of these properties, during use, the auxiliary flow layer reduces the risk of aftertreatment fluid impingement at the aftertreatment fluid impingement risk zone. As such, deposit formation within the exhaust gas passage can be mitigate or entirely avoided.

The exhaust gas passage may define a centreline and may comprise a non-linearity that causes a change in momentum of the bulk flow, the non-linearity may be at least partially defined by the portion of the internal surface comprising the aftertreatment fluid impingement risk zone.

The non-linearity may comprise a bend of the exhaust gas passage.

The bend may comprise an inner bend surface defining an inner bend radius and an outer bend surface defining an outer bend radius, the outer bend radius may be larger than the inner bend radius, and the outer bend surface may comprise the portion of the internal surface defining the predicted aftertreatment fluid impingement risk zone.

The auxiliary passage may comprise an auxiliary passage outlet configured to deliver the auxiliary flow to the exhaust gas passage, and the auxiliary passage outlet may be defined by an opening formed in the outer bend surface.

The outer bend surface may define a proximal end and a distal end relative to the direction of the bulk flow, and the auxiliary passage outlet may be positioned at the distal end of the outer bend surface. Due to the momentum of the aftertreatment fluid upstream of the bend, it is more likely that the predicted aftertreatment fluid concentration zone will form at and cover the outer surface at the distal end of the bend rather than the proximal end of the bend. Therefore, the distal end of the outer bend surface is a suitable location for the introduction of the auxiliary flow.

The bend may define a centreline having an inlet vector and an outlet vector, and the outlet vector may be inclined at an angle of at least around 30° relative to the inlet vector. That is to say, the bend may be a bend having a magnitude of more at least around 30°. In alternative embodiments, the outlet vector may be inclined at an angle of at least around 45°, around 60°, around 75°, or around 90° relative to the inlet vector. In general, the larger the change in direction around the bend, the more likely it is that an aftertreatment fluid concentration zone will form. Accordingly, it is beneficial to introduce the auxiliary flow at bends having a large degree of curvature.

The geometry of the predicted aftertreatment fluid concentration zone may be determined using a computational model.

The predicted aftertreatment fluid impingement risk zone may comprise a region of an internal surface of the exhaust gas passage in which the rate of impingement of aftertreatment fluid by mass may be more than around 50% greater than the average rate of impingement of aftertreatment fluid by mass for the surfaces of the exhaust gas passage as a whole.

The auxiliary passage may receive the auxiliary flow from a position upstream of the turbine outlet passage. For example, the auxiliary passage may receive the auxiliary flow from the turbine inlet passage, from leakage over the blades of the turbine wheel in the turbine wheel chamber, or from leakage around nozzle vanes in a variable geometry mechanism.

The auxiliary passage may comprise a valve configured to permit, prevent or regulate the flow rate of auxiliary flow. The valve may be a wastegate valve and the auxiliary passage may be a wastegate passage. The auxiliary passage may be sized so that it is able to receive a sufficient amount of auxiliary flow to provide a wastegating effect on the turbine. For example, the auxiliary passage may be sized so that the flow rate of the auxiliary flow is at least around 20%, or around 50% of the flow rate of the bulk flow delivered to the turbine inlet passage by the internal combustion engine.

The auxiliary passage may be configured such that auxiliary flow is always permitted to pass therethrough. In such embodiments the auxiliary passage may be sized such that the flow rate of the auxiliary flow is small in comparison to the bulk flow, such that the auxiliary flow does not adversely affect the power produced by the turbine. For example, the auxiliary passage may be sized so that the flow rate of auxiliary flow is at most around 1%, around 2%, around 5% or around 10% of the flow rate of the bulk flow delivered to the turbine inlet passage by the internal combustion engine.

According to a sixteenth aspect of the invention, there is provided an exhaust gas aftertreatment system comprising: a turbine configured to receive an exhaust gas flow from an internal combustion engine, the turbine comprising: a turbine inlet passage configured to receive exhaust gas from an internal combustion engine, the exhaust gas received by the turbine inlet passage defining a bulk flow, a turbine wheel chamber configured to receive the bulk flow from the turbine inlet passage, the turbine wheel chamber configured to contain a turbine wheel supported for rotation about a turbine axis, a turbine outlet passage configured to receive the bulk flow from the turbine wheel chamber, and a dosing module configured to deliver a spray of aftertreatment fluid into the turbine outlet passage; an exhaust gas passage configured to receive the bulk flow from the turbine outlet passage, the exhaust gas passage comprising a non-linearity defined by an internal surface of the exhaust gas passage; and an auxiliary passage configured to receive a portion of the bulk flow, the portion of the bulk flow received by the auxiliary passage defining an auxiliary flow; wherein the auxiliary passage is configured to direct the auxiliary flow along the internal surface of the non-linearity in an auxiliary flow layer.

The auxiliary passage may receive the auxiliary flow from a position upstream of the turbine outlet passage. For example, the auxiliary passage may receive the auxiliary flow from the turbine inlet passage, from leakage over the blades of the turbine wheel in the turbine wheel chamber, or from leakage around nozzle vanes in a variable geometry mechanism.

The non-linearity may comprise a bend of the exhaust gas passage.

The bend may comprise an inner bend surface defining an inner bend radius and an outer bend surface defining an outer bend radius, the outer bend radius may be larger than the inner bend radius, the outer bend surface may comprise the internal surface; and the auxiliary passage may be configured to direct the auxiliary flow layer along the outer bend surface.

The auxiliary passage may comprise an auxiliary passage outlet configured to deliver the auxiliary flow to the exhaust gas passage, and the auxiliary passage outlet may be defined by an opening formed in the outer bend surface.

The outer bend surface may define a proximal end and a distal end relative to the direction of the bulk flow, and the auxiliary passage outlet may be positioned at the distal end of the outer bend surface.

The bend may define a centreline having an inlet vector and an outlet vector, and the outlet vector may be inclined at an angle of at least around 30° relative to the inlet vector.

According to a seventeenth aspect of the invention, there is provided an exhaust gas aftertreatment system comprising: a turbine configured to receive an exhaust gas flow from an internal combustion engine, the turbine comprising: a turbine inlet passage configured to receive exhaust gas from an internal combustion engine, the exhaust gas received by the turbine inlet passage defining a bulk flow, a turbine wheel chamber configured to receive the bulk flow from the turbine inlet passage, the turbine wheel chamber configured to contain a turbine wheel supported for rotation about a turbine axis, a turbine outlet passage configured to receive the bulk flow from the turbine wheel chamber, and a dosing module configured to deliver a spray of aftertreatment fluid into the turbine outlet passage; an exhaust gas passage configured to receive the bulk flow from the turbine outlet passage; and an auxiliary passage configured to receive a portion of the bulk flow, the portion of the bulk flow received by the auxiliary passage defining an auxiliary flow; wherein the exhaust gas passage is defined at least in part by a first surface of a dividing wall, and the auxiliary passage is defined at least in part by a second surface of the dividing wall, the dividing wall being configured to provide thermal communication from the auxiliary passage to the first surface via the second surface; and wherein at least part of the first surface of the dividing wall comprises an aftertreatment fluid impingement risk zone.

During use, when aftertreatment fluid is injected into the turbine outlet passage it may impinge on the first surface. The aftertreatment fluid is generally at a lower temperature than the bulk flow, and therefore forms a heat sink driving heat transfer from the first surface to the aftertreatment fluid. The first surface is heated from two sources. First, the first surface is heated by convective heat transfer from the bulk flow passing through the exhaust gas passage. Secondly, the first surface is heated by the auxiliary flow passing through the auxiliary passage; and in particular by convective heat transfer from the auxiliary flow to the second surface and conductive heat transfer from the second surface to the first surface through the material of the dividing wall. The first and second surfaces therefore ensure that there is a large surface area available for capturing heat from the bulk and auxiliary flows so that this can be transferred to the aftertreatment fluid (for example, compared to the situation in which the auxiliary passage was absent). As a result, the amount of heat that is transferred to the impinged aftertreatment fluid is increased, causing the temperature of the aftertreatment fluid to rise until the aftertreatment fluid evaporates. Accordingly, the formation of deposits in the exhaust gas passage is reduced or prevented.

The first surface may be disposed on an opposite side of the dividing wall to the second surface. The first surface may, in particular, be parallel to the second surface and face in an opposite direction to the second surface. Because the first and second surfaces are on opposite sides of the dividing wall, this provides a direct path for thermal conduction from the second surface to the first surface, leading to improved heating of the first surface.

The dividing wall may define a thickness between the first surface and the second surface, the turbine may comprise a turbine wheel having an exducer portion defining an exducer diameter, and the thickness of the dividing wall may be around 1% to around 10% of the exducer diameter. As such, the dividing wall is relatively thin compared to the geometry of the turbine and the exhaust gas passage. Because the dividing wall is thin, it is better able to conduct heat therethrough. In some embodiments, the thickness of the dividing wall may be up to around 40% of the exducer diameter.

The exhaust gas passage may comprise a non-linearity at least partially defined by the part of the first surface comprising the aftertreatment fluid impingement risk zone.

The non-linearity may comprise a bend.

The bend may comprise an inner bend surface defining an inner bend radius and an outer bend surface defining an outer bend radius, the outer bend may be being larger than the inner bend radius, and the outer bend surface may comprise the part of the first surface defining the aftertreatment fluid impingement risk zone.

The auxiliary passage may comprise an auxiliary passage outlet configured to deliver the auxiliary flow to the exhaust gas passage, and the auxiliary passage outlet may be defined by an opening formed in the outer bend surface.

The outer bend surface may define a proximal end and a distal end relative to the direction of the bulk flow, and the auxiliary passage outlet may be positioned at the distal end of the outer bend surface.

The geometry of the aftertreatment fluid impingement risk zone may be determined using a computational model. The aftertreatment fluid impingement risk zone may alternatively be determined by physical inspection, for example by observing evidence of aftertreatment fluid impingement such as surface pitting etc.

The predicted aftertreatment fluid impingement risk zone may comprise a region of an internal surface of the exhaust gas passage in which the rate of impingement of aftertreatment fluid by mass may be more than around 50% greater than the average rate of impingement of aftertreatment fluid by mass for the surfaces of the exhaust gas passage as a whole.

The auxiliary passage may receive the auxiliary flow from a position upstream of the turbine outlet passage. For example, the auxiliary passage may receive the auxiliary flow from the turbine inlet passage, from leakage over the blades of the turbine wheel in the turbine wheel chamber, or from leakage around nozzle vanes in a variable geometry mechanism.

The auxiliary passage may comprise a valve configured to permit, prevent or regulate the flow rate of auxiliary flow. The valve may be a wastegate valve and the auxiliary passage may be a wastegate passage. The auxiliary passage may be sized so that it is able to receive a sufficient amount of auxiliary flow to provide a wastegating effect on the turbine. For example, the auxiliary passage may be sized so that the flow rate of the auxiliary flow is at least around 20%, or around 50% of the flow rate of the bulk flow delivered to the turbine inlet passage by the internal combustion engine.

The auxiliary passage may be configured such that auxiliary flow is always permitted to pass therethrough. In such embodiments the auxiliary passage may be sized such that the flow rate of the auxiliary flow is small in comparison to the bulk flow, such that the auxiliary flow does not adversely affect the power produced by the turbine. For example, the auxiliary passage may be sized so that the flow rate of auxiliary flow is at most around 1%, around 2%, around 5% or around 10% of the flow rate of the bulk flow delivered to the turbine inlet passage by the internal combustion engine.

According to an eighteenth aspect of the invention there is provided, an exhaust gas aftertreatment system comprising: a turbine configured to receive an exhaust gas flow from an internal combustion engine, the turbine comprising: a turbine inlet passage configured to receive exhaust gas from an internal combustion engine, the exhaust gas received by the turbine inlet passage defining a bulk flow, a turbine wheel chamber configured to receive the bulk flow from the turbine inlet passage, the turbine wheel chamber configured to contain a turbine wheel supported for rotation about a turbine axis, a turbine outlet passage configured to receive the bulk flow from the turbine wheel chamber, and a dosing module configured to deliver a spray of aftertreatment fluid into the turbine outlet passage;
an exhaust gas passage configured to receive the bulk flow from the turbine outlet passage, the exhaust gas passage defining a bend; and an auxiliary passage configured to receive a portion of the bulk flow, the portion of the bulk flow received by the auxiliary passage defining an auxiliary flow; wherein the bend of the exhaust gas passage is defined at least in part by a first surface of a dividing wall, and the auxiliary passage is defined at least in part by a second surface of the dividing wall, the dividing wall being configured to provide thermal communication from the auxiliary passage to the first surface via the second surface.

The first surface may be disposed on an opposite side of the dividing wall to the second surface.

The dividing wall may define a thickness between the first surface and the second surface, the turbine may comprise a turbine wheel having an exducer portion defining an exducer diameter, and the thickness of the dividing wall may be around 1% to around 10% of the exducer diameter.

The bend may comprise an inner bend surface defining an inner bend radius and an outer bend surface defining an outer bend radius, the outer bend radius may be larger than the inner bend radius, and the outer bend surface may comprise the first surface of the dividing wall.

The auxiliary passage may comprise an auxiliary passage outlet configured to deliver the auxiliary flow to the exhaust gas passage, and the auxiliary passage outlet may be defined by an opening formed in the outer bend surface.

The outer bend surface may define a proximal end and a distal end relative to the direction of the bulk flow, and the auxiliary passage outlet may be positioned at the distal end of the outer bend surface.

A detailed description of various embodiments of the invention will now be provided with reference to the accompanying drawings, in which:

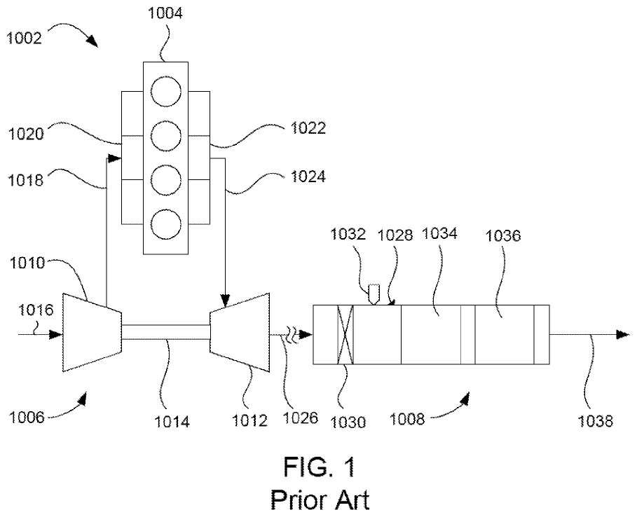

FIG. 1 is a schematic illustration of a prior art internal combustion engine system;

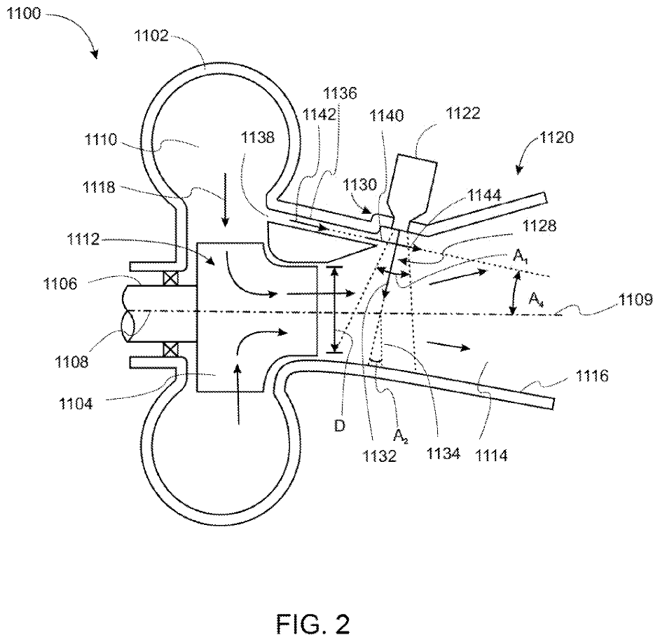

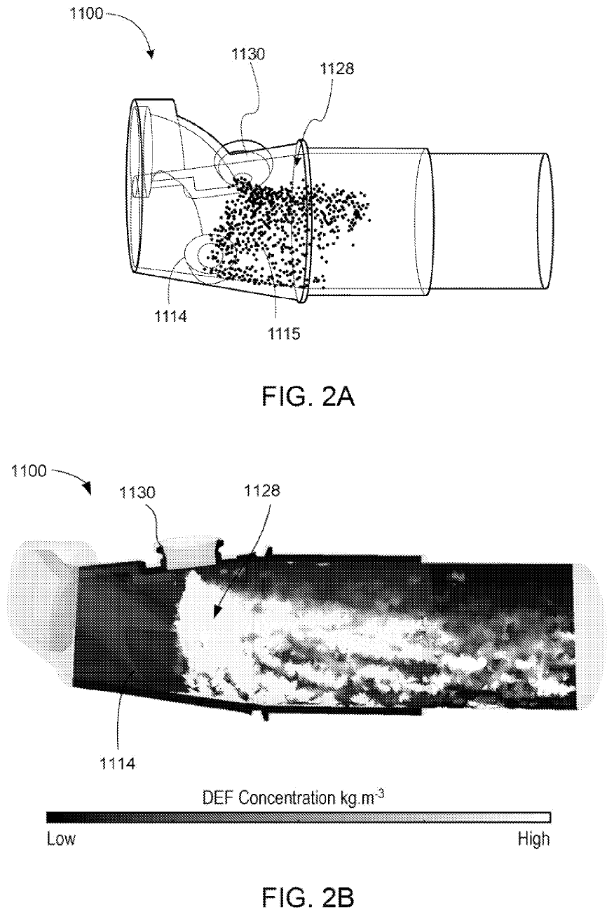

FIG. 2 is a schematic cross-sectional side view of an embodiment of a turbine according to the present invention;

FIG. 2A shows a computational fluid dynamics model of aftertreatment fluid particle location in a turbine according to the present invention;

FIG. 2B shows a computational fluid dynamics model of aftertreatment fluid concentration in a turbine according to the present invention;

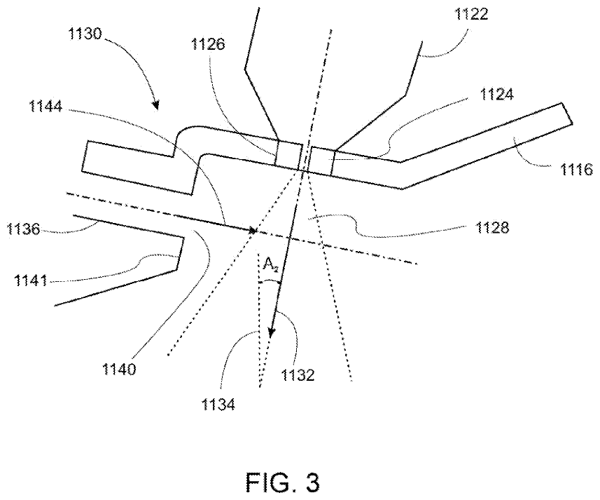

FIG. 3 is an enlarged cross-sectional side view a portion of the turbine of FIG. 2;

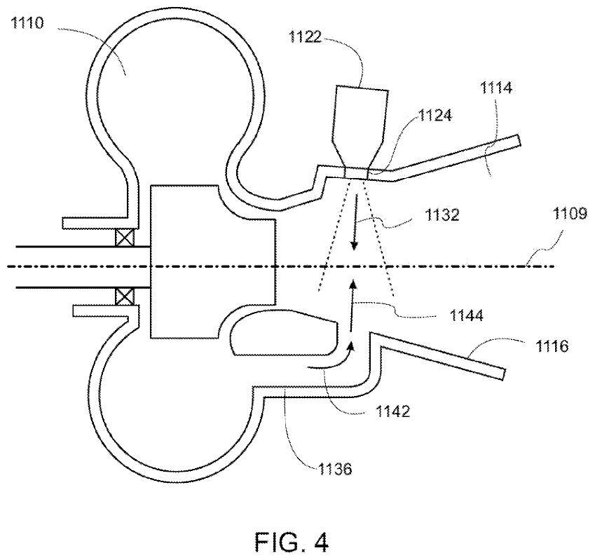

FIG. 4 is a schematic cross-sectional side view of a further embodiment of a turbine according to the present invention;

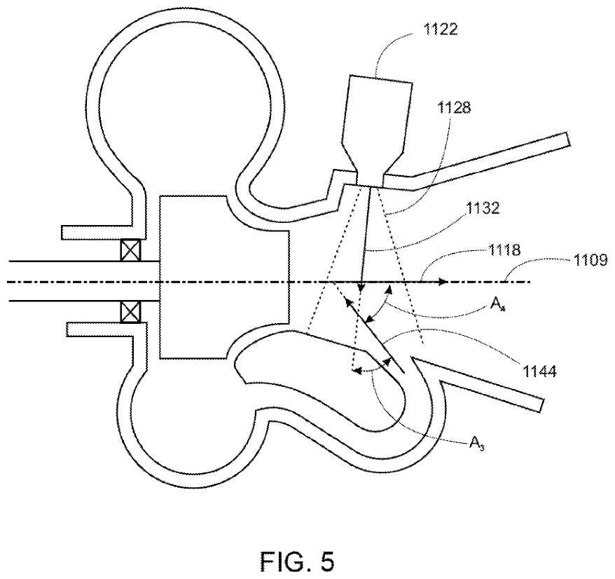

FIG. 5 is a schematic cross-sectional side view of a further embodiment of a turbine according to the present invention;

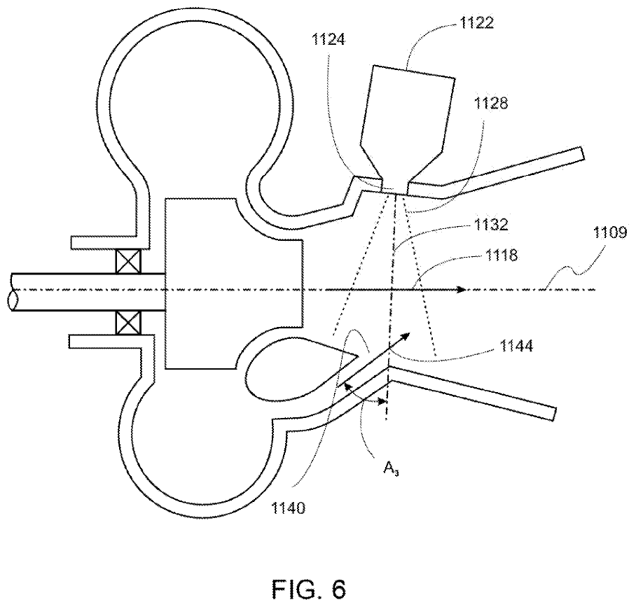

FIG. 6 is a schematic cross-sectional side view of a further embodiment of a turbine according to the present invention;

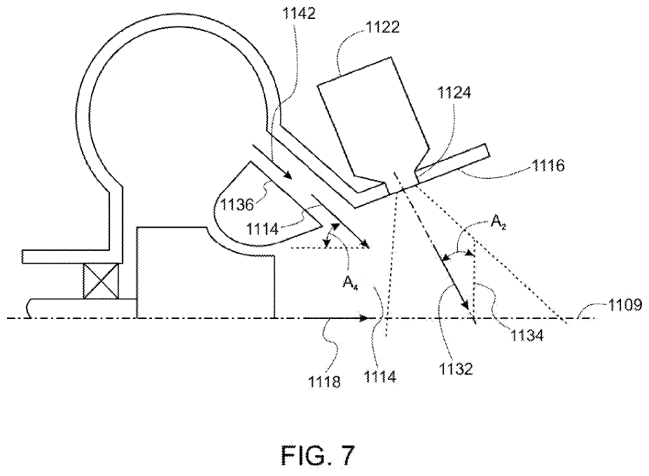

FIG. 7 is a schematic cross-sectional side view of a further embodiment of a turbine according to the present invention;

FIG. 7A is a schematic cross-sectional side view of further embodiment of a turbine according to the present invention, comprising a barrier member;

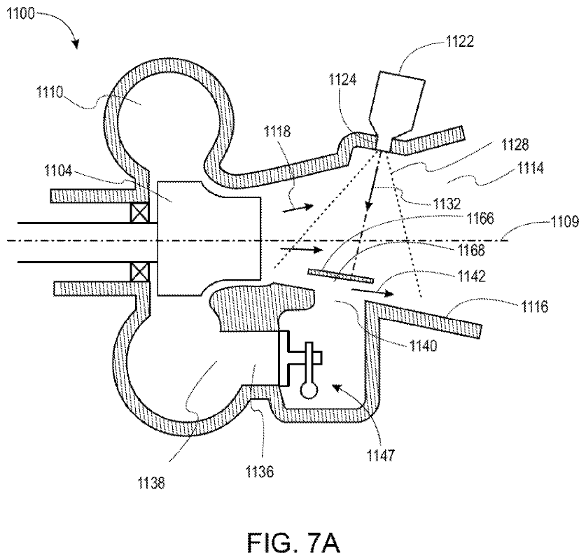

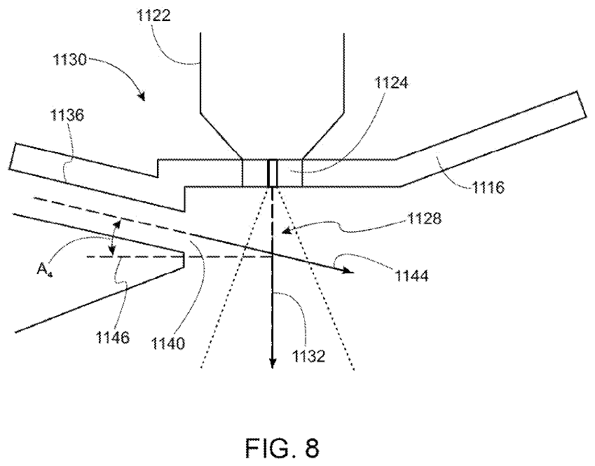

FIG. 8 is a schematic cross-sectional side view of a portion of a turbine according to a further embodiment of the present invention;

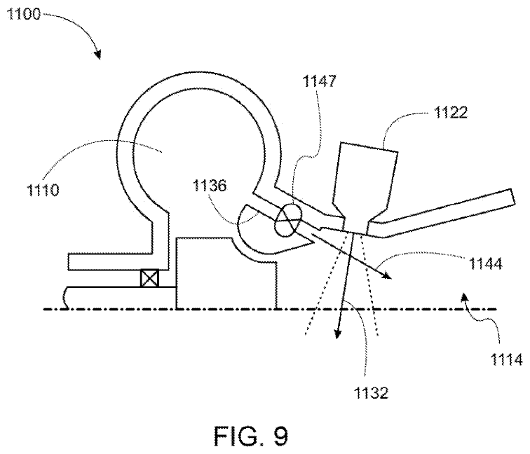

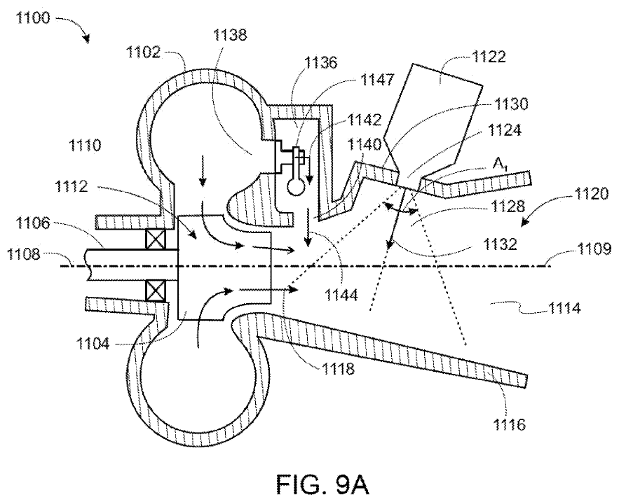

FIG. 9 is a schematic cross-sectional side view of a further embodiment of a turbine according to the present invention;

FIG. 9A is a schematic cross-sectional side view of a further embodiment of a turbine according to the present invention;

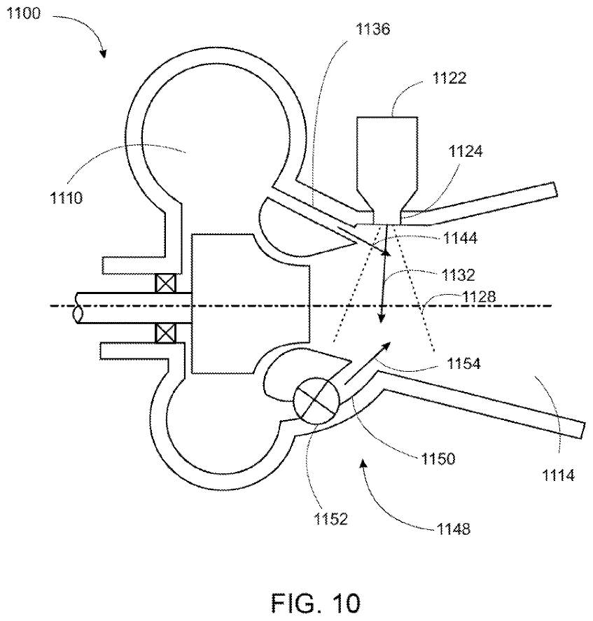

FIG. 10 is a schematic cross-sectional side view of a further embodiment of a turbine according to the present invention;

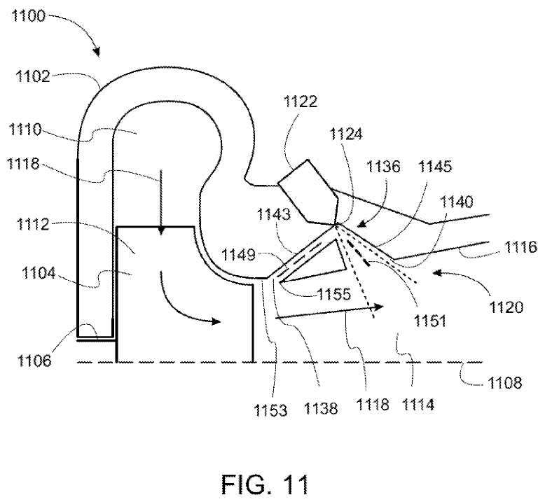

FIG. 11 is a schematic cross-sectional side view of a further embodiment of a turbine according to the present invention;

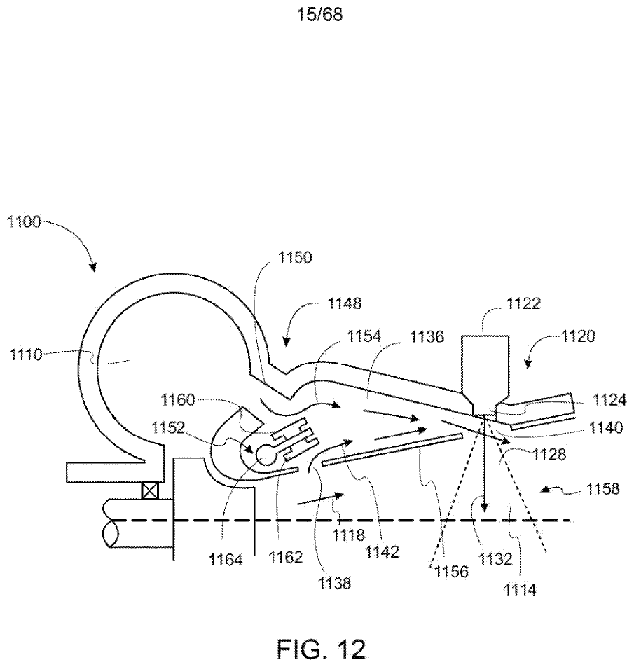

FIG. 12 is a schematic cross-sectional side view of a further embodiment of a turbine according to the present invention;

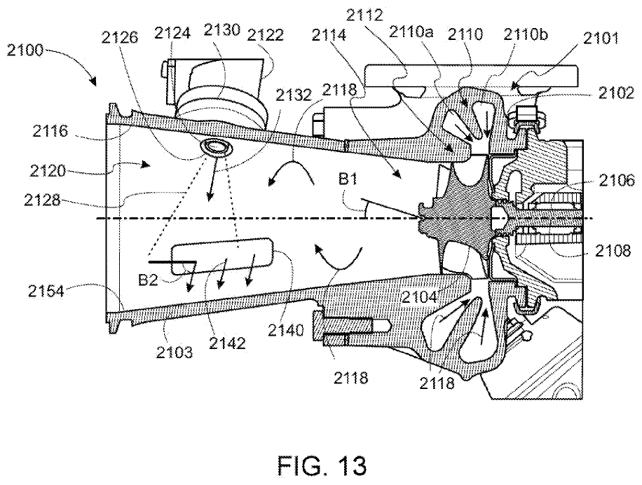

FIG. 13 shows a cross-sectional side view of a turbine according to an embodiment of the present invention;

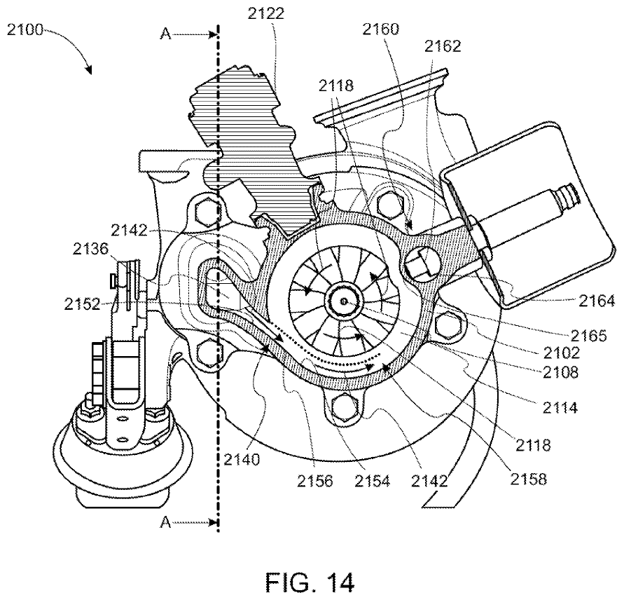

FIG. 14 shows a cross-sectional end view of the turbine of FIG. 13;

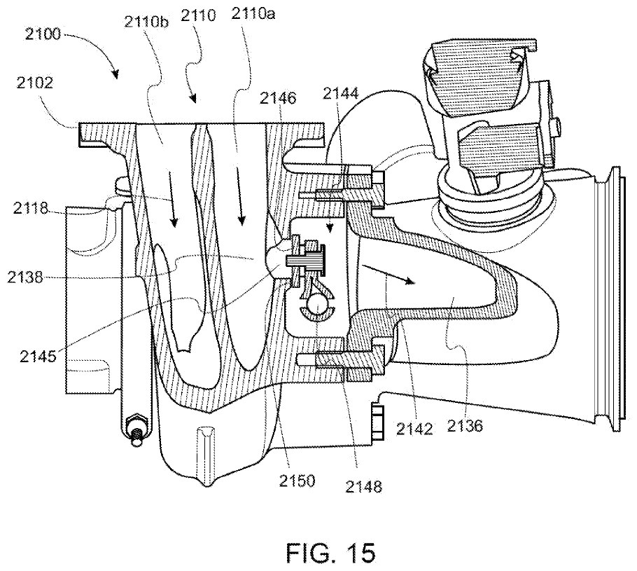

FIG. 15 shows a cross-sectional side view of a wastegate arrangement of the turbine of the FIG. 13 through the line A-A of FIG. 14;

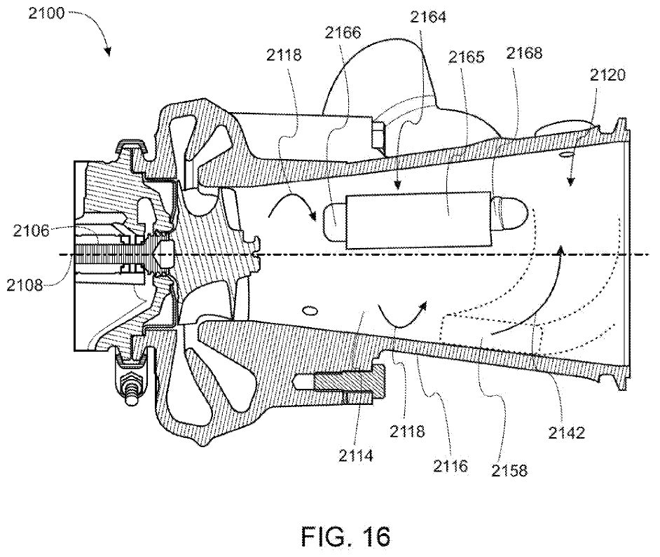

FIG. 16 shows an opposite cross-sectional side view of the turbine of the FIG. 13;

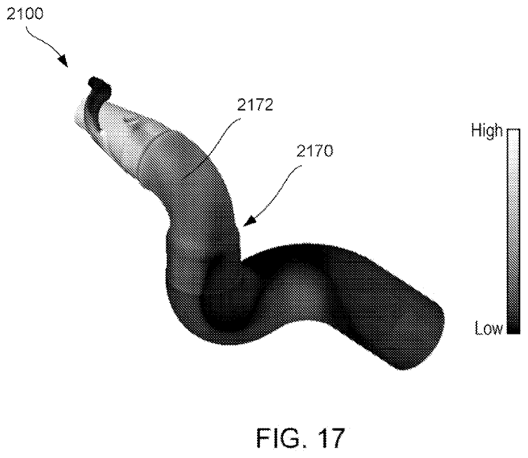

FIG. 17 shows a plot of wall shear within a flow volume of the turbine of the FIG. 13;

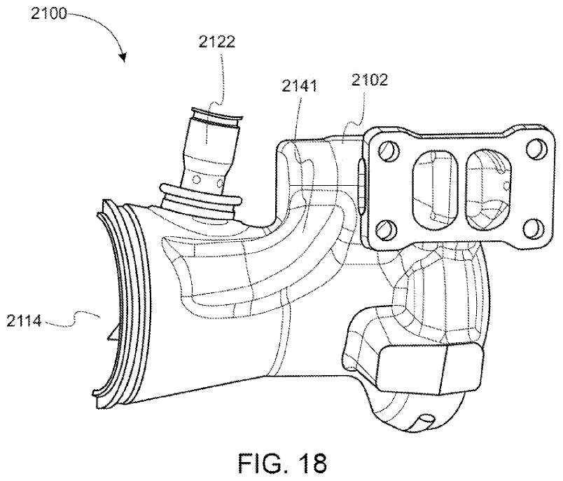

FIG. 18 shows a variation of a turbine according to the present invention comprising a bifurcated auxiliary passage;

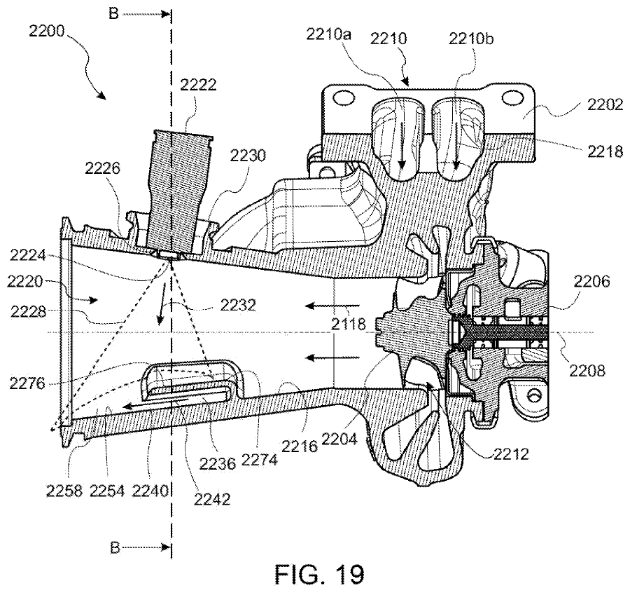

FIG. 19 shows a cross-sectional side view of a turbine according to another embodiment of the present invention;

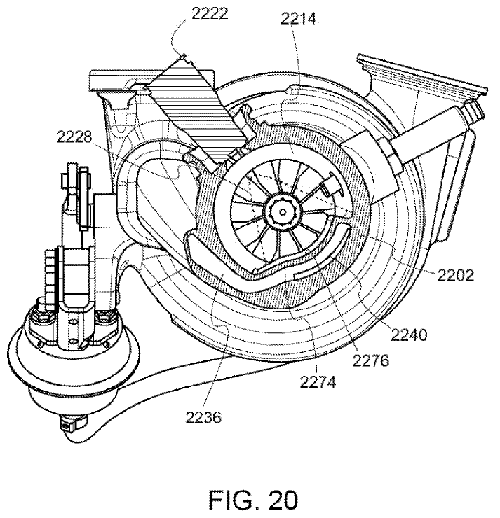

FIG. 20 shows a cross-sectional end view of the turbine of FIG. 19 through the line B-B of FIG. 19;

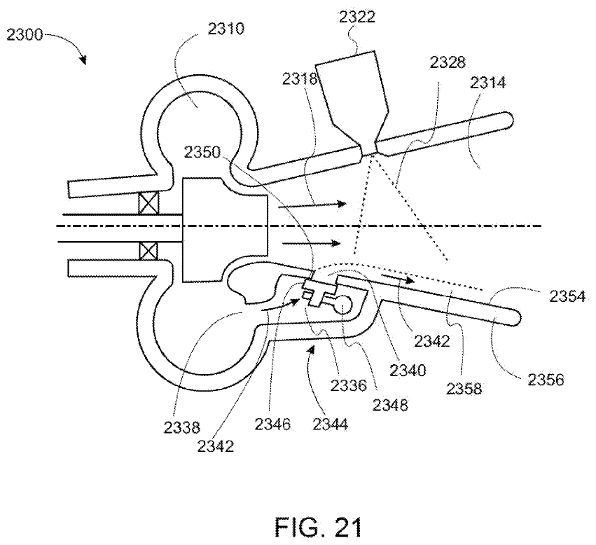

FIG. 21 shows a schematic cross-sectional side view of a turbine according to another embodiment of the present invention;

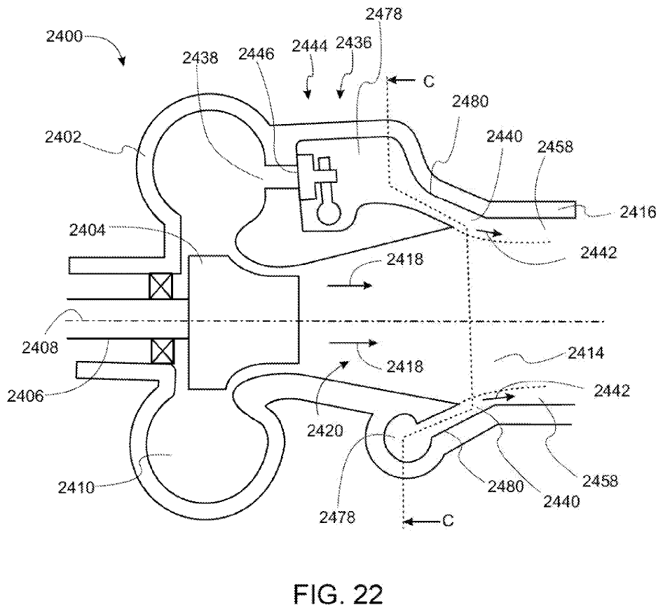

FIG. 22 shows a schematic cross-sectional side view of a turbine according to another embodiment of the present invention;

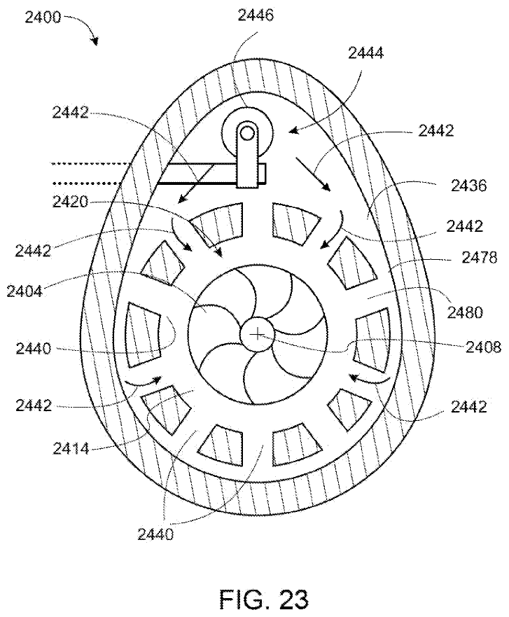

FIG. 23 shows a schematic cross-sectional end view of the turbine of FIG. 22 though the line C-C of FIG. 22;

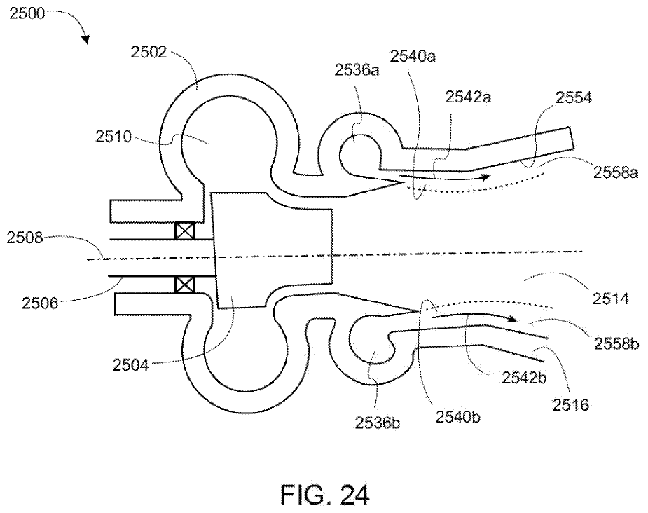

FIG. 24 is a schematic cross-sectional side view of a turbine according to another embodiment of the present invention;

FIG. 25 is a schematic cross-sectional end view of the turbine of FIG. 24;

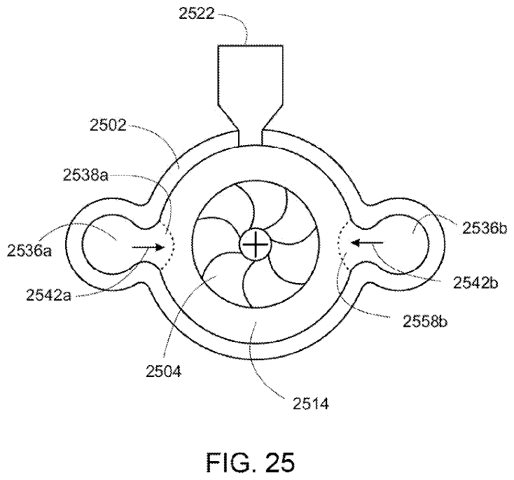

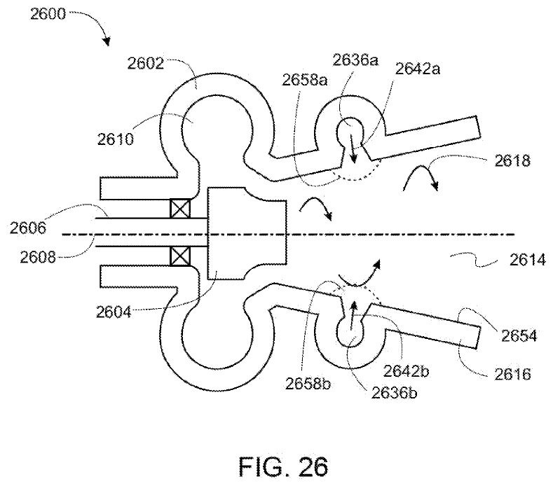

FIG. 26 is a schematic cross-sectional side view of a turbine according to a another embodiment of the present invention;

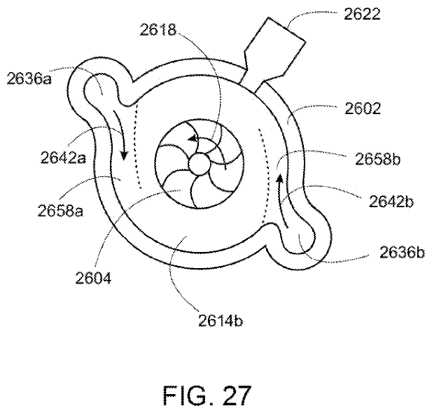

FIG. 27 is a schematic cross-sectional end view of the turbine of FIG. 26;

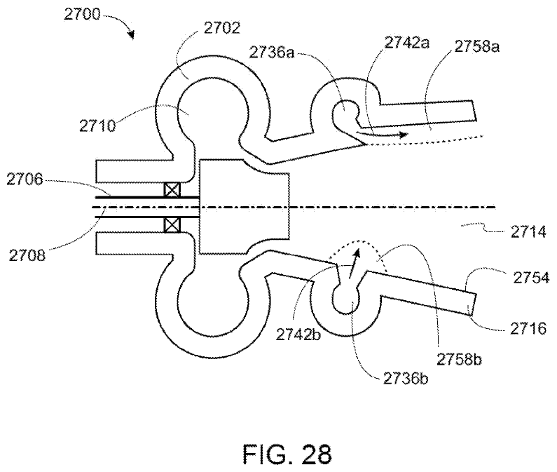

FIG. 28 is a schematic cross-sectional side view of a turbine according to another embodiment of the present invention;

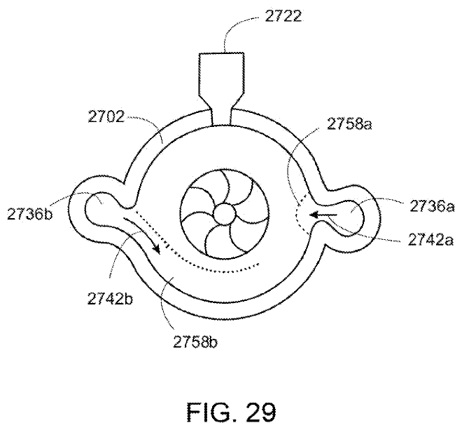

FIG. 29 is a schematic cross-sectional end view of the turbine of FIG. 28;

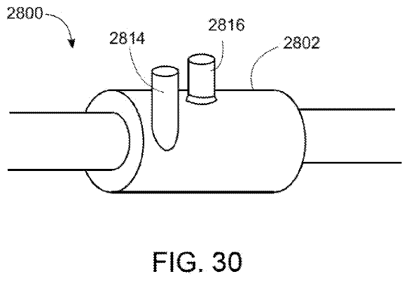

FIG. 30 is a schematic perspective view of an aftertreatment system according to another embodiment of the present invention;

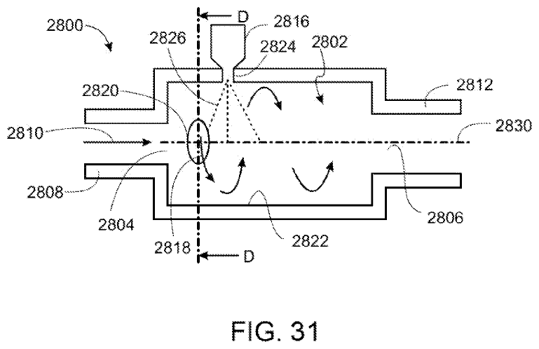

FIG. 31 is a schematic cross-sectional side view of the aftertreatment system of FIG. 30;

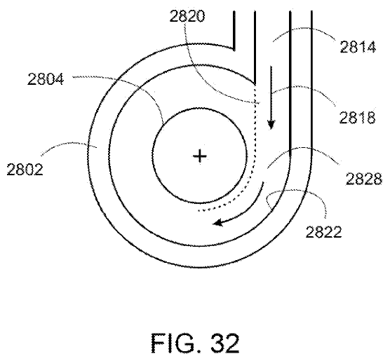

FIG. 32 is a schematic cross-sectional end view through the line D-D of FIG. 31;

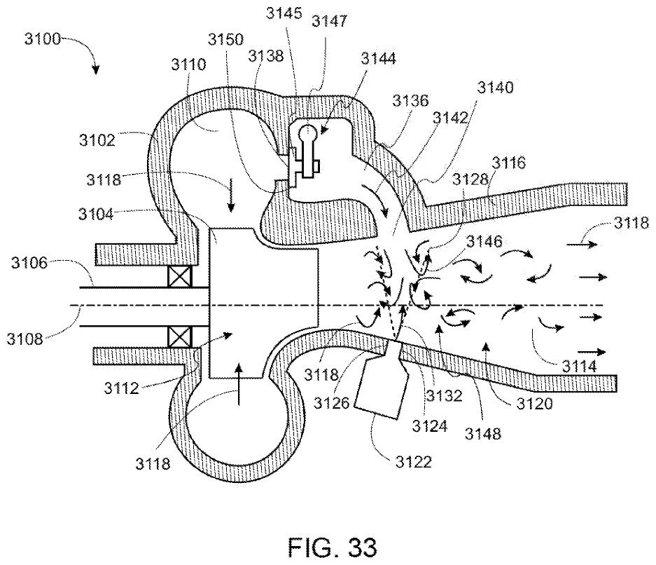

FIG. 33 shows a cross-sectional side view of a turbine according to another embodiment of the present invention;

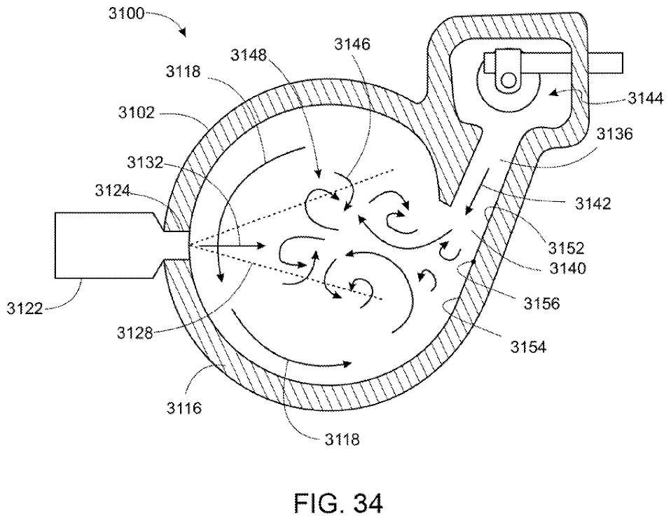

FIG. 34 shows a cross-sectional end view of the turbine of the FIG. 33;

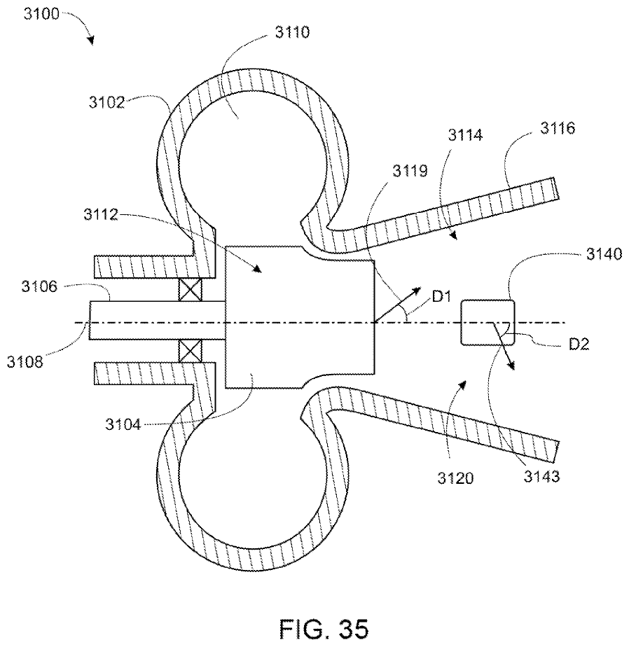

FIG. 35 shows a further cross-sectional side view of the turbine in a plane orthogonal to the view shown in FIG. 33;

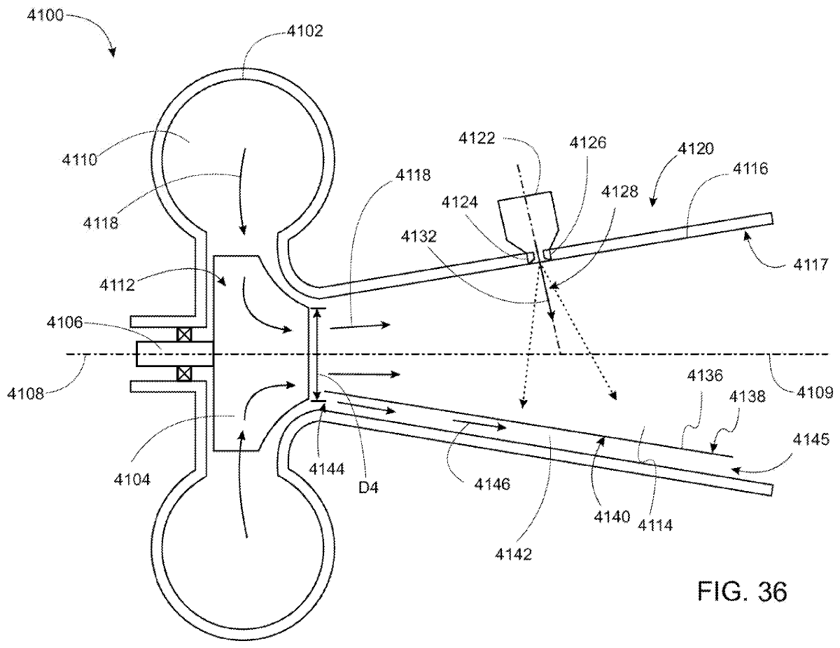

FIG. 36 is a schematic cross sectional side view of another embodiment of a turbine according to the present invention;

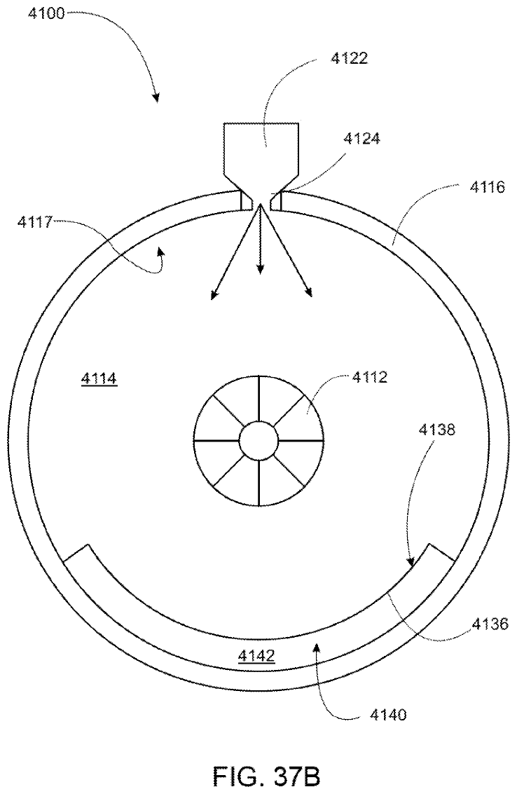

FIG. 37 is a schematic end view of the turbine according to FIG. 36;

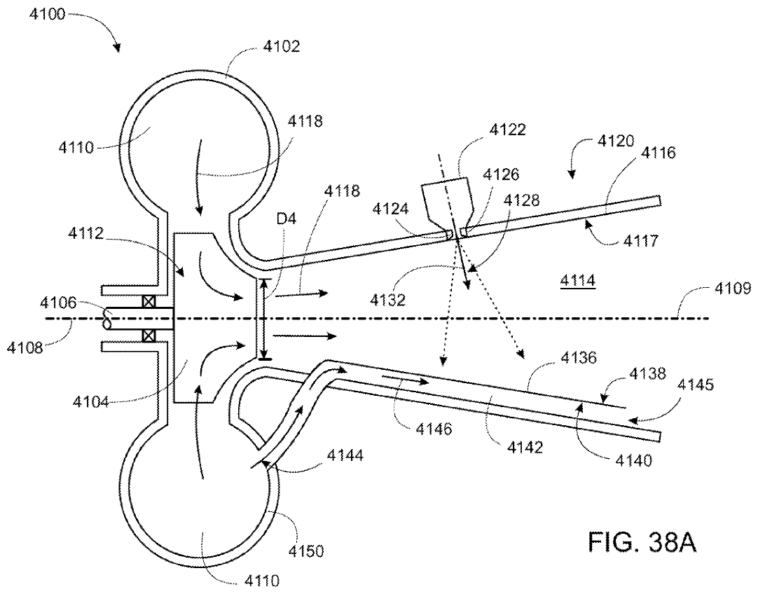

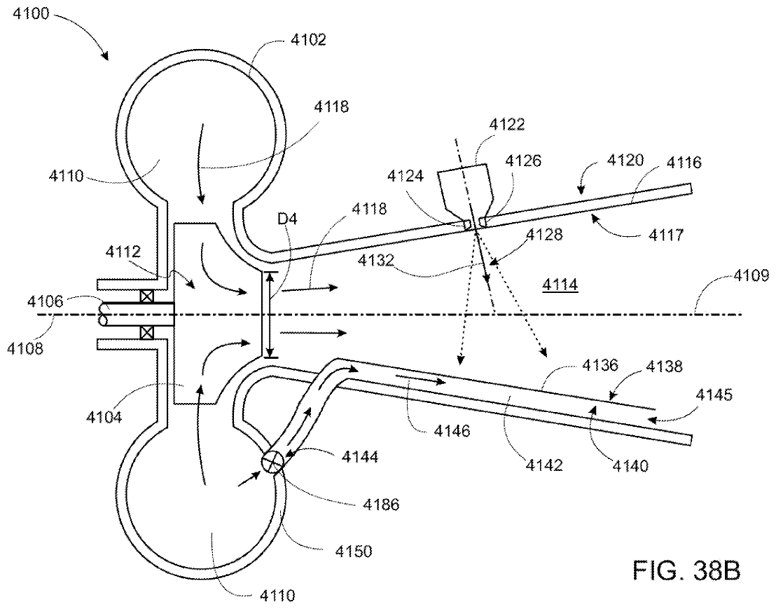

FIG. 38A is a schematic cross-sectional side view of another embodiment of a turbine according to the present invention;

FIG. 38B is a schematic cross-sectional side view of variant of the turbine according to FIG. 38A;

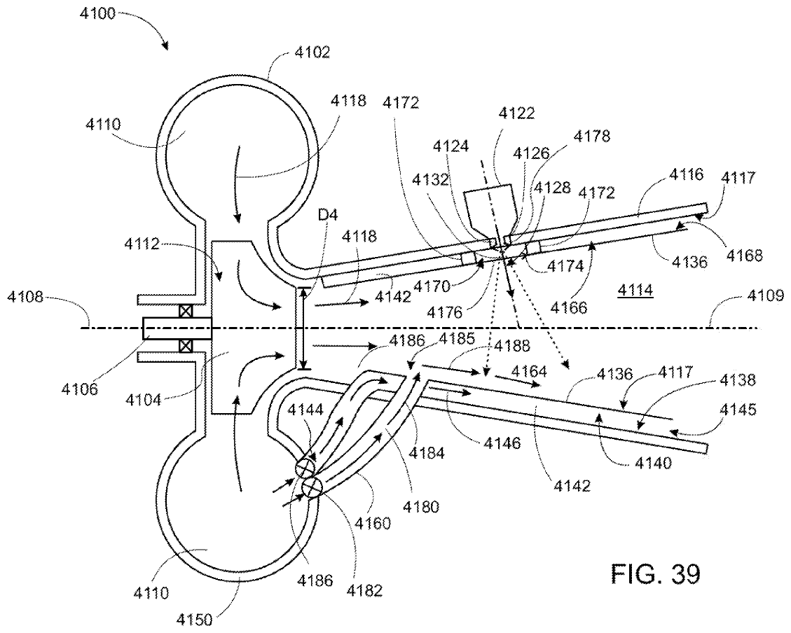

FIG. 39 is a schematic cross-sectional side view of another embodiment of a turbine according to the present invention;

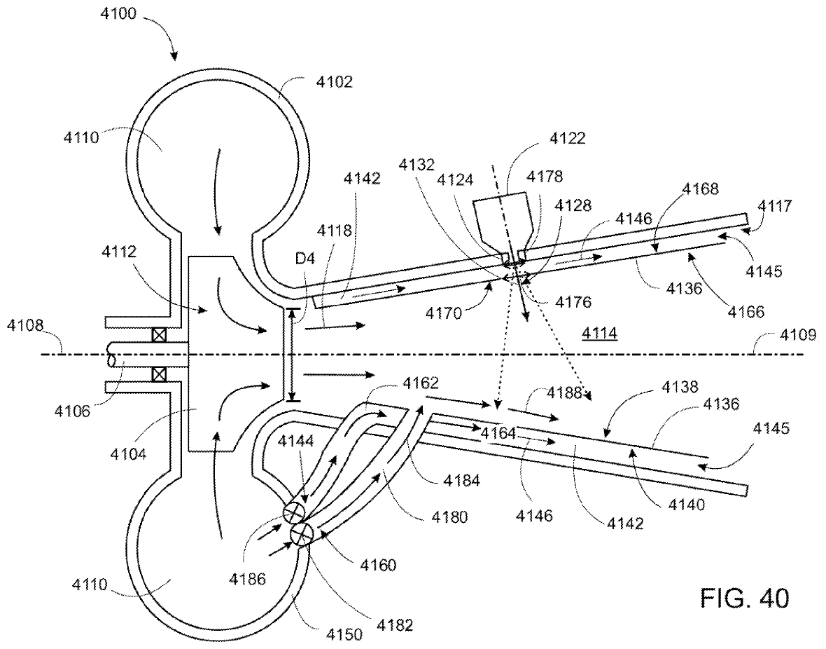

FIG. 40 is a schematic cross-sectional side view of another embodiment of a turbine according to the present invention;

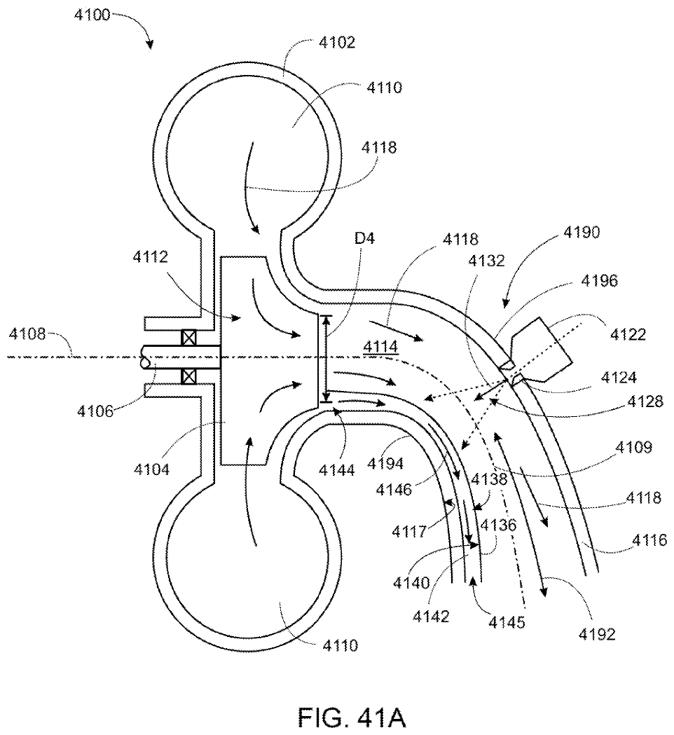

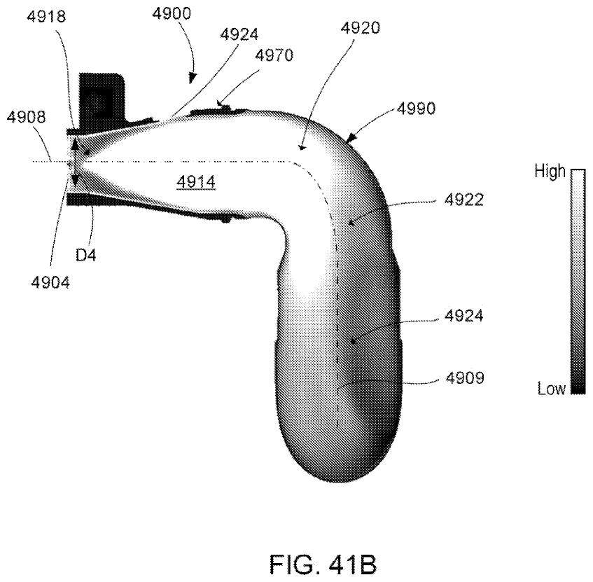

FIG. 41A is a schematic cross-sectional side view of another embodiment of a turbine according to the present invention:

FIG. 41B shows results of a CFD simulation conducted on a turbine according to another embodiment, illustrating exhaust gas turbulent kinetic energy variation downstream of the turbine wheel; and

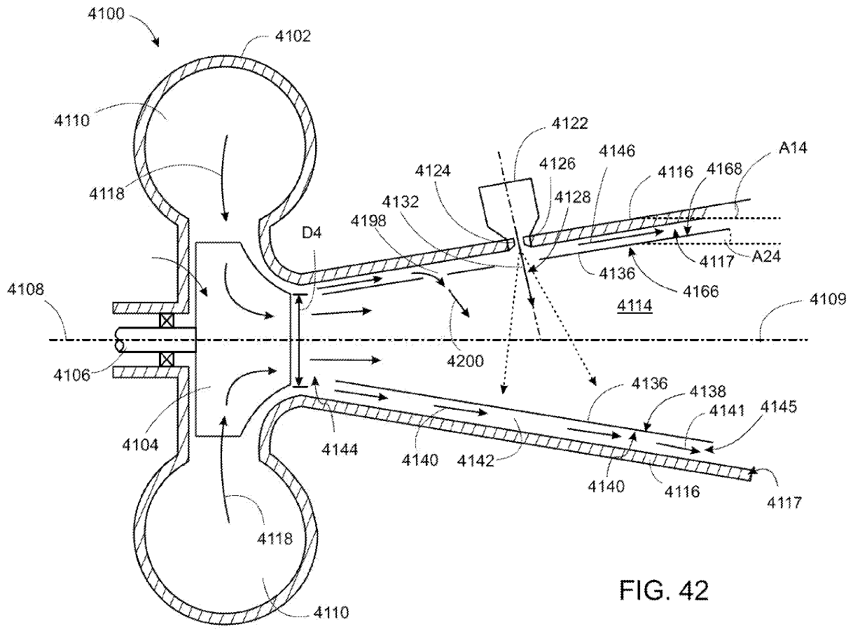

FIG. 42 is a schematic cross-sectional side view of another embodiment of a turbine according to the present invention;

FIG. 43A shows a schematic cross-sectional end view of another embodiment of a turbine according to the present invention;

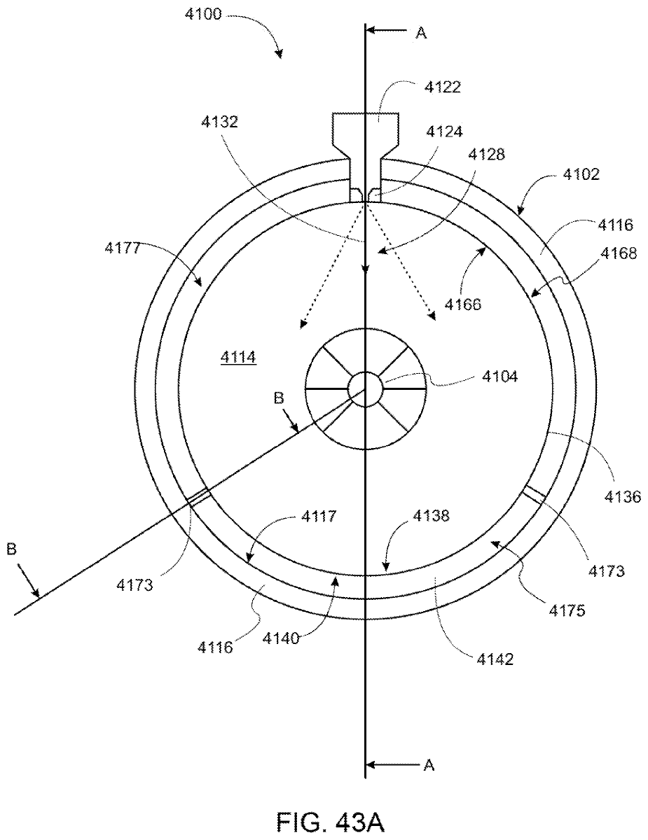

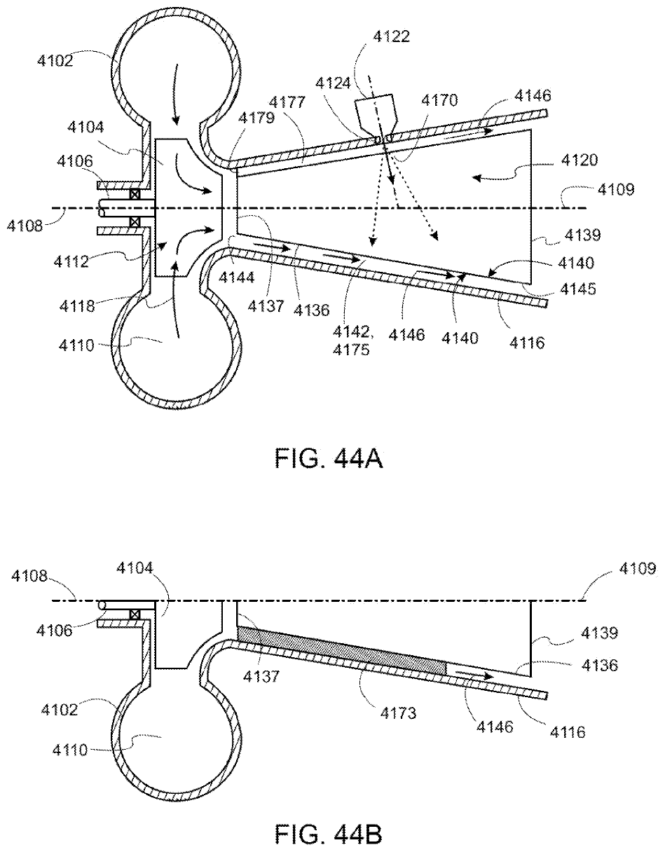

FIG. 44A is a cross-sectional side view of the embodiment of FIG. 43A taken through the line A-A;

FIG. 44B is a partial cross-sectional side view of the embodiment of FIG. 43A taken through the line B-B;

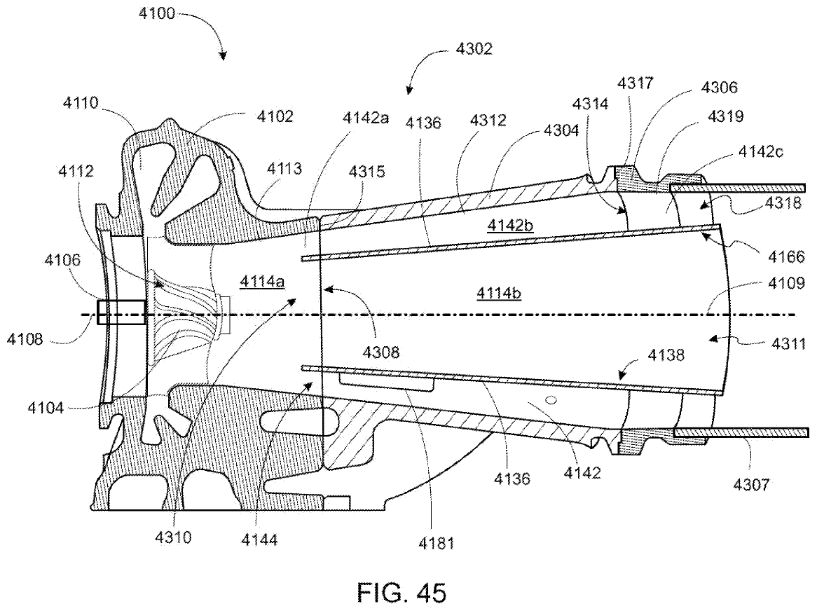

FIG. 45 shows a cross-sectional side view of another embodiment of a turbine according to the present invention;

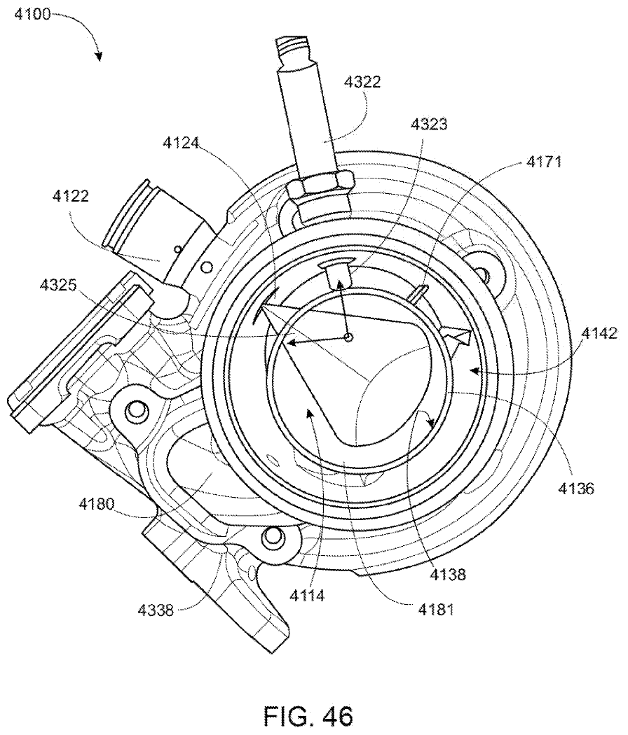

FIG. 46 shows an end view of the turbine according to FIG. 45;

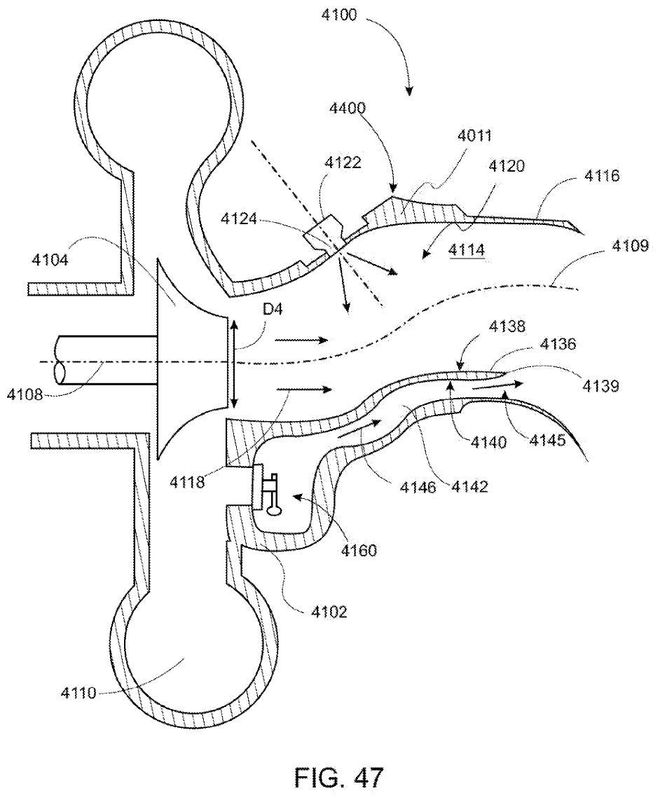

FIG. 47 shows a schematic cross-sectional side view of a turbine according to another embodiment of the present invention;

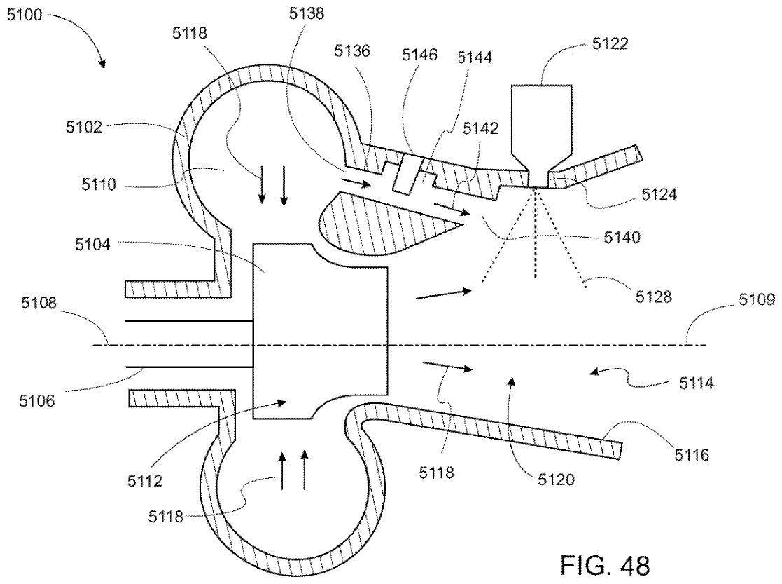

FIG. 48 is a schematic cross-sectional side view of another embodiment of a turbine according to the present invention;

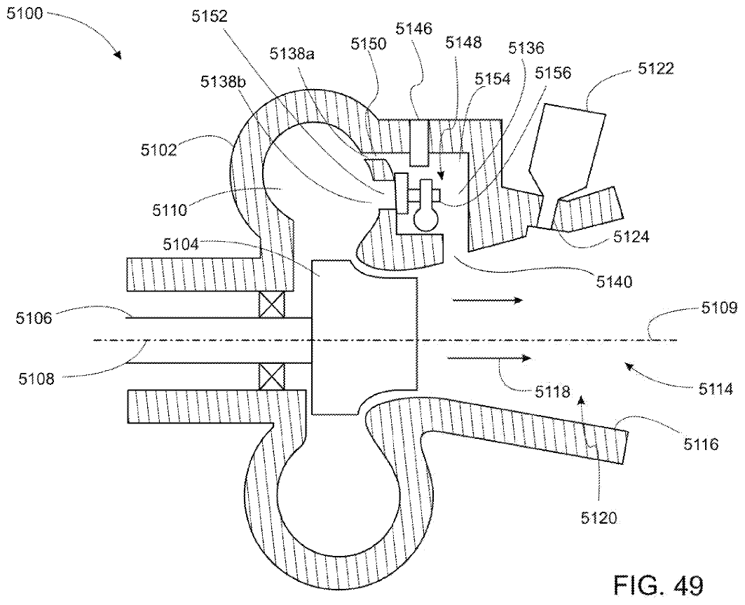

FIG. 49 is a schematic cross-sectional side view of another embodiment of a turbine according to the present invention comprising a wastegate arrangement;

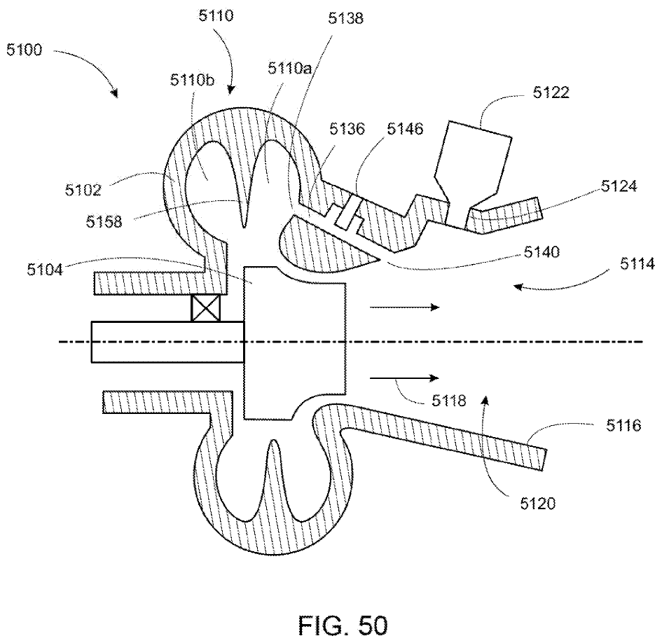

FIG. 50 is a schematic cross-sectional side view of another embodiment of a turbine according to the present invention comprising a twin volute inlet passage;

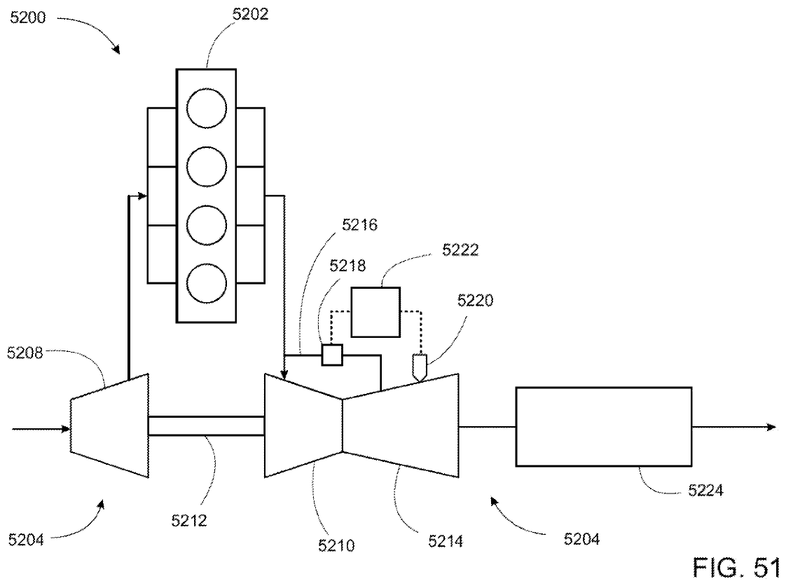

FIG. 51 is a schematic diagram of an internal combustion engine system according to the present invention:

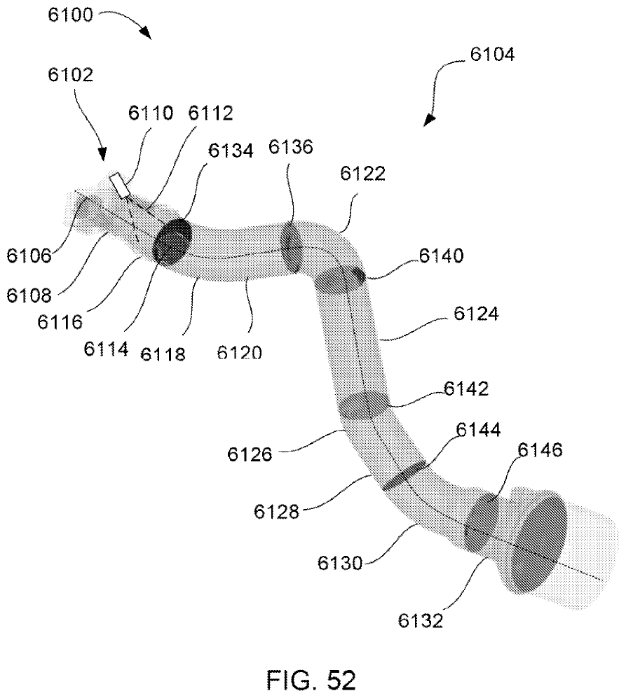

FIG. 52 shows a perspective view of a computational fluid dynamics model of an exhaust gas aftertreatment system in accordance with the present invention;

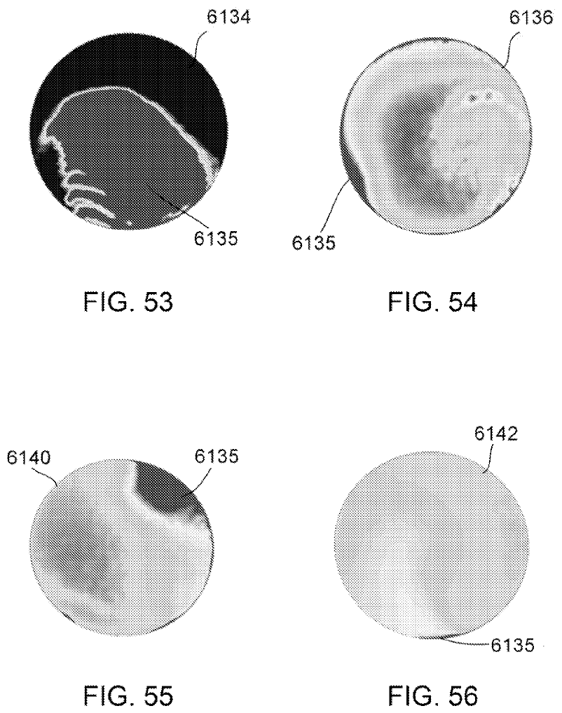

FIGS. 53 to 58 show the relative concentration of aftertreatment fluid of various cross-sections of the exhaust gas aftertreatment system of FIG. 52;

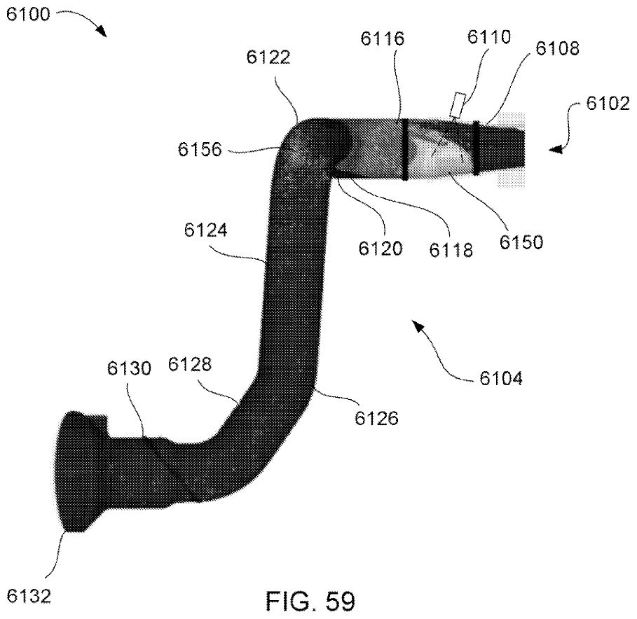

FIG. 59 shows a perspective view of a computational fluid dynamics model of the exhaust gas aftertreatment system showing the likelihood of impingement of exhaust gas aftertreatment fluid on the surfaces of the exhaust gas aftertreatment system;

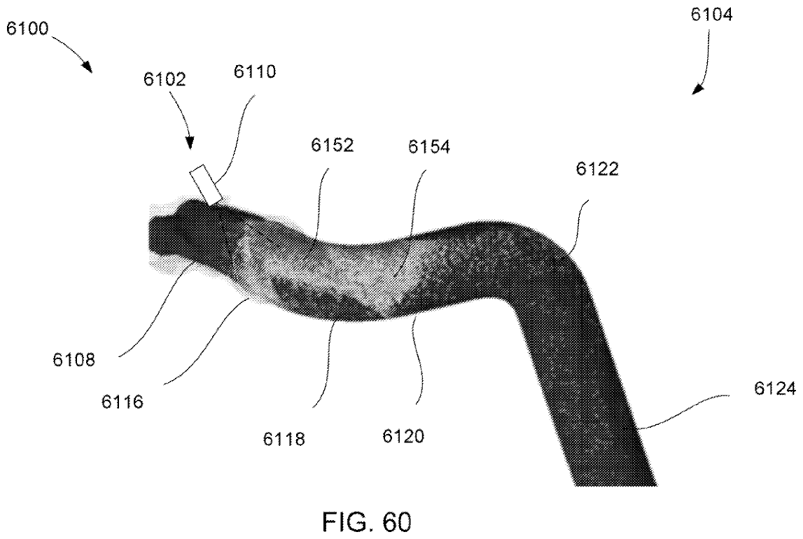

FIG. 60 shows a further perspective view of the computational fluid dynamics model of FIG. 59;

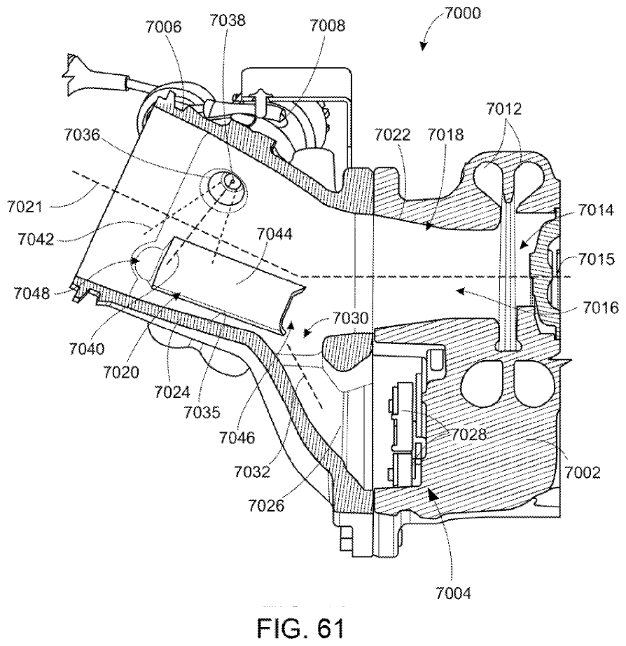

FIG. 61 is a cross-sectional plan view of a turbine in accordance with one or more aspects of the present invention;

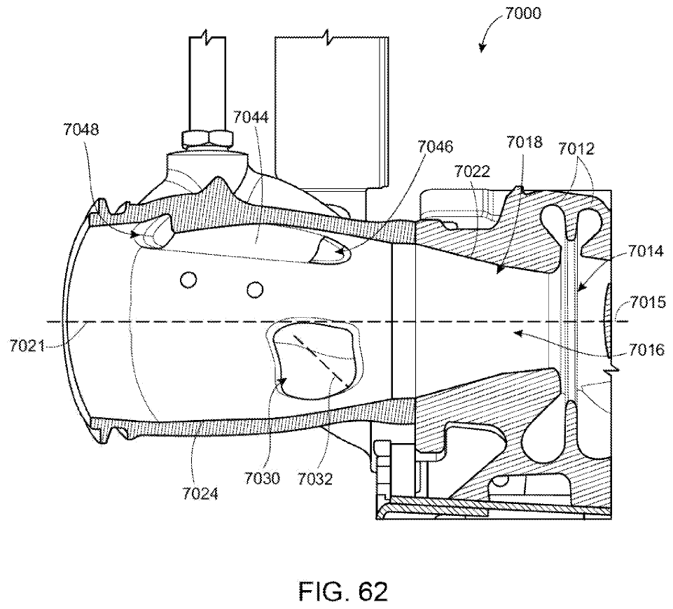

FIG. 62 is a cross-sectional top view of the turbine of FIG. 61;

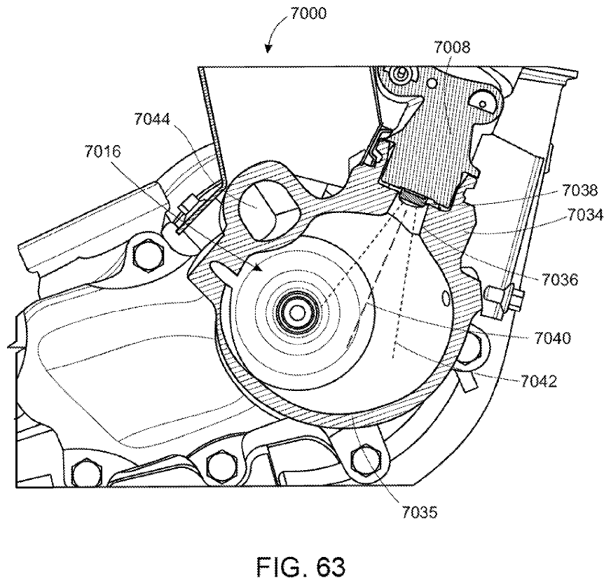

FIG. 63 is a cross-sectional end view of the turbine of FIG. 61 taken through the position of the dosing module;

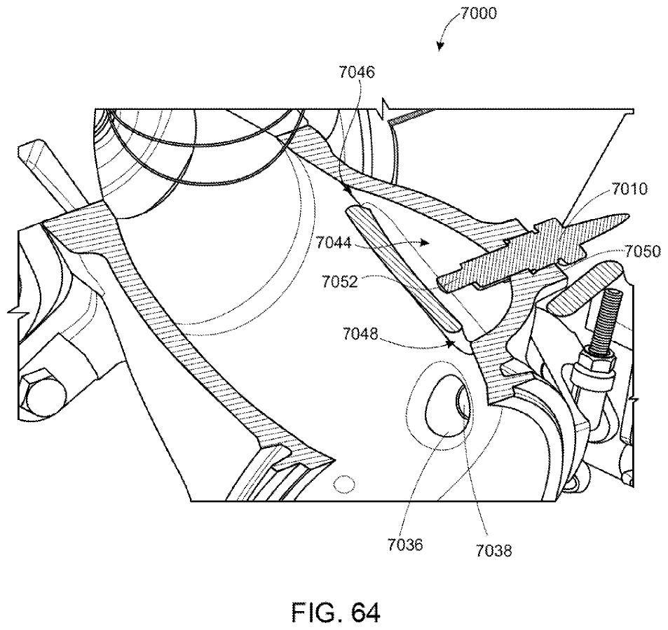

FIG. 64 is a cross-sectional side view of the turbine of FIG. 61 taken through the sensing passage;

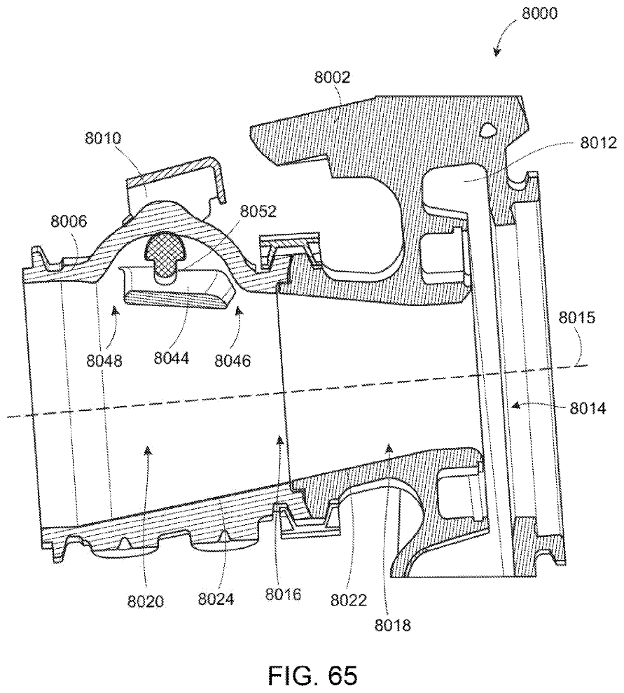

FIG. 65 is a cross-sectional side view of a turbine in accordance with one or more aspects of the present invention;

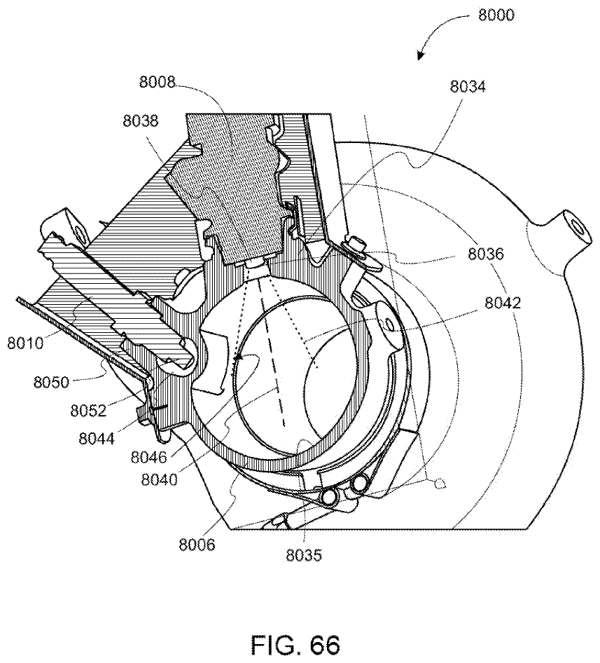

FIG. 66 is a cross-sectional end view of the turbine of FIG. 65 taken through the position of the dosing module and sensing passage; and

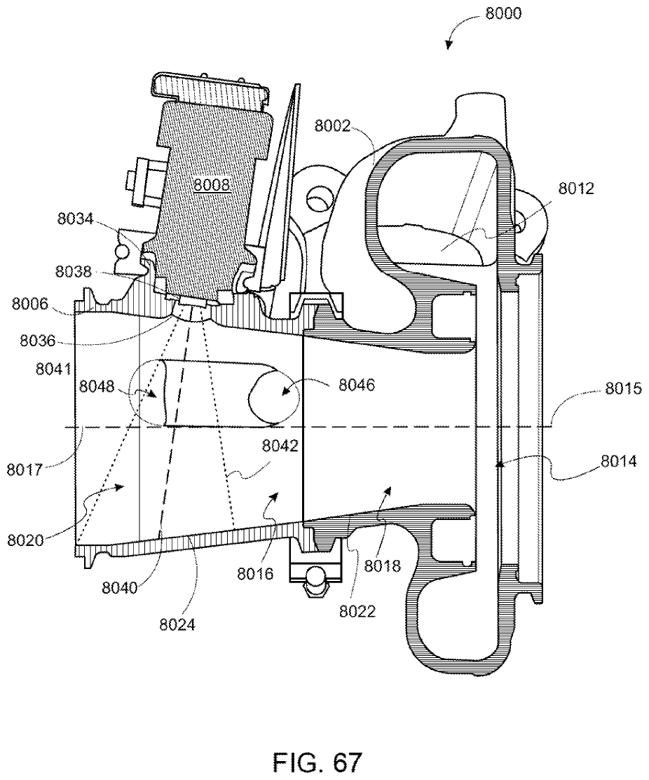

FIG. 67 is a cross-sectional side view of the turbine of FIG. 65 taken through the dosing module.

FIG. 1 shows a schematic view of a turbocharged diesel engine system 1002 according to the prior art. The system 1002 comprises a diesel internal combustion engine 1004, a turbocharger 6 and an exhaust gas aftertreatment system 1008. The turbocharger 6 comprises a compressor 1010 and a turbine 1012 mounted to a common turbocharger shaft 1014 so that the two rotate in unison. The compressor 1010 receives intake air from a low pressure intake duct 1016 connected to atmosphere. The low pressure intake duct 1016 may comprise a particulate filter to clean the intake air. The compressor 1010 compresses the intake air using power provided by the turbocharger shaft 1014 and supplies the compressed intake air to the engine 1004 via a high pressure intake duct 1018 and an intake manifold 1020. Although not shown, the high pressure intake duct 1018 may comprise an intercooler configured to cool the intake air before it reaches the engine 1004. Inside the engine 1004, an internal combustion process takes place and useful work is produced. As a result of the internal combustion process, exhaust gases are created by the engine 1004. The engine 1004 is fluidly connected to an exhaust manifold 1022 configured to receive exhaust gas from the engine 1004. The exhaust manifold 1022 is connected to the turbine 1012 via a high pressure exhaust gas duct 1024. The turbine 1012 extracts energy from the exhaust gas to drive the turbocharger shaft 1014 and thereby power the compressor 1010. Exhaust gas leaving the turbine 1012 is supplied to the exhaust gas aftertreatment system 1008 via a downpipe 1026. The downpipe 1026 is relatively long in extent, for example at least 2 metres in length, as indicated by the broken line in FIG. 1.

The exhaust gas aftertreatment system 1008 comprises a decomposition chamber 1028 having a diameter larger than that of the downpipe 1026. The decomposition chamber 1028 comprises a mixing element 1030 disposed therein. The mixing element 1030 typically comprises a number of baffles configured to deflect the flow through the decomposition chamber 1028 to cause turbulence within the decomposition chamber 1028. The exhaust gas aftertreatment system 1008 comprises a dosing module 1032 configured to inject an exhaust gas aftertreatment fluid, and specifically Diesel Exhaust Fluid (DEF), into the decomposition chamber 1028 downstream of the mixing element 1030 in the region where the exhaust gas is most turbulent. Heat exchange between the DEF and the exhaust gas within the decomposition chamber 1028 causes the urea contained within the DEF to decompose into the reductants ammonia (NH₃) and Isocyanic Acid (HNCO). The mixture of reductants and exhaust gas is then passed to a selective catalytic reducer 1034 (SCR) and a diesel oxidation catalyst 1036 (DOC). Finally, the exhaust gas is passed to an outlet duct 1038 and onwards to a muffler (not shown) before being discharged to atmosphere.

FIG. 2 shows a schematic cross-sectional view of a turbine 1100 according to an embodiment of the present invention. The turbine 1100 comprises a turbine housing 1102 and a turbine wheel 1104 supported by a turbocharger shaft 1106 and configured to rotate about a turbine axis 1108. The turbine housing 1102 defines a turbine inlet passage 1110, a turbine wheel chamber 1112 and a turbine outlet passage 1114. The turbine inlet passage 1110 is configured to receive exhaust gas from an internal combustion engine (not shown). The exhaust gas received from the internal combustion engine by the turbine inlet passage 1110 defines a turbine bulk flow 1118. The turbine inlet passage 1110 is in the shape of a volute configured to encourage swirling of the turbine bulk flow about the turbine axis 110. The turbine wheel chamber 1112 is configured to receive the turbine bulk flow 1118 from the turbine inlet passage 1110. When the turbine bulk flow 1118 passes through the turbine wheel chamber 1112, it impinges upon blades (not shown) of the turbine wheel 1104 thus causing the turbine wheel 1104 to rotate and drive the turbocharger shaft 1106. The turbine wheel 1104 re-directs the turbine bulk flow 1118 so that it flows in an axial direction relative to the turbine axis 1108 and delivers the turbine bulk flow 1118 to the turbine outlet passage 1114. As such, the turbine 1100 is a so-called “radial” turbine. However, in alternative embodiments the turbine 1100 may be an “axial” turbine in which exhaust gas flows in a generally axial direction from the turbine inlet 110 passage to the turbine outlet passage 1114.

The turbine outlet passage 1114 comprises a generally tapered side wall 1116 which defines a diffuser portion 1120 configured to cause expansion of the exhaust gas in the turbine outlet 114. The side wall 1116 is outwardly tapered at an angle of around 7°, however in alternative embodiments any suitable taper angle may be used. For example the taper angle may be up to around 10°, or around 15°, or around 20°. The diffuser portion 1120 is symmetrically centred on the turbine axis 1108, such that the turbine axis 1108 defines a centreline 1109 of the turbine outlet passage 1114. However, in alternative embodiments the diffuser portion 1120 may have any suitable shape. In such embodiments, the centreline 1109 may be defined by the centroid of the turbine outlet passage 1114 relative to the direction of the turbine bulk flow 1118. Accordingly, the centreline 1109 may bend or otherwise diverge away from the turbine axis 1108 in dependence upon the shape of the turbine outlet passage 1114. In yet further embodiments the turbine outlet passage 1114 may comprise a portion of constant diameter immediately downstream of the turbine when 1104 and upstream of the diffuser portion 1120. In other embodiments the turbine outlet passage 1114 may comprise a diffuser portion 1120 formed from multiple conically stepped sections separated by constant diameter portions.

The turbine 1100 further comprises a dosing module 1122 configured to deliver an exhaust gas aftertreatment fluid to the turbine outlet passage. The aftertreatment fluid is, in particular, diesel exhaust fluid (DEF) and is commonly available under the trade mark AdBlue. The dosing module 1122 comprises a nozzle 1124 in fluid flow communication with the turbine outlet passage 1114. The nozzle 1124 is, in particular, an atomising nozzle configured to generate a substantially atomised spray of aftertreatment fluid within the turbine outlet passage 1114. The nozzle 1124 generates a generally conical spray pattern, however in alternative embodiments substantially any suitable spray pattern may be used (for example fan-shaped etc.). The spray pattern has a spray angle A1 of around 45° to around 55°, however in alternative embodiments substantially any suitable spray angle A1 may be used, for example 30°.

With reference to FIG. 3, the nozzle 1124 is received within a hole 1126 defined by a mounting structure 1130 of the turbine housing 1102. The mounting structure 1130 is of a so-called “dog house” design, which comprises a notch-like indentation formed in the side wall 1116 of the turbine outlet passage 1114. The mounting structure 1130 is shaped so that the nozzle 1124 delivers aftertreatment fluid in a spray direction 1132 which faces generally upstream in relation to the turbine bulk flow 1118. In the present embodiment, the spray direction 1132 is inclined at an angle A2 of around 20° relative to a normal 1134 of the centreline 1109 in an upstream direction in relation to the turbine bulk flow 1118.

The aftertreatment fluid is sprayed into a spray region 1128 of the turbine outlet passage 1114. The spray region 1128 encompasses the spatial region in which the atomised spray of aftertreatment fluid has a larger component of velocity in the spray direction 1132 than in the direction of the turbine bulk flow 1118. The atomised spray of aftertreatment fluid leaving the nozzle 1124 has almost all of its velocity in the spray direction 1132 or inclined relative to the spray direction 1132 by up to half of the spray angle A1. However, as the atomised spray of aftertreatment fluid travels laterally across the turbine outlet passage 1114 (i.e. in a direction normal to the turbine bulk flow 1118), interaction between the aftertreatment fluid and the turbine bulk flow 1118 changes the direction of the atomised spray of aftertreatment fluid until the aftertreatment fluid flows entirely in the direction of the turbine bulk flow 1118 (i.e. until the aftertreatment fluid is “carried away” by the momentum of turbine bulk flow 1118). The spray region 1128 corresponds to the portion of the turbine outlet passage 1114 in which the individual droplets of aftertreatment fluid carry more momentum from the dosing module 1122 than from the turbine bulk flow 1118. Accordingly, the geometry of the spray region 1128 is a property of the delivery strength of the dosing module 1128 relative to the momentum of the turbine bulk flow 1118. For the sake of simplicity, the spray region 1128 is illustrated in FIG. 2 as a conical region. However, it will be appreciated that due to the interaction between the turbine bulk flow 1118 and the aftertreatment fluid explained above the spray region 1128 may not, in reality, have a completely conical shape.

FIG. 2A shows a side view of a computational fluid dynamics model of an alternative embodiment of a turbine 1100. In particular, FIG. 2A shows particles 1115 of aftertreatment fluid that have been sprayed into the turbine outlet passage 1114 from a dosing module 1122 (not shown). Although the dosing module 1122 is not shown, a mounting structure 1130 for mounting the dosing module 1122 to the turbine housing can be seen. It is clear that the spray of aftertreatment fluid particles 1115 emanates from the mounting structure 1130 for the dosing module 1122 in a generally conical spray pattern, which defines the spray region 1128. FIG. 2B shows a cross-sectional view of a computational fluid dynamics model through the turbine of FIG. 2A. In particular, FIG. 2B shows the relative concentration of aftertreatment fluid (i.e. DEF) travelling through the turbine outlet passage 1114. Once again, it can be seen that the aftertreatment fluid emanates from the mounting structure 1130 in a conically shaped aftertreatment fluid spray region 1128.

Referring back to FIG. 2, the dosing module 1122 is positioned and oriented so that the spray region 1128 is close to the outlet of the turbine wheel 1104. In general, the temperature of the turbine bulk flow 1118 will be hotter closer to the turbine wheel 1104 than at any position downstream due transient dissipation. Since heat energy is required to cause decomposition of the aftertreatment fluid, it is preferable for the spray region to be as close to the turbine wheel 1104 as possible. In particular, it is preferable for the dosing module 1122 to be positioned and oriented so that at least a portion of the spray region 1128 is within around 10 exducer diameters D from the turbine wheel 1104 along the centreline 1109; the exducer diameter D being the diameter of the exducer portion of the turbine wheel 1104. It has been found that the turbine bulk flow 1118 maintains a relatively high velocity until at least around 4 or 5 exducer diameters from the turbine wheel 1104. Therefore in alternative embodiments the dosing module 1122 may be positioned and oriented so that at least a portion of the spray region 1128 is within around 2, 3, or 5 exducer diameters D from the turbine wheel 1104 along the centreline 1109, to take advantage of the higher velocity turbine bulk flow 1118 in such regions. Depending upon the orientation of the dosing module 1122, in some embodiments this may be achieved by positioning the hole 1126 within the same distances along the centreline 1109 as set out above. It is preferable that aftertreatment fluid does not enter the turbine wheel chamber 1112 as it may impinge upon the turbine wheel 1104 which could lead to deposit formation. Accordingly, it is preferable that the spray region 1128 is positioned entirely downstream of the turbine wheel chamber 1112 (i.e. so that it does not overlap with the turbine wheel chamber 1112).

The turbine 1100 further comprises an auxiliary passage 1136 having an auxiliary passage inlet 1138 and an auxiliary passage outlet 1140. The auxiliary passage 1136 is defined by an elongate conduit of the turbine housing 1102 extending between the auxiliary passage inlet 1138 and the auxiliary passage outlet 1140. However, in other embodiments the auxiliary passage may be formed at least in part from components separate to the turbine housing 1102, for example external tubing or the like. A side wall of the turbine housing 1102 defining the turbine inlet passage 1110 (and, in particular, the volute) comprises an opening that defines the auxiliary passage inlet 1132. As shown in FIG. 3, the mounting structure 1130 of the turbine outlet passage 1114 comprises an opening in a side wall 1141 extending generally orthogonally to the nozzle 1124 that defines the auxiliary passage outlet 1140.

During use, the auxiliary passage 1136 receives a portion of the turbine bulk flow 1118 from the turbine inlet passage 1110 via the auxiliary passage inlet 1138. The portion of the turbine bulk flow 1118 received by the auxiliary passage 1136 defines an auxiliary flow 1142. The conduit-shaped structure of the auxiliary passage 1136 conditions the auxiliary flow 1142 so that it flows in a substantially uniform direction. The auxiliary flow 1142 is then delivered into the turbine outlet passage 1114 by the auxiliary passage outlet. The direction of the auxiliary flow 1142 when it exits the auxiliary passage outlet 1140 defines an auxiliary flow direction 1144. As shown in FIG. 2, the structure of the auxiliary passage 1136 is chosen so that the auxiliary flow direction 1144 is generally normal to the spray direction 1132. Accordingly, when the auxiliary flow 1142 enters the turbine outlet passage 1114, the momentum of the auxiliary flow 1142 carries the auxiliary flow 1142 into the spray region 1128.

As the auxiliary flow 1142 enters the spray region 1128, it collides with the atomised droplets of aftertreatment fluid. This provides many benefits. First, the collisions break up the aftertreatment fluid into smaller droplets. This increases the surface area available for heat exchange between the aftertreatment fluid and the exhaust gas in the turbine outlet. Accordingly, the rate of decomposition of the aftertreatment fluid is increased. Furthermore, the collisions scatter the aftertreatment fluid droplets causing them to disperse throughout the turbine outlet passage. As a result, the aftertreatment fluid, and subsequently the reductants, are more evenly distributed throughout the turbine bulk flow.

Furthermore, because the spray direction 1132 faces upstream, it has a component of momentum in opposition to the turbine bulk flow 1118. This increases the magnitude of the collisions between the turbine bulk flow and the aftertreatment fluid. In general, the more the spray direction 1132 is angled towards the turbine bulk flow 1118 the more the magnitude of the collisions will increase. However, it has been found that if the angle between the spray direction 1132 and the turbine bulk flow 1118 is more than around 45°, the aftertreatment fluid will not be carried across the entire extent of the turbine outlet passage. Therefore, the angle A2 between the spray direction 1132 and the normal 1134 of the centreline 1109 should preferably be kept below this value.

During use, aftertreatment fluid may coalesce around the nozzle 1124. If the aftertreatment fluid cools, it may solidify into deposits that will clog the nozzle 1124 and prevent the successful operation of the aftertreatment system. As shown in FIGS. 2 and 3, to address this the auxiliary passage outlet 1140 is positioned within the mounting structure 1130 and sufficiently close to the nozzle 1124 that it produces a shearing force on the nozzle 1124. This shearing force prevents droplets of aftertreatment fluid coalescing in the vicinity of the nozzle 1124 and therefore keeps the nozzle 1124 clean during operation. In order to promote cleaning of the nozzle 1124 of the dosing module 1122, preferably the auxiliary passage outlet 1140 is positioned as close as possible to the nozzle 1124 along the spray axis 1132. In particular, if it is desired to promote nozzle 1124 cleaning, then the auxiliary passage outlet 1140 may be positioned such that is substantially flush with the nozzle 1124, thus increasing the shearing force applied across the nozzle 1124. However, with reference to FIG. 3, in the illustrated embodiment the auxiliary passage outlet 1140 is offset (i.e. spaced apart) from the nozzle 1124 by a small distance along the spray direction 1132. In particular the auxiliary passage outlet 1140 can be spaced apart from the nozzle 1124 along the spray axis 1132 by up to around 25% of the diameter of the turbine outlet passage at the same axial position along the centreline 1109 as the auxiliary passage outlet 1140. This allows the aftertreatment fluid to spread outwardly and collide with a greater amount of the auxiliary flow. If the auxiliary passage outlet is spaced apart from the nozzle 1124 in this manner, the auxiliary flow 1142 will interact with fully-developed droplets, and act to carry these into the turbine outlet passage 1114. However, it should be noted that the velocity of the turbine bulk flow 1118 increases away from the side wall 1118. As such, if the auxiliary passage outlet 1140 is spaced apart from the nozzle 1124 too far then the velocity of the turbine bulk flow 1118 will be too large in relation to the auxiliary flow 1142 and will diminish the effect of the auxiliary flow 1142 on the aftertreatment fluid and may prevent the auxiliary flow 1142 from reaching the nozzle 1124. Accordingly, it is preferable that maximum spacing from the auxiliary passage outlet 1140 to the nozzle 1124 along the spray axis 1132 is no more than around 25% of the diameter of the turbine outlet passage 1114.

Although the auxiliary flow direction 1144 is normal to the spray direction 1132, it will be appreciated that in alternative embodiments the auxiliary flow direction may be inclined relative to a normal of the spray direction by a small amount, for example up to around 20 or around 30°. Angles within this range tend to provide sufficient sideways collision with the aftertreatment fluid to promote spray breakup and scattering. It has been found that if the auxiliary flow direction 1144 is angled off-normal in a direction towards the dosing module 1122 this promotes increased disturbance to the aftertreatment fluid, thus promoting the formation of smaller droplets. However, angling the auxiliary flow direction 1144 towards the dosing module 1122 will increase the risk that aftertreatment fluid impinges and solidifies upon the sidewall 1116. On the other hand, if the auxiliary flow is inclined off-normal in a direction towards the centreline of the turbine, the auxiliary flow 1142 promotes aftertreatment fluid penetrating further into the turbine outlet passage 1114. However, this does not cause the droplets of aftertreatment fluid to break up as much, and therefore the aftertreatment fluid is less well-mixed.

The dosing module 1122 and mounting structure 1130 may be oriented at substantially any circumferential position relative to the centreline 1109 of the turbine outlet passage 1114. That is to say, the dosing module and mounting structure 1130 may be positioned at any angular position relative to the centreline 1109 in a plane normal to the centreline. The precise circumferential position of the dosing module 1122 may be chosen in dependence upon a number of factors, including packaging requirements and the desired orientation of the dosing module relative to other components of the turbine 1100, for example, the auxiliary passage 1136.

FIG. 4 shows an alternative embodiment of the invention in which the auxiliary passage outlet 1140 directly faces the dosing module 1122 and the auxiliary passage 1136 is configured to deliver the auxiliary flow 1142 in an auxiliary flow direction 1144 exactly opposite the spray direction 1132. During use, the auxiliary flow 1142 passes into the spray region 1128 whereupon it collides with the aftertreatment fluid. Because the auxiliary flow direction 1144 is directly opposite the spray direction 1132, the difference in momentum between the auxiliary flow 1142 and the aftertreatment fluid is at its largest, and therefore the magnitudes of the collisions between the fluid particles composing the auxiliary flow and the aftertreatment fluid are at their maximum. The collisions cause the droplets of aftertreatment fluid to break up and scatter more effectively, thus increasing the amount of heat transferred to the aftertreatment fluid to promote decomposition, and improving the mixing of the aftertreatment fluid with the turbine bulk flow 1118. Furthermore, because the auxiliary flow 1142 directly faces the spray direction, the auxiliary flow 1142 prevents aftertreatment fluid from impinging on the side wall 1116 of the turbine outlet passage opposite the dosing module 1122. As such, deposit formation on the side wall 1116 of the turbine outlet passage 1114 is avoided.

Although the auxiliary flow direction 1144 is directly opposite the spray direction 1132 in the embodiment of FIG. 4, it will be appreciated that in alternative embodiments the auxiliary flow direction 1144 may be inclined relative to the spray direction 1132. FIG. 5 shows an alternative embodiment in which the auxiliary flow direction 1144 is oriented in the upstream direction in relation to the turbine bulk flow by an angle A3 of around 40°. Where the incline A3 of the auxiliary flow direction 1144 relative to the spray direction 1132 is around 50° the component of momentum of the auxiliary flow 1142 opposite to the spray direction 1132 is sufficiently large enough to cause spray breakup as described above. In addition, because the auxiliary flow direction 1144 faces upstream relative to the turbine bulk flow 1118, the auxiliary flow 1142 creates turbulence with the turbine bulk flow 1118 which provides improved mixing of the aftertreatment fluid and the exhaust gases in the spray region 1128. This promotes improved decomposition of the aftertreatment fluid and more even distribution of reductants within the turbine bulk flow 1118. To provide increased turbulence, it has been found that the angle A4 between the auxiliary flow direction 1144 and the centreline 1109 should in the range of around 45° to around 90°, and preferably around 45° to around 60°. However, if the turbulence generated is too large, it will restrict flow through the turbine outlet passage 1114 and will exert a back pressure on the turbine 1100 resulting in reduced power output from the engine.

FIG. 6 shows an alternative embodiment in which the auxiliary flow 1142 is oriented in the downstream direction relative to the turbine bulk flow 1118 by an angle A3 of around 45°. However, in alternative embodiments the angle A3 may be between around 0° to around 90°, around 0° to around 45°, around 30° to around 90°, around 40° to around 80°, around 45° to around 70°, around 45°, or around 55°. Where the incline A3 of the auxiliary flow direction 1144 relative to the spray direction 1132 is within the ranges above, the component of momentum of the auxiliary flow 1142 opposite to the spray direction 1132 is sufficiently large to cause spray breakup. Because the auxiliary flow 1142 faces downstream relative to the turbine bulk flow 1118, the amount of turbulence within the turbine outlet passage 1114 is reduced, and therefore high back pressure on the turbine 1100 is avoided. However, this comes at the cost of reduced mixing of the aftertreatment fluid with the turbine bulk flow 1118.

Preferably, in such embodiments, the auxiliary passage outlet 1140 should be positioned slightly upstream of the nozzle 1124 of the dosing module 1122 relative to the centreline 1109, as shown in FIG. 6. This helps to ensure that the product of the combined momentums of the auxiliary flow 1142 and the turbine bulk flow 1118 directs the auxiliary flow 1142 into the spray region 1128.

FIG. 7 shows a further alternative embodiment of the invention in which the nozzle 1124 of the dosing module 1122 is mounted flush to the tapered side wall 1116 of the turbine outlet passage 1114. Accordingly, the spray direction 1132 is oriented in a downstream direction in relation to the turbine bulk flow 1118 and is inclined relative to the normal 1134 of the centreline 1109 by an angle A2 equal to the taper angle of the side wall 1116. In this embodiment, the auxiliary passage 1136 is configured to deliver the auxiliary flow 1142 to the turbine outlet passage 1114 in an auxiliary flow direction 1144 that is inclined relative to the centreline 1109 of the turbine outlet passage 1114 by an angle A4 of around 60°. Because the auxiliary flow direction 1144 is angled towards the centreline 1109, when the auxiliary flow 1142 passes into the spray region the momentum of the auxiliary flow 1142 carries the aftertreatment fluid across a greater lateral extent of the turbine outlet passage 1114 (i.e. a greater extent along the normal 1134 to the centreline 1109). Therefore, aftertreatment fluid 1142 is more evenly distributed across the entire width of the turbine outlet passage 1114. Additionally, because the spray direction 1132 faces downstream in relation to the turbine bulk flow 1118 the momentums of the auxiliary flow 1142 and the aftertreatment fluid face in generally the same direction. Accordingly, it is easier for the auxiliary flow 1142 to transfer momentum to the aftertreatment fluid to carry it across the turbine outlet passage 1114.

Although the angle A4 in the present embodiment is around 60°, it will be appreciated that in alternative embodiments the angle A4 may be substantially any suitable angle in which the auxiliary flow 1142 can transfer momentum to the aftertreatment fluid to carry it across the lateral extent of the turbine outlet passage 1114. It has been found that where the angle A4 is less than around 45° the momentum of the auxiliary flow 1142 in the direction of the normal 1134 to the centreline 1109 is insufficient to increase the extent to which the aftertreatment fluid flows laterally across the turbine outlet passage. Accordingly, the angle A4 should be more than this value. However, if the angle A4 is too steep then the aftertreatment fluid may be carried too far across the turbine outlet passage 1114 such that it impinges upon the opposite side wall 1116 to the dosing module, and presents a risk of deposit formation. As such, the angle A4 should be within the range of around 45° to around 60°. For optimum momentum assistance the angle A4 should be around 67.5° minus angle A2.

Furthermore, although the nozzle 1124 of the dosing module 1122 is oriented flush with the side wall 1116, it will be appreciated that in alternative embodiments the dosing module 1122 may be oriented so that it is inclined relative to the side wall 1116. For example, the dosing module 1122 may be oriented so that the angle A2 between the spray direction 1132 and the normal 1134 of the centreline 1109 is up to around 90°. The more the spray direction 1132 is inclined relative to the normal 1134 of the centreline 1109, the more the aftertreatment fluid is aligned with the turbine bulk flow 1118 and therefore less turbulence between the aftertreatment fluid and turbine bulk flow 1118 is generated and so back pressure on the turbine is avoided. However, at larger angles the aftertreatment fluid may be less well mixed and may not be uniformly distributed across the width of the turbine outlet passage. A balance between these two factors can be struck if the angle A2 is less than around 45°.

FIG. 7A shows a further alternative embodiment in which the auxiliary passage 1136 comprises a valve arrangement 1147 configured to permit, prevent or regulate flow through the auxiliary passage 1136. The valve arrangement 1147 may be substantially any valve arrangement (e.g. flap type, poppet, rotary barrel etc.). The auxiliary passage 1136 receives auxiliary flow 1142 from the turbine inlet passage 1110 via the auxiliary passage inlet 1138 and delivers the auxiliary flow 1142 to the turbine outlet passage 1114 via the auxiliary passage outlet 1140. Accordingly, the auxiliary passage 1136 functions as a wastegate passage and the valve arrangement 1147 as a wastegate valve. The auxiliary passage outlet 1140 is positioned opposite the dosing module 1122 such that it generally opposes the spray direction 1132. However, in contrast to the embodiment of FIG. 4, the turbine 1100 of FIG. 7A further comprises a barrier member 1166 extending generally normal to the spray direction 1132 and disposed between the auxiliary passage outlet 1140 and the dosing module 1122.

The barrier member 1166 is sized so that it substantially covers the auxiliary passage outlet 1140 from the perspective of the dosing module 1122 in the spray direction 1132. In particular, the barrier member 1166 has an extent generally normal to the spray direction 1132 and generally axially along the centreline 1109 that is longer than the corresponding extent of the auxiliary passage outlet 1140, and defines a circumferential extent relative to the centreline 1109 that is longer than the corresponding circumferential extent of the auxiliary passage outlet 1140. Accordingly, the barrier member 1166 prevents aftertreatment fluid delivered into the turbine outlet passage 1114 by the dosing module 1122 from entering the auxiliary passage 1136 via the auxiliary passage outlet. This mitigates or prevents aftertreatment fluid from impinging on the surfaces of the auxiliary passage 1136, and therefore reduces the chance that aftertreatment fluid will solidify within the auxiliary passage 1136 and cause a blockage. Preferably the barrier member 1166 is made from a corrosion resistant material such as stainless steel. The barrier member 1166 is preferably made from sheet metal that is provided as an insert within the turbine housing. Alternatively the barrier member 1166 may be an integral part (for example, an integrally cast part) of the housing or a connection adapter of the like.

The barrier member 1166 is spaced apart from the side wall 1116 of the turbine housing 1102 to define a channel 1168 within the turbine outlet passage 1114. The channel 1168 is open at opposite proximal and distal ends in relation to the turbine wheel 1104. The proximal end receives a portion of the turbine bulk flow from the turbine outlet passage 1114. The auxiliary passage outlet 1140 is disposed between the proximal end distal ends of the channel 1168, such that the auxiliary passage outlet 1140 is covered by the barrier member 1166 as discussed above. The channel 1168 receives the auxiliary flow 1142 from the auxiliary passage outlet 1140. The momentum of the turbine bulk flow 1118 in the channel 1168 interacts with the auxiliary flow 1142 and deflects the auxiliary flow 1142 such that it flows in a generally axial direction along the centreline 1109 away from the turbine wheel 1104. The mixture of the turbine bulk flow 1118 and the auxiliary flow then leaves the channel 1168 via the distal end whereupon it passes into the spray region 1128. In some embodiments, the barrier member 1166 may be sized so that the proximal end of the channel 1168 is positioned upstream of the most upstream extent of the spray region 1128. As such, this eliminates the possibility that aftertreatment fluid will enter the proximal end of the channel 1168. However, even if the proximal end of the channel 1168 is downstream of the most upstream part of the spray region 1128, the fact that the barrier member 1166 covers the auxiliary passage outlet 1140 provides a sufficient amount of shielding to mitigate against the formation of solid deposits in the auxiliary passage 1136.

FIG. 8 shows a further embodiment of the present invention in which the dosing module 1122 is oriented so that the spray direction 1132 faces generally normal to the centreline 1109. Because the spray direction 1132 is normal to the centreline 1109 the aftertreatment fluid is injected into the turbine outlet passage 1114 with maximum momentum in a lateral direction relative to the turbine bulk flow 1118. Accordingly, the aftertreatment fluid is carried across a greater lateral extent of the turbine outlet passage 1114. Furthermore, because the auxiliary passage outlet 1140 is positioned within the mounting structure (such as in the embodiment of FIGS. 2 and 3), the auxiliary flow 1142 is able to exert a shearing force on the nozzle 1124 to keep the nozzle clean. Additionally, the auxiliary passage 1136 is oriented so that it is inclined relative to the centreline 1109 and a normal 1146 of the spray direction by an angle A4 of around 20°. As such, the auxiliary flow is also able to increase the momentum of the aftertreatment fluid in the lateral direction across the turbine outlet passage 1114, so as to ensure that the aftertreatment fluid is distributed across the entire width of the passage 1114.

In all of the embodiments described above, the auxiliary passage 1136 is substantially free from flow restrictors or valves that would choke or selectively prevent flow from the auxiliary passage inlet 1138 to the auxiliary passage outlet 1140. As such, the auxiliary passage functions as a full-duty bypass which is operable to deliver the auxiliary flow 1142 to the spray region 1128 at all operating conditions of the turbine 1100 and thus the beneficial effects of delivering the auxiliary flow into the spray region 1128 described above may always be provided. The cross-sectional area of the auxiliary passage 1136 may be chosen so that the auxiliary flow 1142 is a relatively small proportion of the turbine bulk flow 1118. For example, the mass flow rate of the auxiliary flow 1142 may be around 0.1%, 0.2%, 0.5%, 1%, 2% or 5% of the mass flow rate of exhaust gas entering the turbine inlet 110 (i.e. the mass flow rate of exhaust gas leaving the engine). As such, the auxiliary passage 1136 functions as a constant or “full-duty” bypass. The auxiliary passage 1136 may define a constant cross-sectional area along its entire length, or the cross-sectional area of the auxiliary passage 1136 may vary along the length of the auxiliary passage. Where the cross-sectional area of the auxiliary passage 1136 varies, the flow rate of the auxiliary flow can be controlled by appropriately sizing the narrowest portion of the auxiliary passage 1136.

With reference to FIG. 9, in other embodiments the auxiliary passage 1136 may connect the turbine inlet passage 1110 to the turbine outlet passage 1114 and may comprise a valve 1147 configured to selectively permit, prevent or regulate the flow through the auxiliary passage 1136 from the turbine inlet passage 1110 to the turbine outlet passage 1114. In such embodiments, the auxiliary passage 1136 is functionally equivalent to a wastegate passage, and the valve 1147 is functionally equivalent to a wastegate valve. The size of the auxiliary passage 1136 may therefore be chosen so that the maximum allowable flowrate therethrough is large enough to provide sufficient wastegating functionality. For example, the auxiliary passage 1136 may be sized so that the mass flow rate of the auxiliary flow may be up to around 25% or around 50% of the mass flow rate of exhaust gas entering the turbine inlet 110.

The valve 1147 may be configured so that it substantially prevents flow through the auxiliary passage 1136. However, if this is the case when the valve 1147 is fully closed no auxiliary flow passes through the auxiliary passage 1136 and therefore the auxiliary flow cannot influence the aftertreatment fluid or turbine bulk flow in the turbine outlet passage. Accordingly, the valve 1147 may be designed such that it cannot entirely prevent flow through the auxiliary passage. For example, the valve 1147 may be configured so that it cannot be fully closed, or may be controlled so that it does not fully close during use. Additionally or alternatively, the valve 1147 may comprise one or more leakage passages configured to permit a small amount of auxiliary flow to pass through the valve 1147 even when the valve 1147 is in its most restricted configuration. The amount of leakage permitted may be around 0.1%, 0.2%, 0.5%, 1%, 2% or 5% of the mass flow rate of exhaust gas entering the turbine inlet 110. In such embodiments, the auxiliary flow is always permitted to flow through the auxiliary passage 1136 so that it can influence the aftertreatment fluid and turbine bulk flow during all operating conditions of the engine, whilst the turbine also has the ability to bypass larger amounts of flow through the wastegate passage to provide sufficient wastegating functionality.

In the embodiment of FIG. 9, the auxiliary passage 1136 is configured to introduce the auxiliary flow 1142 into the turbine outlet passage 1114 over the nozzle 1124 of the dosing module 1122, to thereby keep the nozzle 1124 clean. In particular, the auxiliary passage 1136 is configured so that the auxiliary flow direction 1144 at the auxiliary passage outlet 1140 is angled generally orthogonal to the spray direction 1132 of the aftertreatment fluid. In this respect the embodiment of FIG. 9 provides the same advantages as the embodiment of FIG. 2 discussed above, and may therefore have a corresponding construction.

FIG. 9A shows a variation on the embodiment of FIG. 9 in which the auxiliary passage 1136 is configured to introduce the auxiliary flow 1142 into the turbine outlet passage 1114 in an auxiliary flow direction 1144 generally normal to the turbine axis 1108. The auxiliary passage outlet 1140 is positioned upstream of the dosing module 1122 relative to the turbine axis 1108. The dosing module 1122 is mounted in a mounting structure 1130 of the kind previously described above. The auxiliary passage outlet 1140 and the dosing module 1122 are positioned on the same side of the turbine axis 1108 as one another, such that the auxiliary flow direction 1144 and the spray direction 1132 are both oriented generally transverse to the turbine axis 1108 in the same direction. However, the nozzle 1124 of the dosing module 1122 is oriented in a slightly upstream direction in relation to the turbine axis 1108. In particular, the angle of the spray direction 1132 relative to the turbine axis 1108, the spray angle A1 of the nozzle 1124, and the spacing of the nozzle 1124 from the auxiliary passage outlet 1140 are chosen such that the auxiliary flow 1142 will enter a portion of the spray region 1128.

During use, when the wastegate valve 1147 is open, auxiliary flow 1142 will be delivered to the turbine outlet passage 1114 by the auxiliary passage 1136. Because the auxiliary flow direction 1144 is generally orthogonal to the turbine axis 1108, the auxiliary flow will impinge upon and be reflected by the portion of the side wall 1116 on the opposite side of the auxiliary passage outlet 1140 relative to the turbine axis 1108. The impingement of the auxiliary flow 1142 against the side wall 1116 will generate a relatively large amount of turbulence, which improves mixing of the aftertreatment fluid with the auxiliary flow 1142 and the turbine bulk flow 1118. Therefore, the aftertreatment fluid will decompose faster and will be more evenly distributed throughout the turbine outlet passage.

Furthermore, because the dosing module 1122 is positioned on the same side of the turbine outlet passage 1114 relative to the turbine axis 1108 as the auxiliary passage outlet 1140, the chance that any aftertreatment fluid will enter the auxiliary passage 1136 via the auxiliary passage 11140 is mitigated. In particular, for aftertreatment fluid to enter the auxiliary passage outlet 1140 its momentum would have to be reversed, which would not be possible due to the momentum of the turbine bulk flow 1118, or the momentum of the auxiliary flow 1142 when the turbine outlet the wastegate valve 1147 is open. Any aftertreatment fluid which settles in the auxiliary passage 1136 could solidify forming a blockage and/or preventing operation of the wastegate valve 1147.

FIG. 10 shows a further alternative embodiment of the invention in which the turbine 1100 comprises a wastegate arrangement 1148 in addition to the auxiliary passage 1136. The structure and configuration of the auxiliary passage 1136 the auxiliary flow direction 1144, the dosing module 1122 and the spray direction 1132 are substantially the same as that set out above in relation to FIGS. 2 and 3. The wastegate arrangement 1148 comprises a wastegate passage 1150 and a wastegate valve 1152. The wastegate passage 1150 extends between the turbine inlet passage 1110 and the turbine outlet passage 1114. The wastegate passage 1152 is configured to receive a portion of the turbine bulk flow 1118. The portion of the turbine bulk flow 1118 received by the wastegate passage 1150 defines a wastegate flow 1154. The wastegate valve 1152 is configured to selectively permit, prevent or regulate the flow through the wastegate passage 1152.

The auxiliary passage 1136 is free from any valves or restrictions, and therefore the auxiliary passage is able to provide a constant flow of exhaust gas to the spray region 1128 irrespective of whether the wastegate valve 1152 is open or closed. This is particularly useful for ensuring that the nozzle 1124 is always subjected to a shearing action by the auxiliary flow 1142 and to thereby avoid the formation of any deposits at the nozzle 1124, as well as for promoting spray breakup and improved mixing. However, it will be appreciated that the auxiliary passage 1136 may be configured in any of the alternative configurations described above in relation to the other embodiments of the invention.

As described above, because the auxiliary passage 1136 is free from valves or restrictors, the mass flow rate through the auxiliary passage 1136 must be relatively small in proportion to the overall mass flow from the engine so as to not adversely affect turbine performance. As such, the auxiliary passage 1136 cannot provide an effective wastegating function. However, because the turbine 1100 also comprises the wastegate arrangement 1148, the turbine 1100 is able to combine the advantage of the improved spray break up, mixing and nozzle cleaning provided by the auxiliary passage 1136 with wastegate functionality.

Additionally, the wastegate arrangement 1148 may be configured to deliver the wastegate flow 1154 into the turbine outlet passage 1114 in the same manner as the auxiliary flow 1142 according to any of the embodiments of the invention above. By doing so, the wastegate arrangement 1148 is able to provide some or all of the same advantages as described above in relation to the auxiliary passage 1136 of the other embodiments. One such example is illustrated in FIG. 10, in which the wastegate flow 1154 is delivered to the turbine outlet passage 1114 in substantially the same manner as the auxiliary flow in the embodiment of FIG. 6. Accordingly, when the wastegate valve 1152 is open, the wastegate flow 1154 is able to provide the same advantages as set out above in relation to the auxiliary flow 1144 of the embodiment of FIG. 6 (namely, breaking up the droplets of aftertreatment fluid without causing excessive turbulence). In general, it will be appreciated that the auxiliary flow 1142 and the wastegate flow 1154 may be introduced into the turbine outlet passage in any combination of the configurations of the above described embodiments.

In yet further embodiments, the auxiliary passage inlet 1138 may be positioned in a location other than the turbine inlet passage 1110. For example, the auxiliary passage inlet could be positioned within the turbine wheel cavity 112 or within the turbine outlet passage 1114. In general, it will be appreciated that the auxiliary passage inlet 1138 may be positioned substantially anywhere within the turbine 1100 such that it is able to receive a portion of the turbine bulk flow 1118.

FIG. 11 shows a further embodiment of the present invention in which the nozzle 1124 of the dosing module 1122 is positioned approximately half way along the auxiliary passage 1136. The nozzle 1124 is configured to inject the aftertreatment fluid at an angle relative to the turbine axis 1108. The auxiliary passage 1136 defines an inlet portion 1143 extending from the auxiliary passage inlet 1138 to the nozzle 1124 of the dosing module 1122, and an outlet portion 1145 extending from the nozzle 1124 of the dosing module 1122 to the auxiliary passage outlet 1140.

The inlet portion 1143 defines an inlet axis 1149 extending longitudinally along the inlet portion 1143. The inlet axis 1149 is inclined relative to the turbine axis 1108 (or a centreline) by around 45°. However, in alternative embodiments the inlet axis 1149 may be inclined relative to the turbine axis 1108 by around 20° to around 70°, around 30° to around 60°, or around 40° to around 50°. In general, a shallower angle between the inlet axis 1149 and the turbine axis 1108 is preferable so that the axial momentum of the exhaust gas entering the auxiliary passage 1136 is not lost.

The outlet portion 1145 defines an outlet axis 1151 extending longitudinally along the outlet portion 480. The outlet axis 1151 is inclined relative to the turbine axis 1108 (or centreline) by around 45°. However, in alternative embodiments the inlet axis 1149 may be inclined relative to the turbine axis 1108 by up to around 70°, around 20° to around 70°, around 30° to around 60°, or around 40° to around 50°. Again, in general, a shallower angle between the outlet axis 1151 and the turbine axis 1108 is preferable to conserve axial momentum, and also to reduce the risk of DEF impingement on the wall of the turbine outlet passage 1114 opposite the dosing module 1122. However, if the angles of the inlet axis 1149 or the outlet axis 1151 are too shallow, then the axial distance between the auxiliary passage inlet 1138 and the auxiliary passage outlet 1140 will increase. This makes the arrangement less compact and could potentially cause the auxiliary passage outlet 1140 to lie outside the preferred range of around 10 exducer diameters from the turbine wheel 1104.

During use, a portion of the turbine bulk flow 1118 is received by the inlet portion 1143 of the auxiliary passage 1136. The auxiliary flow is then directed past the nozzle 1124 and through the outlet portion 1145. As the auxiliary flow passes the nozzle 1124, aftertreatment fluid is injected into the auxiliary flow, and the mixture of auxiliary flow and aftertreatment fluid is delivered to the turbine outlet passage 1114. Because the auxiliary flow and aftertreatment fluid mix in the turbine outlet passage, the auxiliary passage can be considered to be configured to direct the auxiliary flow into a spray region of the turbine outlet passage.

In alternative embodiments the inlet portion 1143 and the outlet portion 1145 may not extend longitudinally, but instead may comprise complex geometry including bends, twists or the like. In such cases, the inlet axis 1149 and the outlet axis 1151 may be centrelines extending along the inlet portion 1143 and the outlet portion 1145 respectively. The relevant angle between these centrelines and the turbine axis 1108 (or a centreline of the turbine outlet passage 1114) may be measured as the angle between a tangent to the centreline at the centroid of the auxiliary passage inlet 1138 or the auxiliary passage outlet 1140 to the turbine axis 1108.

The inlet portion 1143 defines a generally constant cross-sectional area, whilst the outlet portion 1145 diverges along the outlet axis 1151 in the direction from the nozzle 1124 of the dosing module 1122 to the auxiliary passage outlet 1140. During use, the nozzle 1124 generates a generally conical spray pattern of atomised DEF, shown by dotted lines in FIG. 10. Preferably, the outlet portion 1145 diverges at an angle that is equal to or greater than the angle of the spray cone generated by the nozzle 321. Because the outlet portion 1145 diverges at such an angle, this ensures that DEF does not impinge on the sides of the auxiliary passage 1136 and therefore deposit formation in the auxiliary passage is avoided. However, if the outlet portion 1145 diverges at too steep of an angle, the auxiliary flow will decelerate such that it loses the potential to influence flow in the turbine outlet passage 1114. Therefore, in alternative embodiments the spray cone angle may be around 45° to around 50°, whilst the outlet portion 1145 of the auxiliary passage 1136 diverges at a shallower angle, such as a round 5° to 10°. Although the aftertreatment fluid will be likely to impinge on the walls of the outlet portion 1145, the velocity of the auxiliary flow will remain high such that shearing forces will clean any impinged aftertreatment fluid from the walls to avoid deposit formation.

The turbine outlet passage 1114 of the present embodiment comprises a straight portion 1153 which is a generally cylindrical extension of the outlet of the turbine wheel chamber 1112 leading up to the auxiliary passage inlet 1138. The straight portion 1153 defines a first portion of the turbine outlet passage 1114 having a first flow area measured in a plane perpendicular to the turbine axis 1108. The turbine outlet passage 1114 further comprises a diffuser portion 1120 which begins immediately downstream of the auxiliary passage inlet 1138 at a vertex 1155 defined between the auxiliary passage inlet 1138 and the side wall 1116. The vertex 1155 defines a second portion of the turbine outlet passage 1114 having a second flow area measured in a plane perpendicular to the turbine axis 1108. In order to encourage a greater portion of the turbine bulk flow 1118 to enter the auxiliary passage 1136, the second flow area is smaller than the first flow area. In general, the smaller the second flow area is in comparison to the first flow area, the greater the proportion of the turbine bulk flow that is forced into the auxiliary passage inlet. However, if the second flow area is too small, a high back pressure will be exerted on the engine which will increase pumping work. Therefore, preferably the second flow area is smaller than the first flow area by between around 5% to around 15%, and preferably by around 10%.

FIG. 12 shows a further embodiment of the present invention comprising an auxiliary passage 1136 and a wastegate passage 1150 which are in fluid communication with one another. In the present embodiment, the turbine housing 1102 defines a plenum 1158 downstream of the turbine wheel chamber 1112. A conically shaped insert 1156 is received within the plenum 1158 and divides the plenum 1158 into the turbine outlet passage 1114 and the auxiliary passage 1136. Due to its conical shape, the insert 1156 defines the diffuser portion 1120 of the turbine outlet passage 1114. The diffuser is preferably made from stainless steel, so that any aftertreatment fluid which impinges thereon does not cause corrosion.

The insert 1156 comprises a first aperture defining the auxiliary passage inlet 1138. The auxiliary passage inlet 1138 is positioned in fluid flow communication with the turbine outlet passage 1114 so that it may receive a portion of the turbine bulk flow 1118. The inlet 1156 further comprises a second aperture defining the auxiliary passage outlet 1140. The auxiliary passage outlet 1140 is positioned in fluid flow communication so that it can deliver auxiliary flow 1142 from the auxiliary passage 1136 to the turbine outlet 114. The auxiliary passage outlet 1140 is positioned downstream of the auxiliary passage inlet 1138 with respect to the turbine bulk flow.

The nozzle 1124 of the dosing module 1122 is mounted in a wall of the turbine housing 1102 defining part of the auxiliary passage 1136. In particular, the nozzle 1124 is aligned with the auxiliary passage outlet 1140 such that the spray direction 1132 faces directly through the auxiliary passage outlet 1140. Accordingly, aftertreatment fluid is injected through the auxiliary passage outlet 1140 and into the turbine outlet passage 1114, such that the spray region 1128 is substantially located within the turbine outlet passage 1114.

The turbine 1100 comprises wastegate arrangement 1148 comprising the wastegate passage 1150. The wastegate passage 1150 fluidly extends from the turbine inlet passage 1110 to the auxiliary passage 1136. The wastegate arrangement comprises a wastegate valve 1152 which is configured to selectively open and close the wastegate passage 1150. The wastegate valve 1152 is a flap-type valve supported for rotation by an actuation rod 1164 and comprises a first valve portion 1160 and a second valve portion 1162. The first valve portion 1160 is configured to sealingly engage and substantially block the wastegate passage 1150. The second valve portion 1162 is positioned on an opposing side of the wastegate valve 1152 to the first valve portion 1160 and is configured to sealingly engage and substantially block the auxiliary inlet 1138. The wastegate valve 1152 is rotatable between a first configuration in which the first valve portion 1160 blocks the wastegate passage 1150 whilst the auxiliary passage inlet 1138 remains open, a second configuration in which both the wastegate passage 1150 and the auxiliary passage inlet are open, and a third configuration in which the wastegate passage 1150 is open and the second valve portion 1162 blocks the auxiliary passage inlet 1138.

During use, in the first configuration turbine bulk flow 1118 is received by the auxiliary passage 1136 via the auxiliary passage inlet 1138. The turbine bulk flow 1118 received by the auxiliary passage 1136 defines the auxiliary flow 1142. The auxiliary flow 1142 leaves the auxiliary passage 1136 via the auxiliary passage outlet 1140 and is directed into the spray region 1128 within the turbine outlet passage 1114. In this manner the auxiliary flow 1142 is able to provide improved droplet break up, improved mixing, and is able to keep the nozzle 1124 free of deposits.

In the second configuration, turbine bulk flow 1118 is received by the wastegate passage 1150 to define a wastegate flow 1154 which is delivered to the auxiliary chamber 1136. The wastegate flow 1154 has not passed through the turbine wheel 1104 and therefore has a much higher pressure than the auxiliary flow 1136. The wastegate flow 1154 passes through the auxiliary passage 1136 and enters the turbine outlet passage 1114 via the auxiliary passage outlet 1140. Because the wastegate flow 1154 passes through the auxiliary passage outlet 1140, the wastegate flow is able to provide the same benefit as the auxiliary flow 1142 in the first configuration described above, namely improved droplet break up, improved mixing and nozzle cleaning. In the second configuration, because the pressure of the wastegate flow 1154 is higher than the auxiliary flow 1142 and the turbine bulk flow 1118, some of the wastegate flow 1154 may leave the auxiliary passage 1136 via the auxiliary passage inlet 1138. This could cause a large turbulence in the region of the turbine outlet passage 1114 in the vicinity of the auxiliary passage inlet 1136, which could create a large back pressure on the turbine 1100. Since the purpose of opening the wastegate passage 1150 is to reduce the speed of the turbine wheel 1104, this back pressure may be tolerable.

In the third configuration, no turbine bulk flow 1118 is received from the auxiliary passage inlet 1138. Instead, the auxiliary passage 1136 only receives the wastegate flow 1154 from the wastegate passage 1150. This configuration ensures that all of the wastegate flow 1154 exits the auxiliary passage via the auxiliary outlet 1140. Accordingly, the turbulence issue described above in relation to the second configuration is avoided.

It will be appreciated that since both the auxiliary flow 1142 and the wastegate flow 1154 are defined by a portion of the turbine bulk flow 1118 the auxiliary flow 1142 and the wastegate flow 1154 may be considered functionally equivalent to one another when delivered to the turbine outlet 114 via the auxiliary passage outlet 1140. As such, the wastegate flow 1154 may be considered to be a further embodiment of an auxiliary flow (but one that has been taken from a separate source to the auxiliary flow 1142).

Although the embodiments described above comprise a single auxiliary passage, it will be appreciated that in alternative embodiment substantially any number of auxiliary passages may be used. Each auxiliary passage may be configured to provide a different beneficial effect from those described above in relation to the prior embodiments than the other auxiliary passages.

In all of the embodiments above, the turbine housing 1102 may be a single monolithic housing which defines all of the turbine inlet passage 1110, turbine wheel chamber 1112 and turbine outlet 114. Preferably, the turbine housing 1102 is made from cast iron or cast stainless steel. Where the latter is used, this reduces the chance of corrosion caused by the aftertreatment fluid. In alternative embodiments the turbine housing 1102 may comprise an assembly of two or more housing components defining portions of the turbine 1100. In particular, the turbine housing may comprise a first housing portion defining the turbine inlet passage 1110, the turbine wheel chamber 1112 and a portion of the turbine outlet passage 1114, and a second housing portion (also referred to as a connection adapter) defining the remainder of the turbine outlet passage 1114. The first housing component may be made from cast iron and the second housing component may be made from cast stainless steel (since only the second housing component will be exposed to aftertreatment fluid). In further embodiments the turbine housing 1102 may be made from cast iron, and the turbine outlet passage 1114 may comprise a lining of stainless steel, similar to the insert 1156 of the embodiment of FIG. 11.

FIG. 13 shows a turbine 2100 according to an embodiment of the present invention. The turbine 2100 forms part of a turbocharger, although in alternative embodiments the turbine may be used for substantially any suitable application, such as power generation or the like. The turbine 2100 comprises a turbine housing assembly 2101 comprising a main turbine housing 2102 and a connection adapter 2103. The turbine 2100 further comprises a turbine wheel 2104 supported by a turbocharger shaft 2106 and configured to rotate about a turbine axis 2108.

The turbine housing assembly 2101 defines a turbine inlet passage 2110, a turbine wheel chamber 2112 and a turbine outlet passage 2114. In particular, the main turbine housing 2102 defines the turbine inlet passage 2110, the turbine wheel chamber 2112 and an upstream portion of the turbine outlet passage 2114. The connection adapter 2103 defines a downstream portion of the turbine outlet passage 2114. The connection adapter 2103 is configured for connection to a downstream network of exhaust gas conduits which will eventually carry the exhaust gas to atmosphere.

The turbine 2100 is configured as a so-called “twin volute” turbine such that the turbine inlet passage 2110 comprises a pair of coextensive inlet volutes 2110a, 2110b configured to receive exhaust gas from an internal combustion engine (not shown). Each inlet volute 2110a, 2110b may be considered to define part of the turbine inlet passage 2110. The exhaust gas received from the internal combustion engine by the turbine inlet passage 2110 defines a turbine bulk flow 2118. The turbine inlet volutes 2110a, 2110b encourage swirling of the turbine bulk flow about the turbine axis 2110. Although the turbine 2100 is a twin volute turbine, it will be appreciated that this is not essential to the invention and that in alternative embodiments the turbine 2100 may have substantially any arrangement of volutes, for example a single volute or a so-called “dual volute” in which the volutes are angularly displaced from one another rather than coextensive.

The turbine wheel chamber 2112 is configured to receive the turbine bulk flow 2118 from the turbine inlet passage 2110. When the turbine bulk flow 2118 passes through the turbine wheel chamber 2112, it impinges upon blades (not shown) of the turbine wheel 2104 thus causing the turbine wheel 2104 to rotate and drive the turbocharger shaft 2106. The turbine wheel 2104 re-directs the turbine bulk flow 2118 so that it flows in an axial direction relative to the turbine axis 2108 and delivers the turbine bulk flow 2118 to the turbine outlet passage 2114. As such, the turbine 2100 is a so-called “radial” turbine. However, in alternative embodiments the turbine 2100 may be an “axial” turbine in which exhaust gas flows in a generally axial direction from the turbine inlet 2110 passage to the turbine outlet passage 2114.

The turbine outlet passage 2114 comprises a generally tapered side wall 2116 which defines a diffuser portion 2120 configured to cause expansion of the exhaust gas in the turbine outlet 2114. The side wall 2116 is outwardly tapered at an angle of around 7°, however in alternative embodiments any suitable taper angle may be used. The diffuser portion 2120 is symmetrically centred on the turbine axis 2108, such that the turbine axis 2108 defines a centreline of the turbine outlet passage 2114. References to a “turbine axis” herein will therefore be taken to apply correspondingly to a “centreline” defined by the turbine outlet passage. However, in alternative embodiments the diffuser portion 2120 may have any suitable shape. In such embodiments, the centreline may be defined by the centroid of the turbine outlet passage 2114 relative to the direction of the turbine bulk flow 2118. Accordingly, the centreline may bend or otherwise diverge away from the turbine axis 2108 in dependence upon the shape of the turbine outlet passage 2114. References herein to the turbine axis 2108 may therefore be understood to apply equally to the feature of a centreline. In yet further embodiments, the side wall 2116 may be generally cylindrical, such that the turbine 2100 does not comprise a diffuser portion 2120.

The turbine 2100 further comprises a dosing module 2122 configured to deliver an exhaust gas aftertreatment fluid to the turbine outlet passage. The aftertreatment fluid is, in particular, diesel exhaust fluid (DEF) and is commonly available under the trade mark AdBlue. The dosing module 2122 comprises a nozzle 2124 in fluid flow communication with the turbine outlet passage 2114. The nozzle 2124 is, in particular, an atomising nozzle configured to generate a substantially atomised spray of aftertreatment fluid within the turbine outlet passage 2114. The nozzle 2124 generates a generally conical spray pattern, however in alternative embodiments substantially any suitable spray pattern may be used (for example fan-shaped etc.). The spray pattern has a spray angle of around 55°, however in alternative embodiments substantially any suitable spray angle may be used. The nozzle 2124 is received within a hole 2126 defined by a mounting structure 2130 of the turbine housing 2102. The nozzle 2124 delivers aftertreatment fluid in a spray direction 2132 which faces generally towards the turbine axis 2108 and generally downstream in relation to the turbine bulk flow 2118. In the present embodiment, the spray direction 2132 is inclined at an angle of around 7° relative to a normal of the centreline 2109 such that it is generally normal to the taper angle. However, in alternative embodiments the spray direction 2132 may be inclined up to around 15° relative to the normal of the centreline 2109.

The aftertreatment fluid is sprayed into a spray region 2128 of the turbine outlet passage 2114. The spray region 2128 encompasses the spatial region in which the atomised spray of aftertreatment fluid has a larger component of velocity in the spray direction 2132 than in the direction of the turbine bulk flow 2118. The atomised spray of aftertreatment fluid leaving the nozzle 2124 has almost all of its velocity generally in the spray direction 2132. However, as the atomised spray of aftertreatment fluid travels laterally across the turbine outlet passage 2114 (i.e. in a direction normal to the turbine bulk flow 2118), interaction between the aftertreatment fluid and the turbine bulk flow 2118 changes the direction of the atomised spray of aftertreatment fluid until the aftertreatment fluid flows entirely in the direction of the turbine bulk flow 2118 (i.e. until the aftertreatment fluid is “carried away” by the momentum of turbine bulk flow 2118). The spray region 2128 corresponds to the portion of the turbine outlet passage 2114 in which the individual droplets of aftertreatment fluid carry more momentum from the dosing module 2122 than from the turbine bulk flow 2118. Accordingly, the geometry of the spray region 2128 is a property of the delivery strength of the dosing module 2128 relative to the momentum of the turbine bulk flow 2118. For the sake of simplicity, the spray region 2128 is illustrated in FIG. 13 as a conical region. However, it will be appreciated that due to the interaction between the turbine bulk flow 2118 and the aftertreatment fluid explained above the spray region 2128 will not, in reality, have a completely conical shape.

FIG. 2B shows a plot of the relative concentration of aftertreatment fluid in the turbine 2100. The plot of FIG. 2B is taken from a computational fluid dynamics model of the turbine 2100 when the wastegate valve (described later) is closed. In the plot, the spray region 2128 can be clearly seen as a region of high concentration of aftertreatment fluid emanating from the vicinity of the mounting structure 2130. As noted above, the spray region is generally conical in shape, but is deflected by the momentum of the bulk flow 2118 such that the aftertreatment fluid is carried down the turbine outlet passage 2114.

With reference to FIGS. 14 and 15, the turbine 2100 further comprises an auxiliary passage 2136 and a valve arrangement 2144. The auxiliary passage 2136 comprises an auxiliary passage inlet 2138 and an auxiliary passage outlet 2140. The auxiliary passage inlet 2138 is formed by an opening in the wall of one of the inlet volutes 2110a of the turbine inlet passage 2110 and is therefore defined by the turbine housing 2102. Accordingly, the auxiliary passage inlet 2138 is operable to receive a portion of the turbine bulk flow 2118 from the turbine inlet passage 2110. The portion of the turbine bulk flow 2118 received by the auxiliary passage 2138 defines an auxiliary flow 2142. The auxiliary passage outlet 2140 is formed by an opening in the sidewall 2116 of the turbine outlet passage, such that the auxiliary passage 2138 is operable to deliver the auxiliary flow to a position downstream of the turbine wheel 2104. In particular, the auxiliary passage outlet 2140 is formed as an opening in the connection adapter 2103.

The valve arrangement 2144 is configured to permit, prevent and control the passage of the auxiliary flow 2142 through the auxiliary passage 2136. With reference to FIG. 15, the valve arrangement 2144 is a so-called “flap” type valve arrangement comprising a valve member 2146 supported for rotation by an actuator rod 2148. Rotation of the actuator rod 2148 causes the valve member 2146 to move into and out of engagement with a valve seat 2150 defined by the housing 2102 surrounding the auxiliary passage inlet 2138. When the valve member 2146 engages the valve seat 2150, the turbine bulk flow 2118 is prevented from entering the auxiliary passage 2136, such that there is substantially no auxiliary flow 2142. When the valve member 2146 disengages the valve seat 2150, a portion of the turbine bulk flow enters the auxiliary passage 2136 to define the auxiliary flow 2142. The flow rate of the auxiliary flow 2142 can be adjusted by controlling the degree of engagement and/or separation between the valve member 2146 and the valve seat 2150. Although the valve arrangement 2144 shown is a flap type valve arrangement, it will be appreciated that in alternative embodiments substantially any suitable valve may be used. For example, a rotary “barrel” type valve arrangement, a poppet valve, a sliding mechanism or the like may be used.

Because the auxiliary passage 2136 extends from a position upstream of the turbine wheel 2104 to a position downstream of the turbine wheel 2104, the valve arrangement 2144 therefore functions as a wastegate valve and the auxiliary passage 2136 functions as a wastegate passage. The auxiliary passage inlet 2138 is sized such that when the valve arrangement 2144 is fully open the flow rate of auxiliary flow 2142 through the auxiliary passage 2136 is at least around 25% of the flow rate of turbine bulk flow 2118 delivered to the turbine inlet passage 2110 by the internal combustion engine. That is to say, the auxiliary passage 2136 is capable of bypassing at least around 25% of the flow received by the turbine inlet passage 2110 around the turbine wheel 2104 when the valve arrangement 2144 is fully open. This enables enough exhaust gas to bypass the turbine wheel 2104 so that the power produced by the turbine 2100 is reduced by a sufficient amount to prevent overspeed events.

As shown in FIG. 13, during use when the turbine bulk flow 2118 in the turbine outlet passage 2114 leaves the turbine wheel 2104, it travels along the turbine axis 2108. However, with reference to FIG. 14, due to the rotation of the turbine wheel 2104, the mean (i.e. bulk or overall) velocity of the turbine bulk flow 2118 in the turbine outlet passage 2114 also defines an angular component around the turbine axis 2108. Accordingly, the turbine bulk flow 2118 travels in a generally spiral-like path away from the turbine wheel 2104. The angular direction of rotation of the turbine wheel 2104 can be said to define a positive angular direction, and the turbine bulk flow 2118 circulates about the turbine axis 2108 in the positive angular direction, as shown by the arrows in FIG. 14. The combination of angular and axial momentum of the turbine bulk flow 2118 may also be described as “swirl”.

With reference to FIGS. 14 and 15, the auxiliary passage 2136 extends in both an axial direction along the turbine axis 2108 and in a circumferential direction around the turbine axis 2108. When the valve arrangement 2144 is open the auxiliary flow 2142 is initially received in an axial direction relative to the turbine axis 2108. However, the shape of the auxiliary passage 2136 re-orients the auxiliary flow 2142 so that it flows both axially and circumferentially around the turbine axis 2108. In particular, the auxiliary flow passage 2136 is configured so that the momentum of the auxiliary flow 2142 is directed in the same angular direction around the turbine axis 2108 as the turbine bulk flow 2118 (that is to say, in the positive angular direction). Accordingly, when the auxiliary flow 2142 enters the turbine outlet passage 2114, the auxiliary flow 2142 is encouraged to swirl around the turbine axis 2108 in the positive angular direction. Because the auxiliary flow 2142 and the turbine bulk flow 2118 flow in the same angular direction, this minimises any disturbances caused to the turbine bulk flow 2118 by the auxiliary flow. Furthermore, the auxiliary flow 2142 will impart some of its momentum onto the turbine bulk flow 2118, causing an increase in the magnitude of swirling motion of the turbine bulk flow 2118.

With reference to FIG. 14, the housing 2102 comprises a first flow surface 2152 defining the radially outermost part of the auxiliary passage 2136 relative to the turbine axis 2108. The first flow surface 2152 may alternatively be referred to as an auxiliary passage surface. The side wall 2116 of the housing 2102 comprises a second flow surface 2154 which defines the radially outermost part of the turbine outlet passage 2114 relative to the turbine axis 2108. The second flow surface 2154 is a surface of the diffuser portion 2120. The second flow surface 2154 may alternatively be referred to as a turbine outlet passage surface. The flow first surface 2152 and the second flow surface 2154 join one another at an interface 2156. The first flow surface 2152 is angled relative to a tangent of the second flow surface 2154 at the interface 2156 by an angle of around 2° away from the turbine axis 2108. Preferably, the first flow surface 2152 and the second flow surface 2154 should be as tangential as possible, such that the relative angle therebetween is 0°. However, in alternative embodiments the first flow surface 2152 may be angled relative to the tangent of the second flow surface 2154 by up to around 5°, around 10°, or around 15° towards or away from the turbine axis 2108. Because the angle of the first flow surface 2152 is very close to that of the tangent of the second flow surface 2154 at the interface 2156, when the auxiliary flow 2142 enters the turbine outlet passage 2114 it does so generally tangentially to the second flow surface 2154. As such, there is minimal disturbance to the auxiliary flow 2142 as it passes from the auxiliary passage 2136 to the turbine outlet passage 2114.

It is preferable that the interface 2156 is as smooth as possible. If the interface is sharp-edged, this could cause the auxiliary flow layer to separate from the second flow surface 2154, which would be detrimental to the aerodynamics of the auxiliary flow layer 2142. Accordingly, the interface 2156 may comprise a so-called “blended transition” between the first surface 2152 and the second surface 2154. The blended transition may be, for example, a curved surface having a large radius of curvature. By incorporating a “blended transition” at the interface 2156, larger angles between the first flow surface 2152 and the second flow surface 2154 can be tolerated, for example up to or above 20°.

With reference to FIG. 14, when the auxiliary flow 2142 is delivered to the turbine outlet passage 2114, it is directed along the second flow surface 2154 in an auxiliary flow layer 2158. The auxiliary flow layer 2158 acts as a boundary layer flowing over the second flow surface 2154. The boundary of the auxiliary flow layer 2158 is denoted in FIG. 14 by dotted lines. The auxiliary flow 2142 within the auxiliary flow layer has been conditioned by the auxiliary passage 2136 such that the auxiliary flow 2142 flows generally uniformly in substantially the same direction. Furthermore, since the auxiliary flow 2142 is sourced from a position upstream of the turbine wheel 2104, it has a higher internal energy than the turbine bulk flow 2118 in the turbine outlet passage 2114. Accordingly, the velocity of the auxiliary flow 2142 within the auxiliary flow layer 2158 is generally higher than the velocity of the turbine bulk flow 2118 within the turbine outlet passage 2114. The higher velocity within the auxiliary flow layer 2158 creates a region of very high fluidic shearing forces.

With reference to FIGS. 13 and 14, the auxiliary passage outlet 2140 is generally aligned with the dosing module 2122 along the turbine axis 2108, and is angularly displaced from the dosing module 2122 by around 90° in the positive angular direction. As a result, the dosing module 2122 is positioned on an opposite side of the turbine outlet passage 2114 to the part of the auxiliary flow layer 2158 just beyond the point at which the auxiliary flow 2142 enters the turbine outlet passage 2114. During use, when aftertreatment fluid is injected into the turbine outlet passage 2114 by the dosing module 2122, the aftertreatment fluid travels across the turbine outlet passage 2114 in the direction of the second flow surface 2154. However, due to the high fluid velocity and high shearing forces in the auxiliary flow layer 2158, the auxiliary flow 2142 in the auxiliary flow layer 2158 acts to deflect the droplets of aftertreatment fluid away from the second flow surface 2154. Furthermore, the shearing forces cause the droplets of aftertreatment fluid to break up, thus making the aftertreatment fluid droplets easier to deflect. Accordingly, the auxiliary flow layer 2158 acts as a fluidic barrier which inhibits or otherwise hinders or prevents aftertreatment fluid from making contact with the second flow surface. The auxiliary flow layer 2158 may therefore be thought of as a high-shear “cushion” which prevents or reduces the amount of aftertreatment fluid contacting the second flow surface 2154.

This provides two benefits to the turbine 2100. First, because aftertreatment fluid cannot reach the second flow surface 2154, the risk of deposit formation caused by pooling of aftertreatment fluid on a surface that is below the evaporation temperature of the aftertreatment fluid is avoided. Therefore, the auxiliary passage outlet 2114 is kept free from possible blockages caused by the formation of solid deposits of aftertreatment fluid. Secondly, because the droplets of aftertreatment fluid that are broken up by the auxiliary flow layer 2158 are reduced in size, heat transfer from the exhaust gas in the turbine outlet passage 2114 to the aftertreatment fluid is improved, causing faster evaporation of the water component of the aftertreatment fluid, and faster decomposition of the urea component of the aftertreatment fluid into the reductants required to support the SCR reaction. Thus, the auxiliary flow layer 2158 also improves the decomposition rate of the aftertreatment fluid.

In addition, the shearing forces of the auxiliary flow layer 2158 act to “spread out” any aftertreatment fluid that has settled on the sidewall 2116. This increases heat transfer to the settled aftertreatment fluid, causing it to evaporate. Additionally, the high shearing forces also act to strip aftertreatment fluid from the sidewall 2116, so that the aftertreatment fluid is re-entrained in the exhaust gas. Furthermore, the shearing forces simply act to spread the aftertreatment fluid in a downstream direction towards the downstream aftertreatment components such as SCR catalysts or the like.

As a result of the advantages described above, it is possible to perform aftertreatment fluid decomposition within the turbine outlet passage 2114 itself rather than in a separate decomposition chamber downstream. Put another way, the use of the auxiliary flow layer 2158 enables the dosing module 2122 to be placed closer to the turbine wheel 2104, such that the turbine 2100 is able to provide a venue for reductant decomposition and therefore eliminates the need to have a separate decomposition chamber downstream of the turbine 2100.

The turbine wheel 2104 defines an exducer portion having an exducer diameter. With reference to FIG. 13, the centre of the nozzle 2124 of the dosing module 2122 is positioned approximately 2 exducer diameters downstream of the turbine wheel 2104 along the turbine axis 2108. Likewise, the geometric centre of the auxiliary passage outlet 2140 is positioned approximately 2 exducer diameters downstream of the turbine wheel 2104 along the turbine axis 2108. Accordingly, both the nozzle 2124 and the auxiliary passage outlet 2140 can be considered as being positioned close to the turbine wheel 2104. However, in alternative embodiments the geometric centres of the nozzle 2124 and/or the auxiliary passage outlet may be positioned around 1, around 1.5, around 2.5, around 5 or around 10 exducer diameters away from the turbine wheel 2104 along the turbine axis 2108 (or along a centreline defined by the turbine outlet passage 2114).

Although the use of an auxiliary flow layer 2158 substantially reduces or prevents any aftertreatment fluid from contacting the second flow surface 2154, it is nevertheless preferable that the connection adapter 2103 and/or the turbine housing 2102 are made from stainless steel so as to prevent corrosion in the event that any aftertreatment fluid impinges on the second flow surface 2154.

The auxiliary flow layer 2158 defines a thickness in a radial direction relative to the turbine axis 2108. The thickness of the auxiliary flow layer 2158 is dependent upon the dimensions of the auxiliary passage outlet 2140. The precise dimensions of the auxiliary passage outlet 2140 may therefore be chosen in dependence upon a desired thickness of the auxiliary flow layer 2158 at a given operating condition of the turbine 2100. In the present embodiment, the thickness of the auxiliary flow layer 2158 is around 15% of the radius of the turbine outlet passage 2114 measured at the centre of the auxiliary passage outlet 2140 when the valve assembly 2144 is fully open. In general, the larger the thickness of the auxiliary flow layer 2158, the less likely it is that aftertreatment fluid will reach the second flow surface 2154. As such, preferably the thickness of the auxiliary flow layer 2158 is at least around 5% of the radius of the turbine outlet passage 2114. However, if the auxiliary flow layer is too thick, it will act to impede the flow of turbine bulk flow 2118 through the turbine outlet passage 2114. As such, preferably the thickness of the auxiliary flow layer 2158 is at most around 25% of the radius of the turbine outlet passage 2114.

With reference to FIG. 13, the auxiliary passage outlet 2140 is generally in the shape of a parallelogram having a pair of long sides delimiting a width of the auxiliary passage outlet 2140, and a pair of short sides delimiting a depth of the auxiliary passage outlet 2140. Accordingly, the auxiliary passage outlet 2140 can be described as “letterbox” shaped. The long sides extend in a generally axial direction relative to the turbine axis 2108, however since the side wall 2116 is frusto-conically shaped the long sides are inclined relative to the turbine axis 2108 by the taper angle of the side wall 2116. The short sides extend in a generally circumferential direction relative to the turbine axis 2108. Accordingly, the auxiliary flow layer 2158 generated by the auxiliary passage outlet 2140 is relatively wide in comparison to its thickness. Preferably, the width of the auxiliary flow layer 2158 should be wide enough to capture as much aftertreatment fluid as possible injected by the dosing module 2122. Therefore, the width of the auxiliary passage outlet 2140 may be chosen in dependence upon the properties of the dosing module 2122, and in particular the spray angle of the dosing module 2122.

In the embodiment shown, the width of the auxiliary passage outlet 2140 is around 75% of the diameter of the turbine outlet passage 2114 measured at the centre of the auxiliary passage outlet 2140. However, in alternative embodiments the width of the auxiliary passage outlet 2140 may be anywhere between around 50% to around 100%, around 150% or around 200% of the radius of the turbine outlet passage 2114. In general, widening the auxiliary passage outlet 2140 provides improved area coverage of the second flow surface 2154 by the auxiliary flow layer 2158. In some embodiments, the width of the auxiliary passage outlet 2140 may be chosen in dependence upon the spray angle of the dosing module 2122, and in particular so that the auxiliary flow layer 2158 is wide enough to catch as much aftertreatment fluid as possible. However, in order to provide adequate shearing forces to support the functionality of the auxiliary flow layer 2158, the auxiliary flow layer 2158 may need to be made thinner as the width increases, and therefore chance of aftertreatment fluid reaching the second flow surface 2154 will increase.

In the embodiment shown, the depth of the auxiliary passage outlet 2140 is around 25% of the width of the auxiliary passage outlet 2140. It has been found that this provides a good balance between ensuring a sufficient width of the auxiliary flow layer 2158 and providing a thick enough layer to support the shearing effects. However, in alternative embodiments the depth of the auxiliary passage may be around 15% to around 50% of the width of the auxiliary passage outlet 2140, or any dimension suitable for producing an auxiliary flow layer 2158 having a thickness in the ranges specified above.

The auxiliary passage outlet 2140 defines a flow area perpendicular to the direction of flow of the auxiliary flow 2142 therethrough. With reference to FIG. 14, the flow area of the auxiliary outlet passage 2140 is preferably narrower than the flow area of the auxiliary passage 2136 upstream of the auxiliary passage outlet 2140. In particular, with reference to FIG. 15, since the auxiliary passage 2138 comprises a valve arrangement 2144, the auxiliary passage necessarily comprises a plenum large enough to contain the valve arrangement 2144. As such, the flow through the plenum is relatively low velocity. However, because the flow area of the auxiliary passage 2136 decreases as it narrows towards the auxiliary passage outlet 2140, the auxiliary flow 2142 is accelerated as it enters the turbine outlet passage 2114. As such, the auxiliary passage outlet 2140 helps to increase the shearing forces in the auxiliary flow layer 2158.

With reference to FIG. 15, the valve arrangement 2144 comprises a valve opening 2145. The valve opening 2145 is in direct communication with one of the inlet volutes 2110a. The valve opening 2145 is covered by a valve member 2146, as described below. The valve opening 2145 defines a valve flow area in a direction normal to the direction of flow through the valve opening 2145. The flow area of the auxiliary passage outlet 2140 is chosen so that it is at least 1.2 times larger than the valve flow area. Because the flow area of the auxiliary passage outlet 2140 is larger than the valve flow area, this ensures that the auxiliary passage outlet 2140 does not act to choke the flow of auxiliary flow 2142. Accordingly, high velocity and high shear flow conditions can be ensured in the auxiliary flow layer 2158.

As described above, the valve arrangement 2144 is positioned over the valve opening 2145 which is in communication with the turbine inlet 2110. As such, the valve arrangement is positioned upstream of the auxiliary passage outlet 2140. It is preferable that distance between the auxiliary passage outlet 2140 and the valve arrangement 2144 is relatively short, so as to reduce the amount of pipe friction exerted on the auxiliary flow by the auxiliary passage 2136. In the present embodiment, the turbine outlet passage 2140 is spaced apart from the valve assembly 2144 by a distance of around 6 or 7 times the depth of the auxiliary passage outlet 2140. In this context, the distance between the valve assembly 2144 and the auxiliary passage outlet 2140 is the distance along a streamline of the auxiliary flow from the valve opening 2145 to the auxiliary passage outlet 2140. However, it has been found that adequate performance can be achieved when the turbine outlet passage 2140 is spaced apart from the valve assembly 2144 by a distance up to around 15 times the depth of the auxiliary passage outlet 2140.

Although the auxiliary passage outlet 2140 described above is generally parallelogram or “letterbox” shaped, it will be appreciated that in alternative embodiments the auxiliary passage outlet may be any suitable shape. For example, the auxiliary passage outlet could be circular, triangular, square or the like. However, it is generally preferable that the auxiliary passage outlet 2140 is of a shape that is longer in one dimension than the other, so as to provide an auxiliary flow layer 2158 with a relatively large width in comparison to its thickness. Therefore, the auxiliary passage outlet 2140 may be a shape having one or more long sides, for example, a trapezium, an elongate slot or the like. In yet further embodiments, the auxiliary passage outlet may be oriented at any suitable angle relative to the turbine axis 2108. For example, the auxiliary passage outlet 2140 could extend generally parallel to the turbine axis 2108, transverse to the turbine axis 2108 or at any angle inbetween.

With continued reference to FIG. 13, the motion of the turbine bulk flow 2118 defines a first swirl angle A1. The “swirl angle” of a flow is a measure of the relative amount of circumferential motion relative to axial motion. When the swirl angle is zero, the flow has no circumferential motion and flows entirely axially. When the swirl angle is 90, the flow has no axial motion and flows entirely circumferentially. Accordingly, the swirl angle B1 of the turbine bulk flow 2118 is the relative angle between the direction of flow of the turbine bulk flow 2118 and the turbine axis 2108. The size of the first swirl angle is dependent upon of the configuration of the turbine wheel 2104 (e.g. the shape of the turbine blades and the like), the pressure and flowrate of the turbine bulk flow 2118 delivered to the turbine wheel 2104, and the speed of rotation of the turbine wheel 2104. Accordingly, the size of the first swirl angle will vary depending upon the operating condition of the turbine 2100. However, typically the first swirl angle is in the range of around 0° to around 70° in either the positive or negative direction. The auxiliary passage 2136 directs the auxiliary flow 2142 into the turbine outlet passage 2114 at a second swirl angle B2. The size of the second swirl angle B2 will depend upon the pressure and flow rate of the auxiliary flow 2142 as well as the geometry of the auxiliary passage 2138. From a purely geometric perspective, the auxiliary passage 2136 is shaped so that the auxiliary flow 2142 is directed entirely orthogonally to the turbine axis 2108 (and in the same direction around the turbine axis 2108 to the swirl of the bulk flow). However, momentum of the bulk flow 2118 along the turbine axis 2108 will deflect the auxiliary flow 2142. As such, when the valve arrangement 2144 is fully open, the second swirl angle is generally in the range of around 30° to around 85° (that is to say, at most, it is slightly short of orthogonal to the turbine axis 2108).

Because the second swirl angle B2 is steeper than the first swirl angle A1, the auxiliary flow 2142 has a greater component of velocity in the circumferential direction than the turbine bulk flow 2118. The auxiliary flow 2142 will impart some of this velocity onto the turbine bulk flow 2118, thereby increasing the magnitude of the swirling motion of the turbine bulk flow 2118. This acts to provide further shearing forces in the turbine bulk flow 2118 which deflect and break up the droplets of aftertreatment fluid so that they cannot reach the second flow surface 2154. However, it will be appreciated that in alternative embodiments the auxiliary passage 2136 may be configured to deliver the auxiliary flow 2142 at a second swirl angle B2 that is substantially the same as the first swirl angle A1, or which is within an acceptable variation such as for example ±5°, ±10°, or ±15°.

In further embodiments, the auxiliary passage 2136 may be shaped so that the auxiliary flow 2142 is directed at an angle relative to the orthogonal to the turbine axis 2108, for example up to around 10°, 20°, 30°, 45° or 60° relative to the orthogonal to the turbine axis 2108. In such embodiments, the swirl angle of the auxiliary flow 2142 will be diminished.

It has also been found that by introducing the auxiliary flow 2142 into the turbine passage outlet 2114 with swirling momentum increases mixing of the aftertreatment fluid with the turbine bulk flow 2118 outside of the auxiliary flow layer 2158. That is to say, the swirling momentum of the auxiliary flow layer 2158 acts as a fluidic agitator, which imparts fluidic frictional forces onto the turbine bulk flow 2118. This increases the turbulent motion in the turbine bulk flow 2118, and in turn improves mixing of the turbine bulk flow 2118 with the aftertreatment fluid. Accordingly, more heat is transferred to the aftertreatment fluid, which improves the rate of decomposition.

Because the auxiliary passage 2136 is a wastegate passage, the auxiliary flow 2140 does not flow through the auxiliary passage at all operating conditions of the turbine 2100. Accordingly, there are operating conditions in which not additional swirling momentum is imparted on the turbine bulk flow 2118. In alternative embodiments, the auxiliary passage outlet 2114 may comprise one or more guide vanes which protrude into the auxiliary passage to impart additional swirling momentum to the turbine bulk flow 2118. This ensures that swirling is improved even when no auxiliary flow 2142 is available.

With reference to FIGS. 14 and 16, the turbine 2100 further comprises an exhaust gas sensor 2160, for example of the type described above/below in relation to FIGS. 48 to 51. The sensor arrangement 2160 comprises a sensor 2162 disposed within a sensor passage 2164. The sensor passage 2164 is defined by a conduit of the housing 2102 which protrudes partially into the turbine outlet passage 2114 to define a protrusion 2165. The sensor passage 2164 has a circular cross-section and extends in a generally axial direction relative to the turbine axis 2108 along the side wall 2116 of the diffuser portion 2120. The centre of the sensor passage 2164 is generally aligned with the second flow surface 2154, such that the sensor passage 2164 is in fact inclined relative to the turbine axis 2108 by the taper angle of the diffuser portion 2120.

The sensor passage 2164 defines a sensor passage inlet 2166 and a sensor passage outlet 2168. The sensor passage inlet 2166 is in fluid flow communication with the turbine outlet passage 2114 such that the sensor passage inlet 2166 receives a portion of the turbine bulk flow 2118 from the turbine outlet passage 2114. The portion of the turbine bulk flow 2118 received by the sensor passage 2164 defines a sensor flow (not labelled). The sensor passage outlet 2168 is in fluid flow communication with the turbine outlet passage 2114 at a position downstream of the sensor passage inlet 2166 relative to the turbine bulk flow 2118. The sensor passage outlet 2168 is configured to deliver the sensor flow back into the turbine bulk flow 2118.

The auxiliary passage outlet 2140 is positioned such that the swirling motion of the auxiliary flow 2142 carries the auxiliary flow layer 2158 past the sensor passage outlet 2168 at a position downstream of the sensor passage outlet 2168 relative to the turbine bulk flow 2118. The path of the auxiliary flow layer 2158 is illustrated in FIG. 16 by dotted lines. The precise position of the auxiliary passage outlet 2140 relative to the sensor passage outlet 2168 can be determined, for example, based upon the swirl angle B2 of the auxiliary flow 2142 (i.e. the second swirl angle), the swirl angle of the turbine bulk flow 2118 in the immediate vicinity of the auxiliary passage outlet 2140 (which may be slightly shallower than the first swirl angle 1 as the turbine bulk flow 2118 enters the turbine outlet passage 2114), and the angular position of the turbine passage outlet 2140 relative to the sensor passage outlet 2168 about the turbine axis 2108. Such calculations may be aided, for example, by computational analysis or experimentation.

Because the auxiliary flow layer 2158 passes downstream of the sensor passage outlet 2168, the auxiliary flow layer 2158 does not pass over the protrusion 2165 of the sensor passage 2164. Accordingly, the auxiliary flow layer 2158 is not disturbed or broken up by the protrusion 2165. Therefore the auxiliary flow layer 2158 does not generate additional turbulence close to the side wall 2116 of the turbine outlet passage 2114 which would reduce the near-wall shearing forces and make aftertreatment fluid more likely to contact the second flow surface 2154. Furthermore, because the auxiliary flow layer 2158 is not broken up, the auxiliary flow layer 2158 is able to provide a fluidic barrier at other parts of the internal combustion engine system downstream of the sensor passage 2164. However, it would be apparent to the skilled person that the sensor passage 2164 does not necessarily need to be present in order for the auxiliary flow layer 2158 to provide a fluidic barrier at other parts of the internal combustion engine system, as discussed below.

It will be appreciated that, in general, the position of the auxiliary passage outlet 2140, the swirl angle of the auxiliary flow 2142 as it enters the turbine outlet passage 2114 (i.e. the second swirl angle B2) the geometry of the turbine outlet passage 2114 and the geometry of any network 2172 of conduits downstream of the turbine 2100 may be chosen so that the auxiliary flow layer 2158 flows over any surfaces where aftertreatment fluid is likely to impinge. That is to say, not only can the auxiliary flow layer 2158 be directed to flow over high risk areas for impingement in the turbine outlet passage 2114 (e.g. “primary risk” areas), but also over high risk areas of the system further downstream (e.g. “secondary risk” areas).

FIG. 17 shows a plot of wall shear forces in the flow volume of the turbine 2100. As shown in the figure, the internal combustion engine comprises a network 2170 of flow conduits downstream of the turbine 2100. The network comprises a bent portion 2172 immediately downstream of the turbine outlet passage 2114 which directs the turbine bulk flow around a bend of approximately 90°. During use, due to the axial momentum imparted upon the aftertreatment fluid by the turbine bulk flow 2118 in the turbine outlet passage 2114, aftertreatment fluid that is injected into the turbine outlet passage 2114 by the dosing module 2122 is likely to impinge upon the outer apex of the bent portion 2172. However, the auxiliary passage 2136 is configured such that not only does the auxiliary flow layer 2158 pass downstream of the sensor passage 2164, but the auxiliary flow layer 2158 also passes over the outer apex of the bent portion 2172. This can be seen in FIG. 17 by the presence of high shear forces on the outer apex of the bent portion 2172. Therefore, the auxiliary flow layer 2158 is able to provide a fluidic barrier covering the outer apex of the bent portion 2172, thus reducing the likelihood of any aftertreatment fluid impinging upon the outer apex of the bent portion 2172 on forming solid deposits.

FIG. 18 shows a variation of the turbine 2100 of FIG. 13 of the present invention. The variation of FIG. 18 is substantially identical to the embodiment of FIG. 13, and differs in that the auxiliary passage 2136 is bifurcated such that it comprises first and second branches. In FIG. 18, only half of the turbine housing 2102 is shown. The first branch terminates at the auxiliary passage outlet 2140 and functions as described previously above. The second branch 2141 terminates in a second auxiliary passage outlet that is positioned generally opposite the auxiliary passage outlet 2140 of the first branch. Although the second auxiliary passage outlet is not shown in FIG. 18, it will be appreciated that it is positioned generally at the end of the visible contours defining the second branch 2141. In particular, the second auxiliary passage outlet is positioned on generally the same side of the turbine outlet passage 2114 as the dosing module 2122, and is generally aligned with the dosing module 2122 along the turbine axis 2108. Because the second auxiliary passage outlet is positioned near the dosing module 2122, the auxiliary flow that has passed through the second branch 2141 is delivered close to the spray region 2128 of the dosing module. This acts to increase the temperature of the exhaust gas in the spray region, thus providing more heat and improving decomposition of the injected aftertreatment fluid.

During use, as explained above, the auxiliary flow layer 2158 creates a region of high velocity in the lower portion of the turbine outlet passage 2114. Accordingly, the velocity of the bulk flow 2118 in the upper part of the turbine outlet passage 2114 is relatively slow. This slow moving exhaust gas may re-circulate, which will impede flow through the turbine outlet passage 2114 and increase the back pressure on the engine. However, because the second auxiliary passage outlet is positioned opposite the auxiliary passage outlet 2140 of the first branch, the auxiliary flow leaving the second branch acts to increase the velocity of the exhaust gas in the upper portion of the auxiliary passage outlet 2114. Accordingly, this reduces the likelihood that the exhaust gas will recirculate in the upper portion of the turbine outlet passage.

Finally, it will be appreciated that when the bulk flow 2118 is directed around bends or the like (such as that shown in FIG. 17) if the bend is too sharp, there is a tendency for the flow to separate from the surfaces of the passage and recirculate. This is particularly likely to happen where the local flow velocity over the inner part of the bend is too high. Such recirculation of the flow impedes flow through the passage and exerts a back pressure on the engine. It has been found that by using the second branch of the auxiliary passage to deliver flow into the upper portion of the turbine outlet passage, the local flow velocity on the inner part of the bend can be slowed. In effect, the second branch acts to “smooth out” regions of very high velocity, so that the velocity profile across the width of the passage is more even. Accordingly, this can be used to mitigate flow separation over bends in pipework.

Although the auxiliary passage 2136 delivers the auxiliary flow 2142 into the turbine outlet passage 2114 in a direction which induces swirling of the auxiliary flow 2142 about the turbine axis 2108, it will be appreciated that in alternative embodiments the auxiliary passage 2136 may deliver the auxiliary flow 2142 in substantially any direction which guides the auxiliary flow along a surface of the turbine outlet passage 2114 (i.e. the second flow surface 2154). Provided that the auxiliary flow 2142 is guided over a surface of the turbine outlet passage 2114, the auxiliary flow 2142 will define an auxiliary flow layer 2158 that is able to act as a fluidic barrier to deflect aftertreatment fluid away from the surface over which the auxiliary flow layer 2158 flows, regardless of whether or not the auxiliary flow has any swirling motion or not.

For example, FIGS. 19 and 20 show a another embodiment of a turbine 2200 according to the present invention. The turbine 2200 is substantially identical to the turbine 2100 of the embodiment of FIG. 13 other than in respect of the differences described below. Like reference numerals have therefore been used to denote equivalent features to the embodiment of FIG. 13. In the turbine 2200 of the embodiment shown in FIGS. 19 to 20, the housing 2202 comprises a shield structure 2274 which protrudes into the turbine outlet passage 2114 approximately halfway along the diffuser portion 2220. The shield structure 2274 extends circumferentially about the turbine axis 2208 along a portion of the side wall 2216. The shield structure 2274 has a generally L-shaped cross-section so that it defines a channel that is closed along a side proximal to the turbine wheel 2204 and open along a side distal to the turbine wheel 2204. The channel defines a portion of the auxiliary passage 2236, and the open side of the channel defines the auxiliary passage outlet 2240. Accordingly, the auxiliary passage outlet 2240 is oriented generally normal to the turbine axis 2208 in a direction facing away from the turbine wheel 2204.

During use, the auxiliary flow 2242 is delivered to the turbine outlet passage 2214 by the auxiliary passage 2236. Due to the shape of the shield structure 2274, and the orientation of the auxiliary passage outlet 2240, the auxiliary flow 2242 exits the auxiliary passage 2236 in a generally axial direction in relation to the turbine axis 2208. That is to say, the auxiliary flow 2242 exits the auxiliary passage with no or very little swirl. After the auxiliary flow 2242 leaves the auxiliary passage outlet 2240, it flows across a surface 2254 of the side wall 2216 immediately downstream of the shield structure 2274 in an auxiliary flow layer 2258.

The shield structure 2274 is positioned on an opposite side of the turbine outlet passage 2214 to the nozzle 2222. With reference to FIG. 18, the shield structure 2274 is approximately axially aligned with the nozzle 2222 relative to the turbine axis 2208. In the figure, the spray region 2228 is directed towards both an upper surface 2276 of the shield structure 2274 and the surface 2254 of the turbine outlet passage 2214 over which the auxiliary flow layer 2258 flows. However, during use, the turbine bulk flow 2218 will impart axial momentum on the aftertreatment fluid which will carry the aftertreatment fluid downstream of the spray region shown in the figure. As such, the majority of the aftertreatment fluid will impinge upon the auxiliary flow layer 2258 downstream of the auxiliary passage outlet 2258 rather than on the upper surface 2276 of the shield structure 2274. As described in relation to the embodiment of FIG. 13, the auxiliary flow layer 2258 is a high-velocity and high-shear region which will deflect and break up any aftertreatment fluid which passes into it. Thus, the auxiliary flow layer 2258 impedes or prevents aftertreatment fluid from reaching the surface 2254 of the turbine outlet passage 214.

The thickness of the auxiliary flow layer 2258 is determined by the extent to which the shield structure 2274 protrudes into the auxiliary passage outlet 2214 and the size and shape of the auxiliary passage outlet 2240. The larger the shield structure 2274, the larger the auxiliary passage outlet 2240 may be and therefore the thicker the auxiliary flow layer may be. However, increasing the extent to which the shield structure 2274 protrudes into the turbine outlet passage 2214 reduces the cross-sectional area of the turbine outlet passage 2214 and therefore produces a back pressure on the turbine bulk flow which may reduce the efficiency of the turbine 2200. Therefore, preferably the shield structure defines a relatively narrow depth in comparison to its length, for example in the proportions described above in relation to the embodiment of FIG. 13. The shield structure 2274 provides a physical barrier between the auxiliary flow 2242 and the turbine bulk flow 2118, which enables the auxiliary flow 2242 to establish flow in a generally uniform direction without interference by the turbine bulk flow 2118.

As a brief aside, because the auxiliary passage 2236 functions as a wastegate passage which receives the auxiliary flow 2242 from a position upstream of the turbine wheel 2204, the temperature of the auxiliary flow 2242 within the auxiliary passage 2236 will be relatively hot. Accordingly, the auxiliary flow 2242 will transfer heat into the shield structure 2274 causing the temperature of the upper surface 2276 of the shield structure 2274 to rise. As such, any aftertreatment fluid which does impinge upon the upper surface 2276 of the shield structure 2274 will evaporate, thus reducing the likelihood that aftertreatment fluid will solidify on the shield structure 2274 causing a blockage.

Although the embodiment of the turbine 2200, shown in FIGS. 19 to 20, described above comprises a shield structure 2274, it will be appreciated that in alternative embodiments the shield structure 2274 may be absent. In particular, the auxiliary passage outlet 2240 may be formed by an opening in the side wall 2216 extending in a generally circumferential direction relative to the turbine axis 2208. In such embodiments, as the auxiliary flow 2242 leaves the auxiliary passage outlet 2240, the momentum of the turbine bulk flow 2118 will effectively “squeeze” the auxiliary flow 2242 against the surface 2254 of the side wall 2216 to form the auxiliary flow layer.

Although the embodiment shown in FIGS. 19 to 20 comprises a single auxiliary passage outlet 2240, it will be appreciated that in alternative embodiments the auxiliary passage 2236 may comprise two or more auxiliary passage outlets 2240. The auxiliary passage outlets 2240 may be spaced around the turbine axis 2208 at equal or unequal intervals. In particular, the positions of the auxiliary passage outlets 2240 can be chosen so as to ensure that the auxiliary flow 2258 passes over a particular portion of the flow surface 2254 of the side wall 2216.

FIG. 21 shows an alternative embodiment of a turbine 2300 according to a another embodiment of the present invention. The turbine 2300 is substantially identical to the turbines of the previous embodiments aside from the differences described below. Like reference numerals have therefore been used to refer to like features of the previous embodiments. The turbine 2300 of the embodiment of the invention shown in FIG. 21 differs from the previous two embodiments principally in the valve arrangement 2344 is positioned at the auxiliary passage outlet 2340. In particular, the auxiliary passage outlet 2340 is formed as an opening in the side wall 316 of the turbine outlet passage 2314. The valve arrangement 2344 defines a circumferentially extending valve seat 2350 surrounding the auxiliary passage outlet 2340. The valve member 2346 is positioned inside the auxiliary passage 2336, such that it does not protrude into the turbine outlet passage 2314. In some embodiments, the valve member 2346 may be configured so that at least part of it is received within the auxiliary passage outlet 2340 so that the received part is flush with the surface 2354 of the turbine outlet passage 2314 side wall 316.

During use, when it is desired to reduce the power produced by the turbine 2300 the valve member 2346 is moved out of engagement with the valve seat 2350. In doing so, the valve member 2356 and the valve seat create a narrow gap therebetween which widens as the valve arrangement 2344 is opened further. When the gap is very narrow, auxiliary flow 2342 is able to pass through it and into the turbine passage outlet 2314. However, the narrow geometry of the gap causes the auxiliary flow passing through the gap to accelerate, thus increasing the velocity of the auxiliary flow 2342 and the shearing forces in the auxiliary flow layer 2358. Because the valve arrangement 2344 is positioned at the auxiliary passage outlet, this means that the high velocity auxiliary flow 2342 is delivered directly to the turbine outlet passage 2314. This is in contrast, for example, to the embodiment shown in FIG. 15 in which the auxiliary flow 2142 has space to re-expand and decelerate before reaching the auxiliary passage outlet 2140. Accordingly, in the embodiment shown in FIG. 21, the auxiliary flow layer 2358 formed in the turbine outlet passage 2314 is better able to deflect and break up any aftertreatment fluid with which it interacts. Therefore, aftertreatment fluid can be prevented from reaching the surface 2354 of the turbine outlet passage 2314.

In order to ensure that the shearing forces in the auxiliary flow layer 2358 do not dissipate, the valve arrangement 2344 is preferably placed as close as possible to the auxiliary passage outlet 2340. In particular, the auxiliary passage outlet 2340 may define a width in a plane normal to the centreline, and the valve member 2346 may be positioned upstream of the auxiliary passage outlet 2340 by no more than around half, one or two such widths. In some embodiments, the turbine outlet passage 2314 may include a shield structure, such as that described above in relation to the embodiment shown in FIGS. 19 to 20. The valve arrangement 2344 may be positioned within the shielding structure.

FIGS. 22 and 23 show a further turbine 2400 according to a another embodiment the present invention. The turbine 2400 is substantially identical to the turbines of the previous embodiments aside from the differences described below. Like reference numerals have therefore been used to refer to like features of the previous embodiments. As in the previous embodiments, the turbine 2400 comprises an auxiliary passage 2436 which extends from the turbine inlet passage 2410 to the turbine outlet passage 2414. However, unlike the previous embodiments, whilst the auxiliary passage 2436 comprises a single auxiliary passage inlet 2438, the auxiliary passage 2436 comprises a multitude of auxiliary passage outlets 2440 distributed circumferentially about the turbine axis 2408. In particular, with reference to FIG. 22, the auxiliary passage 2436 comprises a plenum 2478 and ten branches 2480. For simplicity, not all branches 2480 are labelled in the figure. Although ten branches 2480 are illustrated, it will be appreciated that in alternative embodiments substantially any suitable number of branches may be used. The plenum 2478 extends generally toroidally around the turbine axis 2408. The branches 2480 are equispaced about the turbine axis 2408 and extend between the plenum 2478 and the turbine outlet passage 2414. The branches 2480 extend in a generally axial direction relative to the turbine axis 2408 and are inclined relative to the turbine axis 2108 at an angle of around 15. Preferably, the angle between the branches 2480 and the turbine axis 2408 should be as shallow as possible, however in some embodiments the angle could be up to around 30°.

During use, when the valve arrangement 2444 is open, the plenum 2478 receives auxiliary flow 2442 from the auxiliary passage inlet 2438. The auxiliary flow 2442 is distributed around the turbine axis 2408 by the plenum 2478 and fed into each of the branches 2480. The branches 2480 deliver the auxiliary flow 2442 to the auxiliary passage outlets 2440 and direct the auxiliary flow 2442 into the turbine outlet passage 2414 in a series of auxiliary flow layers 2458. Because the auxiliary passage outlets 2458 are distributed around the circumference of the turbine outlet passage 2414, the auxiliary flow layers 2458 are also distributed around the circumference. Depending upon the number and distribution of the branches 2480, the auxiliary flow layers 2458 may merge downstream of the auxiliary passage outlets 2480 to define a single auxiliary flow layer 2458 which covers the entire side wall 2416.

Although not shown in the figures, the turbine 2400 comprises a dosing module configured to inject aftertreatment fluid into the turbine outlet passage 2414. The dosing module is positioned so that it has a nozzle in fluid flow communication with the diffuser portion 2420 of the turbine outlet passage 2414. Accordingly, the aftertreatment fluid is injected at a position slightly upstream of the auxiliary passage outlets 2414. However, because the auxiliary flow layers 2458 merge to form a single auxiliary flow layer 2458 covering the entire side wall 2416, regardless of where the aftertreatment fluid is carried by the turbine bulk flow 2418, the auxiliary flow layer 2458 will be present to deflect and break up any aftertreatment fluid which might impinge on the side wall 2416. As such, the dosing module can be oriented at different circumferential positions about the turbine axis 2408 to suit packaging requirements.

It will be appreciated that since the auxiliary flow 2442 is a wastegate flow, the temperature of the auxiliary flow is higher than that of the turbine bulk flow. Because the auxiliary flow 2442 is distributed evenly around the turbine axis 2408, the heat distribution within the turbine outlet passage when the auxiliary flow 2442 and the turbine bulk flow merge is more even. This helps to reduce the presence of “hot spots”, and ensures more even reductant decomposition across the turbine outlet passage.

In an alternative to the turbine 2400 of the embodiment shown in FIGS. 22 to 23, in further embodiments the branches 2480 can be angled so that they also extend circumferentially in relation to the turbine axis 2408. In particular, the branches 2480 may be oriented so that they introduce the auxiliary flow in a tangential direction relative to the turbine outlet passage in a plane normal to the turbine axis 2408. Accordingly, the branches 2480 can be used to induce swirling motion of the auxiliary flow 2442 about the turbine axis 2408, for example in the positive angular direction. This provides substantially the same benefits as discussed above in relation to the embodiment shown in FIGS. 13 to 15. However, since the branches 2480 are distributed around the turbine axis 2408, the swirling momentum is more evenly imparted around the circumference of the turbine outlet passage 2414.

FIGS. 24 and 25 show another embodiment of a turbine 2500 according to the present invention. The turbine 2500 differs from the previous embodiments principally in that the auxiliary passage 2536 comprises a first auxiliary passage branch 2536a in fluid communication with the turbine outlet 2514 via a first auxiliary passage outlet 2540a, and a second auxiliary passage branch 2136b in fluid communication with the turbine outlet 2514 via a second auxiliary passage outlet 2140b. The first and second auxiliary passage branches 2536a, 2536b are fluidly connected to one another and receive an auxiliary flow 542 from a wastegate arrangement (not shown) in a corresponding manner to the embodiment shown in FIGS. 22 to 23 discussed above. The auxiliary passage 2536 splits the auxiliary flow 542 into a first auxiliary flow portion 2542a which flows through the first auxiliary passage branch 2536a and a second auxiliary flow portion 2542b which flows through the second auxiliary passage branch 2536b.

The first and second auxiliary passage branches 2536a, 2536b are configured to deliver their respective auxiliary flows in a generally axial direction relative to the turbine axis 2508. Accordingly, as explained in relation to the embodiment above shown in FIGS. 19 to 20, the first and second auxiliary flows 2542a, 2542b form respective first and second auxiliary flow layers 2558a, 2558b on the surface 2554 of the side wall 2516. The two auxiliary flow layers 2558a, 2558b can be used to prevent aftertreatment fluid injected into the turbine outlet passage 2514 by the dosing module 2522 from reaching the surface 2554 of the side wall 2516. By using two auxiliary flow layers 558 (rather than one), the auxiliary flow layers 558 can be controlled to flow over specific portions of the turbine outlet passage surface 2554 were aftertreatment fluid is likely to impinge, even if these impingement risk areas are relatively well spaced apart from one another. Furthermore, the area of the surface 2554 of the side wall 2516 covered by auxiliary flow layers 558 can be increased.

The first and second auxiliary passage outlets 2540a, 2540b are positioned generally opposite one another with respect to the turbine axis 2508. Because the auxiliary passage outlets 2540a, 2540b are positioned opposite one another, this induces additional turbulence within the turbine bulk flow 518 between the two auxiliary flow layers 2558a, 558, thus improving mixing of aftertreatment fluid and improved decomposition. However, in alternative embodiments it will be appreciated that the first and second auxiliary passage outlets may be positioned at substantially any angular position relative to one another. In particular, the relative positions of the first and second auxiliary passage outlets 2540a, 2540b may be chosen so that the auxiliary flow layers 2558a, 2558b flow over one or more specific portions of the surface 2554 of the side wall 2516 which presents a high risk of aftertreatment fluid impingement.

In the embodiment shown in FIGS. 24 to 25 described above the first and second auxiliary passage outlets 2540a, 2540b do not comprise shielding structures. However, it will be appreciated that in alternative embodiments one or both of the first and second auxiliary passage outlets 2540a, 2540b may comprise a shielding structure (such as the shield structure 2274 of the embodiment shown in FIGS. 19 to 20 described above).

FIGS. 26 and 27 show another embodiment of a turbine 2600 in accordance with the present invention. The turbine 2600 of the embodiment shown in FIGS. 26 and 27 is substantially identical to the turbine of the embodiment shown in FIGS. 24 to 25 described above, and differs principally in that the first and second auxiliary passage branches 2636a, 2636b and respective first and second auxiliary passage outlets 640a, 640b deliver the respective first and second auxiliary flow portions 2642a, 2642b in a substantially tangential direction relative to the turbine axis 2608 and the surface 2654 of the side wall 2616. That is to say, in a corresponding manner to that described above in relation to the embodiment of FIG. 13. Accordingly, the auxiliary passage branches 2636a, 2636b are each configured to deliver the auxiliary flow portions 2642a, 2642b in a direction which causes the auxiliary flow portions 2642a, 2642b to swirl about the turbine axis 2606 in the positive angular direction. That is to say, the first and second auxiliary flow layers 2658a, 2658b have swirling momentum in the same direction as the turbine bulk flow 2618. Using two swirl-inducing auxiliary passage branches 2636a, 2636b provides much the same benefits as the embodiment shown in FIGS. 24 to 25, but also promotes more swirling motion thus increasing the amount of shearing forces in the auxiliary flow layers 2658a, 2658b.

FIGS. 28 and 29 show another embodiment of a turbine 2700 in accordance with the present invention. The turbine 2700 is substantially identical to the turbines of the embodiments shown in FIGS. 24 to 27 described above and differs principally in that the first auxiliary passage branch 2736a and first auxiliary passage outlet 740a deliver the first auxiliary flow portion 2742a in a generally axial direction relative to the turbine axis 2708 (i.e. in a corresponding manner to the embodiment shown in FIGS. 24 to 25), and the second auxiliary passage branch 2736b and second auxiliary passage outlet 740b deliver the second auxiliary flow portion 2742b in a substantially tangential direction relative to the turbine axis 2708 and the surface 2754 of the side wall 2716 (i.e. in a corresponding manner to the embodiment shown in FIGS. 26 and 27). Therefore, the turbine 2700 is able to provide a mixture of the benefits of the embodiments shown in FIGS. 24 to 27.

With reference to the embodiments shown in FIGS. 22 to 29 of the invention, when the auxiliary passage comprises multiple branches this may mean that the necessary housing takes up additional room which is not always available due to packaging requirements. However, in any such embodiments, additional space can be freed up by re-orienting the valve assembly. For example, in the embodiments shown in FIGS. 22 to 29 the valve assemblies are shown at a sideways position relative to the turbine inlet passages. It has been found that additional space can be freed up by positioning the valve assemblies on top of the turbine inlet passages (for example, at a position radially outwards of the turbine inlet passages relative to the turbine axes). Re-positioning the valve assemblies may allow the auxiliary passage outlets to be positioned axially closer to the turbine wheel.

With reference to the embodiment shown in FIG. 13 (although equally applicable to any of the other above or below described embodiments), although the auxiliary passage 2136 extends between a position of the turbine inlet passage 2110 upstream of the turbine wheel and a position downstream of the turbine wheel, it will be appreciated that in alternative embodiments the auxiliary passage 2136 may receive fluid from a position that is not upstream of the turbine wheel 2104. Therefore the auxiliary passage 2136 does not, in all embodiments of the invention, necessarily function as a wastegate passage. For example, the auxiliary passage 2136 may receive fluid from the turbine outlet passage 2114 to define the auxiliary flow 2142. In such embodiments, the auxiliary passage 2136 may extend from an auxiliary passage inlet 2138 in fluid flow communication with the turbine outlet passage 2114 to an auxiliary passage outlet 2140 that is also in fluid flow communication with the turbine outlet passage. The auxiliary passage inlet 2138 may be positioned upstream of the auxiliary passage outlet 2140 relative to the turbine bulk flow 2118.

In yet further embodiments, the auxiliary passage 2136 may receive fluid from a region that is upstream of the turbine passage outlet 2114. For example, the auxiliary passage 2136 may receive fluid from the turbine wheel chamber 2112. In particular, the auxiliary passage 2136 may comprise an auxiliary passage inlet 2138 that is formed as an opening in the turbine wheel chamber 2122 so that it may receive exhaust gas that has spilled over the tips of the blades of the turbine wheel 2104 to form the auxiliary flow 2142. In yet further embodiments, the auxiliary passage 2136 may receive fluid from other areas of tip leakage, for example leakage over the tips of nozzle vanes of a variable geometry turbine.

In yet further embodiments, the auxiliary passage 2136 may be substantially free of any valves or closures, such that flow therethrough is always permitted across all operating conditions of the turbine 2100. Accordingly, the auxiliary flow layer 2158 can be generated at all operating conditions of the turbine 2100, and is not dependent upon the opening of a valve arrangement 100 (which may only be open during certain operating conditions). In such embodiments, when the auxiliary passage 2136 receives turbine bulk flow 2118 from a position upstream of the turbine outlet passage 2114, it is preferable that the auxiliary passage 2136 does not let so much exhaust gas bypass the turbine wheel 2104 (or a portion of the turbine wheel 2104) that the efficiency of the turbine is significantly reduced. In particular, the auxiliary passage 2136 may be sized so that during use the flow rate of the auxiliary flow 2142 is around 0.1%, 0.2%, 0.3%, 0.4%, 0.5%, 1%, 1.5%, 2%, 2.5%, 3%, 4%, or 5% of the flow rate of the turbine bulk flow 2118 received by the turbine inlet passage 2110. It has been found that when the flow rate of the auxiliary flow 2142 is kept small in relation to the flow rate of the total flow delivered to the turbine 2100 by the internal combustion engine, the drop in efficiency of the turbine is also relatively small. In particular, where the flow rate of the auxiliary flow is around 1% of the turbine bulk flow 2118, the drop in efficiency is also around 1%. Whilst this is still a moderate drop in efficiency in the context of a turbine, it is sufficiently small that it is tolerable in relation to the previously described benefits. However, because the flow rate of auxiliary flow 2142 is relatively small, the shearing forces produced by the auxiliary flow layer 2158 are also relatively small, and therefore the auxiliary flow layer 2158 may be less effective than an auxiliary flow layer which receives fluid via a wastegate valve arrangement (such as the valve 2144 above).

In some further embodiments, the auxiliary passage 2136 may be comprise a valve arrangement 2144, however the valve arrangement 2144 may be configured such that it always permits some leakage therethrough, such that auxiliary flow 2142 is provided across all operating conditions. The flow rate of the leakage may be in the proportions discussed in the paragraph above. This can be achieved, for example, by the use of leakage holes in the valve arrangement 2144 or control of the valve arrangement 2144 so that it does not fully close. Such embodiments combine the benefit of having a relatively large amount of flow available to support a strong auxiliary flow layer 2158 when the wastegate valve is open, whilst always providing at least some auxiliary flow layer 2158 when the wastegate valve is closed.

Although the turbine 2100 comprises a turbine housing assembly 2101 having a turbine housing 2102 and a connection adapter 2103, it will be appreciated that in alternative embodiments of the invention the turbine housing assembly may comprise any suitable number of components. For example, the turbine housing assembly 2101 may be formed from a single integral component, or from an assembly of multiple components as necessitated by manufacturing and assembly requirements.

FIGS. 30 to 32 show another embodiment of the present invention. Unlike the previous embodiments of the invention, the present embodiment of the present invention relates to an aftertreatment system 2800 of an internal combustion engine system rather than a turbine. However, the underlying working principles and benefits are the same. The aftertreatment system 2800 comprises a decomposition chamber 2802 having a decomposition chamber inlet 2804 and a decomposition chamber outlet 2806. The decomposition chamber inlet 2804 is connected to an upstream pipe section 2808 which receives a bulk flow 2810 from the internal combustion engine system. The decomposition chamber 2802 is generally cylindrical, and defines a cross-sectional area that is larger than that of the upstream pipe section 2808. The decomposition chamber outlet 2806 is connected to a downstream pipe section 2812, which is configured to route the bulk flow 2810 to further downstream components of the aftertreatment system 2800 (for example an SCR catalyst or the like) and eventually to atmosphere.

The aftertreatment system 2800 further comprises an auxiliary passage 2814 and a dosing module 2816. The auxiliary passage 2814 receives an auxiliary flow 2818 of exhaust gas from the internal combustion engine system. The auxiliary passage 2814 comprises an auxiliary passage outlet 2818 formed in a side wall 2822 of the decomposition chamber 2802. The dosing module 2816 comprises a nozzle 2824 received through a hole of the decomposition chamber 2802 such that it is in fluid communication with the interior of the decomposition chamber 2802. The nozzle 2824 generates an atomised spray of aftertreatment fluid which permeates across the decomposition chamber 2802 in a spray region 2826 shown in FIG. 31 in dotted lines.

During use, when the bulk flow 2810 enters the decomposition chamber 2802 the change in size of the decomposition chamber 2802 compared to the upstream pipe section 2808 causes the bulk flow 2810 to expand, decelerate, and form turbulent vortices. Subsequently, aftertreatment fluid is injected into the turbulent bulk flow 2810 via the dosing module 2816. Because the bulk flow 2810 is turbulent, the aftertreatment fluid mixes with the bulk flow 2810, causing heat to be transferred to the aftertreatment fluid and for the aftertreatment fluid to decompose into the reductants required to support the SCR reaction. However, despite such mixing, aftertreatment fluid may still impinge upon the side wall 2822 of the decomposition chamber 2802, where it may solidify and cause a blockage.

With reference to FIG. 32, as in the case of the previous embodiments of the invention, in the present embodiment the auxiliary flow 2818 is introduced into the decomposition chamber 2802 in an auxiliary flow layer 2828 (indicated by dotted lines) which flows across a surface of the side wall 2822. To achieve this, the auxiliary passage 2814 is configured to introduce the auxiliary flow 2818 in a direction substantially tangential to the side wall 2822 of the decomposition chamber 2802. However, as with the previous embodiments, some angular misalignment may be permitted. The auxiliary flow layer 2828 is a high-velocity and high-shear layer which is able to deflect and break up any aftertreatment fluid with which it interacts, so as to hinder or prevent aftertreatment fluid reaching the side wall 2822. As such, the working principle of the present embodiment is exactly the same as the previous embodiments.

With reference to FIG. 31, due to the axial momentum of the bulk flow 2810, when the auxiliary flow 2818 is introduced into the decomposition chamber 2802 it will begin to swirl around a longitudinally extending centreline 2830 of the decomposition chamber. The auxiliary passage outlet 2820 is therefore positioned slightly upstream of the dosing module nozzle 2824 such that the auxiliary flow layer 2828 passes over the portion of the side wall 2822 that is most likely to suffer from impingement of aftertreatment fluid. Accordingly, the auxiliary flow layer 2828 is able to reduce or prevent deposit build up on the side wall 2822. The swirling momentum also improves mixing of aftertreatment fluid with the bulk flow 2810 in the decomposition chamber 2802, thus improving decomposition.

In further embodiments the auxiliary passage 2814 may be angled relative to the centreline 2830 such that the auxiliary passage imparts swirling momentum to the auxiliary flow 2818 as it enters the decomposition chamber. The auxiliary passage 2814 may be configured to impart swirling momentum at the same swirl angles discussed in relation to the previous embodiments.

The auxiliary passage 2814 may receive exhaust gas from substantially any suitable part of the internal combustion engine system. For example, the upstream pipe section 2808 may receive exhaust gas from a first bank of engine cylinders and the auxiliary passage 2814 may receive exhaust gas form a second bank of engine cylinders. Alternatively, the auxiliary passage 2814 could receive exhaust gas from a position of the upstream pipe section 2808 that is upstream of the decomposition chamber 2802. Because the auxiliary passage 2514 defines a narrow cross-sectional area in relation to the decomposition chamber 2802, the auxiliary flow 2818 will be higher velocity than the bulk flow 2810 and therefore the auxiliary flow layer 2828 will have sufficient energy to prevent aftertreatment fluid impinging on the side wall 2822. Where the internal combustion engine system comprises a turbine, the auxiliary passage 2814 may receive exhaust gas from a position of the internal combustion engine system upstream of the turbine wheel (and downstream of the internal combustion engine). In such embodiments, the auxiliary passage 2814 may function as a wastegate passage allowing exhaust gas to bypass the turbine wheel. Accordingly, the auxiliary passage may comprise a valve (e.g. a wastegate valve) to control the flow therethrough.

Although the decomposition chamber 2802 is illustrated as a straight cylindrical chamber, it will be appreciated that in alternative embodiments the decomposition chamber 2802 may be any suitable cross-sectional shape and may define any suitable path to suit packaging requirements. For example, the decomposition chamber 2802 may comprise one or more bends to allow it to fit compactly within a given space in the engine compartment. Where the decomposition chamber comprises bends, the auxiliary passage 2814 may be positioned and orientated to introduce the auxiliary flow 2818 into the decomposition chamber in such a manner that the auxiliary flow layer 2828 passes over the outer apex of one or more of the bends so as to reduce the chance of aftertreatment fluid forming deposits at the bends.

It will be appreciated that, since the underlying principle of the eighth embodiment is substantially the same as that of the previous embodiments, the eighth embodiment may be modified to include equivalent features to those of the previous embodiments to provide corresponding effects. For example, the decomposition chamber may comprise a diffuser portion. The auxiliary passage may have multiple auxiliary passage outlets (see e.g. FIGS. 22 and 23). The auxiliary passage may be configured so that flow therethrough is always permitted. The auxiliary passage may or may not function as a wastegate passage bypassing a turbine. The auxiliary passage outlet may have corresponding geometry and proportions to the previous embodiments (see e.g. the embodiments shown in FIGS. 13 to 20). The decomposition chamber may have a shield structure to protect the auxiliary passage outlet (see e.g. the embodiment shown in FIGS. 19 to 20). The auxiliary flow may flow in an axial direction rather than swirling (see e.g. the embodiment shown in FIGS. 19 to 20). The decomposition chamber may comprise a sensor arrangement and the auxiliary flow layer may pass downstream of an outlet of a sensor passage (see e.g. the embodiment of FIG. 13). The auxiliary passage may have two branches in which both branches deliver the auxiliary flow layer in an axial direction (e.g. as per the embodiment shown in FIGS. 24 to 25). The auxiliary passage may have two branches in which both branches deliver the auxiliary flow layer in a tangential direction (e.g. as per the embodiment shown in FIGS. 26 to 27). The auxiliary passage may have two branches in which once branch delivers the auxiliary flow layer in an axial direction and the other branch delivers the auxiliary flow in a tangential direction (e.g. as per the embodiment shown in FIGS. 28 to 29).

FIG. 33 shows a turbine 3100 according to another embodiment of the present invention. The turbine 3100 forms part of a turbocharger, although in alternative embodiments the turbine may be used for substantially any suitable application, such as power generation or the like. The turbine 3100 comprises a turbine housing 3102 and a turbine wheel 3104 supported by a turbocharger shaft 3106 and configured to rotate about a turbine axis 3108.

The turbine 3100 defines a turbine inlet passage 3110, a turbine wheel chamber 3112 and a turbine outlet passage 3114. The turbine inlet 3110 is configured to receive exhaust gas from an internal combustion engine (not shown). The exhaust gas received from the internal combustion engine by the turbine inlet passage 3110 defines a turbine bulk flow 3118. The turbine inlet 3110 is in the shape of a volute which encourages swirling of the turbine bulk flow about the turbine axis 3110. Although the turbine 3100 is a single volute turbine, it will be appreciated that this is not essential to the invention and that in alternative embodiments the turbine 3100 may have substantially any arrangement of volutes, for example a single volute or a so-called “twin volute” turbine comprising two coextensive side-by-side volutes or a so-called “dual volute” in which the volutes are angularly displaced from one another rather than coextensive.

The turbine wheel chamber 3112 is configured to receive the turbine bulk flow 3118 from the turbine inlet passage 3110. When the turbine bulk flow 3118 passes through the turbine wheel chamber 3112, it impinges upon blades (not shown) of the turbine wheel 3104 thus causing the turbine wheel 3104 to rotate and drive the turbocharger shaft 3106. The turbine wheel 3104 re-directs the turbine bulk flow 3118 so that it flows in an axial direction relative to the turbine axis 3108 and delivers the turbine bulk flow 3118 to the turbine outlet passage 3114. As such, the turbine 3100 is a so-called “radial” turbine. However, in alternative embodiments the turbine 3100 may be an “axial” turbine in which exhaust gas flows in a generally axial direction from the turbine inlet 3110 passage to the turbine outlet passage 3114.

The turbine outlet passage 3114 comprises a generally tapered side wall 3116 which defines a diffuser portion 3120 configured to cause expansion of the exhaust gas in the turbine outlet 3114. The side wall 3116 is outwardly tapered at an angle of around 7°, however in alternative embodiments any suitable taper angle may be used. The diffuser portion 3120 is symmetrically centred on the turbine axis 3108, such that the turbine axis 3108 defines a centreline of the turbine outlet passage 3114. References to a “turbine axis” herein will therefore be taken to apply correspondingly to a “centreline” defined by the turbine outlet passage. However, in alternative embodiments the diffuser portion 3120 may have any suitable shape. In such embodiments, the centreline may be defined by the centroid of the turbine outlet passage 3114 relative to the direction of the turbine bulk flow 3118. Accordingly, the centreline may bend or otherwise diverge away from the turbine axis 3108 in dependence upon the shape of the turbine outlet passage 3114. References herein to the turbine axis 3108 may therefore be understood to apply equally to the feature of a centreline. In yet further embodiments, the side wall 3116 may be generally cylindrical, such that the turbine 3100 does not comprise a diffuser portion 3120.

The turbine 3100 further comprises a dosing module 3122 configured to deliver an exhaust gas aftertreatment fluid to the turbine outlet passage. The aftertreatment fluid is, in particular, diesel exhaust fluid (DEF) and is commonly available under the trade mark AdBlue. The dosing module 3122 comprises a nozzle 3124 in fluid flow communication with the turbine outlet passage 3114. The nozzle 3124 is, in particular, an atomising nozzle configured to generate a substantially atomised spray of aftertreatment fluid within the turbine outlet passage 3114. The nozzle 3124 generates a generally conical spray pattern, however in alternative embodiments substantially any suitable spray pattern may be used (for example fan-shaped etc.). The spray pattern has a spray angle of around 55°, however in alternative embodiments substantially any suitable spray angle may be used such as for example 30° or 45°. The nozzle 3124 is received within a hole 3126 of the turbine housing 3102. The nozzle 3124 delivers aftertreatment fluid in a spray direction 3132 which faces generally towards the turbine axis 3108 and generally downstream in relation to the turbine bulk flow 3118. In the present embodiment, the spray direction 3132 is inclined at an angle of around 7° relative to a normal of the centreline 3109.

The aftertreatment fluid is sprayed into a spray region 3128 of the turbine outlet passage 3114, shown by dotted lines. The spray region 3128 encompasses the spatial region in which the atomised spray of aftertreatment fluid has a larger component of velocity in the spray direction 3132 than in the direction of the turbine bulk flow 3118. The atomised spray of aftertreatment fluid leaving the nozzle 3124 has almost all of its velocity generally in the spray direction 3132. However, as the atomised spray of aftertreatment fluid travels laterally across the turbine outlet passage 3114 (i.e. in a direction normal to the turbine bulk flow 3118), interaction between the aftertreatment fluid and the turbine bulk flow 3118 changes the direction of the atomised spray of aftertreatment fluid until the aftertreatment fluid flows entirely in the direction of the turbine bulk flow 3118 (i.e. until the aftertreatment fluid is “carried away” by the momentum of turbine bulk flow 3118). The spray region 3128 corresponds to the portion of the turbine outlet passage 3114 in which the individual droplets of aftertreatment fluid carry more momentum from the dosing module 3122 than from the turbine bulk flow 3118. Accordingly, the geometry of the spray region 3128 is a property of the delivery strength of the dosing module 3128 relative to the momentum of the turbine bulk flow 3118. For the sake of simplicity, the spray region 3128 is illustrated in FIG. 33 as a conical region. However, it will be appreciated that due to the interaction between the turbine bulk flow 3118 and the aftertreatment fluid explained above the spray region 3128 will not, in reality, have a completely conical shape (see for example FIGS. 2A and 2B).

The turbine 3100 further comprises an auxiliary passage 3136 and a valve arrangement 3144. The auxiliary passage 3136 comprises an auxiliary passage inlet 3138 and an auxiliary passage outlet 3140. The auxiliary passage inlet 3138 is formed by an opening in the wall of the turbine inlet passage 3110 and is therefore defined by the turbine housing 3102. Accordingly, the auxiliary passage inlet 3138 is operable to receive a portion of the turbine bulk flow 3118 from the turbine inlet passage 3110. The portion of the turbine bulk flow 3118 received by the auxiliary passage 3138 defines an auxiliary flow 3142. The auxiliary passage outlet 3140 is formed by an opening in the sidewall 3116 of the turbine outlet passage, such that the auxiliary passage 3138 is operable to deliver the auxiliary flow 3142 to a position downstream of the turbine wheel 3104.

The valve arrangement 3144 is configured to permit, prevent and control the passage of the auxiliary flow 3142 through the auxiliary passage 3136. With reference to FIG. 33, the valve arrangement 3144 is a so-called “flap” type valve arrangement comprising a valve member 3145 supported for rotation by an actuator rod 3147. Rotation of the actuator rod 3147 causes the valve member 3145 to move into and out of engagement with a valve seat 3150 defined by the housing 3102 surrounding the auxiliary passage inlet 3138. When the valve member 3145 engages the valve seat 3150, the turbine bulk flow 3118 is prevented from entering the auxiliary passage 3136, such that there is substantially no auxiliary flow 3142. When the valve member 3145 disengages the valve seat 3150, a portion of the turbine bulk flow enters the auxiliary passage 3136 to define the auxiliary flow 3142. The flow rate of the auxiliary flow 3142 can be adjusted by controlling the degree of engagement and/or separation between the valve member 3145 and the valve seat 3150. Although the valve arrangement 3144 shown is a flap type valve arrangement, it will be appreciated that in alternative embodiments substantially any suitable valve may be used. For example, a rotary “barrel” type valve arrangement, a poppet valve, a sliding mechanism or the like may be used.

Because the auxiliary passage 3136 extends from a position upstream of the turbine wheel 3104 to a position downstream of the turbine wheel 3104, the valve arrangement 3144 therefore functions as a wastegate valve and the auxiliary passage 3136 functions as a wastegate passage. The auxiliary passage inlet 3138 is sized such that when the valve arrangement 3144 is fully open the flow rate of auxiliary flow 3142 through the auxiliary passage 3136 is at least around 25% of the flow rate of turbine bulk flow 3118 delivered to the turbine inlet passage 3110 by the internal combustion engine. That is to say, the auxiliary passage 3136 is capable of bypassing at least around 25% of the flow received by the turbine inlet passage 3110 around the turbine wheel 3104 when the valve arrangement 3144 is fully open. This enables enough exhaust gas to bypass the turbine wheel 3104 so that the power produced by the turbine 3100 is reduced by a sufficient amount to prevent overspeed events.

As shown in FIGS. 33 and 34, during use when the turbine bulk flow 3118 in the turbine outlet passage 3114 leaves the turbine wheel 3104, it travels along the turbine axis 3108. However, with reference to FIG. 34, due to the rotation of the turbine wheel 3104, the turbine bulk flow 3118 in the turbine outlet passage 3114 also travels in an angular direction around the turbine axis 3108. That is to say, the turbine bulk flow also travels in a spiral-like path away from the turbine wheel 3104. The angular direction of rotation of the turbine wheel 3104 can be said to define a positive angular direction, and the turbine bulk flow 3118 circulates about the turbine axis 3108 in the positive angular direction, as shown by the arrows in FIG. 34. The combination of angular and axial momentum of the turbine bulk flow 3118 may also be described as “swirl”.

The auxiliary passage 3136 extends in both an axial direction along the turbine axis 3108 and in a circumferential direction around the turbine axis 3108. When the valve arrangement 3144 is open the auxiliary flow 3142 is initially received in an axial direction relative to the turbine axis 3108. However, the shape of the auxiliary passage 3136 re-orients the auxiliary flow 3142 so that it flows both axially and circumferentially around the turbine axis 3108. In particular, the auxiliary flow passage 3136 is configured so that the momentum of the auxiliary flow 3142 is directed in the opposite angular direction around the turbine axis 3108 as the turbine bulk flow 3118 (that is to say, in the negative angular direction). Accordingly, when the auxiliary flow 3142 enters the turbine outlet passage 3114, the auxiliary flow 3142 collides head-on with the turbine bulk flow 3118 flowing in the opposite angular direction. As a result, a large amount of turbulence is generated as indicated by the vortices 3146.

The region of the turbine outlet passage 3114 containing the turbulent vortices 3146 defines a turbulence region 3148. The turbulence region 3148 is the three-dimensional space within the turbine outlet passage 3114 occupied by a mixture of turbine bulk flow 3118, auxiliary flow 3142 and aftertreatment fluid where the flow conditions are turbulent. Within the turbulence region 3148, the flow will typically exhibit a Reynolds number of around 10,000 or higher. The Reynolds number of the flow can be arrived at mathematically, and is for example derivable using computational fluid dynamics. Accordingly, based on the geometry of the turbine 3100 and the flow conditions the turbine 3100 is subjected to, the skilled person can derive the position and extent of the turbulence region 3148.

The nozzle 3124 of the dosing module 3122 is positioned and oriented relative to the turbulence region 3148 so that the spray region 3128 substantially overlaps with the turbulence region 3148. That is to say, the dosing module 3122 is configured to direct the aftertreatment fluid into the turbulence region 3148. Many suitable positions and orientations of the dosing module 3122 and nozzle 3124 are possible for this purpose. For example, as shown in FIGS. 33 and 34 the nozzle 3124 may be positioned approximately level with and opposite the auxiliary passage outlet 3140 relative to the turbine axis 3108. However, in alternative embodiments the nozzle 3124 could be positioned upstream of the auxiliary passage outlet 3140 relative to the turbine axis 3108 so that the aftertreatment fluid is carried into the turbulence region by the turbine bulk flow 3118. In such embodiments, the nozzle could be oriented so that the spray direction 3132 faces downstream towards the turbulence region 3148. Alternatively, the nozzle 3124 could be positioned axially downstream of the auxiliary passage outlet 3140 and oriented so that the spray direction 3132 faces upstream and into the turbulence region 3148. Furthermore the nozzle could be positioned at any angular position about the turbine axis provided that the aftertreatment fluid is directed into or carried into the turbulence region 3148. For example, the nozzle could be positioned on the same side of the turbine axis 3108 as the auxiliary passage outlet 3140, or could be axially spaced apart from the auxiliary passage outlet 3140 by ±30°, ±45°, ±90, or 180°.

Due to the turbulence of the exhaust gases in the turbulence region 3148, when the aftertreatment fluid is injected into the turbulence region 3148 a very high rate of collisions between the aftertreatment fluid and the exhaust gases takes place. Consequently, heat is transferred from the hot exhaust gases to the aftertreatment fluid relatively quickly. This causes the aftertreatment fluid to decompose into the required reductants more quickly and ensures that the proportion of the aftertreatment fluid which decomposes is as full as possible. Furthermore, due to the high turbulence, once decomposed the reductants are uniformly distributed throughout the turbine bulk flow. This ensures that sufficient reductant is available to support the SCR reaction at all physical points of the SCR catalyst.

With reference to FIG. 34, the housing 3102 comprises a first flow surface 3152 defining the radially outermost part of the auxiliary passage 3136 relative to the turbine axis 3108. The first flow surface 3152 may alternatively be referred to as an auxiliary passage surface. The side wall 3116 of the housing 3102 comprises a second flow surface 3154 which defines the radially outermost part of the turbine outlet passage 3114 relative to the turbine axis 3108. The second flow surface 3154 is a surface of the diffuser portion 3120. The second flow surface 3154 may alternatively be referred to as a turbine outlet passage surface. The flow first surface 3152 and the second flow surface 3154 join one another at an interface 3156. The first flow surface 3152 is tangential to the second flow surface 3154 at the interface 3156. However, in alternative embodiments the first flow surface 3154 may be inclined relative to the second flow surface 3154 at the interface by an angle of up to around 2°, around 5°, around 10°, around 15°, around 20°, or around 45° towards or away from the turbine axis 3108. When the angle of the first flow surface 3152 is close to that of the tangent of the second flow surface 3154 at the interface 3156, when the auxiliary flow 3142 enters the turbine outlet passage 3114 it does so in a completely opposite direction to the turbine bulk flow 3118. As such, maximum disturbance to the turbine bulk flow 3118 is generated so as to cause largest amount of turbulence possible. Accordingly, it is preferable for the first flow surface 3152 and the second flow surface 3154 to be as tangential as possible.

With reference to FIG. 35, the momentum direction vector 3119 of the turbine bulk flow 3118 defines a first swirl angle D1. The “swirl angle” of a flow is a measure of the relative amount of circumferential motion relative to axial motion. When the swirl angle is zero, the flow has no circumferential motion and flows entirely axially. When the swirl angle is 90, the flow has no axial motion and flows entirely circumferentially. Accordingly, the swirl angle D1 of the turbine bulk flow 3118 is the relative angle between the direction of flow of the turbine bulk flow 3118 and the turbine axis 3108. The size of the first swirl angle is dependent upon of the configuration of the turbine wheel 3104 (e.g. the shape of the turbine blades and the like), the pressure and flowrate of the turbine bulk flow 3118 delivered to the turbine wheel 3104, and the speed of rotation of the turbine wheel 3104. Accordingly, the size of the first swirl angle D1 will vary depending upon the operating condition of the turbine 3100. However, typically the first swirl angle is in the range of around 0° to around 70° in either the positive or negative direction.

The auxiliary passage 3136 directs the auxiliary flow 3142 into the turbine outlet passage 3114 along the momentum direction vector 3143 at a second swirl angle D2. The size of the second swirl angle D2 will depend upon the pressure and flow rate of the auxiliary flow 3142 as well as the geometry of the auxiliary passage 3138. From a purely geometric perspective, the auxiliary passage 3136 is shaped so that the auxiliary flow 3142 is directed entirely orthogonally to the turbine axis 3108 (and in the opposite direction around the turbine axis 3108 to the swirl of the bulk flow). However, momentum of the bulk flow 3118 along the turbine axis 3108 will deflect the auxiliary flow 3142. As such, when the valve arrangement 3144 is fully open, the second swirl angle is generally in the range of around 30° to around 85°. The flow rate of the turbine bulk flow 3118 will generally be higher than that of the auxiliary flow 3142. However, because the second swirl angle D2 is steeper than the first swirl angle D1, the auxiliary flow 3142 has a large component of velocity in the circumferential direction which is able to match or exceed the circumferential directional component of the turbine bulk flow 3118. Accordingly, the magnitude of the collision between the turbine bulk flow 3118 and the auxiliary flow 3142 is increased to ensure maximum turbulence is generated. However, it will be appreciated that in alternative embodiments the auxiliary passage 3136 may be configured to deliver the auxiliary flow 3142 at a second swirl angle D2 that is substantially the same as the first swirl angle D1, or greater.

Although the auxiliary passage 3136 extends between a position of the turbine inlet passage 3110 upstream of the turbine wheel and a position downstream of the turbine wheel, it will be appreciated that in alternative embodiments the auxiliary passage 3136 may receive fluid from a position that is not upstream of the turbine wheel 3104. Therefore the auxiliary passage 3136 does not, in all embodiments of the invention, necessarily function as a wastegate passage. For example, the auxiliary passage 3136 may receive fluid from the turbine outlet passage 3114 to define the auxiliary flow 3142. In such embodiments, the auxiliary passage 3136 may extend from an auxiliary passage inlet 3138 in fluid flow communication with the turbine outlet passage 3114 to an auxiliary passage outlet 3140 that is also in fluid flow communication with the turbine outlet passage. The auxiliary passage inlet 3138 may be positioned upstream of the auxiliary passage outlet 3140 relative to the turbine bulk flow 3118.

In yet further embodiments, the auxiliary passage 3136 may receive fluid from a region that is upstream of the turbine passage outlet 3114. For example, the auxiliary passage 3136 may receive fluid from the turbine wheel chamber 3112. In particular, the auxiliary passage 3136 may comprise an auxiliary passage inlet 3138 that is formed as an opening in the turbine wheel chamber 3112 so that it may receive exhaust gas that has spilled over the tips of the blades of the turbine wheel 3104 to form the auxiliary flow 3142. In yet further embodiments, the auxiliary passage 3136 may receive fluid from other areas of tip leakage, for example leakage over the tips of nozzle vanes of a variable geometry turbine.

In yet further embodiments, the auxiliary passage 3136 may be substantially free of any valves or closures, such that flow therethrough is always permitted across all operating conditions of the turbine 3100. Accordingly, the auxiliary flow layer 158 can be generated at all operating conditions of the turbine 3100, and is not dependent upon the opening of a valve arrangement 3100 (which may only be open during certain operating conditions). In such embodiments, when the auxiliary passage 3136 receives turbine bulk flow 3118 from a position upstream of the turbine outlet passage 3114, it is preferable that the auxiliary passage 3136 does not let so much exhaust gas bypass the turbine wheel 3104 (or a portion of the turbine wheel 3104) that the efficiency of the turbine is significantly reduced. In particular, the auxiliary passage 3136 may be sized so that during use the flow rate of the auxiliary flow 3142 is around 0.1, %, 0.2%, 0.3%, 0.4%, 0.5%, 1%, 1.5%, 2%, 2.5%, 3%, 4%, or 5% of the flow rate of the turbine bulk flow 3118 received by the turbine inlet passage 3110. It has been found that when the flow rate of the auxiliary flow 3142 is kept small in relation to the flow rate of the total flow delivered to the turbine 3100 by the internal combustion engine, the drop in efficiency of the turbine is also relatively small. In particular, where the flow rate of the auxiliary flow is around 1% of the turbine bulk flow 3118, the drop ion efficiency is also around 1%. Whilst this is still a moderate drop in efficiency in the context of a turbine, it is sufficiently small that it is tolerable in relation to the previously described benefits. However, because the flow rate of auxiliary flow 3142 is relatively small, the shearing forces produced by the auxiliary flow layer 158 are also relatively small, and therefore the auxiliary flow layer 158 may be less effective than an auxiliary flow layer which receives fluid via a wastegate valve arrangement (such as the valve 3144 above).

In some further embodiments, the auxiliary passage 3136 may be comprise a valve arrangement 3144, however the valve arrangement 3144 may be configured such that it always permits some leakage therethrough, such that auxiliary flow 3142 is provided across all operating conditions. The flow rate of the leakage may be in the proportions discussed in the paragraph above. This can be achieved, for example, by the use of leakage holes in the valve arrangement 3144 or control of the valve arrangement 3144 so that it does not fully close. Such embodiments combine the benefit of having a relatively large amount of flow available to support a strong turbulence region 3148 when the wastegate valve is open, whilst always providing at least some turbulence when the wastegate valve is closed.

Although the auxiliary passage 3136 comprises a single auxiliary passage outlet 3140, it will be appreciated that in alternative embodiments the auxiliary passage may comprise multiple auxiliary passage outlets. Increasing the number of auxiliary passage outlets 3140 may enable more control over the size and shape of the turbulence region 3148. For example, when only a single auxiliary passage outlet 3140 is used, the turbulence region 3148 will be concentrated around the region at which the turbine bulk flow 3118 and the auxiliary flow 3142 collide, and therefore the turbulence region 3148 will be positioned slightly off-centre relative to the turbine axis 3108. However, if a number of auxiliary passage outlets are distributed around the turbine axis 3108, the turbulence region 3148 can be enlarged so that it is generally positioned centrally relative to the axis 3108. The larger size and more central position of the turbulence region may enable a greater amount of aftertreatment fluid to be decomposed.

Although the turbine 3100 is described as having a single turbine housing 3102, it will be appreciated that in alternative embodiments the turbine 3100 may comprise a turbine housing assembly having multiple components. For example, the turbine 3100 may comprise a main turbine housing which defines the turbine inlet passage, the turbine wheel chamber and a portion of the turbine outlet passage. Additionally, the turbine 3100 may comprise a connection adapter mountable to the main turbine housing and defining the remainder of the turbine outlet passage and the auxiliary passage. The turbine housing 3102 (or the main turbine housing or the connection adapter) may be made from any suitable material and, in particular are made from cast iron or stainless steel. It is particularly beneficial for the turbine outlet passage to be made from a stainless steel component (or lined by a stainless steel component) as stainless steel is resistant to corrosion cause by the urea content of the aftertreatment fluid.

The turbine wheel 3104 defines an exducer portion having an exducer diameter. The centre of the nozzle 3124 of the dosing module 3122 is positioned approximately 2 exducer diameters downstream of the turbine wheel 3104 along the turbine axis 3108 9 or along a centreline of the turbine outlet passage 3114). Likewise, the geometric centre of the auxiliary passage outlet 3140 is positioned approximately 2 exducer diameters downstream of the turbine wheel 3104 along the turbine axis 3108. Accordingly, both the nozzle 3124 and the auxiliary passage outlet 3140 can be considered as being positioned close to the turbine wheel 3104. Because the auxiliary passage outlet 3140 is close to the turbine wheel, the swirling motion of the turbine bulk flow 3118 has not dissipated, and therefore the magnitude of the collision with the auxiliary flow 3142 is greater. In general, the closer the auxiliary passage outlet 3140 is to the turbine wheel 3104, the greater the magnitude of the collision with the turbine bulk flow 3118. However, in alternative embodiments the geometric centres of the nozzle 3124 and/or the auxiliary passage outlet may be positioned around 1, around 1.5, around 2.5, around 5 or around 10 exducer diameters away from the turbine wheel 3104 along the turbine axis 3108 (or along a centreline defined by the turbine outlet passage 3114).

FIG. 36 shows a schematic cross-sectional view of a turbine 4100 according to an embodiment of the present invention. The turbine 4100 comprises a turbine housing 4102 and a turbine wheel 4104 supported by a turbocharger shaft 4106 and configured to rotate about a turbine axis 4108. The turbine housing 4102 defines a turbine inlet passage 4110, a turbine wheel chamber 4112 and a turbine outlet passage 4114. The turbine inlet passage 4110 is configured to receive exhaust gas from an internal combustion engine (not shown). The exhaust gas received from the internal combustion engine by the turbine inlet passage 4110 defines a turbine bulk flow 4118. The turbine inlet passage 4110 is in the shape of a single volute configured to encourage swirling of the turbine bulk flow 4118 about the turbine axis 4110. In other embodiments the inlet passage 4110 may be a twin volute defining two paths for exhaust gas to pass through and having one or more outlets where exhaust gas is delivered into a turbine wheel chamber. The turbine wheel chamber 4112 is configured to receive the turbine bulk flow 4118 from the turbine inlet passage 4110. When the turbine bulk flow 4118 passes through the turbine wheel chamber 4112, it impinges upon blades (not shown) of the turbine wheel 4104 thus causing the turbine wheel 4104 to rotate and drive the turbocharger shaft 4106. The turbine wheel 4104 re-directs the turbine bulk flow 4118 so that it flows in an axial direction relative to the turbine axis 4108 and delivers the turbine bulk flow 4118 to the turbine outlet passage 4114. As such, the turbine 4100 is a so-called “radial” turbine. However, in alternative embodiments the turbine 4100 may be an “axial” turbine in which exhaust gas flows in a generally axial direction from the turbine inlet 4110 passage to the turbine outlet passage 4114.

The turbine outlet passage 4114 comprises a generally tapered side wall 4116 which defines a diffuser portion 4120 configured to cause expansion of the exhaust gas in the turbine outlet passage 4114. The side wall 4116 is outwardly tapered at an angle of around 7°, however in alternative embodiments any suitable taper angle may be used. The diffuser portion 4120 is symmetrically centred on the turbine axis 4108, such that the turbine axis 4108 defines a centreline 4109 of the turbine outlet passage 4114. However, in alternative embodiments the diffuser portion 4120 may have any suitable shape. In such embodiments, the centreline 4109 may be defined by the centroid of the turbine outlet passage 4114 relative to the direction of the turbine bulk flow 4118. Accordingly, the centreline 4109 may bend or otherwise diverge away from the turbine axis 4108 in dependence upon the shape of the turbine outlet passage 4114.

The turbine 4100 further comprises a dosing module 4122 configured to deliver an exhaust gas aftertreatment fluid to the turbine outlet passage 4114. The aftertreatment fluid is, in particular, diesel exhaust fluid (DEF) and is commonly available under the trade mark AdBlue. The dosing module 4122 comprises a nozzle 4124 in fluid flow communication with the turbine outlet passage 4114. The nozzle 4124 is, in particular, an atomising nozzle configured to generate a substantially atomised spray of aftertreatment fluid within the turbine outlet passage 4114. The nozzle 4124 generates a generally conical spray pattern, however in alternative embodiments substantially any suitable spray pattern may be used (for example fan-shaped etc.).

In the present embodiment, the nozzle 4124 is disposed a hole 4126 in the tapered side wall 4116 of the turbine 4100. In particular, the nozzle 4122 is flush with an inner surface 4117 of the tapered side wall 4116 which partly defines the turbine outlet passage 4114. In other embodiments, the nozzle 4124 may be received in a mounting structure, the mounting structure may comprise a recessed portion such that the nozzle 4122 is set back from the inner surface 4117 of the tapered side wall 4116. The nozzle 4122 is positioned so that aftertreatment fluid is delivered into the turbine outlet passage 4114 in a generally downstream direction in relation to the turbine bulk flow 4118. In other embodiments, the aftertreatment fluid may be sprayed in a generally upstream direction relative to the turbine bulk flow 4118, or orthogonally to the turbine axis 4108.

The aftertreatment fluid is sprayed into a spray region 4128 of the turbine outlet passage 4114. The spray region 4128 encompasses the spatial region in which the atomised spray of aftertreatment fluid has a larger component of velocity in the spray direction 4132 than in the direction of the turbine bulk flow 4118. The atomised spray of aftertreatment fluid leaving the nozzle 4124 has almost all of its velocity in the spray direction 4132. However, as the atomised spray of aftertreatment fluid travels laterally across the turbine outlet passage 4114 (i.e. in a direction normal to the turbine bulk flow 4118), interaction between the aftertreatment fluid and the turbine bulk flow 4118 changes the direction of the atomised spray of aftertreatment fluid until the aftertreatment fluid flows entirely in the direction of the turbine bulk flow 4118 (i.e. until the aftertreatment fluid is “carried away” by the momentum of turbine bulk flow 4118). The spray region 4128 corresponds to the portion of the turbine outlet passage 4114 in which the individual droplets of aftertreatment fluid carry more momentum from the dosing module 4122 than from the turbine bulk flow 4118. Accordingly, the geometry of the spray region 4128 is a property of the delivery strength of the dosing module 4128 relative to the momentum of the turbine bulk flow 4118. For the sake of simplicity, the spray region 4128 is illustrated in FIG. 36 as a conical region. However, it will be appreciated that due to the interaction between the turbine bulk flow 4118 and the aftertreatment fluid explained above the spray region 4128 will not, in reality, have a completely conical shape (see, for example, FIGS. 2A and 2B).

The dosing module 4122 is positioned and oriented so that the spray region 4128 is close to the outlet of the turbine wheel 4104. In general, the temperature of the turbine bulk flow 4118 will be hotter closer to the turbine wheel 4104 than at any position downstream due transient dissipation. Since heat energy is required to cause decomposition of the aftertreatment fluid, it is preferable for the spray region 4128 to be as close to the turbine wheel 4104 as possible. In particular, it is preferable for the dosing module 4122 to be positioned and oriented so that the nozzle 4124 is positioned within around 10 exducer diameters D4 from the turbine wheel 4104 along the centreline 4109; the exducer diameter D4 being the diameter of the exducer portion of the turbine wheel 4104. In alternative embodiments the nozzle 4124 of the dosing module 4122 may be positioned within around 2, 3, or 5 exducer diameters D4 from the turbine wheel 4104 along the centreline 4109. Depending upon the orientation of the dosing module 4122, in some embodiments this may be achieved by positioning the hole 4126 (or, more particularly, the nozzle 4124) within the same distances along the centreline 4109 as set out above. It is preferable that aftertreatment fluid does not enter the turbine wheel chamber 4112 as it may impinge upon the turbine wheel 4104 which could lead to deposit formation. Accordingly, it is preferable that the spray region 4128 is positioned entirely downstream of the turbine wheel chamber 4112 (i.e. so that it does not overlap with the turbine wheel chamber 4112).

The turbine 4100 comprises dividing wall 4136. The dividing wall 4136 is an axially extending tapered side wall which is radially spaced apart from, and is generally parallel with, the side wall 4116 of turbine housing 4102. As better seen in FIG. 37, which is an end view of the turbine 4100 according to FIG. 36, the dividing wall 4136 is an arcuate wall, such that it has a first surface 4138 which is a concave surface and a second surface 4140 which is a convex surface. The turbine outlet passage 4114 is defined partly by the inner surface 4117 of the side wall 4116 and partly by the first surface 4138 of the dividing wall 4136. In other embodiments, for example in the embodiments shown in FIGS. 40 and 41A, and discussed in more detail below, the dividing wall 4136, may be an annular side wall, such that the dividing wall extends in a circumferential direction with respect to the turbine axis to define an entire perimeter of at least a portion of the turbine outlet passage 4114.

The dividing wall 4136 is formed as part of the turbine housing 4102, but in other embodiments the dividing wall 4136 may be a component that is separate to the turbine housing 4102. For example, the dividing wall 4136 may be a stainless steel insert that is provided in the turbine housing 4102.

The first surface 4138 of the dividing wall 4136 defines a boundary of the turbine outlet passage 4114. The first surface 4138 is positioned opposite the nozzle 4124 of the dosing module 4122. During use, when aftertreatment fluid is delivered to the turbine outlet passage by the dosing module, some aftertreatment fluid will impinge upon the first surface 4138 (subject to any momentum exchange between the aftertreatment fluid and the turbine bulk flow 4118 which carries the aftertreatment fluid downstream of the dividing wall 4136).

In use, as the turbine bulk flow 4118 passes though the turbine outlet passage 4114, the turbine bulk flow 4118 will heat the first surface 4138 of the dividing wall 4136. However, the heat transferred from the turbine bulk flow 4118 to the dividing wall 4136 is generally not sufficient to heat the first surface 4138 of the dividing wall 4136 to a high enough temperature to cause evaporation of any aftertreatment fluid that impinges and settles on the first surface 4138. As such, there is a risk that aftertreatment fluid which impinges upon the first surface 4138 will solidify and form a blockage in the turbine outlet passage.

To mitigate against this, the turbine 4100 further comprises an auxiliary passage 4142 configured to provide additional heat to the dividing wall 4136. The auxiliary passage 4142 has an auxiliary passage inlet 4144 and an auxiliary passage outlet 4145. The auxiliary passage 4142 is defined by an elongate axial conduit of the turbine housing 4102. The auxiliary passage 4142 is partly defined by the side wall 4116 and the second surface 4140 of the dividing wall 4136 and extends from the auxiliary passage inlet 4144 to the auxiliary passage outlet 4145.

During use, the auxiliary passage 4142 receives a portion of the turbine bulk flow 4118 from the turbine outlet passage 4114 via the auxiliary passage inlet 4144. The auxiliary passage inlet 4144 is positioned close to the exducer of the turbine wheel 4104, such that as the turbine bulk flow 4118 leaves the turbine wheel 4104 a portion of the turbine bulk flow 4118 passes into the auxiliary passage 4142 via the auxiliary passage inlet 4144. Preferably, the auxiliary passage inlet 4144 is positioned as close as possible to the turbine wheel 4104 and preferably no more than around 0.5 exducer diameters D4 from the turbine wheel 4104 along the centreline 4109.

The bulk flow 4118 leaving the turbine wheel has a large component of momentum directed axially along the centreline 4108. Although the side wall 4116 is tapered and will act to deflect some of the turbine bulk flow 4118 away from the centreline, the direction of flow of the turbine bulk flow 4118 is still dominated by the axial momentum imparted on it by the turbine wheel 4104 and therefore flows in a generally axial direction along the centreline 4108. Therefore, increasing the distance between the auxiliary passage inlet 4144 and the turbine wheel 4104 increases the likelihood that the momentum of the turbine bulk flow 4118 will carry the bulk flow 4118 over the top of the dividing wall 4136. Accordingly, this results in a decrease in the amount of exhaust gas received by the auxiliary passage inlet 4144. Thought of another way, it is preferable that the auxiliary passage inlet 4144 is to some extent overlapped with the exducer of the turbine wheel 4104 in a radial direction relative to the centreline 4108. The less the two overlap, the less auxiliary flow is received by the auxiliary passage 4142. In some embodiments, entry into the auxiliary passage 4142 can be improved with the use of a scoop or louver at the auxiliary passage inlet 4144, which may enable the auxiliary passage inlet to be placed further away from the turbine wheel 4104.

In order to ensure that aftertreatment fluid does not accidentally enter the auxiliary passage 4142, the auxiliary passage inlet 4144 is positioned axially upstream of the dosing module 4122. The portion of the turbine bulk flow 4118 received by the auxiliary passage 4142 defines an auxiliary flow 4146.

As the auxiliary flow 4146 passes through the auxiliary passage 4142 heat is transferred to the first surface 4138 not only from the turbine bulk flow 4118, but also from the auxiliary flow 4146 (via the second surface 4140). Accordingly, the surface area available to receive heat energy for heating the first surface 4138 is increased, and hence the temperature of the first surface 4138 increases. This in turn, advantageously, increases the heat available to evaporate of any aftertreatment fluid which has settled on the first surface 4138 of the dividing wall 4136 and increases the rate of such evaporation. The increased temperature of the first surface 4138 reduces the risk that impinged aftertreatment fluid will solidify and cause a blockage. Since the risk of deposit formation resulting from impinged aftertreatment fluid is mitigated or reduced, the dosing module can be positioned in narrower pipe geometries than previously possible. In particular, this allows the dosing module 4122 to be positioned closer to the turbine wheel 4104.

In use, heat is transferred from the turbine bulk flow 4118 in the turbine outlet passage 4114 to the first surface 4138 of the dividing wall 4136. Such heat transfer may be convective and/or conductive. Heat is also transferred from the auxiliary flow 4146 in the auxiliary passage 4142 to the second surface 4140 of the dividing wall 4136. Again, such heat transfer may be convective and/or conductive. Finally, heat is transferred from the second surface 4140 of the dividing wall 4136 to the first surface 4138 of the dividing wall by conduction.

It will be appreciated that in the embodiment shown in FIG. 36, because the auxiliary flow 4126 and the turbine bulk flow 4118 have both passed through the turbine wheel 4104 the temperature of the two flows will be the same. As such, the first surface 4138 and the second surface 4140 may be heated to the same temperature and reach equilibrium. However, in use, aftertreatment fluid which emanates from the nozzle 4124 of the dosing module 4122 may contact the first surface 4138 of the dividing wall 4136. Because the aftertreatment fluid is generally stored at ambient temperature, it typically has a lower temperature which than the first surface 4138 of the dividing wall 4136. As such, the impinged aftertreatment fluid acts to cool the first surface 4138, thus creating a heat gradient across the dividing wall 4136 driving heat transfer. Accordingly, in use, the second surface 4140 of the dividing wall 4136 generally maintains a higher temperature than that of the first surface 4138, such that there is generally heat transfer from the second surface 4140 to the first surface 4138 by conduction.

In order to enable adequate heat transfer from the second surface 4140 to the first surface 4138, the dividing wall is preferably made from a thermally conductive material. In particular the dividing wall may be made from a metal or a metal alloy, and preferably a metal and/or an alloy with a thermal conductivity k (W/m·K) which is greater or equal to 10 W/m K. Suitable materials for this purpose include Copper (around 400 W/m·K), Aluminium (around 200 W/m·K), Pearlitic Iron (around 50 W/m·K), Stainless Steel (around 25 W/m·K), Chrome or Nickel (around 60 W/m·K). In other embodiments, the dividing wall may be formed from a plurality of materials to provide improved durability under certain conditions. For example, the dividing wall may comprise a first layer defining the first surface 4138 and a second layer defining the second surface 4140. Since the first layer will interact with aftertreatment fluid, the material of the first layer may be chosen to have improved corrosion resistance. A suitable material of this type may be stainless steel. However, the second layer will not be exposed to aftertreatment fluid and may therefore be chosen to have a high thermal conductivity. A suitable material may be copper or the like. Furthermore, materials having directional heat transfer properties, such as pyrolytic graphite, may be employed to may be employed to provide high thermal conductivity between the first and second surfaces and low conductivity along the dividing wall.

The diving wall 4136 may define a thickness between the first surface 18 and the second surface 4140 which is relatively small compared to a thickness of the side wall 4116. In this context, the thickness of the side wall 4116 may be measured between the inner surface 4117 and a radially outermost surface of the side wall 4116. In other words, the thickness of the side wall 4116 or the dividing wall 4136 is dimension of the wall or orthogonal to both its length and circumferential extend. In some embodiments the thickness of the dividing wall 4136 and the thickness of the side wall 4116 may be sized relative to the diameter D4 of the turbine wheel exducer. For example, the side wall 4116 may be 0.2 exducer diameters and the ratio of the thickness of the side wall 4116 to the thickness of the dividing wall 4136 may be 3:1, such that the dividing wall 4136 has a thickness that is around 5% of the exducer diameter D. In other embodiments the thickness of the dividing wall 4136 may be 25% of the thickness of the side wall 4116. In further embodiments, it may not be necessary for the thickness of the dividing wall 4136 and/or the side wall 4116 to be scaled with the exducer diameter D4 of the turbine wheel 4104. As such, irrespective of the exducer diameter D4 the dividing 4136 wall may have a thickness that i between around 1.5 mm to around 10 mm and the side wall 4116 may have a thickness that is between around 3 mm to around 15 mm. The dividing wall may be made as a separate sheet metal insert that is received and secured within the turbine outlet, and the turbine outlet may be a cast component. Alternatively, the two may be integrally formed.

The auxiliary passage outlet 4145 is configured to deliver the auxiliary flow 4146 into the turbine outlet passage 4114 at a location downstream of the nozzle. Preferably, the auxiliary passage outlet 4145 should be aligned with the downstream most part of the spray cone of the dosing module 4122 relative to the centreline 4108. This ensures that the majority of the aftertreatment fluid is “caught” by the first surface so that it is heated and evaporated. Accordingly, the spacing between the nozzle 4124 and the auxiliary passage outlet may dependent upon the spray angle of the nozzle 4124 and the diameter of the turbine outlet passage 4114. In particular, the auxiliary passage outlet may be positioned downstream of the nozzle 4124 by at least around 1 or around 2 exducer diameters D4 along the centreline 4109. In further embodiments the auxiliary passage outlet may be further downstream, for example up to around 3, 5 or 10 exducer diameters from the turbine wheel 4104 along the centreline 4109.

It has been found that when the auxiliary passage outlet is positioned at such a distance downstream of the nozzle 4124, the dividing wall 4136 is sufficiently large that it is able to catch the vast majority of the aftertreatment fluid which would otherwise impinge upon the side wall 4116 (for example, if the dividing wall 4136 was absent). To this end, the dividing wall 4136 also extends around a proportion of the circumference of the turbine outlet passage 4114 that is wide enough to catch the aftertreatment fluid delivered by the dosing module 4122. In particular, the circumferential extent of the dividing wall 4136 may be chosen in dependence upon the spray angle of the dosing module 4122. In the embodiment of FIG. 36, the dividing wall 4136 extends around approximately ⅓ of the perimeter of the turbine outlet passage 4114 where the dividing wall is located, however greater or lesser circumferential extents are also envisaged. By sizing the dividing wall in the manner described above, it can be ensured that the regions of the turbine outlet passage 4114 at high risk of aftertreatment fluid impingement have a surface temperature sufficiently hot to cause the aftertreatment fluid to evaporate immediately. It will further be appreciated that the dividing wall 4136 could be sized and oriented such that it is only present in regions at high risk of aftertreatment fluid impingement.

In further embodiments, the auxiliary passage outlet 4145 may be aligned with the nozzle 4124 of the dosing module 4122 or spaced apart from it by less than 1 exducer diameter along the centreline 4108. This provides the advantage that approximately half of the aftertreatment fluid will impinge upon the first surface where it will evaporate, and the remainder will be subject to high shearing forces in an auxiliary flow layer such as that described in relation to FIGS. 13 to 32.

To further mitigate against the risk of solid deposit formation of aftertreatment fluid in the turbine outlet passage, the auxiliary passage outlet 4145 may be configured to deliver the auxiliary flow 4146 into the turbine outlet passage 4114 in a manner which further decreases the risk of aftertreatment fluid deposition on the side wall 4116. This may be particularly advantageous for embodiments where the dividing wall 4136 only extends across a region of the side wall 4116 which is at highest risk of aftertreatment fluid impingement. For example, the auxiliary flow 4146 may be delivered into the turbine outlet passage 4114 in a manner which increases the turbulent kinetic energy of the turbine bulk flow 4118. By way of example, the auxiliary flow 4146 may be reintroduced into the turbine outlet passage 4114 in a direction that is generally normal to the direction of the turbine bulk flow 4118, such that the momentum exchange between the delivered auxiliary flow 4146 and the turbine bulk flow 4118 is relatively large. Therefore, the turbulent kinetic energy of the turbine bulk flow 4118 is increased and further mixing between the turbine bulk flow 4118, the delivered auxiliary flow 4146 and the aftertreatment fluid is promoted. Alternatively, the auxiliary flow 4146 may be introduced into the auxiliary passage outlet in an auxiliary flow layer which is able to deflect and break up droplets of aftertreatment fluid before they impinge upon the side wall 4116, such as for example as described in relation to FIGS. 13 to 32.

The dosing module 4122 is inclined relative to the centreline 4109 so that it injects the aftertreatment fluid in a generally downstream direction relative to the turbine bulk flow 4118 in the turbine outlet passage 4114. This is beneficial in that the momentum of the aftertreatment fluid is generally in the same direction as the turbine bulk flow 4118, and therefore the aftertreatment fluid may be more readily carried downstream by the turbine bulk flow 4118. However, the dosing module 4122, in other embodiments, can point in any substantially suitable direction. For example, the dosing module 4122 may be configured to inject aftertreatment fluid in a generally upstream direction relative to the turbine bulk flow 4118 or directly towards the first surface 4138 of the dividing wall.

The turbine 4100 may form part of an exhaust gas aftertreatment system comprising one or more selective catalytic reduction (SCR) catalysts configured to receive exhaust gas from the turbine 4100 via a conduit downstream of the turbine outlet passage 4114. During operation of the engine, it is generally necessary to deliver aftertreatment fluid to the exhaust gas to ensure there is a sufficient quantity of reductants within the exhaust gas to support the SCR reaction. However, it is not always possible to deliver aftertreatment fluid to the exhaust gas. One such example is shortly after ignition of the internal combustion engine (e.g. up to around 5 minutes from ignition, although this could be shorter, such as for example up to around 20 seconds). During such conditions, when the engine has started from cold conditions, the catalyst is not hot enough to overcome the reaction enthalpy required for reduction of NOx. Therefore, any aftertreatment fluid introduced into the exhaust gas when the catalyst is too cool will not be used for NOx reduction and is therefore unnecessary. Furthermore, it is often not necessary to deliver the aftertreatment fluid during such conditions because reductants such as ammonia, which were decomposed from the aftertreatment fluid during a previous operation cycle of the engine, will be stored in the catalysts. The mass of reductant stored in the catalysts from the previous operation cycle is typically large enough to support the SCR reaction for a short period of time once the catalyst reaches the required temperature, to ensure NOx is converted from the exhaust gas during this period. Nevertheless, it is generally preferable to begin aftertreatment dosing as soon as possible after the catalyst is hot enough.

However, before ignition the first surface 4138 of the dividing wall 4136 is likely to be at ambient temperature, and will therefore be below the evaporation temperature of the aftertreatment fluid. As such, any aftertreatment fluid, such as urea or ammonia, which contacts the first surface 4138 might solidify, forming a blockage. Therefore, the dosing module 4124 may be controlled to delay aftertreatment fluid delivery until such time that the first surface 4138 of the dividing wall 4136 is hot enough to cause any aftertreatment fluid that impinges thereupon to evaporate. To this end, the exhaust gas aftertreatment system may comprise a controller configured to control the operation of the doser in dependence upon one or more parameters. Such parameters may include, for example, the time from engine ignition (e.g. up to 5 minutes), or a temperature measurement. The temperature measurement may be taken from the first surface 4138 and/or the dividing wall 4136 or the like for example using a thermistor or infrared sensor. This measurement may be compared to a threshold value indicative of the evaporation temperature of a constituent chemical of the aftertreatment fluid (e.g. the evaporation temperature of urea or ammonia).

FIG. 38A shows an alternative embodiment of the invention in which the auxiliary passage inlet 4144 is defined by an opening in a wall 4150 of the turbine housing 4102 that defines the volute of the turbine inlet passage 4110.

As with the embodiment shown in FIG. 36, the turbine 4100, comprises a dividing wall 4136 comprising a first surface 4138 which partly defines the turbine outlet passage 4114, and a second opposing surface 4140 which partly defines the auxiliary passage 4142. However, in the embodiment shown in FIG. 38B, the auxiliary passage 4142 receives the auxiliary flow 4146 from the volute of the turbine inlet passage 4110. In particular, a portion of the turbine bulk flow 4118 which is in the turbine inlet passage 4110 passes into the auxiliary passage 4140 via the auxiliary passage inlet 4144 (that is, instead of passing through the turbine wheel chamber 4112 and the turbine wheel 4104 as per the previous embodiment).

In the illustrated embodiment, the auxiliary passage 4142 extends from the auxiliary passage inlet in the form of a conduit having a portion exterior to the turbine housing 4102. However, it will be appreciated that this arrangement is illustrative only. In other embodiments, the auxiliary passage 4142 may be integrated into the turbine housing 4102, for example as part of a casting. The auxiliary passage 4142 may have substantially any arrangement which routes auxiliary flow 4146 from the turbine inlet passage 4110 to the turbine outlet passage 4114.

In use, as the turbine bulk flow 4118 passes through the turbine wheel chamber 4112 and impinges on the blades of the turbine wheel 4104, mechanical work is extracted from the turbine bulk flow gas 4118 and the turbine wheel 4104 rotates about the turbine axis 4108. The mechanical work extracted from the turbine bulk flow 4118 is realised, generally, as a decrease in temperature and velocity of the turbine bulk flow 4118. Accordingly, the turbine bulk flow 4118 in the turbine inlet passage 4110 is generally hotter that the turbine bulk flow 4118 in the turbine outlet passage 4114.

Because the auxiliary passage 4140 receives the auxiliary flow 4146 from the turbine inlet passage 4110 the auxiliary flow 4146 is hotter than the turbine bulk flow 4118 in the turbine outlet passage 4114. As such, more heat is transferred to the second surface 4140 of the dividing wall 4136 than in the embodiment of FIG. 36, and thus the rate of heat transfer to the first surface 4138 of the dividing wall 4136 is increased. This provides additional energy to ensure that the first surface 4138 of the dividing wall 4136 is hot enough to cause evaporation of any aftertreatment fluid that impinges upon it.

The turbine 4100 of FIG. 38A does not comprise any valves or other components for restricting the flow of exhaust gas into the auxiliary passage 4142 from the turbine inlet passage 4110. Accordingly, exhaust gas is freely permitted to flow from the turbine inlet passage 4110 to the turbine outlet passage across all operating conditions of the turbine 4100. Because the auxiliary flow 4146 does not pass through the turbine wheel 4104, no energy is extracted from the auxiliary flow 4146 by the turbine wheel 4104 and thus the power produced by the turbine 4100 is reduced. To mitigate against such power reduction, the auxiliary passage 4142 is sized so that is only able to receive a relatively small amount of flow, and thus limit the overall power reduction of the turbine 4100. In particular, the auxiliary passage 4142 may be sized to receive at most around 1%, around 2%, around 2.5% around 3%, around 5% or around 10% of the exhaust gas delivered to the turbine inlet passage 4110 by the engine. Such sizing can be achieved, for example, by selecting an appropriate cross-sectional area of the narrowest portion of the auxiliary passage 4142. The remainder of the exhaust gas passes through the turbine wheel 4104. In general, the smaller the amount of exhaust gas the auxiliary passage 4142 is sized to receive, the smaller the reduction on the power output of the turbine 4100. Although some power reduction is inevitable, if solid deposits are able to build-up in the turbine outlet passage 4114 the reduction in power output of the turbine wheel 4104 due to back pressure caused by the solid deposits may be greater than the loss in power output due to the auxiliary flow passage 4142. Therefore, providing a constant auxiliary flow 4146 which mitigates against the build-up of solid deposits increases the longevity of the turbine 4100 and allows the turbine wheel 4104 to maintain a higher power output over time.

As with the embodiment described in FIG. 36, the dosing module 4124 may be controlled to selectively deliver aftertreatment fluid into the turbine outlet passage 4114. In particular, the dosing module 4124 may be controlled to only deliver aftertreatment fluid into the turbine outlet passage 4114, when an upstream engine has been running for a predetermined length of time, or when the first surface 4138 of the dividing wall has reached a predetermined temperature.

FIG. 38B shows a schematic cross-sectional side view of a variant of the turbine 4100 as shown in FIG. 38A. The turbine 4100 in FIG. 38B differs from the turbine 4100 of FIG. 38A, in that the auxiliary passage 4142 comprises a valve arrangement having a valve 4186. The valve 4186 is configured to selectively permit, prevent and/or regulate flow through the first auxiliary passage 4142. The valve 4186 may transition from a fully open position, where exhaust gas is freely permitted to pass through the auxiliary passage 4142, to a fully closed position, where the valve 4186 is configured to substantially block exhaust gas passing from the turbine inlet passage 4110 through the auxiliary passage 4142. The valve 4186 may also transition between a range of partially closed positions. When the valve arrangement is in a fully closed position the exhaust gas is substantially prevented passing from through the auxiliary passage 4142. Therefore, all of the exhaust gas in the turbine inlet passage 4110 will pass through the turbine wheel 4104, and in turn the power output of the turbine wheel 4104 be maximised. Likewise, when the valve 4186 is partially or fully open, some exhaust gas can bypass the turbine wheel 4104 and thus the power output of the turbine 4100 may be reduced. Such arrangements can be used to prevent overspeed events occurring at the compressor end of the turbocharger. Accordingly, the valve 4186 and auxiliary passage 4142 function as a wastegate passage.

In order to ensure sufficient wastegating functionality, the auxiliary passage 4142 may be sized such that it is able to receive at least around 10%, around 25% or around 50% of the exhaust gas delivered to the turbine inlet passage 4110 by the engine. Accordingly, the power reduction of the turbine 4100 when the valve 4186 is open will be sufficient to decelerate the rotational speed of the turbine wheel 4104, and thereby avoid choke and surge events at the compressor end. Such sizing may be achieved by ensuring that the cross-sectional area of the auxiliary passage 4142 throughout is large enough to support sufficiently high flow rates therethrough. Therefore the auxiliary passage 4142 of the embodiment of FIG. 38B is likely to be larger than that of the embodiment of FIG. 38A discussed above. Because the auxiliary passage 4142 of FIG. 38A receives a larger amount of flow, the auxiliary passage may be able to support heating of a large surface area. As such, the extent of the dividing wall 4136 may be increased, to provide a larger for aftertreatment fluid impingement.

In some embodiments, the valves 4186 may allow for a small amount of exhaust gas to pass through the auxiliary passage 4142 even when the valve 4186 is in its closed configuration. Such arrangements provide a constant bleed of exhaust gas from the turbine inlet passage 4110 to the turbine outlet passage 4114. Providing a constant bleed of exhaust gas through the auxiliary passage 4142 further mitigates against aftertreatment solidifying on the first surface 4138 of the dividing wall 4136.

As previously discussed, shortly after engine ignition the dividing wall 4136 is likely to be at ambient temperature. Therefore, any aftertreatment fluid which impinges upon the dividing wall 4136 will not evaporate, and may form a blockage in the turbine outlet passage 4114. As described, during the period after engine ignition the catalysts typically contain a sufficient amount of embedded reductant to support the SCR reaction for a short period, and therefore activation of the dosing module 4122 can be delayed until the dividing wall is hot enough to cause evaporation of the aftertreatment fluid. In the present embodiment, it is advantageous to control the valve 4186 such that it is in an open configuration during the period following engine ignition. When the valve 4186 is open, the auxiliary passage 4142 receives hot exhaust gas from the turbine inlet passage 4110 and is therefore heated faster than if the valve 4186 were closed during this period. The valve 4186 may subsequently be closed in dependence upon one or more parameters such as the time since engine ignition or the temperature of the dividing wall 4136. Control over the valve 4186 and the dosing module 4122 may be achieved using a controller.

In further operating conditions, the dosing module 4122 may be controlled such that dosing occurs only when the first surface 4138 of the dividing wall 4136 is hot enough to support evaporation of aftertreatment fluid. For example, should the valve 4186 be closed for a long period of time, the temperature of the dividing wall may reduce below a threshold temperature indicative of the evaporation temperature of one or more of the chemical constituents of the aftertreatment fluid. Such a temperature drop may be detected using a thermistor in communication with the dividing wall or an infrared thermometer and compared to the threshold temperature (e.g. by the controller). Alternatively, the temperature drop could be predicted based upon the length of time that the valve 4186 has remained closed. When such a temperature drop occurs, the dosing module 4122 may be deactivated (e.g. by the controller). Subsequently, the valve 4186 may be opened (e.g. by the controller) so that the auxiliary flow 4146 re-heats the dividing wall 4136 so that it is hot enough to support evaporation of the aftertreatment fluid.

FIG. 39 shows another embodiment of a turbine 4100 according to the present invention. The embodiment of FIG. 39 differs from the previous embodiment in that the dividing wall 4136 circumferentially surrounds the turbine outlet passage 4114 about the centreline 4109. The auxiliary passage 4142 is defined between the dividing wall 4136 and the side wall 4116 and therefore also circumferentially surrounds the turbine outlet passage 4114. The auxiliary passage 4142 diverges outwardly from the centreline 4109 parallel to the side wall 4116 and therefore defines the shape of a tapered annular passage. In use, the auxiliary flow 4146 is radially outwards of and surrounds the turbine bulk flow 4118. The cross sectional area of the turbine outlet passage 4114 may be chosen so that the valve 4186 is able to bypass a sufficient amount of flow around the turbine wheel to provide a wastegating effect.

As with the previous embodiments, the dividing wall 4136 comprises a first surface 4138 facing the dosing module 4122 and a second surface 4140 opposite the first surface and facing the side wall 4116. Additionally, the dividing wall 4136 comprises a third surface 4166 and a fourth surface 4168. The third surface 4166, like the first surface 4138 is a concave arcuate surface. The third surface 4166 defines a portion of the turbine outlet passage 4114 together with the first surface 4138. The fourth surface 4168 is an opposing face of the dividing wall 4136 to the third surface 4166, and is therefore an arcuate convex surface. The fourth surface 4168 partly defines the auxiliary passage 4142 together with the second surface 4140. Although the dividing wall 4136 is described as having first 4138, second 4140, third 4166 and fourth 4168 surfaces, it will be appreciated that the third surface 4166 may be a continuation of the first surface 4138, and that the fourth surface 4168 may be a continuation of the second surface 4140.

During use, as the auxiliary flow 4146 passes through the auxiliary passage 4142 heat is transferred from the auxiliary flow 4146 to the first 4138 and third 4166 surfaces of the dividing wall 4136, via the second 4140 and fourth 4168 surfaces respectively. Accordingly, the entire circumference of the dividing wall 4136 which defines the turbine outlet passage 4114 is heated. This has the beneficial effect as described above in relation to FIGS. 36 to 38B, in that the surfaces of the dividing wall 4136 are heated to a temperature whereby any aftertreatment fluid which impinges on the surface evaporates, thereby mitigating against solid deposit formation. Due to the orientation of the nozzle 4124 any impingement of aftertreatment fluid would mostly occur on the first surface 4138 of the dividing wall 4136, however, it is possible that some aftertreatment fluid may impinge on the third surface 4166, and therefore heating of the third surface 4166 further mitigates against solid deposit formation. Further, as previously explained, because the auxiliary flow 4146 is hotter than the turbine bulk flow 4118 in the turbine outlet passage 4114, the first 4138 and third 4166 surfaces will also act to heat the turbine bulk flow 4118. Heating the turbine bulk flow 4118 promotes decomposition of the delivered aftertreatment fluid in the turbine outlet passage 4114.

The nozzle 4124 of the dosing module 4122 is substantially aligned with the inner surface 4117 of the side wall 4116 of the turbine housing, such that the nozzle 4124 is radially outwards of the fourth surface 4168 of the dividing wall 4138. The dividing wall 4136 comprises an aftertreatment delivery opening 4170, which is an aperture in the dividing wall 4136 extending between the third 4166 and fourth 4168 surfaces. The aftertreatment delivery opening 4170 is aligned with the nozzle 4124 such that aftertreatment fluid which is ejected from the nozzle 4124 can pass through a portion of the auxiliary passage 4142 and through the aftertreatment delivery opening 4170 into the turbine outlet passage 4170. Because the nozzle 4124 is radially outwards of the dividing wall 4136, the generally conical spray pattern of the aftertreatment fluid is able to develop as it passes through the auxiliary passage 4142 before reaching the turbine outlet passage 4114. Allowing the conical spray pattern of the aftertreatment fluid to start developing prior to mixing with the turbine bulk flow 4118 in the turbine outlet passage promotes uniform mixing of the aftertreatment fluid with the turbine bulk flow 4118. The diameter 4176 of the aftertreatment delivery opening 4170 is larger than the diameter 4178 of the nozzle 4124, such that the aftertreatment fluid can readily pass into the turbine outlet passage 4114 without impinging on the fourth surface 4168 of the dividing wall 4136. In other embodiments, the nozzle 4124 may be substantially aligned with the aftertreatment delivery opening 4170 in the dividing wall 4136, such that the conical spray pattern only develops in the turbine outlet passage 4114, in this case, the diameter 4176 of the aftertreatment delivery opening 4170 may be substantially the same as the diameter 4178 of the nozzle 4124.

The turbine 4100 further comprises a support structure 4172 configured to support the dividing wall 4136. The support structure 4172 is provided in the auxiliary passage 4142 and comprises an annular wall which extends between the inner surface 4117 of the side wall 4116 of the turbine housing 4102 and the fourth surface 4168 of the dividing wall 4136. The support structure 4172 defines a central conduit 4174 aligned with the nozzle 4124 of the dosing module 4122 and with the aftertreatment delivery opening 4170 As such the central conduit 4174 defines a fluid pathway from the nozzle 4124 to the aftertreatment delivery opening 4170. In doing so, the support structure 4172 blocks the auxiliary flow 4146 from passing over the nozzle 4124 and over the aftertreatment delivery opening 4170. In other words, the auxiliary flow 4146 is diverted around the support structure 4172. Preventing the auxiliary flow 4146 from passing over the nozzle 4124 and the aftertreatment delivery opening 4170 means that no momentum exchange takes place between the auxiliary flow 4146 and the aftertreatment fluid. This allows the conical spray pattern of the aftertreatment to develop uniformly prior to mixing with the turbine bulk flow 4118 in the turbine outlet passage. The support structure 4172 can therefore be considered to support the dividing wall 4136 and to provide a shielded fluidic pathway for the aftertreatment fluid from the auxiliary flow 4146.

In other embodiments, the support structure 4172 may serve to only support the dividing wall 4136 and to not provide any shielding effect of the aftertreatment fluid. For example, the support structure may be open to the auxiliary passage 4142. Alternatively, the support structure may shield the nozzle 4122 and the aftertreatment fluid from the auxiliary flow 4146 without supporting the dividing wall 4136. In further alternatives, the turbine 4100 may comprise a plurality of support structures. Exemplary support structures may be struts, arms, fins, vanes, baffles or any suitable structure for supporting the dividing wall 4136 and/or shielding the aftertreatment fluid. It may be preferable to minimise the number of support structures provided so as to minimise any disturbance to the auxiliary flow 4146 and to mitigate against the auxiliary flow 4146 heating components other than the dividing wall 4136.

The turbine 4100 of FIG. 39 also differs from the previous embodiments in that it comprises two separate auxiliary passages. In particular, the auxiliary passage 4142 may be considered to define a first auxiliary passage 4142 whilst the turbine also comprises a second auxiliary passage 4180. The second auxiliary passage 4180 extends from the turbine inlet passage 4110 to an opening defined in the dividing wall 4136. The portion of the turbine bulk flow 4118 received by the second auxiliary passage 4180 defines a second auxiliary flow 4184. The second auxiliary passage 4180 is configured to deliver the second auxiliary flow to a portion of the turbine outlet passage bounded by the dividing wall 4136.

The turbine 4100 also comprises a dual wastegate arrangement 4160 configured to control flow through the two auxiliary passages. The dual wastegate arrangement comprises a first valve 4186 configured to selectively permit, prevent and/or regulate flow through the first auxiliary passage 4146 and comprises a second valve 4182 configured to selectively permit, prevent and/or regulate the flow through the second auxiliary passage 4180.

Because the first auxiliary passage 4142 and the second auxiliary passage 4180 allow exhaust gas to pass from the turbine inlet passage 4110 to the turbine outlet passage 4114 without passing through the turbine wheel 4104, the first and second auxiliary passages 4142, 4180 are functionally equivalent to wastegate passages. Likewise, the first and second valves 4186, 4182 are functionally equivalent to wastegate valves. The first and second valves 4186, 4182 may be substantially any suitable valve type. For example, the first and second valves 4186, 4182 may be so called “flap type” valves comprising valve members configured to selectively block the respective first and second auxiliary passages 4142, 4180, actuated by a corresponding actuation rod. In alternative embodiments one or both of the valves may be a different valve type such as a so-called “poppet” valve or a “rotary barrel” valve. The first valve 4186 and the second valve 4182 may be independently (e.g. separately) controlled. In other embodiments, the first valve 4186 and the second valve 4182 may be actuated in unison, for example by a single actuation rod.

The second auxiliary passage 4180 is configured to deliver the second auxiliary flow 4184 into the turbine outlet passage 4114 at a location that is axially upstream of and generally opposite the nozzle 4124 of the dosing module 4122 relative to the turbine axis 4108. Furthermore, the second auxiliary passage 4180 is configured to deliver the second auxiliary flow 4184 into the turbine outlet passage 4114 in such a manner that the second auxiliary flow 4184 is directed along the first surface 4138 of the dividing wall 4136. During use, as the second auxiliary flow 4184 flows along the first surface 4138 it defines an auxiliary flow layer 4188.

As the auxiliary flow layer 4188 travels along the first surface 4138 of the dividing wall 4136, it heats the first surface 4138. Because the second auxiliary flow layer 4188 is hotter than the turbine bulk flow 4118 in the turbine outlet passage 4114, heat energy from the second auxiliary flow layer 4188 further increases the temperature of the first surface 4138 of the dividing wall 4136. Therefore, more heat energy is available to cause evaporation of any aftertreatment fluid that contacts the dividing wall 4136.

The second auxiliary flow layer 4188 typically exhibits high velocity and high shear. As such, the second auxiliary flow layer 4188 also creates a fluidic obstruction which acts to deflect and break up aftertreatment fluid close to the first surface 4138. Consequently, the second auxiliary flow layer 4188 inhibits aftertreatment fluid from impinging on the first surface 4138, to further reduce the chance of solid deposits forming on the dividing wall 4136, such as for example in the manner of the auxiliary flow layer described in relation to the embodiments of FIGS. 13 to 32.

In order to minimise the chance of solid deposits forming on the dividing wall 4136, the second auxiliary flow 4184 is preferably delivered to the turbine outlet passage 4114 through a second auxiliary passage outlet 4185 at a position upstream of the nozzle 4124 of the dosing module 4122. However, since the dividing wall 4136 is heated by the first auxiliary flow 4146 it is not essential that the second auxiliary flow 4184 is delivered into the turbine outlet passage 4114 at such a position, since the heat of the dividing wall 4136 will cause any impinged aftertreatment fluid to evaporate. As such, in alternative embodiments the second auxiliary flow 4184 may be delivered at a location which is axially aligned with the nozzle 4124 or is axially downstream of the nozzle 4124.

In a further alternative embodiment, instead of forming a second auxiliary flow layer 4188, the second auxiliary flow 4184 may be delivered into the turbine outlet passage 4114 in a manner which increases the turbulent kinetic energy of the turbine bulk flow in the turbine outlet passage 4114. This may be achieved, for example, by introducing the second auxiliary flow 4146 at a generally orthogonal angle relative to the turbine bulk flow, or in a direction facing upstream in relation to the turbine bulk flow 4118. By increasing the turbulence in the turbine outlet passage, mixing of the aftertreatment fluid and the exhaust gas is improved. Therefore, the aftertreatment fluid will be more evenly distributed throughout the turbine bulk flow 4118. As another alternative, the second auxiliary flow 4184 may be delivered in a manner so as to provide a cleaning effect around an area of the nozzle 4124, for example by passing the second auxiliary flow 4146 over the nozzle 4124 of the dosing module 4122.

The first and second auxiliary valves 4186, 4182 may be independently controlled to transition between a fully open position and a fully closed position and intermediate positions. In a fully open position, exhaust gas may freely pass from the turbine inlet passage 4110 through the respective auxiliary passage 4142, 4180. In a fully closed position, the valves 4186, 4182 substantially prevent exhaust gas passing into the respective auxiliary passage 4142, 4180. In intermediate positions, the valve 4186, 4182 may restrict the amount of exhaust gas that is able to pass through the auxiliary passages 4142, 4180. In some embodiments, when in a fully closed position, one or both of the valves 4186, 4182 may allow for a small amount of exhaust gas to pass through the respective auxiliary passage 4142, 4180, such that there is a constant bleed of exhaust gas from the turbine outlet passage 4110 to the turbine outlet passage. Providing a constant bleed of exhaust gas through the auxiliary passage 4142, 4180 further mitigates against aftertreatment solidifying on the first surface 4138 of the dividing wall 4136.

In other embodiments, the first auxiliary passage 4142 and/or the second auxiliary passage 4180 may not comprise first and second auxiliary valves 4186, 4182 respectively. When the first and second auxiliary passages 4142, 4180 do not comprise auxiliary valves, exhaust gas in the turbine inlet passage 4110 may freely flow into and through the first and second auxiliary passages 4142, 4180. The first and second auxiliary passages 4142, 4180 may be sized to restrict the amount of exhaust gas from the turbine inlet 4110 that is able to pass through them, for example, around 0.5%, 1%, 2%, 2.5%, or 5% of the exhaust gas in the turbine outlet passage 4110 may pass through each of the first and second auxiliary passages 4142, 4180. Restricting the amount of gas that is able to pass through the first and second auxiliary passage 4142, 4180 aids in recovering energy from the exhaust by it passing through the turbine wheel 4104, while simultaneously preventing aftertreatment pooling on surfaces of the turbine outlet passage 4114.

Finally, it will be appreciated that in alternative embodiments the dividing wall 4136 and the first auxiliary passage 4142 need not be annular in shape. That is to say, the turbine 4100 could comprise two auxiliary passages 4142, 4180 (such as the embodiment of FIG. 39) whilst the dividing wall 4136 only extends over a portion of the turbine outlet passage (such as the embodiment of FIG. 36).

FIG. 40 shows a variation to the embodiment of FIG. 39 in which the first auxiliary flow 4146 is permitted to flow over the nozzle 4124. Accordingly, the turbine 4100 does not comprise support structures, baffles or the like within the auxiliary passage 4142 surrounding the nozzle 4124. As the first auxiliary flow 4146 passes over the nozzle 4124, the shearing force of the first auxiliary flow 4146 over the nozzle 4124 prevents droplets of aftertreatment fluid coalescing in the vicinity of the nozzle 4124 and therefore keeps the nozzle 4124 clean. The shearing force of the first auxiliary flow 4146 over the nozzle 4124 may also dislodge any small solid deposits which have formed.

In general, it is preferential for all of the aftertreatment fluid to be delivered into the turbine outlet passage 4114, so as to prevent solid deposit formation in the first auxiliary passage 4142. However, as the first auxiliary flow 4146 passes over the nozzle 4124 the first auxiliary flow 4146 may deflects some aftertreatment fluid axially downstream and into the auxiliary passage 4142. However, the amount of aftertreatment fluid that passes into the auxiliary passage 4142 will be relatively small. Because the proportion of aftertreatment fluid is small, the aftertreatment fluid will readily mix with the auxiliary flow 4146 and decompose faster. Furthermore, the decomposed reductants will be more evenly distributed throughout the turbine bulk flow 4118 once the auxiliary flow subsequently merges with the turbine bulk flow 4118.

FIG. 41A shows an alternative embodiment of a turbine 4100 according to the present invention. Of the previously described alternative embodiments, the turbine 4100 of FIG. 41A is most similar to the embodiment of FIG. 36, and differs principally in that the turbine outlet passage 4114 comprises a bend 4190. It can be seen clearly in FIG. 41A that the centreline 4109 deviates away from the turbine axis 4108, whereas in the previously described alternative embodiments of the invention, the centreline 4109 is aligned with the turbine axis 4108. The bend 4190 may be necessary for example due to packaging requirements in the engine compartment.

The side wall 4116 of the turbine outlet passage 4114 defines an inner bend 4194 and an outer bend 4196. The auxiliary passage 4142 generally conforms to the shape of the inner bend 4194, such that it is correspondingly bent. As the auxiliary flow 4146 passes through the auxiliary passage 4142 the reaction force of the side wall 4116 causes its momentum to diverge away from the turbine axis 4108.

The turbine bulk flow 4118 in the turbine outlet passage 4114 typically contains one or more zones of high turbulent kinetic energy. In this context, a high turbulent kinetic energy zone is any part of the turbine outlet passage 4114 in which the local Reynolds number is around 10,000 or more. The local Reynolds number can be determined for example by calculation, and in particular by using computational fluid dynamics, or alternatively can be arrived at experimentally. It has been found that it is beneficial to inject the aftertreatment fluid into these highly turbulent zones as local recirculation of the flow promotes uniform mixing of the aftertreatment fluid with the turbine bulk flow 4118 and improves heat transfer to the aftertreatment fluid resulting in faster and more complete reductant decomposition. In some embodiments, the turbine outlet passage 4114 can be shaped to promote such turbulent kinetic energy zones, for example by comprising a diffuser portion.

Typically, for non-bent turbine outlet passages, the regions of highest turbulent kinetic energy are found within around 5 exducer diameters from the turbine wheel 4104 along the centreline 4109. Beyond this distance, the turbulent kinetic energy begins to dissipate and the flow becomes increasingly laminar. In general circumstances, it is therefore preferable that the nozzle 4124 is positioned no more than this distance downstream of the turbine wheel 4104. However, turbulent kinetic energy dissipates at a faster rate when the turbine bulk flow 4118 is forced to change direction, such as through the bend portion 4190 of the present embodiment. Accordingly, downstream of the bend portion 4190, indicated as region 4192, the turbine bulk flow 4118 has relatively low turbulent kinetic energy. It follows that it is not desirable to deliver aftertreatment fluid into the region 4192 downstream of the bend portion 4190, as sufficient mixing between the turbine bulk flow 4118 and the aftertreatment fluid will not occur.

FIG. 41B is a plot showing the variation of turbulent kinetic energy of exhaust gas, downstream of a turbine wheel, obtained from a CFD simulation conducted on a turbine 4900 where the turbine outlet passage 4114 defines a bend.

The turbine 4900 comprises a turbine housing 902 and a turbine wheel 4904 (configured to rotate about a turbine axis 4108). Downstream of the turbine wheel 4904, the turbine housing 902 defines part of a turbine outlet passage 4914. For simplicity, a dividing wall and an auxiliary passage are omitted. The turbine outlet passage 4914 defines a centreline 909. The centreline 909 is initially aligned with the turbine axis 4908, where the turbine outlet passage 4914 is generally axial. However, where the turbine outlet passage 4914 comprises a bend portion 4990, the flow axis 909 deviates away from the turbine axis 4908 so as to follow the bend 4990 of the turbine outlet passage 4914.

It is clear from FIG. 41B that a zone of high turbulent kinetic energy exists within the turbine outlet passage 4914. The zone begins at around 0.5 exducer diameters along the central axis 909 (e.g. from the most downstream point of the turbine wheel 4104), as indicated at the position shown by arrow 4918. Almost all of the exhaust gas flow in the turbine outlet passage 4914 has a high level of turbulent kinetic energy (as per the graphical legend) until a position just upstream of the bend portion 4990, as indicated by arrow 4920. The turbulent kinetic energy of the exhaust gas flow dissipates around the bend 4990. At a position just downstream of the bend 4990, as indicated by arrow 4922, only around half of the exhaust gas flow has a high turbulent kinetic energy. Further downstream, as indicated by arrow 4924, none of the exhaust gas has a high turbulent kinetic energy. As such, it is apparent that turbulence will dissipate around any bends of the turbine outlet passage or downstream.

Returning to FIG. 41A, because the turbulent kinetic energy dissipates around the bend 4190, it is preferable that the aftertreatment fluid is introduced into the turbine outlet passage 4114 before the turbine bulk flow 4118 has traversed the bend. As exemplified by FIG. 41B, it is preferable to position the nozzle 4124 so that it is no further downstream relative to the turbine wheel 4104 than the apex of the bend portion 4190. With reference to FIG. 41A, the dosing module 4122 and nozzle 4124 are positioned approximately at the apex of the bend portion 4190. The nozzle 4124 is oriented so that the spray direction 4132 faces generally towards the centreline 4109 and the dividing wall 4136. As such, when aftertreatment fluid is delivered into the turbine outlet passage 4114 it passes into a region where the turbine bulk flow 4118 still has relatively high turbulent kinetic energy.

In particular, it has been found that the nozzle 4124 should be positioned at a distance that is between around 0.5 to around 5 exducer diameters of the turbine wheel 4104 from the most downstream point of the turbine wheel 4104, when measured along the central axis 4109. When the nozzle is positioned at such distances from the turbine wheel 4104, the aftertreatment fluid will be injected into a relatively turbulent region and will therefore be better mixed with the exhaust gas. In particular, it can be seen from FIG. 41B that the high turbulence region starts around 0.5 exducer diameters from the turbine wheel 4104 and extends downstream to around 5 turbine wheel exducer diameters from the turbine wheel along the centreline 4909.

Although the turbulent kinetic energy of the turbine bulk flow 4118 is higher upstream of the bend portion 4190, it will be appreciated that not all of the region upstream of the bend portion 4190 is of high turbulence. In particular, the flow conditions in the immediate vicinity of the turbine wheel 4104 are often laminar, and the turbulent zones may not begin to form until slightly downstream of the turbine wheel 4104. To give turbulence sufficient distance from the turbine wheel 4104 to develop, it is preferable to position the nozzle at least around 0.5 or 1 exducer diameters downstream of the turbine wheel 4104 along the centreline 4109.

Finally, because the nozzle 4124 faces the dividing wall 4136, aftertreatment fluid which does not mix with the turbulent exhaust gas in the turbine outlet passage 4114 will be evaporated in the event that it impinges on dividing wall 4136. Additionally, the convex nature of the first surface 4138 provides a wider area from the perspective of the nozzle 4124 for catching aftertreatment fluid delivered by the dosing module 4122.

Although the auxiliary passage 4142 is shown to receive a portion of the turbine bulk flow 4118 from the turbine outlet passage 4114, it will be appreciated that in other embodiments, the auxiliary passage 4142 may be configured to receive a portion of the turbine bulk flow 4118 from the turbine inlet passage 4110 such as in the embodiment of FIG. 38A. It will be appreciated that the turbine 4100 may also comprise any of the features described in the embodiments shown in FIGS. 38A to 40, for example a second auxiliary passage, an annular auxiliary passage, valve members, support structures, diffuser portions or the like.

FIG. 42 shows a further embodiment of the present invention, in which the auxiliary passage 4142 defines a converging nozzle. Like the embodiments shown in FIGS. 40 to 41B, the dividing wall 4136 extends circumferentially around the centreline 4109, such that the first surface 4138 and the third surface 4166 of the dividing wall 4136 together define the entire perimeter of the turbine outlet passage 4114. Accordingly, the auxiliary passage 4142 is an annular passage, extending in an axial direction along the turbine axis 4108 in a direction away from the turbine wheel 4104. The auxiliary passage inlet 4144, like the embodiments shown in FIGS. 36, 37, 41A and 41B is configured to receive a portion of the turbine bulk flow 4118 from the turbine outlet passage 4114, and the auxiliary passage inlet 4144 is provided proximate the exducer of the turbine wheel 4104.

The side wall 4116 of the turbine housing 4102 is tapered and diverges away from the centreline 4109 at a first taper angle A14. Similarly, the dividing wall 4136 also diverges away from the centreline 4109, however this time at a second taper angle A24. The second taper angle A24 is steeper than the first taper angle A14. The first taper angle A14 is around 7° and the second taper angle A24 is around 10°. Because the dividing wall 4136 is positioned concentrically within the side wall 4116 and has a larger taper angle than the side wall 4116, the dividing wall 4136 converges towards the side wall 4116 along the centreline 4109. As such, the cross-sectional area of the auxiliary passage 4142 decreases along the centreline 4109 from the auxiliary passage inlet 4144 to the auxiliary passage outlet 4145. Accordingly, the auxiliary passage 4142 defines an annular nozzle. Due to the reduction in cross-sectional area, during use, as the auxiliary flow 4146 passes through the auxiliary passage 4142, the velocity of the auxiliary flow 4146 increases and the pressure of the auxiliary flow 4146 decreases.

The auxiliary passage outlet 4145 delivers the high velocity auxiliary flow into the turbine outlet passage 4114 in a fast-moving and generally annular auxiliary flow layer 4141 across a surface 4117 of the turbine outlet passage 4114. The auxiliary flow layer 4141 provides the same functionality as the auxiliary flow layer discussed in relation to FIGS. 13 to 32. In particular, the auxiliary flow layer 4141 provides a high-velocity high-shear layer which acts to deflect and break up any aftertreatment fluid which passes into it. Accordingly, the auxiliary flow layer 4141 mitigates against the aftertreatment fluid contacting the surface 4117 and forming deposits. In addition, the auxiliary flow layer 4141 may also be used to remove aftertreatment fluid which has settled on the surface and thereby prevent solid deposit formation.

Because the dividing wall 4136 is tapered, it will act to diffuse the turbine bulk flow 4118 and increase turbulence. In some operating conditions the expansion of the turbine bulk flow 4118 creates one or more “recirculation zones” at which the turbine bulk flow 4118 recirculates thus creating a fluidic obstruction in the flow and increase back pressure on the turbine. Such recirculation zones typically occur within the centre of the turbine outlet passage 4114 (i.e. along the centreline 4109) approximately 2 to 4 exducer diameters downstream of the turbine wheel.

To mitigate against the formation of such recirculation zones, the dividing wall 4136 therefore further comprises an auxiliary aperture 4198. The auxiliary aperture 4198 is an opening extending between the third surface 4166 and the fourth surface 4168 of the dividing wall 4136. The auxiliary aperture 4198 is positioned upstream of the nozzle 4124 of the dosing module 4122 and preferably around 2 to 4 exducer diameters downstream of the turbine wheel 4104 so that it is aligned with any possible recirculation zones. The auxiliary aperture 4198 provides a fluidic pathway from the auxiliary passage 4142 to the turbine outlet passage 4114 allowing a portion of the auxiliary flow 4146 to enter the turbine outlet passage 4114 in the vicinity of any possible recirculation zones. The auxiliary flow 4146 that has passed through the auxiliary aperture 4198 increases the turbulent kinetic energy in the recirculation zone, promoting better mixing with aftertreatment fluid injected by the nozzle 4124.

The auxiliary aperture 4198 is preferably sized such that only a portion of the auxiliary flow 4146, generally around 10% to 25%, can pass through the auxiliary aperture 4198. The remainder of the auxiliary flow 4146 continues to flow through the auxiliary passage 4142 so that it can provide sufficient heat to the dividing wall and/or to provide sufficient energy to the auxiliary flow layer 4141.

In other embodiments, the turbine 4100 may comprise a plurality of auxiliary apertures 4198. The plurality of auxiliary apertures 4198 may be axially aligned and/or axially offset from one another. The plurality of auxiliary apertures may also be circumferentially spaced from one another.

FIGS. 43A to 44B show a further embodiment of a turbine 4100 according to the present invention. The turbine 4100 of FIG. 43A is most similar in construction to the turbine of FIG. 36, and differs principally in that the dividing wall 4136 extends circumferentially around the entire perimeter of the turbine outlet passage 4114 concentric to the centreline 4109. The side wall 4116 is concentric to the dividing wall 4136 are both are tapered outwardly relative to the centreline 4109 at a common taper angle. As such, the dividing wall 4136 has a hollow frusto-conical shape and defines a diffuser portion 4120 of the turbine outlet passage 4114. The dividing wall defines a first surface 4138 on its interior side (facing towards the centreline 4109) and a second surface 4140 on its exterior side (facing away from the centreline 4109). The region of space between the second surface 4140 of the dividing wall 4136 and the side wall 4116 has the shape of a tapered annular passage.

The dividing wall comprises a proximal end 4137 relative to the turbine wheel 4104 and a distal end 4139 relative to the turbine wheel 4104. The nozzle 4124 of the dosing module 4122 is positioned between the proximal end 4137 and the distal end 4139. The dividing wall comprises an aftertreatment fluid delivery opening 4170 aligned with the nozzle 4124 through which aftertreatment fluid can be delivered to the turbine outlet passage 4114. The nozzle 4124 of the dosing module 4122 faces the first surface 4138 of the dividing wall 4136 through the aftertreatment fluid delivery opening 4170.

The dividing wall 4136 is supported by two elongate support struts 4173 extending generally parallel to the centreline 4109. The support struts 4173 extend from the proximal end 4137 and terminate at a point that is axially between the nozzle 4124 and the distal end 4139 of the dividing wall 4136 relative to the centreline 4109. The support struts 4173 are circumferentially spaced apart from one another about the centreline 4109 and are positioned symmetrically relative to a plane A-A bisecting the dosing module 4122 and nozzle 4124. In the present embodiment, the support struts are spaced approximately 120° apart from one another about the centreline 4109.

The support struts 4173 bisect the annular region of space between the second surface 4140 of the dividing wall 4136 and the side wall 4116 into two generally annular sectors. The first sector 4175 is defined between the support struts 4173 on the opposite side of the centreline 4109 to the dosing module 4122. The second sector 4177 is defined by the remainder of the region of the annular space not forming part of the first sector 4175 (i.e. between the support struts 4173 on the same side of the centreline as the dosing module 4122). As such, the second sector 4177 is generally larger than the first sector 4175.

The first sector 4175 is open at the proximal end 4137 of the dividing wall 4136 to receive a portion of the turbine bulk flow 4118 from the turbine outlet passage 4114. By contrast, the second sector 4177 is blocked at the proximal end 4137 by a baffle 4179 preventing turbine bulk flow 4118 at the proximal end 4137 of the dividing wall 4136 from entering the second sector 4177 (see FIG. 44A).

During use, turbine bulk flow 4118 will be received by the first sector 4175 between the support struts 4173, the side wall 4116 and the second surface 4140 of the dividing wall 4136. Accordingly, the first sector 4175 may be considered to define part of an auxiliary passage 4142, and the portion of the turbine bulk flow 4118 received by the first sector 4175 may be considered to define an auxiliary flow 4146. The proximal end of the first sector may be considered to define an auxiliary passage inlet 4144 The auxiliary flow 4146 will travel axially along the first sector 4175 until it reaches the terminal ends of the support struts 4173. Beyond the terminal ends of the support struts 4173, the auxiliary flow 4146 is no longer constrained to flow in the first sector 4175, and may spread circumferentially outwards and into the remainder of the annular region defined between the second surface 4140 of the dividing wall 4136 and the side wall 4116. Finally, the auxiliary flow 4146 will pass beyond the distal end 4139 of the dividing wall and into the turbine outlet passage 4114. The distal end of the annular region of space between the dividing wall 4136 and the side wall 4116 may be considered to define an auxiliary passage outlet.

Because the auxiliary flow 4146 is restricted to flowing in the first sector 4175, only the portion of the dividing wall 4136 between the support structures 4173 defining the first sector 4175 is heated. As such, only the portion of the first surface 4138 of the dividing wall 4136 opposite the nozzle 4124 is heated. Accordingly, the heat energy available in the auxiliary flow 4146 is concentrated in this region, to increase the temperature of the first surface 4138 and thereby cause evaporation of any aftertreatment fluid that impinges thereupon.

Preferably, the distal end 4139 of the dividing wall 4136 is spaced sufficiently downstream of the nozzle 4124 so that it can catch aftertreatment fluid delivered by the dosing module 4122, in a corresponding manner as explained previously above. In particular, the distal end 4139 is at least zero to around 3 turbine wheel exducer diameters downstream of the nozzle 4124 relative to the centreline 4109. As explained, the spacing of the distal end 4139 of the dividing wall 4136 form the nozzle 4124 may be chosen in dependence upon the angle of the spray direction 4136 (e.g. if the spray direction faces downstream), the velocity of the aftertreatment fluid or the turbine bulk flow 4118 or the like.

As described above, the support struts 4173 terminate at an axial position between the nozzle 4124 and the distal end 4139 of the dividing wall 4136. Preferably, the support struts terminate around half way between the nozzle 4124 and the distal end 4139 of the dividing wall 4136. However, the terminal positions of the support struts 4173 may be chosen in dependence upon the desired axial extent of the first sector 4175. In particular, the terminal positions of the support struts are preferably sufficiently downstream of the nozzle 4124 such that the hot part of the dividing wall 4136 is able to catch and evaporate aftertreatment fluid from the dosing module 4124. As such, the terminal positions of the support struts 4173 may be chosen in dependence upon the angle of the spray direction 4136 (e.g. if the spray direction faces downstream), the velocity of the aftertreatment fluid or the turbine bulk flow 4118 or the like.

In order to ensure that the portion of the dividing wall 4136 opposite the dosing module 4122 is hot enough to cause evaporation of aftertreatment fluid, the angular spacing between the support struts 4173 is preferably chosen so that it is wider than the projected region of aftertreatment fluid impingement. As such, the angular spacing between the support struts may be chosen in dependence upon the spray angle of the dosing module 4122.

Downstream of the terminal ends of the support struts 4173 the auxiliary flow 4146 flows around the entire annulus between the dividing wall 4136 and the side wall 4116. This annular region may be considered to define a portion of the auxiliary passage 4142. Because the auxiliary flow 4146 spreads circumferentially outwards in this region, the entire circumference of the dividing wall 4136 is heated. Furthermore, the auxiliary flow 4146 is evenly distributed around annulus relative to the centreline 4109 such that when it leaves the auxiliary passage outlet 4145 it creates minimal disturbance to the turbine bulk flow 4118, ensuring a smooth transition. Additionally, the auxiliary flow 4146 may form an annular auxiliary flow layer that helps to inhibit aftertreatment fluid from impinging upon the side wall 4116.

Although not shown, the second sector 4177 may be closed by a second baffle so as to prevent auxiliary flow from entering the second sector 4177. The second baffle may extend between the terminal ends of the support struts 4173.

Due to the use of the support struts 4173 and the baffle 4179, the portion of the dividing wall 4136 that is heated by the auxiliary flow 4146 can be easily modified to suit a particular need. For example, multiple pairs of support struts 4173 could be employed defining sectors therebetween which are open to receive turbine bulk flow 4118. These additional sectors can be aligned with regions of the dividing wall 4136 where aftertreatment fluid impingement is likely to take place. As such, the energy of the auxiliary flow 4146 can be concentrated by one or more pairs of support struts 4173 into localised regions based on likelihood of aftertreatment fluid impingement.

Although the described embodiment comprises a pair of support struts 4173, it will be appreciated that in alternative embodiments additional support struts may be provided, for example to provide additional structural support. The support struts 4173 may extend parallel to the centreline 4109 in a substantially straight manner, or may be angles relative to the centreline 4109 such that the support struts spiral around the centreline 4109. in general, any number or configuration of support struts or baffles may be used to concentrate auxiliary flow 4146 in locations of need or along a desired path.

In all of the embodiments above (relating to the use of a dividing wall 4136), the turbine housing 4102 may be a single monolithic housing which defines all of the turbine inlet passage 4110, turbine wheel chamber 4112 and turbine outlet 4114. Preferably, the turbine housing 4102 is made from cast iron or cast stainless steel. Where the latter is used, this reduces the chance of corrosion caused by the aftertreatment fluid. In alternative embodiments the turbine housing 4102 may comprise an assembly of two or more housing components defining portions of the turbine 4100. In particular, the turbine housing may comprise a first housing portion defining the turbine inlet passage 4110, the turbine wheel chamber 4112 and a portion of the turbine outlet passage 4114, and a second housing portion (also called a connection adapter) defining the remainder of the turbine outlet passage 4114. The first housing component may be made from cast iron and the second housing component may be made from cast stainless steel (since only the second housing component will be exposed to aftertreatment fluid). In further embodiments the turbine housing 4102 may be made from cast iron, and the turbine outlet passage 4114 may comprise a lining of stainless steel, the lining of stainless steel may define all or part of the dividing wall 4136.

FIG. 45 shows a cross-sectional side view of another embodiment of a turbine 4100 according to the present invention and FIG. 46 shows an end view of the same embodiment.

As with the previously described embodiments, the turbine 4100 also comprises a dividing wall 4136 separating the auxiliary passage 4142 from the turbine outlet passage 4114, and a dosing module 4122 configured to deliver aftertreatment fluid into the turbine outlet passage 4114. The dividing wall 4136 is generally annular in shape and tapers in the direction away from the turbine wheel 4104. As such, the dividing wall 4136 defines a diffuser for decelerating the turbine bulk flow 4118.

As best seen in FIG. 45, the turbine 4100 differs from the previously described embodiments it that it further comprises a multi-part housing assembly 4302 comprising the turbine housing 4102, a connection adapter 4304, a downpipe adapter 4306 and a downpipe 4307. In general, the use of a connection adapter 4304 that is separately formed to the turbine housing 4102 is advantageous because this allows different connection adapters to be mounted to the same turbine housing 4102 design. Different connection adapters may incorporate different features for different applications. Moreover, different connection adapters may be designed to fit within specific packaging requirements in dependence upon the design of the engine system within which they are incorporated.

The turbine housing 4102 defines the turbine inlet passage 4110, the turbine wheel chamber 4112 and part of the turbine outlet passage 4114. In particular, the turbine housing 4102 comprises a generally tapered interior surface 4113 defining an upstream portion 4114a of the turbine outlet passage 4114.

The connection adapter 4304 comprises a first end 4308 coupled to the turbine housing 4102 at a first interface 4315. The connection adapter is coupled to the turbine housing 4102 using fasteners (e.g. bolts), clips, v-bands or the like. Although not shown, the first interface may comprise a gasket to provide gas-tight sealing between the turbine housing 4102 and the connection adapter 4304.

The connection adapter 4304 comprises the dividing wall 4136, which is supported by an elongate support strut 4171 (see FIG. 46). The dividing wall 4136 is in the shape of a tapered annulus extending along the turbine axis 4108. The support strut 4171 supports the dividing wall 4136 such that the dividing wall 4136 is concentrically aligned relative to the turbine axis 4108. Although only one support strut 4171 is shown in the illustrated embodiment, it will be appreciated that in alternative embodiments substantially any number of support struts 4171 may be used.

The dividing wall 4136 defines a downstream portion 4114b of the turbine outlet passage 4114b. The dividing wall 4136 defines an opening 4310 at a proximal end relative to the turbine wheel 4104 that is open such that the downstream portion 4114b of the turbine outlet passage 4114 receives the turbine bulk flow 4118 from the upstream portion 4114a of the turbine outlet passage 4114.

The dividing wall 4136 extends into a region of space bounded by the turbine housing 4102, such that it extends axially over the first interface 4315. The dividing wall 4136 and the interior surface 4113 of the turbine housing 4102 define an upstream portion 4142a of the auxiliary passage 4142 therebetween. The upstream portion 4142a of the auxiliary passage 4142 receives a portion of the turbine bulk flow 4118 in the upstream portion 4114a of the turbine outlet passage 4114 to define the auxiliary flow 4142.

The connection adapter 4304 comprises a generally tapered interior surface 4312 concentrically arranged around the dividing wall 4136. The interior surface 4312 of the connection adapter 4302 and the dividing wall 4136 have substantially the same taper angle, such that the two are generally conical and extend parallel to one another. The dividing wall 4136 and the interior surface 4312 of the connection adapter 4302 define a middle portion 4142a of the auxiliary passage 4142 therebetween. The middle portion 4142b of the auxiliary passage 4142 receives the auxiliary flow 4146 from the upper portion 4142a.

With reference to FIG. 46, the dosing module 4122 is supported by the connection adapter 4122 such that the nozzle 4124 is substantially aligned with the interior surface 4312 of the connection adapter 4304. The dividing wall 4136 comprises an aftertreatment fluid aperture 4325 through which aftertreatment fluid is sprayed into the downstream portion 4114b of the turbine outlet passage 4114 so that it mixes with the turbine bulk flow 4118.

The downpipe adapter is 4306 is coupled to a second end 4314 of the connection adapter 4304 at a second interface 4317. The second end 4314 of the connection adapter 4304 is axially opposite the first end 4308 of the connection adapter 4304. The downpipe adapter 4306 is a generally annular ring that is weldable to a downpipe 4307 to form a permanent gas-tight connection therebetween. The downpipe adapter 4306 is coupled to the connection adapter 4304 for example using fasters, clips, v-bands or the like. The second interface 4317 may comprise a gasket (not shown) to provide a gas-tight seal between the connection adapter 4304 and the downpipe adapter 4306.

The dividing wall 4136 extends into a region of space bounded by the downpipe adapter 4306, such that it extends axially across the second interface 4317. The dividing wall 4136 and an interior surface 4319 of the downpipe adapter 4306 define a downstream portion 4142c of the auxiliary passage 4142 therebetween. The downstream portion 4142c of the auxiliary passage 4142 receives the auxiliary flow 4146 from the middle portion 4142b of the auxiliary passage 4142. A distal end of the dividing wall 4136 and the downpipe 4307 define a generally annular opening therebetween that defines an auxiliary passage outlet 4318. During use, auxiliary flow 4146 leaves the downstream portion 4142c of the auxiliary passage 4142 via the auxiliary passage outlet 4318 and continues onwards via the downpipe 309. The distal end of the dividing wall 4136 defines an opening 4311 that is configured to deliver the turbine bulk flow 4118 in the downstream portion 4114b of the turbine outlet passage 4114 to the downpipe 4307. Downstream of the distal end of the dividing wall 4136, the turbine bulk flow 4118 and the auxiliary flow 4146 merge together.

At the first and second interfaces 4315, 4317, slight misalignments between adjacent components during assembly may create surface discontinuities. These discontinuities provide a sheltered location for aftertreatment fluid to settle, whereupon it may cool and form solid deposits or surface corrosion (such as surface pitting). However, because the dividing wall 4136 extends across the first and second interfaces 4315, 4317 aftertreatment fluid that is delivered to the turbine outlet passage 4114 is prevented from reaching the interfaces 4315, 4317. As such, the dividing wall 4136 acts as a shield to prevent aftertreatment from gathering at the interfaces 4315, 4317. Therefore, the dividing wall 4136 mitigates the risk of deposit formation and corrosion caused by aftertreatment fluid settling at the interfaces 4315, 4317.

The turbine 4100 is a wastegated turbine, comprising a wastegate passage 4180 having a wastegate valve (not shown). The wastegate passage 4180 is configured to deliver exhaust gas from the turbine inlet passage 4110 to the turbine outlet passage 4114 without passing through the turbine wheel 4104. The wastegate passage 4180 is partially defined by the turbine housing 4102 and partially by the connection adapter 4304. The wastegate passage 4180 comprises a wastegate outlet 4181 defined by the connection adapter 4304. The wastegate outlet 4181 is in fluid communication with the middle portion 4142b of the auxiliary passage.

During use, when the wastegate valve is closed, the dividing wall 4136 will be heated by the turbine bulk flow 4118 in the downstream portion 4114b of the turbine outlet passage 4114 and the auxiliary flow 4146 passing through the auxiliary passage 4142. As such, any aftertreatment fluid which impinges on the first surface 4138 of the dividing wall 4136 will be heated and evaporate. When the wastegate valve is opened, wastegate flow will be delivered to the auxiliary passage 4142 such that it merges with the auxiliary flow 4146. Because the wastegate flow has not passed through the turbine wheel 4104, it will be slightly hotter than the auxiliary flow 4146 received from the upstream portion 4114a of the turbine outlet passage 4114. As such, the temperature of the auxiliary flow 4146 will be raised by the presence of the wastegate flow, thus increasing the heat energy available for causing evaporation of any aftertreatment fluid that settles on the first surface 4138.

The turbine 4100 further comprises an exhaust gas sensor 4322 configured to sense the amount of NOx in the exhaust gas which has passed through the turbine wheel 4104. In alternative embodiments, the exhaust gas sensor 4322 may be configured to measure a different property of the exhaust gas, for example velocity, pressure, temperature, the relative or absolute concentrations of one or more chemical constituents of the exhaust gas or the like. With reference to FIG. 46, the NOx sensor 4322 is supported by the connection adapter 4304. The NOx sensor 4322 comprises a sensing end 4323 that is positioned in the middle portion 4142b of the auxiliary passage 4142. As such, the NOx sensor is configured to sense the properties of the auxiliary flow 4146 within the auxiliary passage 4142. Because the sensing end 4323 of the NOx sensor 4322 is positioned in the auxiliary passage, the NOx sensor 4322 is shielded from the aftertreatment fluid delivered by the dosing module 4122 by the dividing wall 4136. As such, aftertreatment fluid is less likely to contact the NOx sensor 4322, which could potentially damage the NOx sensor and/or lead to inaccurate readings. Additionally, the NOx sensor 4322 is positioned axially upstream of the nozzle 4124. This further mitigates against aftertreatment fluid contacting and damaging the NOx sensor 4322 or leading to inaccurate readings. It will be appreciated that in alternative embodiments, the NOx sensor 4322 may be provided at any suitable position of the turbine 4100, and in some embodiments the NOx sensor 4322 may be absent.

Although the dividing wall 4136 is shown as forming part of the connection adapter 4304, it will be appreciated that in alternative embodiments the dividing wall may be a separate component to the connection adapter 4304. For example, the dividing wall 4136 may be provided as a sleeve mountable to the connection adapter 4304. In further alternatives, the dividing wall 4136 may be supported by the turbine housing 4102 and/or the downpipe adapter 4306. Because the dividing wall 4136 is likely to come into contact with aftertreatment fluid, the dividing wall 4136 may be formed from a corrosion resistant material, for example stainless steel.

Although the embodiment of FIGS. 45 and 46 comprises a wastegate assembly having a wastegate passage 4180, it will be appreciated that in other embodiments the wastegate passage 4182 may not comprise a valve member. In such embodiments, exhaust gas may freely pass through the passage 4182 from the turbine inlet passage 4110 to the turbine outlet passage 4114. In yet further embodiments, the turbine 4100 may not comprise the illustrated wastegate passage 4180.

FIG. 47 shows a schematic cross-sectional side view of another embodiment of a turbine 4100 according to the present invention. As with the previously described embodiments, the turbine 4100 comprises a dividing wall 4136 comprising a first surface 4138 which partly defines the turbine outlet passage 4114, and a second opposing surface 4140 which partly defines the auxiliary passage 4142. The auxiliary passage 4142 receives turbine bulk flow 4118 from the turbine inlet passage 4110 via a wastegate arrangement 4160 to define an auxiliary flow 4146. Because the auxiliary flow 4146 is received from upstream of the turbine wheel chamber 4112 the auxiliary flow 4146 does not pass through the turbine wheel 4104. The auxiliary passage 4142 further comprises a valve arrangement (not shown) for controlling the flow of auxiliary flow 4146 therethrough. The auxiliary passage 4142 is therefore functionally equivalent to a wastegate passage. However, in alternative embodiments the auxiliary passage 4142 may not comprise any valve arrangements, so that auxiliary flow 4146 is always permitted to flow therethrough.

The turbine outlet passage 4114 defines a diffuser portion 4120 that is configured to cause expansion of the exhaust gas in the turbine outlet passage 4114. The diffuser portion 4120 defines a centreline 4109 of the turbine outlet passage 4114 extending from the turbine axis 4108. The centreline 4109 is the line prescribed defined by the geometric centroid of the turbine outlet passage 4114. In contrast to the embodiments shown in FIGS. 36 to 38B the diffuser portion 4120 is stepped, such that the centreline 4109 of the turbine outlet passage 4114 deviates from the turbine axis 4108 along a generally s-shaped path. Accordingly, the diffuser portion 4120 may be referred to as having an offset arrangement relative to the turbine axis 4108.

The diffuser portion 4120 is partially defined by the side wall 4116 and partially by the dividing wall 4136. The side wall 4116 is shaped so that it moves radially away from the turbine axis 4108 with increasing distance from the turbine wheel 105, and the dividing wall 4136 is shaped so that it moves radially towards the turbine axis 4108 with increasing distance from the turbine wheel 105. The divergence of the side wall 4116 is larger than that of the dividing wall 4136 such that the cross-sectional area of the turbine outlet passage 4114 increases with distance from the turbine wheel 4104. The offset shape of the diffuser portion 120 may be necessary for packaging requirements in the engine compartment.

The turbine 4100, comprises a dosing module 4124 configured to deliver aftertreatment fluid into the turbine outlet passage 4114. The dosing module 4122 is positioned approximately half way along the stepped part of the side wall 4116 defining the diffuser portion 4120. At this position, the dosing module 4122 is less than around 4 exducer diameters form the turbine wheel 4104, however the dosing module 4122 could be positioned at any suitable location depending upon packaging requirements. Due to the stepped shape of the diffuser portion 4120, at the position half way along the stepped part of the side wall 4116 the dosing module 4122 has a more central position when looking downstream along the remainder of the turbine outlet passage 4114. As such, the dosing module 4122 can be oriented so that it points in a generally downstream direction. With reference to FIG. 47, the angle of the dosing module 4122 relative to the turbine axis 4108 is approximately 45°. However, in alternative embodiments steeper or shallower angles may be used. Because the dosing module 4122 points in a downstream direction, the aftertreatment fluid has a relatively large proportion of its momentum in the same direction as the turbine bulk flow 4118. As such, the aftertreatment fluid is more readily carried downstream and mixed with the turbine bulk flow 4118.

As shown in FIG. 47, the dividing wall 4136 extends to a position downstream of the dosing module 4122. In particular, the dividing wall 4136 comprises a distal end 4139 that is positioned at least around 1 or 2 exducer diameters downstream of the nozzle 4124 of the dosing module 4122 along the centreline 4109. Because the dividing wall 4136 extends beyond the position of the nozzle 4124 of the dosing module 4122 relative to the centreline 4109, the dividing wall 4136 forms a barrier preventing aftertreatment fluid from entering the auxiliary passage 4142. Aftertreatment fluid which enters the auxiliary passage 4142 via the auxiliary passage outlet 4145 may cool and solidify, which could cause damage to the wastegate valve. Furthermore, during use when the wastegate valve is open the dividing wall 4136 will be heated by the auxiliary flow 4146. As such, any aftertreatment fluid which impinges on the first surface 4138 will evaporate and thus deposit formation within the turbine outlet passage 4114 is mitigated.

In general terms, any housing components of the turbine 4100 that are likely to come into contact with aftertreatment fluid, such as for example the side wall 4116 of the turbine outlet passage 4114, the dividing wall 4136 or the like are at risk of corrosion. As such, these components may be may be at least partly formed from, or lined with, stainless steel. It is also advantageous to provide a stainless steel surface at any bends and/or diverging portions (e.g. diffusers) in the turbine outlet passage where aftertreatment fluid is likely to impinge. This may be achieved, for example, by way of a stainless steel lining, or by manufacturing the relevant bend or diffuser from stainless steel. Furthermore, stainless steel linings may advantageously be provided at any joints or interfaces between components defining the turbine outlet passage. For example, a stainless steel sleeve may be provided between the turbine housing and the connection adapter to reduce the risk of corrosion at the joint line therebetween. A stainless steel sleeve may at least in part define the dividing wall 4136, or may in some embodiments be provided in addition to the dividing wall 4136.

FIG. 48 shows a schematic cross-sectional view of a turbine 5100 according to an embodiment of the present invention. The turbine 5100 comprises a turbine housing 5102 and a turbine wheel 5104 supported by a turbocharger shaft 5106 and configured to rotate about a turbine axis 5108. The turbine housing 5102 defines a turbine inlet passage 5110, a turbine wheel chamber 5112 and a turbine outlet passage 5114. The turbine inlet passage 5110 is configured to receive exhaust gas from an internal combustion engine (not shown). The exhaust gas received from the internal combustion engine by the turbine inlet passage 5110 defines a turbine bulk flow 5118. The turbine inlet passage 5110 is in the shape of a volute configured to encourage swirling of the turbine bulk flow about the turbine axis 5110. The illustrated turbine 5100 comprises a single volute, however in alternative embodiments the turbine may comprise more than one volute, as described below in relation to FIG. 50.

The turbine wheel chamber 5112 is configured to receive the turbine bulk flow 5118 from the turbine inlet passage 5110. When the turbine bulk flow 5118 passes through the turbine wheel chamber 5112, it impinges upon blades (not shown) of the turbine wheel 5104 thus causing the turbine wheel 5104 to rotate and drive the turbocharger shaft 5106. The turbine wheel 5104 re-directs the turbine bulk flow 5118 so that it flows in an axial direction relative to the turbine axis 5108 and delivers the turbine bulk flow 5118 to the turbine outlet passage 5114. As such, the turbine 5100 is a so-called “radial” turbine. However, in alternative embodiments the turbine 5100 may be an “axial” turbine in which exhaust gas flows in a generally axial direction from the turbine inlet 5110 passage to the turbine outlet passage 5114.

The turbine outlet passage 5114 comprises a generally tapered side wall 5116 which defines a diffuser portion 5120 configured to cause expansion of the exhaust gas in the turbine outlet 5114. The side wall 5116 is outwardly tapered at an angle of around 7°, however in alternative embodiments any suitable taper angle may be used. The diffuser portion 5120 is symmetrically centred on the turbine axis 5108, such that the turbine axis 5108 defines a centreline 5109 of the turbine outlet passage 5114. However, in alternative embodiments the diffuser portion 5120 may have any suitable shape. In such embodiments, the centreline 5109 may be defined by the centroid of the turbine outlet passage 5114 relative to the direction of the turbine bulk flow 5118. Accordingly, the centreline 5109 may bend or otherwise diverge away from the turbine axis 5108 in dependence upon the shape of the turbine outlet passage 5114. In yet further embodiments, the turbine may not comprise a diffuser, such that the turbine outlet passage is generally a cylindrical shape.

The turbine 5100 further comprises a dosing module 5122 configured to deliver an exhaust gas aftertreatment fluid to the turbine outlet passage. The aftertreatment fluid is, in particular, diesel exhaust fluid (DEF) and is commonly available under the trade mark AdBlue. The dosing module 5122 comprises a nozzle 5124 in fluid flow communication with the turbine outlet passage 5114. The nozzle 5124 is, in particular, an atomising nozzle configured to generate a substantially atomised spray of aftertreatment fluid within the turbine outlet passage 5114. The nozzle 5124 generates a generally conical spray pattern defining a spray region 5128, however in alternative embodiments substantially any suitable spray pattern may be used (for example fan-shaped etc.). The spray pattern has a spray angle A1 of 55°, however in alternative embodiments substantially any suitable spray angle A1 may be used, for example 30° or 45°.

The aftertreatment fluid is sprayed into a spray region 5128 of the turbine outlet passage 5114. The spray region 5128 encompasses the spatial region in which the atomised spray of aftertreatment fluid has a larger component of velocity in the spray direction 132 than in the direction of the turbine bulk flow 5118. The atomised spray of aftertreatment fluid leaving the nozzle 5124 has almost all of its velocity in the spray direction 132 or inclined relative to the spray direction 132 by up to half of the spray angle A1. However, as the atomised spray of aftertreatment fluid travels laterally across the turbine outlet passage 5114 (i.e. in a direction normal to the turbine bulk flow 5118), interaction between the aftertreatment fluid and the turbine bulk flow 5118 changes the direction of the atomised spray of aftertreatment fluid until the aftertreatment fluid flows entirely in the direction of the turbine bulk flow 5118 (i.e. until the aftertreatment fluid is “carried away” by the momentum of turbine bulk flow 5118). The spray region 5128 corresponds to the portion of the turbine outlet passage 5114 in which the individual droplets of aftertreatment fluid carry more momentum from the dosing module 5122 than from the turbine bulk flow 5118. Accordingly, the geometry of the spray region 5128 is a property of the delivery strength of the dosing module 5128 relative to the momentum of the turbine bulk flow 5118. For the sake of simplicity, the spray region 5128 is illustrated in FIG. 48 as a conical region. However, it will be appreciated that due to the interaction between the turbine bulk flow 5118 and the aftertreatment fluid explained above the spray region 5128 will not, in reality, have a completely conical shape (see for example FIGS. 2A and 2B).

The dosing module 5122 is positioned and oriented so that the spray region 5128 is close to the outlet of the turbine wheel 5104. In general, the temperature of the turbine bulk flow 5118 will be hotter closer to the turbine wheel 5104 than at any position downstream due transient dissipation. Since heat energy is required to cause decomposition of the aftertreatment fluid, it is preferable for the spray region to be as close to the turbine wheel 5104 as possible. In particular, it is preferable for the dosing module 5122 to be positioned and oriented so the nozzle 5124 or at least a portion of the spray region 5128 is within around 10 exducer diameters D from the turbine wheel 5104 along the centreline 5109; the exducer diameter D being the diameter of the exducer portion of the turbine wheel 5104. In alternative embodiments the dosing module 5122 may be positioned and oriented so that the nozzle 5124 or at least a portion of the spray region 5128 is within around 2, 3, or 5 exducer diameters D from the turbine wheel 5104 along the centreline 5109. Depending upon the orientation of the dosing module 5122, in some embodiments this may be achieved by positioning the hole 126 within the same distances along the centreline 5109 as set out above. It is preferable that aftertreatment fluid does not enter the turbine wheel chamber 5112 as it may impinge upon the turbine wheel 5104 which could lead to deposit formation on the turbine wheel. Deposit formations on the turbine wheel could cause rotational imbalance of the turbine wheel, and the ammonia may corrode the turbine wheel. Accordingly, it is preferable that the spray region 5128 is positioned entirely downstream of the turbine wheel chamber 5112 (i.e. so that it does not overlap with the turbine wheel chamber 5112).

The turbine 5100 further comprises an auxiliary passage 5136 having an auxiliary passage inlet 5138 and an auxiliary passage outlet 5140. The auxiliary passage 5136 is defined by an elongate conduit of the turbine housing 5102 extending between the auxiliary passage inlet 5138 and the auxiliary passage outlet 5140. However, in other embodiments the auxiliary passage may be formed at least in part from components separate to the turbine housing 5102, for example external tubing or the like. A side wall of the turbine housing 5102 defining the turbine inlet passage 5110 (and, in particular, the volute) comprises an opening that defines the auxiliary passage inlet 132. Likewise, the side wall 5116 of the turbine outlet passage 5114 comprises an opening that defines the auxiliary passage outlet 5140.

During use, the auxiliary passage 5136 receives a portion of the turbine bulk flow 5118 from the turbine inlet passage 5110 via the auxiliary passage inlet 5138. The portion of the turbine bulk flow 5118 received by the auxiliary passage 5136 defines an auxiliary flow 5142. The auxiliary flow passes through the auxiliary passage 5136 and into the turbine outlet passage 5114 via the auxiliary passage outlet 5140. The auxiliary passage outlet 5140 is positioned upstream of the nozzle 5124 of the dosing module 5122. The auxiliary flow 5142 will disturb the turbine bulk flow 5118 when it enters the turbine outlet passage 5114. By positioning the auxiliary passage outlet 5140 upstream of the nozzle 5124, turbulence may be established in the turbine outlet passage before the aftertreatment fluid is injected. As such, the aftertreatment fluid will be better mixed with the turbine bulk flow 5118. In some embodiments, the auxiliary passage outlet 5140 may be positioned adjacent to the nozzle such that the auxiliary flow is delivered over the nozzle 5124 to keep the nozzle clean of aftertreatment fluid.

The auxiliary passage 5136 further comprises a chamber 5144 within which an exhaust gas sensor 5146 is disposed. The exhaust gas sensor 5146 is, specifically, a Nitrogen Oxide (NOx) sensor, configured to determine the relative and/or absolute concentrations of NOx in the auxiliary flow 5142. In particular, the exhaust gas sensor is a Vitesco NOx sensor generation 2.8, however alternatively the sensor may be a Vitesco NOx sensor generation 4. Also suitable for use are Bosch Mobility Solutions NOx sensor and Denso Denso 05L907807AC NOx sensor. However, NOx sensors of other designs and from other manufacturers would also be suitable. However, in alternative embodiments the exhaust gas sensor may be substantially any suitable sensor type that is configured to detect one or more physical parameters of the auxiliary flow 5142. This may include the relative and/or absolute concentrations or one or more other chemicals in the auxiliary flow, for example carbon dioxide or the like. Additionally or alternatively, the exhaust gas sensor could be configured to detect physical parameters of the auxiliary flow such as temperature, pressure, velocity, mass, volumetric flow rate, mass flow rate, or the like.

In operation, the exhaust gas sensor 5146 detects not only the presence of NOx in the exhaust gas but also the presence of the reductants from the aftertreatment fluid, and in particular ammonia NH₃ and isocyanic acid HNCO. During use, the dosing module 5122 injects aftertreatment fluid into the turbine outlet passage. If the exhaust gas sensor 5146 was positioned within the turbine outlet passage 5114, there could be a risk that aftertreatment fluid reductants would be sensed by the exhaust gas sensor 5146 in addition to the NOx. Such contamination would result in an inaccurately high NOx reading, which could cause the controller (e.g. controller 5222 described below) to introduce more aftertreatment fluid into the bulk flow than is required. Additionally there is a risk that the sensor could be damaged by the ammonia from the aftertreatment fluid, which is corrosive). Additionally, any liquid contacting the exhaust gas sensor 5146 could cause thermal shock to the sensor. However, because the auxiliary passage 5136 of the present invention receives fluid from a position upstream of the auxiliary passage outlet 5114, the chance that the auxiliary flow 5142 to which the exhaust gas sensor 5146 will be contaminated with aftertreatment fluid is almost entirely eliminated. In particular, due to the movement of the turbine bulk flow 5118 from the turbine inlet passage 5110 to the turbine outlet passage 5114 via the turbine wheel chamber 5112, it is extremely unlikely that any aftertreatment fluid would make its way into the turbine wheel chamber 5112 or the turbine inlet passage 5110. As such, the accuracy and reliability of the reading of the exhaust gas sensor 5146 is improved.

As described above, aftertreatment fluid is very unlikely to travel upstream against the turbine bulk flow 5118 from the turbine outlet passage 5114 and into the turbine wheel chamber 5122. Therefore, in alternative embodiments of the invention the auxiliary passage 5136 may receive fluid from substantially any suitable position of the turbine 5100 upstream of the turbine outlet passage 5114. For example, the turbine wheel chamber 5112 may comprise an orifice defining the auxiliary passage inlet 5138, such that the auxiliary passage 5136 is able to receive exhaust gas that has spilled over the tips of the turbine blades. Additionally or alternatively, if the turbine 5100 is a variable geometry turbine, the auxiliary passage 5136 may receive fluid from a part of the variable geometry arrangement. For example, in the case of a moving wall variable geometry turbine, the auxiliary passage may receive fluid that would otherwise leak over the tips of the nozzle vanes. As such, the auxiliary passage 5136 may be connected to a shroud cavity holding a shroud plate which receives the nozzle vanes.

The chamber 5144 is a portion of the auxiliary passage having an enlarged cross-sectional flow area compared to the remainder of the auxiliary passage 5136. The presence of the chamber 5144 affords a region of space sufficiently large enough to accommodate the exhaust gas sensor 5146. Additionally, the enlarged cross-sectional area of the chamber 5144 decelerates the auxiliary flow 5142. If the velocity of the auxiliary flow 5142 is too fast, this can lead to inaccurate measurements and runs the risk of damaging the sensor. Therefore decelerating the flow reduces or prevents such inaccuracies and/or damage.

The auxiliary passage 5136 is substantially free from flow restrictors or valves that would choke or selectively prevent flow from the auxiliary passage inlet 5138 to the auxiliary passage outlet 5140. As such, the auxiliary passage 5136 functions as a full-duty bypass around the turbine wheel 5104. That is to say, the auxiliary passage 5136 is operable to deliver the auxiliary flow 5142 to the spray region 5128 at all operating conditions of the turbine 5100. Accordingly, this ensures that there is always a supply of auxiliary flow 5142 which can be sensed by the exhaust gas sensor 5146. Accordingly, accurate exhaust gas readings can be taken continuously during use of the turbine 5100.

It will be appreciated that because the auxiliary flow 5142 does not pass through the turbine wheel 5104, the auxiliary flow 5142 results in a corresponding drop in efficiency of the turbine 5100. As such, the cross-sectional area of the auxiliary passage 5136 is chosen so that the auxiliary flow 5142 is a relatively small proportion of the turbine bulk flow 5118. For example, the cross-sectional area of the auxiliary passage 5136 may be chosen so that the mass flow rate of the auxiliary flow 5142 is around 0.1%, 0.2%, 0.3%, 0.4%, 0.5% 1%, 1.5%, 2%, 5% or 10% of the mass flow rate of exhaust gas entering the turbine inlet 5110 (i.e. the mass flow rate of exhaust gas leaving the engine). It has been found that by limiting the flow rate of the auxiliary flow accordingly, the drop in efficiency of the turbine can be reduced to an acceptable level. Typically, the drop in efficiency at the flow rates above is less than around 1% or 2%.

The auxiliary passage 5136 may define a constant cross-sectional area along its entire length, or the cross-sectional area of the auxiliary passage 5136 may vary along the length of the auxiliary passage. Where the cross-sectional area of the auxiliary passage 5136 varies, the flow rate of the auxiliary flow can be controlled by appropriately sizing the narrowest portion of the auxiliary passage 5136.

Once the auxiliary flow 5142 has passed the exhaust gas sensor 5146, it is then delivered into the turbine outlet passage 5114 by the auxiliary passage outlet 5140. The auxiliary flow 5142 can be used to provide substantially any of the same effects discussed in relation to the other turbine structures disclosed herein and the turbine 5100 may comprise corresponding structures. In particular, the auxiliary flow 5142 can be used to clean the nozzle 5124 of the dosing module 5122, to increase turbulent mixing of aftertreatment fluid in the spray region 5128, to form an auxiliary flow layer (which optionally may induce swirling motion), to heat a dividing wall where fluid impingement is likely to take place, or substantially any combination of such uses.

Although the turbine 5100 described above is depicted as a fixed-geometry turbine, it will be appreciated that in alternative embodiments of the invention the turbine 5100 may comprise a variable geometry mechanism configured to alter the available flow area into or out of the turbine wheel chamber 5112.

Preferably, the turbine housing 5102 is made from cast iron or cast stainless steel. Where the latter is used, this reduces the chance of corrosion caused by the aftertreatment fluid. For simplicity, the turbine 5100 of FIG. 48 is illustrated as having a single integrally formed turbine housing 5102 which defines all of the turbine inlet passage 5110, turbine wheel chamber 5112 and turbine outlet 5114. In alternative embodiments the turbine housing 5102 may comprise an assembly of two or more housing components defining portions of the turbine 5100. In particular, the turbine housing may comprise a first housing portion defining the turbine inlet passage 5110, the turbine wheel chamber 5112 and a portion of the turbine outlet passage 5114, and a second housing portion (also referred to as a connection adapter) defining the remainder of the turbine outlet passage 5114. The first housing component may be made from cast iron and the second housing component may be made from cast stainless steel (since only the second housing component will be exposed to aftertreatment fluid). In further embodiments the turbine housing 5102 may be made from cast iron, and the turbine outlet passage 5114 may comprise a lining of stainless steel or another suitable corrosion-resistant material.

Although the turbine 5100 described above has a single auxiliary passage inlet 5138 and a single auxiliary passage outlet 5140, it will be appreciated that in alternative embodiments the turbine 5100 May have substantially any number of inlets 5138 and outlets 5140.

In a further embodiment, the auxiliary passage inlet 5138 may be positioned in the turbine inlet passage 5110 so that it receives the auxiliary flow 5142 from the turbine inlet passage 5110, and the auxiliary passage outlet 5140 may also be positioned in the turbine inlet passage so that the auxiliary flow is delivered back into the turbine inlet passage 5110. This provides the advantage that none of the auxiliary flow 5142 bypasses the turbine wheel 5104, and therefore the power output from the turbine wheel 5104 is higher. However, in such embodiments it may be necessary to shield the exhaust gas sensor 5146 from high pressure pulses emanating from the engine, for example by using one or more orifice places positioned in the auxiliary passage 5136. In a further embodiment, the turbine may be part of a two-stage turbine system, and the auxiliary passage 5136 may receive the auxiliary flow 5142 from the turbine inlet of a first turbine and deliver the auxiliary flow to the turbine inlet of a second turbine positioned in fluid communication with and downstream of the turbine outlet passage of the first turbine.

FIG. 49 shows a further embodiment of the turbine 5100. The turbine 5100 of FIG. 49 is substantially identical to FIG. 48, and differs only in the manner described below. The turbine 5100 comprises a wastegate arrangement 5148 configured to regulate the flow through the auxiliary passage 5136. In contrast to the previous embodiment, the auxiliary passage 5136 has a bifurcated structure comprising a leakage passage 5150 and a wastegate passage 5152 which lead to a plenum 5154. The leakage passage 5150 defines a first auxiliary passage inlet 5138a and the wastegate passage 5152 defines a second auxiliary passage inlet 5138b both of which are in fluid communication with the turbine inlet passage 5110. The plenum 5154 terminates in an auxiliary passage outlet 5140 which is in fluid communication with the turbine outlet passage 5114.

The leakage passage 5150 is substantially free of valve or closures such that it always permits fluid to leak from the turbine inlet passage 5110 to the plenum 5154 (and subsequently to the turbine outlet passage 5114) across all operating conditions of the turbine 5100. As such, the leakage passage 5150 is preferably sized in the same proportions as the auxiliary passage 5136 described above in relation to FIG. 48. Therefore, the auxiliary flow 5142 passing through the leakage passage 5150 does not cause a significant drop in the efficiency of the turbine 5100 during operation.

The wastegate page 5152 is regulated by a wastegate valve 156. In the present embodiment, the wastegate valve 156 is a flap-type valve, however in alternative embodiments the wastegate valve 156 may be substantially any suitable type of valve, for example a rotary barrel valve, poppet valve or the like. The wastegate valve 156 is configured to selectively permit or prevent fluid flow through the wastegate passage 5152. In contrast to the leakage passage 5150, the function of the wastegate passage 5150 is to permit a significant proportion of the incident turbine bulk flow 5118 to bypass the turbine wheel 5104 and to cause a large drop in the efficiency of the turbine 5100. By doing so, the speed of rotation of the shaft 5106 can be reduced so that choke or surge events on the compressor end are avoided. As such, wastegate passage 5136, plenum 5154 and auxiliary passage outlet 5140 may be chosen so that the maximum allowable flowrate therethrough is large enough to provide sufficient wastegating functionality. For example, the wastegate passage 5136 may be sized so that the mass flow rate of the auxiliary flow may be at least around 25% to around 50% of the mass flow rate of exhaust gas entering the turbine inlet 5110.

The exhaust gas sensor 5146 is disposed within the plenum 156 in proximity to the flow through the leakage passage 5150. During use, because the leakage passage 5150 always permits flow therethrough, this ensures that there is always a sufficient amount of flow available for the exhaust gas sensor 5146 to produce reliable readings. However, because the turbine 5100 of FIG. 49 also comprises a wastegate passage 5152, this means that the speed of the shaft 5106 can also be controlled.

Although the embodiment of FIG. 49 comprises a leakage passage 5150 that is a separate passage to the wastegate passage 5152, it will be appreciated that in alternative embodiments the wastegate arrangement 5148 may define the leakage passage 5150 as part of the wastegate valve 156 itself. For example, the wastegate valve 156 may comprise leakage holes which pass therethrough or grooves formed in the outside of the valve preventing the valve from fully blocking the auxiliary flow 5142. Additionally or alternatively, the portion of the housing against which the wastegate valve seals (i.e. the valve seat) may comprise leakage holes or grooves having the same effect. Further still the wastegate arrangement 5148 may be controlled so that it does not fully close during use.

FIG. 50 shows a further embodiment of the turbine 5100. The turbine 5100 of FIG. 50 is substantially identical to the turbine 5100 of FIG. 48 described above, and differs only in the manner described below. The turbine 5100 of FIG. 50 comprises a turbine inlet passage 5110 having a first volute 5110a and a second volute 5110b which are separated by a volute divider 5158. The first and second volutes 5110a, 5110b receive flow from separate cylinder banks within the internal combustion engine system of which the turbine forms a part. The first and second volutes 5110a, 5110b are arranged in side-by-side fashion so that they are coextensive about the turbine axis 5106. As such, the turbine is a so-called “twin-volute” or “axially divided” turbine. In alternative embodiments the volutes may be angularly staggered about the turbine axis 5108 so as to define a so-called “dual-volute” or “circumferentially divided” turbine.

The auxiliary passage inlet 5138 is positioned in fluid communication with the first inlet volute 5110a. As such, auxiliary flow 5142 is only taken from the first volute 5110a and not from the second volute 5110b. Due to the presence of the volute divider 5158, any disturbances to the turbine bulk flow 5118 in the first volute 5110a are not passed on to the second volute 5110b. By connecting the auxiliary passage 5136 to only the first inlet volute 5110a, this provides a geometry that is relatively easy to manufacture, and reduces the amount of space required.

FIG. 51 discloses an internal combustion engine system 5200 comprising an internal combustion engine 5202, a turbocharger 5204 and an exhaust gas aftertreatment system 206. The turbocharger 5204 comprises a compressor 5208 and a turbine 5210 connected via a turbocharger shaft 5212. The internal combustion engine 5202 and turbocharger 5204 are configured in the same manner as described above in relation to FIG. 1. However, in contrast to the disclosure of FIG. 1, the turbine 5210 is a turbine according to the present invention as described above in relation to FIGS. 48 to 50.

As described previously, the turbine 5210 comprises a diffuser portion 5214, an auxiliary passage 5216, an exhaust gas sensor 5218, and a dosing module 5220. As previously described, the auxiliary passage 5216 extends between the turbine inlet passage and the turbine outlet passage (comprising the diffuser portion 5214). The exhaust gas sensor 5214 is disposed along the auxiliary passage 5216 to sense a physical property of the auxiliary flow flowing therethrough. The dosing module 5220 is positioned in fluid communication with the diffuser portion 5214 to deliver an atomised spray of aftertreatment fluid to the diffuser portion 5214.

The exhaust gas sensor 5218 and the dosing module may also be considered to form part of the aftertreatment system 206 (as well as part of the turbine). The aftertreatment system 206 further comprises a controller 5222 and a selective catalytic reduction (SCR) catalyst 5224. The controller 5222 is in information receiving communication with the exhaust gas sensor 5218 to obtain information relating to a physical parameter of the auxiliary flow from the sensor 5218. The information from the exhaust gas sensor 5218 may be obtained actively due to the sensor 5218 transmitting a signal to the controller 5222, or passively by the controller measuring a property of the sensor 5218 such as electrical impedance, resistance, current flow, voltage or the like. Such information may be received electrically, for example along one or more electrical signal lines, or via any other suitable means of communication including wireless or optical transmission or the like.

The controller 5222 is in control communication with the dosing module 5220. The dosing module is configured to adjust the rate of delivery of aftertreatment fluid to the turbine outlet passage in dependence upon a control signal received from the controller 5222. This may include turning the dosing module 5220 on or off, or adjusting the flow rate of aftertreatment fluid into the turbine outlet passage when the dosing module 5220 is delivering aftertreatment fluid to the turbine outlet passage (i.e. when it is on). The control signal from the controller 5222 may be sent to the dosing module 5220 as a signal along one or more electrical signal wires. Alternatively, the controller 5222 may comprise power electronics that are configured to supply power to and control the dosing module 5220. The control signals may be transmitted electrically, or via any other suitable means of communication including wireless or optical transmission or the like.

During use, exhaust gas that is mixed with aftertreatment fluid in the diffuser portion 5214 is passed to the SCR catalyst. The SCR catalyst 5224 converts NOx contained in the exhaust gas to non-harmful substances. The amount of aftertreatment fluid required to convert the NOx into non-harmful substances using the SCR catalyst 5224 is proportional to the amount of NOx in the exhaust gas. That is to say, if the engine produces more NOx (for example at higher engine speeds), then more aftertreatment fluid is required, and vice versa.

In order to determine the amount of aftertreatment fluid required to convert the NOx in the exhaust gas, the controller 5222 receives information from the exhaust gas sensor 5218 regarding the relative and/or absolute concentration of NOx in the exhaust gas. The controller 5222 then makes a determination regarding whether the current rate of delivery of aftertreatment fluid into the turbine outlet passage is too high or too low relative to the measured concentration of NOx in the exhaust gas. The controller 5222 then sends a control signal to the dosing module 5220 to adjust (or maintain) the rate of aftertreatment fluid delivery accordingly. As such, it can be ensured that the correct amount of aftertreatment fluid is mixed with the exhaust gas to ensure successful NOx conversion in the SCR catalyst 5224.

It will be appreciated that the control of the dosing module 5220 and the rate of delivery of aftertreatment fluid may also be dependent upon other parameters of the exhaust gas as measured by the exhaust gas sensor 5218. For example, the aftertreatment fluid could be adjusted in dependence upon the velocity of the exhaust gas sensed by the sensor 5218, since this may be indicative of an increase in engine speed. Additionally or alternatively, the controller 5222 may be configured to control the operation of the dosing module in dependence upon information other than that received from the sensor 5218. For example, the controller 5222 may be configured to start or stop the dosing module 5220 at a specific point in time following engine ignition.

FIG. 52 shows a computational fluid dynamics model of an exhaust gas aftertreatment system 6100 comprising a turbine 6102 and an exhaust gas passage 6104. Specifically, FIG. 52 shows the relative concentration of exhaust gas aftertreatment that has been introduced into the exhaust gas passage 6104 at different locations of the exhaust gas passage 6104.

The turbine 6102 comprises a turbine inlet passage (not shown) configured to receive exhaust gas from an internal combustion engine (not shown). The exhaust gas received by the turbine inlet passage defines a bulk flow. The turbine 6102 further comprises a turbine wheel chamber (not shown) configured to receive the bulk flow from the turbine inlet passage. The turbine wheel chamber contains a turbine wheel (not shown) supported for rotation about a turbine axis 6106. The turbine further comprises a turbine outlet passage 6108 configured to receive the bulk flow from the turbine wheel chamber. The turbine outlet passage 6108 extends symmetrically along the turbine axis 6106 and is generally conically shaped so as to define a diffuser. However, in alternative embodiments the turbine outlet passage 6108 may be generally straight (such that it does not comprise a diffuser). The turbine 6102 comprises a dosing module 6110 configured to deliver an atomised spray 6112 of aftertreatment fluid into the turbine outlet passage 6108. The dosing module 6110 is oriented in a generally downstream direction in relation to the bulk flow through the turbine outlet passage 6108. However, in alternative embodiments the dosing module 6110 may be oriented in substantially any direction relative to the bulk flow.

The turbine outlet passage 6108 is connected to an upstream end of the exhaust gas passage 6104. The exhaust gas passage 6104 is a hollow conduit configured to route the bulk flow from the turbine passage outlet 6108 to one or more aftertreatment components, such as for example a particulate filter, selective catalytic converter, diesel oxidation catalyst or the like. The exhaust gas passage 6104 defines a centreline 6114, which extends along the geometric centroid of the exhaust gas passage 6104. The exhaust gas passage 6104 comprises a first straight portion 6116 fluidly connected to the turbine outlet passage 6108. The first straight portion 6116 is fluidly connected to a first bend 6118, which is in turn connected in sequence to a second straight portion 6120, a second bend 6122, a third straight portion 6124, a third bend 6126, a fourth straight portion 6128, a fourth bend 6130 and an outlet portion 6132. It will be appreciated that in alternative embodiments the exhaust gas passage 6104 may have any shape and configuration, and that in particular the shape and configuration of the exhaust gas passage 6104 will depend upon the packaging requirements of the engine. As such, the precise number, length, and shape of the straight portions and bends will depend upon the packaging requirements.

FIG. 53 shows the relative concentration of aftertreatment fluid in the exhaust gas passage 6104 for a cross-section of the exhaust gas passage 6104 through plane 6134 of FIG. 52. Plane 6134 is positioned at an interface between the first straight portion 6116 and the first bend 6114, and is downstream of the dosing module 6110. As shown in FIG. 53, the aftertreatment fluid injected into the exhaust gas passage 6104 by the dosing module 6110 exhibits a high concentration in the portion of the exhaust gas passage 6104 generally opposite the dosing module 6110. This is because the momentum imparted on the aftertreatment fluid by the dosing module 6110 carries the aftertreatment fluid across the exhaust gas passage 6104. The region of high concentration defines a predicted aftertreatment fluid concentration zone 6135.

In the present context, the aftertreatment fluid concentration zone 6135 is a three dimensional region in which the concentration of aftertreatment fluid is higher than a particular threshold. Such a threshold may be chosen in dependence upon the specific requirements of the engine system. In one embodiment, the aftertreatment fluid concentration zone may be a region in which the concentration of aftertreatment fluid is higher the average concentration of aftertreatment fluid throughout the exhaust gas passage 6104 as a whole. That is to say, a region in which the concentration of aftertreatment fluid is higher than the concentration that would be expected if the aftertreatment fluid was uniformly dispersed throughout the exhaust gas passage 104. It has been found that if the aftertreatment fluid is entirely uniformly distributed throughout the bulk flow the relative concentration of the aftertreatment fluid is around 1.5% by volume of the bulk flow. Accordingly, the aftertreatment fluid concentration zone 6135 may be any region in which the aftertreatment fluid is at least 1.5% by volume of the bulk flow.

Alternatively, a more stringent measure may be applied. In particular, a high concentration of aftertreatment fluid may be a region in which the concentration of aftertreatment fluid is at least around 50%, around 100%, around 150% or around 200% more than the expected concentration of aftertreatment fluid in the exhaust gas passage when the aftertreatment fluid is uniformly distributed. The aftertreatment fluid concentration zone may therefore encompass a spatial region in which the concentration of aftertreatment fluid is at least 2.25%, around 3%, around 3.5%, around 4% or around 5% by volume of the bulk flow.

FIG. 54 shows the relative concentration of aftertreatment fluid in the exhaust gas passage 6104 for a cross-section of the exhaust gas passage 6104 through plane 6136 of FIG. 52. Plane 6136 is positioned at an interface between the second straight portion 6120 and the second bend 6122. As shown in FIG. 54, the predicted aftertreatment fluid concentration zone 6135 is spread generally annularly around the circumference of the exhaust gas passage 6104 and has reduced in overall size compared to FIG. 53. This occurs due to a combination of factors. First, the swirling momentum imparted on the bulk flow by the turbine wheel causes the aftertreatment fluid to spread radially outwards under centrifugal force. Secondly, the first bend 6118 changes the direction of the momentum of the aftertreatment fluid. Finally, since plane 6138 is further downstream compared to plane 6134, the aftertreatment fluid at the fringes of the predicted aftertreatment fluid concentration zone 6135 has dispersed within the exhaust gas, causing the size of the aftertreatment fluid concentration zone to reduce.

FIG. 55 shows the relative concentration of aftertreatment fluid in the exhaust gas passage 104 for a cross-section of the exhaust gas passage 6104 through plane 6140 of FIG. 52. Plane 6140 is positioned at an interface between the second bend 6122 and the second straight portion 6124. As shown in FIG. 55, the predicted aftertreatment fluid concentration zone 6135 is generally concentrated in a portion of the exhaust gas passage 6104 that corresponds to the radially outermost part of the bend 6122. This occurs due to the second bend 6122 changing the direction of the momentum of the aftertreatment fluid. Additionally, more of the aftertreatment fluid at the fringes of the predicted aftertreatment fluid concentration zone 6135 has dispersed due to the increased distance of plane 6140 form the dosing module 6110.

FIG. 56 shows the relative concentration of aftertreatment fluid in the exhaust gas passage 6104 for a cross-section of the exhaust gas passage 6104 through plane 6142 of FIG. 52. Plane 6142 is positioned at an interface between the third straight portion 6124 and the third bend 6126. As shown in FIG. 56, the size of the predicted aftertreatment fluid concentration zone 6135 is much smaller than in the previous figures and is distributed around the circumference of the passage 6104.

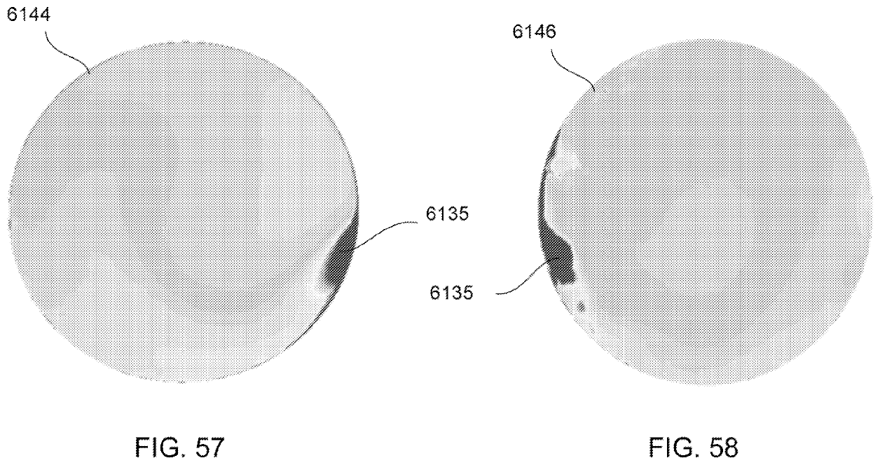

FIG. 57 shows the relative concentration of aftertreatment fluid in the exhaust gas passage 6104 for a cross-section of the exhaust gas passage 6104 through plane 6144 of FIG. 52. Plane 6144 is positioned at an interface between the fourth straight portion 6128 and the fourth bend 6130. As shown in FIG. 57, the predicted aftertreatment fluid concentration region 6135 has grown in size in comparison to plane 6142. This is due to the influence of the third bend 6126, which has deflected the flow through the exhaust gas passage 6104 and cause a localised concentration of aftertreatment fluid close to the circumference of the passage 6104.

FIG. 58 shows the relative concentration of aftertreatment fluid in the exhaust gas passage 6104 for a cross-section of the exhaust gas passage 6104 through plane 6146 of FIG. 52. Plane 6146 is positioned in the outlet portion 6132. As shown in FIG. 58, a predicted aftertreatment fluid concentration zone 6135 exists close to the circumference of the passage 6104. If this predicted aftertreatment fluid concentration zone is not diluted, there is a risk that the catalyst will not receive an even distribution of aftertreatment fluid.

With reference to the above, it can be seen that the aftertreatment fluid travels through the exhaust gas passage along streamlines. Accordingly, the predicted aftertreatment fluid concentration zone streaks, twists, and bends around the geometry of the exhaust gas passage 6104 as it gradually dissipates.

During use, it is desired to disperse the aftertreatment fluid as evenly as possible throughout the exhaust gas passage 6104 before the bulk flow is delivered to any downstream aftertreatment components such as catalysts, and in particular selective catalytic reducers (SCR). If aftertreatment fluid is not uniformly distributed throughout the bulk flow when the bulk flow enters the SCR, some portions of the SCR will not receive enough aftertreatment fluid to support the necessary chemical reactions to remove NOx from the bulk flow (i.e. they will be too lean), whilst other portions of the SCR will have too much aftertreatment fluid (i.e. they will be too rich).

In order to promote more uniform dispersion of aftertreatment fluid throughout the exhaust gas passage 6104, an auxiliary flow may be introduced into the predicted aftertreatment fluid concentration zone. The auxiliary flow is a portion of the bulk flow that has been siphoned off from an upstream position and which is then delivered to the exhaust gas passage 6104. Preferably, the auxiliary flow is a bypass flow, for example a wastegate flow, that is routed around the turbine wheel from a position upstream of the turbine wheel. However, in alternative embodiments the auxiliary flow may be taken from substantially any suitable location of the turbine 6102 or the exhaust gas passage 6104. The auxiliary flow is typically contained within an auxiliary passage (not shown), which may be formed by one or more conduits external to the exhaust gas passage 6104. Preferably, the auxiliary flow is free from aftertreatment fluid.

During use, when the auxiliary flow is delivered into the predicted aftertreatment fluid concentration zone, the momentum of the auxiliary flow will disturb the aftertreatment fluid in the predicted aftertreatment fluid concentration zone, causing the aftertreatment fluid to become turbulent and to mix with the exhaust gas in the bulk flow. Additionally, because the auxiliary flow does not comprise aftertreatment fluid, the auxiliary flow will act to dilute the aftertreatment fluid so that it becomes more evenly dispersed throughout the bulk flow. Accordingly, the auxiliary flow will reduce the size and shape of the predicted aftertreatment fluid concentration zone until eventually the predicted aftertreatment fluid concentration zone no longer exists at the location determined by the computational model. As such, uniform mixing of aftertreatment fluid with the exhaust gas can be more readily achieved. The present invention therefore enables predicted aftertreatment fluid concentration zones that are determined in a computational model to be mitigated in a real world system by introducing an auxiliary flow in an appropriate location of the exhaust gas passage in the real world system.

The predicted aftertreatment fluid concentration zone 6136 is considered to be “predicted” in the sense that its size and shape are determined using a model. The model may be a physical model (i.e. a “real life” model), for example within an engine test cell. Additionally or alternatively, the model may be computational model. For example, the predicted aftertreatment fluid concentration zone may be predicted using computational fluid dynamics software solving a mathematical model of fluid behaviour, for example the Navier-Stokes equations or the like, for a discretised spatial mesh corresponding to the geometry of the exhaust gas passage 104. Once the size, shape and location(s) of the predicted aftertreatment fluid concentration zone are known, the design of the exhaust gas passage can be modified so that auxiliary flow is introduced into the predicted aftertreatment fluid concentration zone. However, as explained above, due to the introduction of the auxiliary flow the predicted aftertreatment fluid concentration zone will diminish or disappear entirely. Accordingly, the predicted aftertreatment fluid concentration zone may not physically exist in the “real-life” exhaust gas aftertreatment system 6100. However, when the auxiliary flow is taken from a wastegate arrangement, because the wastegate arrangement will not be open at all operating conditions of the turbine 6102 it will be appreciated that the auxiliary flow will also not flow in all operating conditions of the turbine. Accordingly, there may be some operating conditions in which the predicted aftertreatment fluid concentration zone does, in fact, exist in real life (i.e. as an aftertreatment fluid concentration zone).

It has been found that predicted aftertreatment fluid concentration zones are more likely to form when there is some form of non-linearity in the exhaust gas passage. Such non-linearities include, for example, changes in pipe width, tapered and stepped pipe sections, bends, weld seams, pipe joints, the presence of turbulators or bluff bodies in the turbine bulk flow, or the like. Such non-linearities tend to result in stagnation or recirculation zones at which aftertreatment fluid collects, such as for example in the predicted aftertreatment fluid concentration zone of FIG. 55, which occurs after the second bend 6122. Additionally any geometries which would act to slow the bulk flow would also generally act to cause the aftertreatment fluid to re-group and form a predicted aftertreatment fluid concentration zone. This may include steps, stators, mixers, vanes, or pipe contractions.

It is not necessary to introduce the auxiliary flow so that the point of introduction is exactly aligned with the non-linearity, and in fact some misalignment along the centreline 6114 may be tolerated. Preferably however, the auxiliary flow is introduced to the exhaust gas passage within around 5 turbine wheel exducer diameters (i.e. the diameter of the exducer of the turbine wheel of the turbine 6102) of the non-linearity. In such cases, the auxiliary flow is introduced close enough to the non-linearity to exchange momentum with the aftertreatment fluid at a position where an aftertreatment fluid concentration zone is likely to occur. In alternative embodiments, the auxiliary passage may be configured to deliver the auxiliary flow into the predicted aftertreatment fluid concentration zone at a position within around 3, around 2, or around 1 exducer diameters of the bend along the centreline. In general terms, the closer that the auxiliary flow is delivered to the non-linearity the more effective it will be at dispersing the predicted aftertreatment fluid concentration zone caused by the non-linearity. The auxiliary flow may be delivered upstream or downstream of the non-linearity.

For example, with reference to FIG. 55 (plane 6140), due to the presence of the second bend 6122 the aftertreatment fluid has formed a predicted aftertreatment fluid concentration zone 6136 on the radially outer side of the second bend 6122. Because it is desirable to disperse the aftertreatment fluid evenly throughout the entire cross-section of the exhaust gas passage 6104, the exhaust gas passage 6104 can be modified so that auxiliary flow is introduced into the aftertreatment fluid concentration zone 6136 at this location. This can be achieved, for example, by placing an opening of the auxiliary passage in the vicinity of the plane 6140 on the outside of the second bend 6122 so that auxiliary flow flows directly into the predicted aftertreatment fluid concentration zone. The plane 6136 may be considered to define a proximal end of second bend 6122 and the plane 6140 may be considered to define a distal end of the second bend 6122. The opening of the auxiliary passage may be positioned at the distal end of the second bend 6122 as this is the position at which the predicted aftertreatment fluid concentration zone has grown to its largest extent.

Where the non-linearity is a bend, it will be appreciated that, in general, the larger the bend the more likely a predicted aftertreatment fluid concentration zone is to form. The magnitude of the bend can be measured by comparing the angular relationship between an inlet vector of the bend and an outlet vector of the bend. The inlet vector is the vector defined along the centreline 6114 at the start of the bend, and the outlet vector is the vector defined by the centreline 6114 at the end of the bend. It has been found that bends having an angle of at least around 30° are more likely to result in the formation of a predicted aftertreatment fluid concentration zone. Therefore, the auxiliary flow may be introduced at a bend having an angle of around 30°. An example of such a bend is the first bend 6118 of the exhaust gas passage 6104. However, in alternative embodiments, auxiliary flow may be introduced at a bend having an angle of at least around 45°, around 60°, around 75°, or around 90°. The second bend 6122, for example, is a bend of around 90°.

The auxiliary flow may be delivered to the auxiliary passage in any suitable direction. The direction at which the auxiliary passage delivers the auxiliary flow into the exhaust gas passage can be configured based upon the geometry of the auxiliary passage. It is generally preferable that the auxiliary flow is delivered in a direction that has a significant component of velocity in a direction perpendicular to the centreline 6114. In particular, the auxiliary passage may deliver the auxiliary flow into the exhaust gas passage in an auxiliary flow direction that is inclined relative to the centreline by at least around 15°. In alternative embodiments, the auxiliary flow direction may be inclined at an angle of at least around 30°, around 45°, around 60°, around 75°, or around 90° relative to the centreline 6114. In general, the steeper the relative angle between the auxiliary flow direction and the centreline 6114, the more turbulence that is generated by momentum exchange between the auxiliary flow and the bulk flow. Increased turbulence in the bulk flow acts to disperse the aftertreatment fluid, and therefore mitigates against the formation of predicted aftertreatment fluid concentration zones.

FIG. 59 is a further computational fluid dynamics model of the exhaust gas aftertreatment system 6100 showing the likelihood of impingement of exhaust gas aftertreatment fluid on the internal surfaces (i.e. walls) of the exhaust gas passage 6104 at different locations of the exhaust gas passage 6104. The model is shown from the perspective of the outside of the exhaust gas passage 6104. It has been found that in regions closer to the dosing module 6110, for example within around 5 or 10 exducer diameters along the centreline 6114 from the turbine wheel a large proportion of aftertreatment fluid exists as large diameter droplets. Such large diameter droplets are more massive than smaller droplets, and therefore carry more momentum.

As shown in FIG. 59, an aftertreatment fluid impingement risk zone 6150 is formed on the opposite side of the turbine outlet passage 6108 to the dosing module 6110. In general, a predicted aftertreatment fluid impingement risk zone includes any region of the inside of the exhaust gas passage 6104 and turbine outlet passage 6108 where the momentum of the aftertreatment fluid will cause it to collide with the walls such that some of the fluid will remain behind in a film layer. This may be quantified as any location where the rate of aftertreatment fluid impingement by mass is more than around the average rate of impingement by mass for the exhaust gas passage 6104 as a whole. Alternatively, a more stringent measure may be applied. In particular, an aftertreatment fluid impingement risk zone may be a region in which the rate of impingement of aftertreatment fluid by mass is at least around 50%, around 100%, around 150% or around 200% more than the rate of impingement of aftertreatment fluid by mass in the exhaust gas passage as a whole. Additionally or alternatively embodiments, the impingement risk can be determined based upon other parameters such as for example wall temperature, wall film thickness (e.g. of impinged aftertreatment in a real-life model), or by using deposit risk metrics that are common within computational fluid dynamics software packages (e.g. a unitless kinetics-based calculation).

It is known that isocyanic acid is a catalyst for deposit initiation in aftertreatment systems. Accordingly, in the context of predicting aftertreatment fluid impingement risk zones, it will be appreciated that the term “aftertreatment fluid” encompasses not only the starting components of urea and water, but also the products derived therefrom and in particular ammonia and isocyanic acid.

In the case of the aftertreatment fluid impingement risk zone 6150, this zone forms due to the momentum imparted on the aftertreatment fluid by the dosing module 6110 carrying the aftertreatment fluid across the turbine outlet passage 6108 where it will impinge upon the internal surfaces of the turbine outlet passage 6108. In particular, the larger droplets will not be deflected by the bulk flow, and are therefore more likely to impinge on the walls of the exhaust gas passage 6104.

FIG. 60 shows a portion of the computational fluid dynamics model of FIG. 59 from a similar perspective to FIG. 52. It can be seen that a further predicted aftertreatment fluid impingement risk zone 6152 exists on the top of the exhaust gas passage 6104 in the vicinity of the first bend 6118. This is due to the swirling motion imparted on the bulk flow by the turbine wheel carrying the aftertreatment fluid in a spiral-like motion along the exhaust gas passage 6104. Again, the bulk flow is less able to overcome the momentum of the larger droplets, and therefore the larger droplets are likely to impinge on the walls in this area.

With continued reference to FIG. 60, it can be seen that another predicted aftertreatment fluid impingement risk zone 6154 exists downstream of the first bend 6118 generally across the interface between the first bend 6118 and the second straight portion 6120. As the bulk flow flows over the outside of the first bend 6118, its direction changes. However, because the larger droplets of aftertreatment fluid carry a relatively large amount of momentum, the bulk flow is unable to deflect the aftertreatment fluid and therefore the aftertreatment fluid is likely to impinge on the radially outer part of the first bend 6118 at the distal end of the first bend relative to the turbine wheel.

With reference again to FIG. 59, it can be seen that yet another predicted aftertreatment fluid impingement risk zone 6156 is formed on the outer radius of the second bend 6122. As the bulk flow travels down the second straight portion 6120, the exhaust gas directs the momentum of the aftertreatment fluid towards the second bend 6122. Once again, the bulk flow is unable to deflect the larger droplets of aftertreatment fluid, which then impinge upon the outer part of the second bend 6122 towards the distal end of the second bend.

The presence of such predicted aftertreatment fluid impingement risk zones can be determined using computational fluid dynamics and/or by real-life modelling in an engine test cell. Such aftertreatment fluid impingement risk zones are undesirable since aftertreatment fluid which impinges on the walls of the exhaust gas passage may solidify and cause a blockage. It has been found that the auxiliary flow can be introduced into the exhaust gas passage in the predicted aftertreatment fluid impingement risk zones to prevent or mitigate the amount of aftertreatment fluid which reaches the surfaces of the exhaust gas passage.

In one embodiment, the auxiliary flow may be introduced in an auxiliary flow layer in a substantially corresponding manner to that described above in relation to FIGS. 13 to 32 and may therefore comprise corresponding features. In particular, the auxiliary passage may comprise an auxiliary passage outlet and may be configured such that when the auxiliary flow enters the exhaust gas passage 6104 it passes over the internal surfaces of the exhaust gas passage 6104 in an auxiliary flow layer. The auxiliary passage outlet is preferably positioned at least partially upstream of one of the predicted aftertreatment fluid impingement risk zones 6150, 6152. By positioning the auxiliary passage outlet slightly upstream of the predicted aftertreatment fluid impingement risk zones 6150, 6152 it can be ensured that the auxiliary flow layer passes over at least a portion of the predicted aftertreatment fluid impingement risk zones 6150, 6152. The auxiliary flow layer therefore acts to deflect aftertreatment fluid away from the predicted aftertreatment fluid impingement risk zones. Additionally, the auxiliary flow layer acts to re-entrain any aftertreatment fluid that has collected on the surfaces of the exhaust gas passage 6104 in these zones. Finally, the auxiliary flow layer acts to spread out any aftertreatment fluid that has impinged on the wall, therefore enabling it to evaporate faster. Accordingly, the risk of deposit formation on the walls can be reduced.

In another embodiment, the aftertreatment system 6100 can be modified to include an auxiliary passage which receives an auxiliary flow which is delivered to the exhaust gas passage. The exhaust gas passage can be modified to include a dividing wall which defines a part of the auxiliary passage and a part of the exhaust gas passage. In particular, the dividing wall may have a first surface which defines part of the exhaust gas passage and may have a second surface which defines part of the auxiliary passage. Accordingly, the dividing wall arrangement is substantially similar in construction and operation to that discussed in relation to FIGS. 36 to 47, and may therefore comprise corresponding features.

In particular, the dividing wall can be positioned so that the first surface of the dividing wall defines a portion of the internal surfaces of the exhaust gas passage that is at least in part covered by an aftertreatment fluid impingement risk zone. That is to say, the dividing wall can be positioned so that the first surface is at the location of an aftertreatment fluid impingement risk zone. By positioning the dividing wall at an aftertreatment fluid impingement risk zone, any aftertreatment fluid which impinges upon the first surface will be heated by heat from the auxiliary flow that has heated the dividing wall. Accordingly, the impinged aftertreatment fluid will be evaporated, thus mitigating against the risk of deposit formation. Furthermore, downstream of the dividing wall, the auxiliary flow may form an auxiliary flow layer that passes over the surfaces of the exhaust gas passage. Accordingly, the dividing wall is also able to provide the same benefits as the embodiment using an auxiliary flow layer described above.

Preferably, the dividing wall should define a wall thickness that is relatively thin in comparison to the diameter of the exhaust gas passage and the exducer of the turbine. The thinner the dividing wall, the more effective it will be at promoting heat transfer therethrough. In particular, the dividing wall should be between around 1% to around 40% of the diameter of the exducer of the turbine wheel, and preferably no more than around 10%.

It has been found that non-linearities in the exhaust gas passage 6104 often result in the formation of aftertreatment fluid impingement risk zones. In particular, locations such as bends are particularly susceptible to the formation of aftertreatment fluid impingement risk zones, for the reasons described above in relation to zones 6150, 6152, 6154, and 6156. Therefore, the auxiliary flow may be introduced in an auxiliary flow layer at a bend so that it passes over a predicted aftertreatment fluid impingement risk zone. In general terms, the steeper the bend the more likely a predicted aftertreatment fluid impingement risk zone is to form, due to the bulk flow requiring more energy to deflect the larger droplets of aftertreatment fluid. It has been found that bends having an angle of at least around 30° are more likely to result in the formation of a predicted aftertreatment fluid impingement risk zone. Therefore, the auxiliary flow may be introduced at a bend having an angle of around 30°. An example of such a bend is the first bend 6118 of the exhaust gas passage 6104. However, in alternative embodiments, auxiliary flow may be introduced at a bend having an angle of at least around 45°, around 60°, around 75°, or around 90°. The second bend 6122, for example, is a bend of around 90°.

Additionally, other non-linearities may cause impingement zones, and in particular the inclusion of bluff bodies in the flow, changes in diameter of the exhaust gas passage, weld seams, pipe joints or any other features which would deflect the momentum of the bulk flow are likely to result in aftertreatment fluid impingement. Furthermore, impingement is also more likely in stagnation and recirculation zones that are caused by the above geometries. Accordingly, the auxiliary flow may be introduced in these regions such that it flows in an auxiliary flow layer that flows over any predicted aftertreatment fluid impingement risk zones, or a dividing wall heated by an auxiliary flow may be placed at the same locations.

As discussed in relation to the predicted aftertreatment fluid concentration zone, it will be appreciated that the predicted aftertreatment fluid impingement risk zone is considered to be “predicted” in the sense that its size and shape are determined using a computational or physical model. Once the size, shape and location(s) of the predicted aftertreatment fluid impingement risk zones are known, the design of the exhaust gas passage can be modified so that auxiliary flow is introduced in an auxiliary flow layer over one or more of the predicted aftertreatment fluid impingement risk zones. However, due to the introduction of the auxiliary flow the predicted aftertreatment fluid impingement zone will diminish or disappear entirely. Accordingly, the predicted aftertreatment fluid concentration zone may not physically exist in “real-life” the exhaust gas aftertreatment system 6100. It should further be noted that when the auxiliary flow is taken from a wastegate arrangement, because the wastegate arrangement will not be open at all operating conditions of the turbine 6102 the auxiliary flow will also not flow in all operating conditions of the turbine. Accordingly, there may be some operating conditions in which the predicted aftertreatment fluid impingement risk zone does, in fact, exist in real life. However, when a dividing wall is used it will be appreciated that the aftertreatment fluid will impinge upon the dividing wall during use, and therefore the aftertreatment fluid impingement risk zone is not a “predicted” one, and can be identified during use for example due to deposits, pitting, staining or the like.

As has been described in detail above, an auxiliary flow can be introduced into the turbine outlet passage to provide various benefits. For example the auxiliary flow can be introduced: (i) so that it passes through a spray region of aftertreatment fluid as per FIGS. 1 to 12 and the accompanying description; (ii) in an auxiliary flow layer that passes over a surface of the turbine outlet passage as per FIGS. 13 to 32 and the accompanying description; (iii) in a direction opposite the swirl direction of the turbine bulk flow as per FIGS. 33 to 35 and the accompanying description; (iv) so that it heats a dividing wall of the turbine outlet passage as per FIGS. 36 to 47 and the accompanying description.

In further embodiments, the auxiliary passage may comprise multiple branches, and each branch of the auxiliary passage may be configured to deliver the auxiliary flow flowing through that branch into the turbine outlet passage so that it provides one of the benefits described in the list above. As such, it is possible to provide a turbine having a combinations of the structures above so as to provide different combinations of the associated advantages. In particular, this enables the turbine to use a specific structure at a specific location to provide particular benefit, whilst using other structures elsewhere in the turbine outlet passage to provide other benefits. For example, where a bend is present I may be advantageous to use the auxiliary flow to heat a dividing wall where aftertreatment fluid is likely to impinge, whilst also using an auxiliary flow layer at another location for example opposite a dosing module. In each case, the auxiliary flow may be a bypass flow that bypasses the turbine wheel, or the auxiliary flow may be received from a position downstream of the turbine wheel.

In particular, the first branch may be structured so that the auxiliary flow provides passes through a spray region of aftertreatment fluid as per FIGS. 1 to 12 and the accompanying description, and the second branch may be structured: so that the auxiliary flow is introduced in an auxiliary flow layer that passes over a surface of the turbine outlet passage as per FIGS. 13 to 32 and the accompanying description, so that the auxiliary flow is introduced in a direction opposite the swirl direction of the turbine bulk flow as per FIGS. 33 to 35 and the accompanying description, or so that the auxiliary flow heats a dividing wall of the turbine outlet passage as per FIGS. 36 to 47 and the accompanying description.

Likewise, the first branch may be structured so that so that the auxiliary flow is introduced in an auxiliary flow layer that passes over a surface of the turbine outlet passage as per FIGS. 13 to 32 and the accompanying description, and the second branch may be structured so that: the auxiliary flow is introduced so that it passes through a spray region of aftertreatment fluid as per FIGS. 1 to 12 and the accompanying description; the auxiliary flow is introduced in a direction opposite the swirl direction of the turbine bulk flow as per FIGS. 33 to 35 and the accompanying description; or the auxiliary flow is introduced so that it heats a dividing wall of the turbine outlet passage as per FIGS. 36 to 47 and the accompanying description.

Furthermore, the first branch may be structured so that the auxiliary flow is introduced in a direction opposite the swirl direction of the turbine bulk flow as per FIGS. 33 to 35 and the accompanying description, and the second branch may be structured so that: the auxiliary flow is introduced so that it passes through a spray region of aftertreatment fluid as per FIGS. 1 to 12 and the accompanying description; the auxiliary flow is introduced in an auxiliary flow layer that passes over a surface of the turbine outlet passage as per FIGS. 13 to 32 and the accompanying description; or the auxiliary flow is introduced so that it heats a dividing wall of the turbine outlet passage as per FIGS. 36 to 47 and the accompanying description.

Finally, the first branch may be structured so that the auxiliary flow is introduced so that it heats a dividing wall of the turbine outlet passage as per FIGS. 36 to 47 and the accompanying description, and the second branch may be structured so that: the auxiliary flow is introduced so that it passes through a spray region of aftertreatment fluid as per FIGS. 1 to 12 and the accompanying description, the auxiliary flow is introduced in an auxiliary flow layer that passes over a surface of the turbine outlet passage as per FIGS. 13 to 32 and the accompanying description, or the auxiliary flow is introduced in a direction opposite the swirl direction of the turbine bulk flow as per FIGS. 33 to 35 and the accompanying description.

As a further alternative, the turbine may comprise two or more separate auxiliary passages. The first auxiliary passage may perform the same function and have a corresponding structure to the first branches described above, and the second auxiliary passage may perform the same function and have a corresponding structure to the second branches described above. Both auxiliary passages may be bypass passages that bypass the turbine wheel, and which may contain valves. Alternatively, only one of the auxiliary passages may be a bypass passage that bypass the turbine wheel, and which may contain a valve. The other auxiliary passage may receive auxiliary flow from a different position, for example from within the turbine outlet passage.

FIG. 61 shows a further embodiment of a turbine 7000. The turbine 7000 comprises a turbine housing 7002, a turbine wheel (not shown), a wastegate arrangement 7004, a connection adapter 7006, a dosing module 7008, and a NOx sensor 7010.

The turbine housing 7002 defines a pair of inlet volutes 7012 and a turbine wheel chamber 7014. In other embodiments, the turbine housing 7002 may define a single inlet volute. Although the turbine wheel is not shown, it will be appreciated that during use the turbine wheel sits within the turbine wheel chamber 7014 where it is supported for rotation relative to the turbine housing 7002 by a shaft (not shown) about a turbine axis 7015. Exhaust gas received from an internal combustion engine (not shown) is delivered via the inlet volutes 7012 to the turbine wheel chamber 7014 whereupon the momentum of the exhaust gas impacts the blades of the turbine wheel to generate rotation of the turbine wheel and shaft.

The connection adapter 7006 is connected to the turbine housing 7002 such that the turbine housing 7002 and connection adapter 7006 in combination define part of a turbine outlet passage 7016. The turbine outlet passage 7016 receives exhaust gas that has passed through the turbine wheel from the turbine wheel chamber 7014. The turbine outlet passage 7016 comprises a first portion 7018 that extends axially in relation to the turbine axis 7015, and a second portion 7020 that is angled relative to the first portion 7018 along an adapter flow axis 7021. The angular difference between the first and second portions 7018, 7020 (i.e. between the turbine axis 7015 and the adapter flow axis 7021) is approximately 30°, however this may be varied to suit any particular packaging requirements. In some embodiments, the second portion 7020 of the turbine outlet passage 7016 may be completely axial relative to the turbine axis 7015 such that it does not comprise any relatively angled portions.

The first portion 7018 of the turbine outlet passage 7016 is defined by the turbine housing 7002 and the second portion 7020 of the turbine outlet passage 7016 is defined by the connection adapter 7006. The second portion 7020 of the turbine outlet passage 7016 receives exhaust gas from the first portion 7018. The first portion 7018 comprises a first diffuser section 7022 and the second portion 7020 comprises a second diffuser section 7024. The first and second diffuser sections 7022, 7024 are regions of the turbine housing 7002 and connection adapter 7006 respectively in which the flow area of the turbine outlet passage 7016 (i.e. the cross-sectional area relative to the direction of flow) increases with distance from the turbine wheel.

The wastegate arrangement 7004 comprises a wastegate passage 7026 that extends between the turbine inlet volutes 7012 and the turbine outlet passage 7016. The wastegate arrangement 7004 further comprises a pair of wastegate valves 7028 which cover respective valve openings (not shown) so as to selectively permit or prevent the flow of exhaust gas through the wastegate passage 7026. The valve openings connect separately to each of the 7012 inlet volutes. The wastegate valves 7028 are mounted to a common actuator (not shown) and are controlled in unison. However, in alternative embodiments, the valves may be controlled separately. The valve openings are generally the same size, however in alternative embodiments the valve opening may be asymmetric. Moreover, the valve openings may be operated using a single valve head rather than a pair of valves 7028. During use, when the wastegate valves 7028 are open, exhaust gas from the inlet volutes 7012 is bypassed to the turbine outlet passage 7016 without passing through the turbine wheel chamber 7014 and turbine wheel.

The wastegate passage 7026 is partially defined by the connection adapter 7006. In particular, the wastegate passage 7026 joins the connection adapter 7006 at a wastegate passage outlet 7030. The wastegate passage outlet 7030 is defined in a side wall 7035 of the connection adapter 7006 and is positioned approximately at the apex of the angular bend defined between the first and second portions 7018, 2020 of the turbine outlet passage 7016 (i.e. approximately at the point at which the adapter flow axis 7021 intersects the turbine axis 7015). The wastegate passage 7026 defines a wastegate flow axis 7032 at the wastegate passage outlet 7030. The wastegate flow axis 7032 defines the direction of flow of exhaust gas from the wastegate passage 7026 as it joins the turbine outlet passage 7020. In the present embodiment, the wastegate flow axis 7032 is angled relative to the adapter flow axis 7021 by approximately 45°. However, in alternative embodiments substantially any angle may be used.

With reference to FIGS. 61 and 63, the connection adapter 7006 comprises a mount 7034 for the dosing module 7008. The mount 7034 defines an opening 7036 within which a nozzle 7038 of the dosing module 7008 is received. The nozzle 7038 is positioned so that it is radially outwards of the side wall 7035 of the connection adapter 7006. However in other embodiments the nozzle 7038 may be substantially aligned with the side wall of the connection adapter 7006. The opening 7036 is positioned within the second diffuser section 7024. The nozzle 7038 is configured to generate a spray of aftertreatment fluid which is directed into the turbine outlet passage 7016 along a spray axis 7040. The spray axis 7040 is angled at around 7° downstream relative to a normal to the adapter axis 7021, however in other embodiments the spray axis 7040 may be angled at a different angle to the adapter axis 7021, for example normal to the adapter axis 7021. The spray of aftertreatment fluid defines a spray region 7042, the presence of which is shown schematically by dotted lines in FIGS. 61 and 63.

The mount 7034 and opening 7036 for the dosing module 7008 are positioned on substantially the opposite side of the turbine outlet passage 7016 to the wastegate passage outlet 7030. Moreover, the mount 7034 and opening 7036 for the dosing module 7008 are positioned downstream of the wastegate passage outlet 7030. The position of the wastegate passage outlet 7030 relative to the spray region 7042 and the angle of the wastegate flow axis 7032 relative to the spray region 7042 are such that, during use, when the wastegate valves 7028 are open, exhaust gas that has passed through the wastegate passage 7026 is directed into the spray region 7042 so that it fluidically exchanges momentum with the injected aftertreatment fluid. Accordingly, it will be appreciated that the embodiment of FIGS. 61 to 64 is a further example of a turbine according to the first aspect of the invention.

The mount 7034 and opening 7036 for the dosing module 7008 are positioned within and/or form part of the connection adapter 7006. However, in alternative embodiments the mount 7034 and opening 7036 for the dosing module 7008 may be positioned within and/or form part of the turbine housing 7002. Because the mount 7034 and opening 7036 for the dosing module 7008 are positioned within the connection adapter 7006 or the turbine housing 7002, this means that the dosing module 7008 is positioned close to the turbine wheel. Accordingly this means that the injected aftertreatment fluid may take advantage of high exhaust gas temperatures which aid evaporation and decomposition. In this regard, the mount 7034, opening 7036 and dosing module 7008 are preferably positioned within a distance of no more than around 10 turbine wheel exducer diameters downstream of the turbine wheel (preferably no more than around 5 exducer diameters, and more preferably no more than around 3 exducer diameters). In this context, a turbine wheel exducer diameter is the diameter of the exducer portion of the turbine wheel, which is approximately equal to the diameter of the narrowest portion of the first diffuser section 7022. In the illustrated embodiment the mount 7034, opening 7036 and dosing module 7008 are positioned at a distance of around 3.3 exducer diameters downstream of the downstream end of the turbine wheel chamber (and wheel).

The connection adapter 7006 comprises a sensor conduit 7044 having a sensor conduit inlet 7046 configured to receive an aliquot of exhaust gas from the turbine outlet passage 7016 and sensor conduit outlet 7048 configured to re-introduce exhaust gas from the sensor conduit 7044 to the turbine outlet passage 7016. The sensor conduit 7044 defines a flow area that is larger than the size of the sensor conduit inlet 7046. Accordingly, the sensor conduit 7044 acts to decelerate the exhaust gas passing therethrough. The sensor conduit comprises a mount 7050 configured to receive the NOx sensor 7010. The NOx sensor 7010 comprises a sensing tip 7052 which protrudes into the interior of the sensor conduit 7044. Because the geometry of the sensing conduit 7044 decelerates the exhaust gas passing therethrough, the sensing tip 7052 is exposed to lower velocity exhaust gas, thus reducing the risk of damage to the sensing tip 7052 and improving the accuracy of sensor readings.

With reference to FIG. 61, the sensor conduit inlet 7046 is positioned upstream of the opening 7036 for the dosing module 7008. Accordingly, the risk of aftertreatment entering the sensor conduit 7044 and adversely affecting readings taken by the NOx sensor 7010 is eliminated. The sensor conduit 7044 is part of the second diffuser section 7024. However, in alternative embodiments the sensor conduit 7044 may be part of the first diffuser section 7022.

FIG. 65 shows a further embodiment of a turbine 8000. The turbine 8000 comprises a turbine housing 8002, a turbine wheel (not shown), a variable geometry mechanism (not shown), a connection adapter 8006, a dosing module 8008, and a NOx sensor 8010.

The turbine housing 8002 defines an inlet volute 8012 and a turbine wheel chamber 8014. In other embodiments, the turbine housing 8002 may define more than one inlet volute 8012. Although the turbine wheel is not shown, it will be appreciated that during use the turbine wheel sits within the turbine wheel chamber 8014 where it is supported for rotation relative to the turbine housing 8002 by a shaft (not shown) about a turbine axis 8015. Exhaust gas received from an internal combustion engine (not shown) is delivered via the inlet volute 8012 to the turbine wheel chamber 8014 whereupon the momentum of the exhaust gas impacts the blades of the turbine wheel to generate rotation of the turbine wheel and shaft.

The connection adapter 8006 is connected to the turbine housing 8002 such that the turbine housing 8002 and connection adapter 8006 in combination define part of a turbine outlet passage 8016. The turbine outlet passage 8016 receives exhaust gas that has passed through the turbine wheel from the turbine wheel chamber 8014. The turbine outlet passage 8016 comprises a first portion 8018 is defined by the turbine housing 8002, and a second portion 8020 that is defined by the connection adapter 8006. The second portion 8020 of the turbine outlet passage 8016 receives exhaust gas from the first portion 8018. The first portion 8018 comprises a first diffuser section 8022 and the second portion 8020 comprises a second diffuser section 8024. The first and second diffuser sections 8022, 8024 are regions of the turbine housing 8002 and connection adapter 8006 respectively in which the flow area of the turbine outlet passage 8016 (i.e. the cross-sectional area relative to the direction of flow) increases with distance from the turbine wheel. The first and second diffuser sections 8022, 8024 are substantially continuous with one another so as to define a single continuous diffuser.

With reference to FIG. 66, the connection adapter 8021 comprises a mount 8034 for the dosing module 8008. The mount 8034 defines an opening 8036 within which a nozzle 8038 of the dosing module 8008 is received. The nozzle 8038 is positioned so that it is radially outwards of the side wall 8035 of the connection adapter 8006. However in other embodiments the nozzle 8038 may be substantially aligned with the side wall of the connection adapter 8006. The opening 8036 is positioned within the second diffuser section 8024. The nozzle 8038 is configured to generate a spray of aftertreatment fluid which is directed into the turbine outlet passage 8016 along a spray axis 8040. The spray axis 8040 is angled at around 7° downstream relative to a normal to the adapter axis 8021, however in other embodiments the spray axis 8040 may be angled at a different angle to the adapter axis 8021, for example normal to the adapter axis 8021. The spray of aftertreatment fluid defines a spray region 8042, the presence of which is shown schematically by dotted lines in FIG. 66. The mount 8034 and opening 8036 for the dosing module 8008 are positioned within the connection adapter 8006. However, in alternative embodiments the mount 8034 and opening 8036 for the dosing module 8008 may be positioned within the turbine housing 8002.

Because the mount 8034 and opening 8036 for the dosing module 8008 are positioned within the connection adapter 8006 or the turbine housing 8002, this means that the dosing module 8008 is positioned close to the turbine wheel. Accordingly this means that the injected aftertreatment fluid may take advantage of high exhaust gas temperatures which aid evaporation and decomposition. In this regard, the mount 8034, opening 8036 and dosing module 8008 are preferably positioned within a distance of no more than around 10 turbine wheel exducer diameters downstream of the turbine wheel (preferably no more than around 5 exducer diameters, and more preferably no more than around 3 exducer diameters). In this context, a turbine wheel exducer diameter is the diameter of the exducer portion of the turbine wheel, which is approximately equal to the diameter of the narrowest portion of the first diffuser section 8022. In the illustrated embodiment, the mount 8034, opening 8036 and dosing module 8008 are positioned within around 1.7 exducer diameters of the downstream end of the turbine wheel and turbine wheel chamber 8014. In other embodiments, the mount 8034, opening 8036 and dosing module 8008 may be positioned anywhere up to around 2 exducer diameters of the downstream end of the turbine wheel and turbine wheel chamber 8014, and are preferably located at least 1 exducer diameter downstream of the downstream end of the turbine wheel and turbine wheel chamber 8014.

The connection adapter 8006 comprises a sensor conduit 8044 having a sensor conduit inlet 8046 configured to receive an aliquot of exhaust gas from the turbine outlet passage 8016 and sensor conduit outlet 8048 configured to re-introduce exhaust gas from the sensor conduit 8044 to the turbine outlet passage 8016. The sensor conduit 8044 defines a flow area that is larger than the size of the sensor conduit inlet 8046. Accordingly, the sensor conduit 8044 acts to decelerate the exhaust gas passing therethrough. The sensor conduit comprises a mount 8050 configured to receive the NOx sensor 8010. The NOx sensor 8010 comprises a sensing tip 8052 which protrudes into the interior of the sensor conduit 8044. Because the geometry of the sensing conduit 8044 decelerates the exhaust gas passing therethrough, the sensing tip 8052 is exposed to lower velocity exhaust gas, thus reducing the risk of damage to the sensing tip 8052 and improving the accuracy of sensor readings.

With reference to FIGS. 66 and 67, the sensor conduit inlet 8046 is positioned upstream of the opening 8036 for the dosing module 8008. According, the risk of aftertreatment entering the sensor conduit 8044 and adversely affecting readings taken by the NOx sensor 8010 is eliminated. The sensor conduit 8044 is part of the second diffuser section 8024. However, in alternative embodiments the sensor conduit 8044 may be part of the first diffuser section 8022.

1. A turbine for a turbocharger, comprising:
a turbine inlet passage configured to receive exhaust gas from an internal combustion engine, the exhaust gas received by the turbine inlet passage defining a turbine bulk flow;
a turbine wheel chamber configured to receive the turbine bulk flow from the turbine inlet passage, the turbine wheel chamber configured to contain a turbine wheel supported for rotation about a turbine axis;
a turbine outlet passage configured to receive the turbine bulk flow from the turbine wheel chamber;
a dosing module configured to deliver a spray of aftertreatment fluid into a spray region of the turbine outlet passage through which the turbine bulk flow passes; and
an auxiliary passage configured to receive a portion of the turbine bulk flow, the portion of the turbine bulk flow received by the auxiliary passage defining an auxiliary flow;
wherein the auxiliary passage is configured to direct the auxiliary flow into the spray region of the turbine outlet passage.

2. A turbine according to claim 1, wherein the dosing module comprises a nozzle configured to generate the spray of aftertreatment fluid, and wherein the nozzle is substantially aligned with or radially outwards of a side wall of the turbine outlet passage.

3. A turbine according to claim 1, wherein the dosing module is configured to deliver the aftertreatment fluid in a spray direction, and the auxiliary passage is configured to direct the auxiliary flow into the spray region in an auxiliary flow direction generally normal to the spray direction.

4. A turbine according to claim 3, wherein the auxiliary flow direction is angularly inclined relative to a normal of the spray direction by an angle of up to around 30°.

5. A turbine according to any of claim 1, wherein the dosing module comprises a nozzle, and the auxiliary passage is configured to direct the auxiliary flow over the nozzle in a direction generally normal to the spray direction.

6. A turbine according to claim 1, wherein the dosing module is configured to deliver the aftertreatment fluid in a spray direction, and the auxiliary passage is configured to direct the auxiliary flow into the spray region in an auxiliary flow direction opposing the spray direction.

7. A turbine according to claim 6, wherein the auxiliary flow is oriented in an upstream direction in relation to the turbine bulk flow, and wherein the auxiliary flow direction is angularly inclined relative to the opposite of the spray direction by an angle of between around 50° to around 90°.

8. A turbine according to claim 6, wherein the auxiliary flow is oriented in a downstream direction in relation to the turbine bulk flow, and wherein the auxiliary flow direction is angularly inclined relative to the opposite of the spray direction by an angle of between around 30° to around 90°.

9. A turbine according to claim 6, wherein the auxiliary passage comprises an auxiliary passage outlet configured to deliver the auxiliary flow to the turbine outlet passage, and wherein the turbine further comprises a barrier member configured to substantially cover the auxiliary passage outlet from the perspective of the dosing module in the spray direction.

10. A turbine according to claim 1, wherein:
the auxiliary passage is configured to direct the auxiliary flow into the turbine outlet passage in an auxiliary flow direction facing a centreline of the turbine outlet passage; and
the dosing module is configured to deliver the aftertreatment fluid in a spray direction facing the centreline.

11. A turbine according to claim 1, wherein the auxiliary passage is configured to direct the auxiliary flow into the turbine outlet passage in an auxiliary flow direction facing downstream in relation to the turbine bulk flow, and
wherein the auxiliary flow direction is inclined relative to a centreline of the turbine outlet passage by an angle of at least around 45°.

12. A turbine according to claim 11, wherein the auxiliary flow direction is inclined relative to the centreline by an angle in the range of around 45° to around 90°, or around 45° to around 60°.

13. A turbine according to claim 1, wherein the auxiliary passage is configured to direct the auxiliary flow into the turbine outlet passage in an auxiliary flow direction facing upstream in relation to the turbine bulk flow, and
wherein the auxiliary flow direction is inclined relative to a centreline of the turbine outlet passage by an angle of at least around 45°.

14. (canceled)

15. (canceled)

16. A turbine according to claim 1, wherein the dosing module defines a spray direction, and wherein the spray direction is oriented upstream in relation to the turbine bulk flow.

17. (canceled)

18. A turbine according to claim 1, wherein the dosing module defines a spray direction, and wherein the spray direction is oriented downstream in relation to the turbine bulk flow.

19. (canceled)

20. (canceled)

21. (canceled)

22. A turbine according to claim 1, wherein the auxiliary passage comprises:
an auxiliary passage inlet positioned in the turbine inlet passage; and
an auxiliary passage outlet positioned in the turbine outlet passage.

23. A turbine according to claim 22, wherein the auxiliary passage comprises a valve configured to control the flow through the auxiliary passage.

24. (canceled)

25. (canceled)

26. (canceled)

27. (canceled)

28. (canceled)

29. (canceled)

30. (canceled)

31. (canceled)

32. (canceled)

33. (canceled)

34. A turbine according to claim 1, wherein the turbine outlet passage defines a diffuser portion, and wherein the dosing module is oriented such that the spray region is located within the diffuser portion.

35. A turbine according to claim 1, wherein the turbine comprises a turbine wheel having an exducer portion defining an exducer diameter, and wherein the dosing module is oriented such that at least a portion of the spray region is positioned within around 10 exducer diameters from the turbine wheel relative to a centreline of the turbine outlet passage.

36. (canceled)

37. (canceled)

38. A method of operating a turbine for a turbocharger, comprising:
receiving exhaust gas from an internal combustion engine into a turbine inlet passage, the exhaust gas received by the turbine inlet passage defining a turbine bulk flow;
receiving the turbine bulk flow from the turbine inlet passage into a turbine wheel chamber, the turbine wheel chamber configured to contain a turbine wheel supported for rotation about a turbine axis;
receiving the turbine bulk flow from the turbine wheel chamber into a turbine outlet passage;
delivering an aftertreatment fluid into a spray region of the turbine outlet passage through which the turbine bulk flow passes using a dosing module;
receiving a portion of the turbine bulk flow into an auxiliary passage, the portion of the turbine bulk flow received by the auxiliary passage defining an auxiliary flow; and
directing the auxiliary flow into the spray region of the turbine outlet passage.

39-362. (canceled)
